(19) United States
(12) Patent Application Publication
(10) Pub. No.: US 2026/0361439 A1
(43) Pub. Date: Nov. 12, 2026

(54) BROADCAST RECEIVING APPARATUS, CONTENT PROTECTION METHOD, REVERBERANT SOUND ADDITION PROCESSING METHOD, AND CONTROLLING METHOD OF BROADCAST RECEIVING APPARATUS

(71) Applicant: Maxell, Ltd., Kyoto (JP)

(72) Inventors: Nobuo MASUOKA, Kyoto (JP); Takuya SHIMIZU, Kyoto (JP); Yasunobu HASHIMOTO, Kyoto (JP); Kazuhiko YOSHIZAWA, Kyoto (JP); Hitoshi AKIYAMA, Kyoto (JP); Nobuaki KABUTO, Kyoto (JP)

(21) Appl. No.: 19/100,334

(22) PCT Filed: Aug. 10, 2023
(86) PCT No.: PCT/JP2023/029279

§ 371 Date: Jan. 31, 2025

(30) Foreign Application Priority Data
Aug. 3, 2022 (JP) 2022-123799
Sep. 22, 2022 (JP) 2022-151952
Nov. 11, 2022 (JP) 2022-181025

(51) Int. Cl. H04H 20/59; H04H 40/18

(52) U.S. Cl. CPC H04H 20/59; H04H 40/18

(57) ABSTRACT

Provided is a technique for more favorably transmitting or receiving an advanced digital broadcasting service. A broadcast receiving apparatus is capable of receiving a signal of each sound source via a broadcasting wave and includes: a broadcast receiver configured to receive the broadcasting wave; an audio output unit including a plurality of speakers and configured to output audio in accordance with the signal of each sound source transmitted from the broadcast receiving apparatus; and a controller. The controller determines a reproduction position of the audio based on the signal of each sound source according to arrangement information of the plurality of speakers, calculates a signal corresponding to a 22.2 ch audio channel based on the signal of each sound source, and then converts the signal corresponding to the 22.2 ch audio channel into a signal for the audio output unit.

### TECHNICAL FIELD

The present invention relates to a broadcast receiving apparatus, a content protection method, a reverberant sound addition processing method, and a controlling method of broadcast receiving apparatus.

### BACKGROUND ART

A digital broadcasting service has been started in each country since the latter half of the 1990s in place of a conventional analog broadcasting service. The digital broadcasting service realized improvement of broadcasting quality using an error correction technique, multi-channel and HD (High Definition) using a compression coding technique, and multimedia of a service using a BML (Broadcast Markup Language) or HTML5 (Hyper Text Markup Language version 5).

In recent years, for the purpose of further improvement of a spectral efficiency, higher resolution, and higher functionality, consideration of an advanced digital broadcasting method is caused to proceed in each country.

### RELATED ART DOCUMENTS

### Patent Documents

Patent document 1: Japanese Unexamined Patent Application Publication No. 2016-144020

### SUMMARY OF THE INVENTION

### Problems to be Solved by the Invention

More than ten years have already passed since the service of the existing digital broadcasting was started, and broadcast receiving apparatuses capable of receiving an existing digital broadcasting service are widespread sufficiently. For this reason, it is necessary to consider compatibility with the existing digital broadcasting service when an advanced digital broadcasting service, which is currently considered, is to be started. Namely, it is preferable that UHD (Ultra High Definition) of a video signal is realized while maintaining viewing environment of the existing digital broadcasting service.

There is a system described in Patent document 1 as a technique for realizing UHD broadcasting in the digital broadcasting service. However, the system described in Patent document 1 is one by which the existing digital broadcasting is replaced, and does not take into consideration the maintenance of the viewing environment of the existing digital broadcasting service.

An object of the present invention is to provide a technique for transmitting or receiving a higher functional advanced digital broadcasting service more favorably in consideration of compatibility with an existing digital broadcasting service.

### Means for Solving the Problem

Techniques described in the following claims are used as means for solving the problem.

As one example, the following broadcast receiving apparatus may be used, that is, a broadcast receiving apparatus capable of receiving a signal of each sound source via a broadcasting wave, the broadcast receiving apparatus comprising: a broadcast receiver configured to receive the broadcasting wave; an audio output unit including a plurality of speakers and configured to output audio according to the signal of each sound source transmitted from the broadcast receiving apparatus; and a controller, in which the controller determines a reproduction position of the audio based on the signal of each sound source according to arrangement information of the plurality of speakers, calculates a signal corresponding to a 22.2 ch audio channel based on the signal of each sound source, and then converts the signal corresponding to the 22.2 ch audio channel into a signal for the audio output unit.

### Effects of the Invention

According to the present invention, it is possible to provide a technique for transmitting or receiving an advanced digital broadcasting service more favorably.

### BRIEF DESCRIPTIONS OF THE DRAWINGS

FIG. 1 is a system configuration diagram of a broadcasting system according to one embodiment of the present invention.

FIG. 2A is a block diagram of a broadcast receiving apparatus according to one embodiment of the present invention.

FIG. 2B is a detailed block diagram of a first tuner/demodulator in the broadcast receiving apparatus according to one embodiment of the present invention.

FIG. 2C is a detailed block diagram of a second tuner/demodulator in the broadcast receiving apparatus according to one embodiment of the present invention.

FIG. 2D is a detailed block diagram of a third tuner/demodulator in the broadcast receiving apparatus according to one embodiment of the present invention.

FIG. 2E is a detailed block diagram of a fourth tuner/demodulator in the broadcast receiving apparatus according to one embodiment of the present invention.

FIG. 2F is a detailed block diagram of a first decoder in the broadcast receiving apparatus according to one embodiment of the present invention.

FIG. 2G is a detailed block diagram of a second decoder in the broadcast receiving apparatus according to one embodiment of the present invention.

FIG. 2H is a software configuration diagram of the broadcast receiving apparatus according to one embodiment of the present invention.

FIG. 3A is a configuration diagram of a broadcast station server according to one embodiment of the present invention.

FIG. 3B is a configuration diagram of a service provider server according to one embodiment of the present invention.

FIG. 3C is a block diagram of a portable information terminal according to one embodiment of the present invention.

FIG. 3D is a software configuration diagram of the portable information terminal according to one embodiment of the present invention.

FIG. 4A is a diagram for explaining a segment configuration for digital broadcasting according to one embodiment of the present invention.

FIG. 4B is a diagram for explaining layer allocation in layer transmission for the digital broadcasting according to one embodiment of the present invention.

FIG. 4C is a diagram for explaining a generating process for an OFDM transmission wave for the digital broadcasting according to one embodiment of the present invention.

FIG. 4D is a diagram for explaining a basic configuration of a transmission path coder for the digital broadcasting according to one embodiment of the present invention.

FIG. 4E is a diagram for explaining an OFDM type segment parameter for the digital broadcasting according to one embodiment of the present invention.

FIG. 4F is a diagram for explaining a transmission signal parameter for the digital broadcasting according to one embodiment of the present invention.

FIG. 4G is a diagram for explaining arrangement of a pilot signal of a synchronous modulation segment for the digital broadcasting according to one embodiment of the present invention.

FIG. 4H is a diagram for explaining arrangement of a pilot signal of a differential modulation segment for the digital broadcasting according to one embodiment of the present invention.

FIG. 5A is a diagram for explaining bit allocation of a TMCC carrier for the digital broadcasting according to one embodiment of the present invention.

FIG. 5B is a diagram for explaining bit allocation of TMCC information for the digital broadcasting according to one embodiment of the present invention.

FIG. 5C is a diagram for explaining transmission parameter information of the TMCC information for the digital broadcasting according to one embodiment of the present invention.

FIG. 5D is a diagram for explaining system identification of the TMCC information for the digital broadcasting according to one embodiment of the present invention.

FIG. 5E is a diagram for explaining a carrier modulation mapping method of the TMCC information for the digital broadcasting according to one embodiment of the present invention.

FIG. 5F is a diagram for explaining frequency converting process identification of the TMCC information for the digital broadcasting according to one embodiment of the present invention.

FIG. 5G is a diagram for explaining physical channel number identification of the TMCC information for the digital broadcasting according to one embodiment of the present invention.

FIG. 5H is a diagram explaining main signal identification of the TMCC information for the digital broadcasting according to one embodiment of the present invention.

FIG. 5I is a diagram for explaining 4K signal transmission layer identification of the TMCC information for the digital broadcasting according to one embodiment of the present invention.

FIG. 5J is a diagram for explaining additional layer transmission identification of the TMCC information for the digital broadcasting according to one embodiment of the present invention.

FIG. 5K is a diagram for explaining identification of a code rate of an inner code of the TMCC information for the digital broadcasting according to one embodiment of the present invention.

FIG. 6A is a diagram for explaining bit allocation of an AC signal for the digital broadcasting according to one embodiment of the present invention.

FIG. 6B is a diagram for explaining configuration identification of the AC signal for the digital broadcasting according to one embodiment of the present invention.

FIG. 6C is a diagram for explaining seismic motion warning information of the AC signal for the digital broadcasting according to one embodiment of the present invention.

FIG. 6D is a diagram for explaining signal identification of the seismic motion warning information of the AC signal for the digital broadcasting according to one embodiment of the present invention.

FIG. 6E is a diagram for explaining seismic motion warning detailed information of the seismic motion warning information of the AC signal for the digital broadcasting according to one embodiment of the present invention.

FIG. 6F is a diagram for explaining the seismic motion warning detailed information of the seismic motion warning information of the AC signal for the broadcasting according to one embodiment of the present invention.

FIG. 6G is a diagram for explaining additional information regarding a transmission control of a modulation wave of the AC signal for the digital broadcasting according to one embodiment of the present invention.

FIG. 6H is a diagram for explaining transmission parameter additional information of the AC signal for the digital broadcasting according to one embodiment of the present invention.

FIG. 6I is a diagram for explaining an error correcting method of the AC signal for the digital broadcasting according to one embodiment of the present invention.

FIG. 6J is a diagram for explaining a constellation form of the AC signal for the digital broadcasting according to one embodiment of the present invention.

FIG. 7A is a diagram for explaining a dual-polarized transmission method according to one embodiment of the present invention.

FIG. 7B is a system configuration diagram of the broadcasting system using the dual-polarized transmission method according to one embodiment of the present invention.

FIG. 7C is a system configuration diagram of the broadcasting system using the dual-polarized transmission method according to one embodiment of the present invention.

FIG. 7D is a diagram for explaining a frequency converting process according to one embodiment of the present invention.

FIG. 7E is a diagram for explaining a configuration of a pass-through transmission method according to one embodiment of the present invention.

FIG. 7F is a diagram for explaining a pass-through transmission band according to one embodiment of the present invention.

FIG. 7G is a diagram for explaining a configuration of the pass-through transmission method according to one embodiment of the present invention.

FIG. 7H is a diagram for explaining the pass-through transmission band according to one embodiment of the present invention.

FIG. 7I is a diagram for explaining the pass-through transmission band according to one embodiment of the present invention.

FIG. 7J is a diagram for explaining a single-polarized transmission method according to one embodiment of the present invention.

FIG. 7K is a system configuration diagram of a broadcasting system using the single-polarized transmission method according to one embodiment of the present invention.

FIG. 7L is a system configuration diagram of the broadcasting system using the single-polarized transmission method according to one embodiment of the present invention.

FIG. 8A is a diagram for explaining a layered division multiplexing transmission method according to one embodiment of the present invention.

FIG. 8B is a system configuration diagram of the broadcasting system using the layered division multiplexing transmission method according to one embodiment of the present invention.

FIG. 8C is a diagram for explaining a frequency conversion amplification process according to one embodiment of the present invention.

FIG. 8D is a system configuration diagram of the broadcasting system using the layered division multiplexing transmission method according to one embodiment of the present invention.

FIG. 9A is a diagram for explaining a protocol stack of an MPEG-2 TS.

FIG. 9B is a diagram for explaining names and functions of tables used in the MPEG-2 TS.

FIG. 9C is a diagram for explaining names and functions of the tables used in the MPEG-2 TS.

FIG. 9D is a diagram for explaining names and functions of descriptors used in the MPEG-2 TS.

FIG. 9E is a diagram for explaining names and functions of descriptors used in the MPEG-2 TS.

FIG. 9F is a diagram for explaining names and functions of descriptors used in the MPEG-2 TS.

FIG. 9G is a diagram for explaining names and functions of descriptors used in the MPEG-2 TS.

FIG. 9H is a diagram for explaining names and functions of descriptors used in the MPEG-2 TS.

FIG. 9I is a diagram for explaining names and functions of descriptors used in the MPEG-2 TS.

FIG. 10A is a diagram for explaining a protocol stack in a broadcast transmission path of MMT.

FIG. 10B is a diagram for explaining the protocol stack in a communication line of the MMT.

FIG. 10C is a diagram for explaining names and functions of tables used in TLV-SI of the MMT.

FIG. 10D is a diagram for explaining names and functions of descriptors used in the TLV-SI of the MMT.

FIG. 10E is a diagram for explaining names and functions of messages used in MMT-SI of the MMT.

FIG. 10F is a diagram for explaining names and functions of tables used in the MMT-SI of the MMT.

FIG. 10G is a diagram for explaining names and functions of descriptors used in the MMT-SI of the MMT.

FIG. 10H is a diagram for explaining names and functions of descriptors used in the MMT-SI of the MMT.

FIG. 10I is a diagram for explaining names and functions of descriptors used in the MMT-SI of the MMT.

FIG. 10J is a diagram for explaining a relation between data transmission of an MMT method and respective tables.

FIG. 11A is an operation sequence diagram of a channel setting process by a broadcast receiving apparatus according to one embodiment of the present invention.

FIG. 11B is a diagram for explaining a data structure of a network information table.

FIG. 11C is a diagram for explaining a data structure of a terrestrial delivery system descriptor.

FIG. 11D is a diagram for explaining a data structure of a service list descriptor.

FIG. 11E is a diagram for explaining a data structure of a TS information descriptor.

FIG. 12A is an appearance diagram of a remote controller according to one embodiment of the present invention.

FIG. 12B is a diagram for explaining banner display at the time of channel selection according to one embodiment of the present invention.

FIG. 13A is a diagram for explaining speaker arrangement.

FIG. 13B is a diagram for explaining speaker arrangement.

FIG. 13C is a diagram for explaining speaker arrangement.

FIG. 14A is a diagram for explaining a positional relationship when a headphone is used.

FIG. 14B is a diagram for explaining a positional relationship when the headphone is used.

FIG. 15A is a configuration example of an audio decoder for an audio signal having only a channel-based signal.

FIG. 15B is a configuration example of an audio decoder for an advanced audio signal.

FIG. 16 is an example of arrangement information of a speaker system.

FIG. 17A is default values of downmix coefficients from a 22.2 ch signal to a 5.1 ch signal.

FIG. 17B is default values of downmix coefficients from the 5.1 ch signal to a 2 ch signal.

FIG. 18 is an example of a screen for selecting a speaker system to be used for audio reproduction.

FIG. 19 is a diagram for explaining metadata of an object-based signal.

FIG. 20A is an example of metadata for specifying a reproduction position of the object-based signal.

FIG. 20B is an example of the metadata for specifying the reproduction position of the object-based signal.

FIG. 20C is an example of the metadata for specifying the reproduction position of the object-based signal.

FIG. 21 is an example of a screen for selecting the reproduction position of the object-based signal.

FIG. 22 is an example of a screen for setting the reproduction position of the object-based signal.

FIG. 23 is an example of the metadata for specifying the reproduction position of the object-based signal.

FIG. 24A is an example of stream data for specifying a reproduction position of the object-based signal.

FIG. 24B is an example of the stream data for specifying the reproduction position of the object-based signal.

FIG. 24C is an example of the stream data for specifying the reproduction position of the object-based signal.

FIG. 25 is a diagram for explaining the number of signals of a HOA method signal.

FIG. 26 is a diagram of a selection screen for selecting an audio signal for each output device.

FIG. 27 is a diagram for explaining audio reproduction in a cooperation device.

FIG. 28A is a diagram for explaining parameters describing the number of audio signals to be transmitted and an acquisition destination.

FIG. 28B is a diagram for explaining a data structure of an audio component descriptor.

FIG. 28C is a diagram for explaining data of an audio component type.

FIG. 29A is an example of displaying an audio signal to be transmitted in an electronic program guide.

FIG. 29B is an example of displaying the audio signal to be transmitted in the electronic program guide.

FIG. 30 is a display example of a signal source and the output device.

FIG. 31A is a diagram for explaining an example of control of content protection processing according to the present embodiment.

FIG. 31B is a diagram for explaining an example of the control of the content protection processing according to the present embodiment.

FIG. 32A is a diagram for explaining an example of the control of the content protection processing according to the present embodiment.

FIG. 32B is a diagram for explaining an example of the control of the content protection processing according to the present embodiment.

FIG. 33 is a diagram illustrating an example of a reverberant sound processing flow when the headphone is used.

FIG. 34A is a diagram illustrating an example of an audio output setting menu.

FIG. 34B is a diagram illustrating an example of a detailed menu for reverberant sound setting.

FIG. 34C is a diagram illustrating an example of banner display indicating a reverberant sound processing state.

FIG. 34D is a diagram illustrating an example of the banner display in partially enlarged display of a broadcast image.

FIG. 34E is a diagram for explaining viewing conditions before and after the partially enlarged display of the broadcast image.

FIG. 35 is a flowchart illustrating a switching operation of a sound image localization mode of the present embodiment.

FIG. 36A is a diagram illustrating an example of an appearance of a remote controller of the present embodiment.

FIG. 36B is a diagram illustrating an example of banner display for setting the sound image localization mode of the present embodiment.

FIG. 37 is a flowchart illustrating a correction operation of θ in a case where the sound image localization mode of the present modification is non-fixed.

### DETAILED DESCRIPTION OF PREFERRED EMBODIMENTS

Hereinafter, an example of an embodiment of the present invention will be described with reference to the drawings.

### First Embodiment

### [System Configuration]

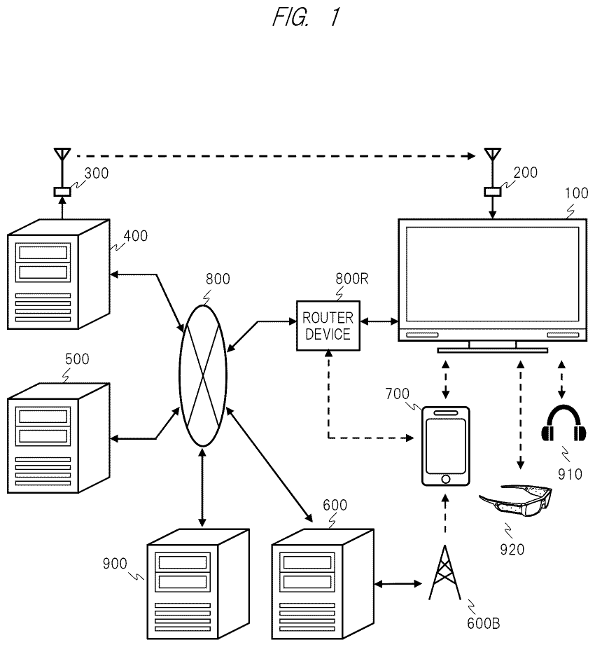

FIG. 1 is a system configuration diagram illustrating one example of a configuration of a broadcasting system.

The broadcasting system is configured by, for example, a broadcast receiving apparatus 100 and an antenna 200, a radio tower 300 and a broadcast station server 400 of a broadcast station, a service provider server 500, a mobile phone communication server 600 and a base station 600B for a mobile phone communication network, a portable information terminal 700, a broadband network 800 such as the Internet and a router device 800R, an information server 900, a headphone 910, and a head mounted display (HMD) 920. Note that the broadcasting system may include either one of the headphone 910 and the HMD 920, or may include a speaker system (not illustrated) instead of the headphone 910 and the HMD 920. Further, various kinds of server apparatuses and communication equipment may further be connected to the Internet 800.

The broadcast receiving apparatus 100 is a television receiver provided with a receiving function for an advanced digital broadcasting service. The broadcast receiving apparatus 100 may further include a receiving function for an existing digital broadcasting service. Moreover, the broadcast receiving apparatus 100 is compatible with a broadcasting/communication cooperation system that combines acquisition of additional content via a broadband network, arithmetic processing by a server apparatus, a presenting process by cooperation with portable terminal equipment, and the like with the digital broadcasting service by linking functions using the broadband network to the digital broadcasting service (the existing digital broadcasting service or the advanced digital broadcasting service). The broadcast receiving apparatus 100 receives a digital broadcasting wave sent out from the radio tower 300 via the antenna 200. The digital broadcasting wave may directly be transmitted from the radio tower 300 to the antenna 200, or may be transmitted via a broadcast satellite or a communication satellite (whose illustration is omitted). A broadcasting signal retransmitted by a cable television station may be received via a cable line or the like. Further, the broadcast receiving apparatus 100 can be connected to the Internet 800 via the router device 800R, and can transmit and receive data by communication with each server apparatus on the Internet 800.

The router device 800R is connected to the Internet 800 with wireless communication or wired communication; is connected to the broadcast receiving apparatus 100 with wired communication; and is connected to the portable information terminal 700 with wireless communication. This makes it possible to mutually execute transmission and reception of data among each server apparatus on the Internet 800, the broadcast receiving apparatus 100, and the portable information terminal 700 via the router device 800R. The router device 800R, the broadcast receiving apparatus 100, and the portable information terminal 700 constitute a LAN (Local Area Network). Note that communication between the broadcast receiving apparatus 100 and the portable information terminal 700 may be executed directly by a method such as BlueTooth (registered trademark) or NFC (Near Field Communication) without the router device 800R.

The radio tower 300 is a broadcasting facility of the broadcast station, and sends out the digital broadcasting wave including various kinds of control information and content data of a broadcasting program (such as moving image content or audio content) according to the digital broadcasting service. Further, the broadcast station includes the broadcast station server 400. The broadcast station server 400 stores metadata such as content data of broadcasting programs and program titles of the respective broadcasting programs, program IDs, program summaries, casts, broadcasting dates, or the like. The broadcast station server 400 provides the content data or the metadata with a service provider on the basis of a contract. Provision of the content data and the metadata to the service provider is executed through an API (Application Programming Interface) included in the broadcast station server 400.

The service provider server 500 is a server apparatus that the service provider prepares for providing a service by the broadcasting/communication cooperation system. The service provider server 500 executes storage, management, distribution, and the like of the content data and the metadata provided from the broadcast station server 400 and content data and applications (such as at least one of operating program or various kinds of data) created for the broadcasting/communication cooperation system. Further, the service provider server 500 also has a function to execute search of providable applications or provision of a list in response to an inquiry from the television receiver. Note that different server apparatuses may respectively execute storage, management, and distribution of the content data and the metadata, and storage, management, and distribution of the applications. The broadcast station may be the same as the service provider, or may be a different provider. A plurality of service provider servers 500 may respectively be prepared for different services. Further, the broadcast station server 400 may be combined with the functions of the service provider server 500.

The mobile phone communication server 600 is connected to the Internet 800, and is also connected to the portable information terminal 700 via the base station 600B. The mobile phone communication server 600 manages telephone communication (telephone call), and transmission and reception of data via the mobile phone communication network of the portable information terminal 700, and allows transmission and reception of data by communication between the portable information terminal 700 and each server apparatus on the Internet 800. Note that the communication between the portable information terminal 700 and the broadcast receiving apparatus 100 may be executed via the base station 600B, the mobile phone communication server 600, the Internet 800, and the router device 800R.

The information server 900 is a server device that provides information on a sound field environment of a concert hall or a theater. The information server 900 provides information that content in a case where sound field complements a broadcast environment metadata is not or insufficient in the broadcast content. For example, in a case where a name of a theater where the play take places is indicated from a title or metadata of the broadcast content, information stored in the information server is searched from the theater name, thereby acquiring information on the sound field environment of the theater and the like. The information server 900 may provide not only the environment information of a performance venue but also a head-related transfer function that considers sound reproduction with the headphone 910. The sound field environment and the head-related transfer function may be provided so as to include a transfer function that considers a deaf person. The information server 900 may have the function of acquiring brain waves of a viewer and arranging a sound field environment and a head-related transfer function suitable for the viewer.

The HMD 920 receives video and audio data from the broadcast receiving apparatus 100, and displays the video and reproduces the audio for the viewer.

### [Hardware Configuration of Broadcast Receiving Apparatus]

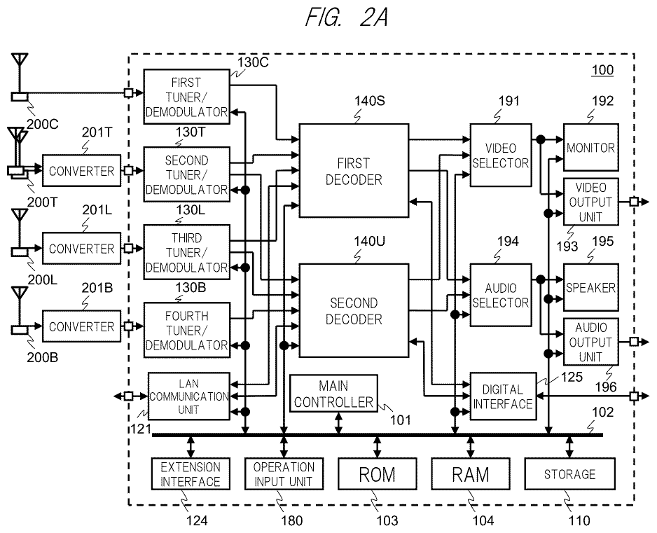

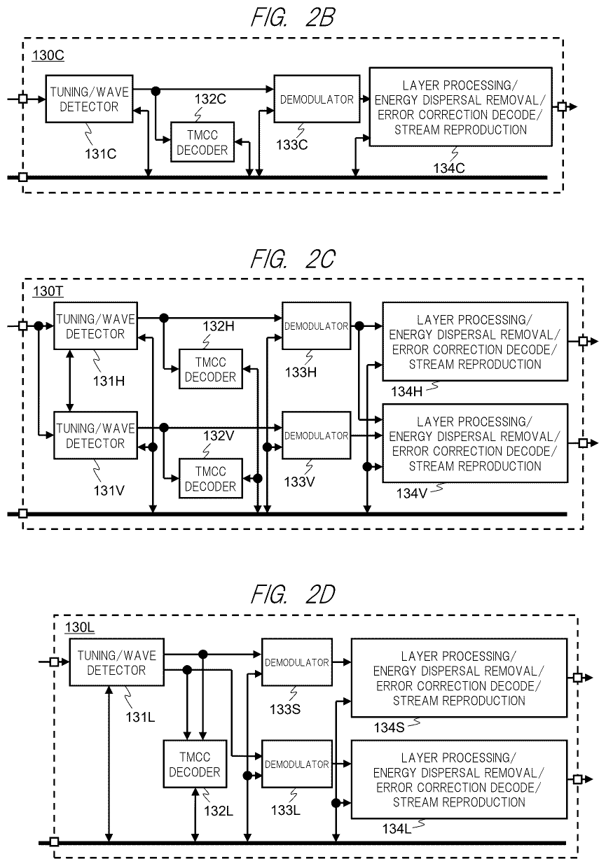

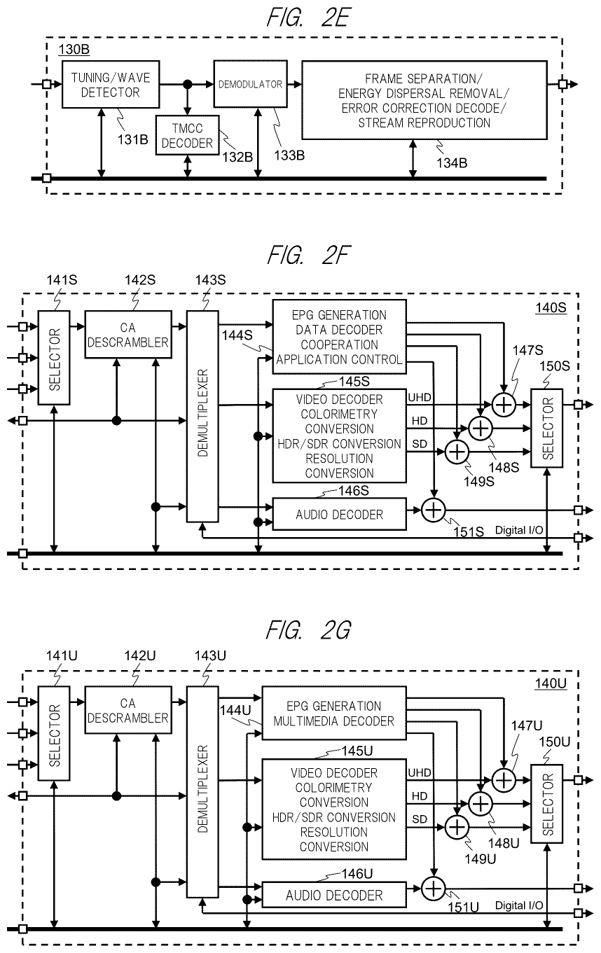

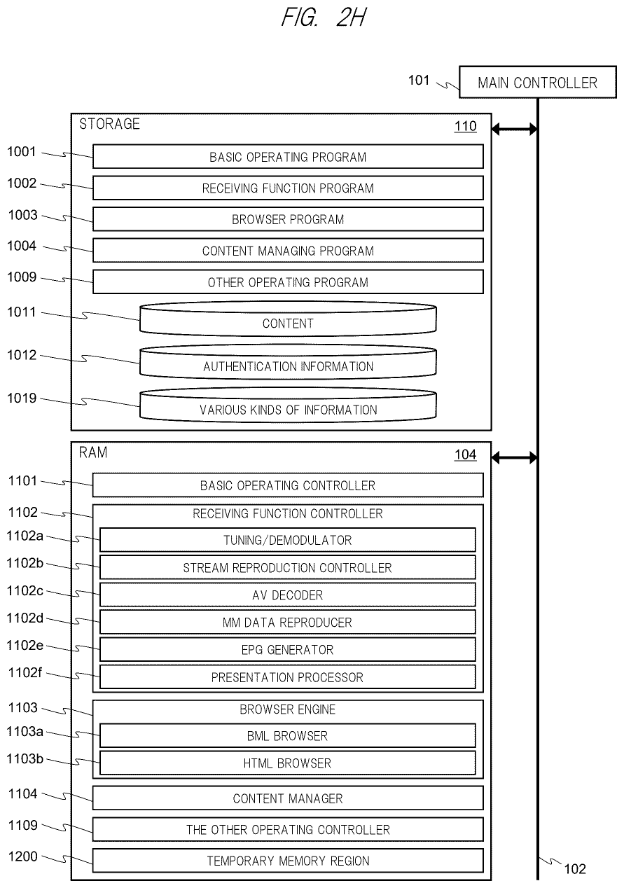

FIG. 2A is a block diagram illustrating one example of an internal configuration of the broadcast receiving apparatus 100.

The broadcast receiving apparatus 100 is configured by a main controller 101, a system bus 102, a ROM 103, a RAM 104, a storage (accumulator) 110, a LAN communication unit 121, an extension interface 124, a digital interface 125, a first tuner/demodulator 130C, a second tuner/demodulator 130T, a third tuner/demodulator 130L, a fourth tuner/demodulator 130B, a first decoder 140S, a second decoder 140U, an operation input unit 180, a video selector 191, a monitor 192, a video output unit 193, an audio selector 194, a speaker 195, and an audio output unit 196.

The main controller 101 is a microprocessor unit that controls the whole broadcast receiving apparatus 100 in accordance with a predetermined operating program. The system bus 102 is a communication path for executing transmission and reception of various kinds of data or commands between the main controller 101 and each of operating blocks in the broadcast receiving apparatus 100.

The ROM (Read Only Memory) 103 is a non-volatile memory in which a basic operating program such as an operating system and other operating programs are stored, for example, and a rewritable ROM such as an EEPROM (Electrically Erasable Programmable ROM) or a flash ROM is used for the ROM 103. Further, operating set values and the like necessary for operations of the broadcast receiving apparatus 100 are stored in the ROM 103. The RAM (Random Access Memory) 104 serves as a work area when the basic operating program or the other operating program is executed. The ROM 103 and the RAM 104 may be configured integrally with the main controller 101. Further, instead of the independent configuration illustrated in FIG. 2A, a partial memory region in the storage (accumulator) 110 may be used as the ROM 103.

An operating program and operating set values of the broadcast receiving apparatus 100, and personal information of a user of the broadcast receiving apparatus 100 are stored in the storage (accumulator) 110. Further, an operating program downloaded via the Internet 800 and various kinds of data created by the operating program can be stored in the storage (accumulator) 110. Further, content such as moving images, still images, or audios, which are obtained from a broadcast wave or downloaded via the Internet 800 can be stored in the storage (accumulator) 110. All or a part of functions of the ROM 103 may be substituted by a partial area of the storage (accumulator) 110. Further, the storage (accumulator) 110 is required to hold stored information even in a state where power is not supplied to the broadcast receiving apparatus 100 from the outside. Therefore, for example, a device including a semiconductor element memory such as a flash ROM or an SSD (Solid State Drive) or a magnetic disk drive such as an HDD (Hard Disc Drive) is used as the storage (accumulator) 110.

Note that each of the operating programs stored in the ROM 103 or the storage (accumulator) 110 can be added, updated, and functionally extended by a downloading process from each server apparatus on the Internet 800 or the broadcast wave.

The LAN communication unit 121 is connected to the Internet 800 via the router device 800R, and executes transmission and reception of data with each of the server apparatuses or the other communication equipment on the Internet 800. Further, the LAN communication unit 121 executes acquisition of content data (or a which are transmitted via a part thereof) of a program, communication line. The LAN communication unit 121 may be connected to the router device 800R through wired communication or wireless communication such as Wi-Fi (registered trademark). The LAN communication unit 121 includes a coding circuit and a decoding circuit. Further, the broadcast receiving apparatus 100 may further be provided with the other communication unit such as a BlueTooth (registered trademark) communication unit, an NFC communication unit, or an infrared communication unit.

Each of the first tuner/demodulator 130C, the second tuner/demodulator 130T, the third tuner/demodulator 130L, and the fourth tuner/demodulator 130B receives the broadcast wave of the digital broadcasting service, and executes a channel selecting process (channel selection) by tuning a channel for a predetermined service on the basis of a control of the main controller 101. Moreover, each of the first tuner/demodulator 130C, the second tuner/demodulator 130T, the third tuner/demodulator 130L, and the fourth tuner/demodulator 130B executes a demodulating process of a modulation wave from a received signal, a waveform shaping process, a reconfiguring process of a frame structure and a layer structure, energy dispersal removal, and error correction decoding process to reproduce a packet stream. Further, each of the first tuner/demodulator 130C, the second tuner/demodulator 130T, the third tuner/demodulator 130L, and the fourth tuner/demodulator 130B executes an extracting and decoding process for a transmission TMCC (Transmission Multiplexing Configuration Control) signal from the received signal.

Note that a digital broadcasting wave of an existing terrestrial digital broadcasting service received by an antenna 200C, which is an antenna for receiving existing terrestrial digital broadcasting, can be inputted into the first tuner/demodulator 130C. Further, one broadcasting signal of a polarized wave of a horizontal (H) polarization signal and a vertical (V) polarization signal of dual-polarized terrestrial digital broadcasting (described later) can also be inputted into the first tuner/demodulator 130C to demodulate a segment of a layer adopting the same modulation method as that of the existing terrestrial digital broadcasting service. Further, a broadcasting signal of single-polarized terrestrial digital broadcasting (described later) can also be inputted into the first tuner/demodulator 130C to demodulate a segment of a layer adopting the same modulation method as that of the existing terrestrial digital broadcasting service. Further, a broadcasting signal of layered division multiplexing terrestrial digital broadcasting (described later) can also be inputted into the first tuner/demodulator 130C to demodulate a segment of a layer adopting the same modulation method as that of the existing terrestrial digital broadcasting service.

A digital broadcasting wave of an advanced terrestrial digital broadcasting service received by an antenna 200T, which is an antenna for receiving the dual-polarized terrestrial digital broadcasting, is inputted into the second tuner/demodulator 130T via a converter 201T. Note that a digital broadcasting wave of an advanced terrestrial digital broadcasting service received by an antenna for receiving the single-polarized terrestrial digital broadcasting (not illustrated) may be inputted into the second tuner/demodulator 130T. In a case where the digital broadcasting wave of the advanced terrestrial digital broadcasting service is inputted into the second tuner/demodulator 130T from the antenna for receiving the single-polarized terrestrial digital broadcasting (not illustrated), the converter 201T may not be interposed. Note that the antenna 200T that receives the digital broadcasting wave of the dual-polarized terrestrial digital broadcasting includes an element that receives a horizontal polarization signal and an element that receives a vertical polarization signal. The antenna for receiving single-polarized terrestrial digital broadcasting (not illustrated) includes one of an element that receives a horizontal polarization signal and an element that receives a vertical polarization signal. The antenna for receiving single-polarized terrestrial digital broadcasting (not illustrated) may be shared with the antenna 200C, which is an antenna for receiving the existing terrestrial digital broadcasting.

The digital broadcasting wave of the advanced terrestrial digital broadcasting service received by an antenna 200L, which is an antenna for receiving the layered division multiplexing terrestrial digital broadcasting, is inputted into the third tuner/demodulator 130L via a converter 201L.

A digital broadcasting wave of an advanced BS (Broadcasting Satellite) digital broadcasting service or an advanced CS (Communication Satellite) digital broadcasting service received by an antenna 200B, which is an antenna for receiving both BS/CS, is inputted into the fourth tuner/demodulator 130B via a converter 201B.

Note that the expression “tuner/demodulator” means a component provided with a tuner function and a demodulator function.

Further, the antenna 200C, the antenna 200T, the antenna 200L, the antenna 200B, the converter 201T, the converter 201L, the converter 201B do not constitute a part of the broadcast receiving apparatus 100, and belong to a facility side such as a building in which the broadcast receiving apparatus 100 is installed.

Further, the existing terrestrial digital broadcasting described above is a broadcasting signal of a terrestrial digital broadcasting service for transmitting video whose maximum resolution is 1920 horizontal pixels×1080 vertical pixels.

Further, details of the dual-polarized terrestrial digital broadcasting (advanced terrestrial digital broadcasting adopting a dual-polarized transmission method) and the single-polarized terrestrial digital broadcasting (advanced terrestrial digital broadcasting adopting a single-polarized transmission method) will be described later. However, it is a broadcasting signal of the terrestrial digital broadcasting service in which video whose maximum resolution is the number of pixels that exceeds 1920 horizontal pixels×1080 vertical pixels can be transmitted. The dual-polarized terrestrial digital broadcasting is terrestrial digital broadcasting using a plurality of polarized waves including a horizontal (H) polarized wave and a vertical (V) polarized wave, and the terrestrial digital broadcasting service in which the video whose maximum resolution is the number of pixels that exceeds 1920 horizontal pixels×1080 vertical pixels can be transmitted is transmitted by a part of divided segments in both the polarized waves of the plurality of polarized waves. The single-polarized terrestrial digital broadcasting is terrestrial digital broadcasting using either polarized wave of a horizontal (H) polarized wave and a vertical (V) polarized wave, and the terrestrial digital broadcasting service in which the video whose maximum resolution is the number of pixels that exceeds 1920 horizontal pixels×1080 vertical pixels can be transmitted is transmitted by a part of divided segments.

Note that in the explanation of each embodiment of the present invention, in a case where the expression “a plurality of polarized waves” is used for the dual-polarized terrestrial digital broadcasting, it means the two polarized waves of the horizontal (H) polarized wave and the vertical (V) polarized wave unless otherwise stated. Further, even in a case where the expression “polarized wave” is simply used, it means the “polarization signal”. Further, in one polarized wave or both the polarized waves of the plurality of polarized waves, the existing terrestrial digital broadcasting described above in which the video whose maximum resolution is 1920 horizontal pixels×1080 vertical pixels is transmitted by a part of divided segments can be transmitted by the same modulation method. Namely, in the dual-polarized terrestrial digital broadcasting, by different segments of the plurality of polarized waves according to each embodiment of the present invention, the existing terrestrial digital broadcasting service in which the video whose maximum resolution is 1920 horizontal pixels×1080 vertical pixels is transmitted and the terrestrial digital broadcasting service in which the video whose maximum resolution is the number of pixels that exceeds 1920 horizontal pixels×1080 vertical pixels can be transmitted can be transmitted at the same time. Further, the single-polarized terrestrial digital broadcasting can transmit the above-described existing terrestrial digital broadcasting in which a video having a maximum resolution of 1920 horizontal pixels×1080 vertical pixels is transmitted in some of the divided segments by the same modulation method. Namely, in single-polarized terrestrial digital broadcasting, by different segments according to each embodiment of the present invention, the existing terrestrial digital broadcasting service in which the video whose maximum resolution is 1920 horizontal pixels×1080 vertical pixels is transmitted and the terrestrial digital broadcasting service in which the video whose maximum resolution is the number of pixels that exceeds 1920 horizontal pixels×1080 vertical pixels can be transmitted can be transmitted at the same time.

Further, although details of the layered division multiplexing terrestrial digital broadcasting (that is, the advanced terrestrial digital broadcasting adopting a layered division multiplexing transmission method) will be described later, signal of the terrestrial digital it is a broadcasting broadcasting service in which the video whose maximum resolution is the number of pixels that exceeds 1920 horizontal pixels×1080 vertical pixels can be transmitted. The layered division multiplexing terrestrial digital broadcasting multiplexes a plurality of digital broadcasting signals whose signal levels are different from each other. Note that the digital broadcasting signals whose signal levels are different from each other means that electric powers with which the digital broadcasting signals are transmitted are different from each other. The layered division multiplexing terrestrial digital broadcasting according to each embodiment of the present invention can transmit, as the plurality of digital broadcasting signals whose signal levels are different from each other, a broadcasting signal of the existing terrestrial digital broadcasting service in which video whose maximum resolution is 1920 horizontal pixels×1080 vertical pixels is transmitted and a broadcasting signal of the terrestrial digital broadcasting service in which the video whose maximum resolution is the number of pixels that exceeds 1920 horizontal pixels×1080 vertical pixels can be transmitted by multiplexing these broadcasting signals as layers with a frequency band of the same physical channel. Namely, in the layered division multiplexing terrestrial digital broadcasting according to each embodiment of the present invention, by a plurality of layers whose signal levels are different from each other, it is possible to transmit the existing terrestrial digital broadcasting service in which the video whose maximum resolution is 1920 horizontal pixels×1080 vertical pixels is transmitted and the terrestrial digital broadcasting in which video whose maximum resolution is the number of pixels that exceeds 1920 horizontal pixels×1080 vertical pixels can be transmitted at the same time.

Note that the broadcast receiving apparatus according to each embodiment of the present invention may be configured so as to be capable of suitably receiving advanced digital broadcasting, include all and it is not essential to of the first tuner/demodulator 130C, the second tuner/demodulator 130T, the third tuner/demodulator 130L, and the fourth tuner/demodulator 130B. For example, the broadcast receiving apparatus may include at least one of the second tuner/demodulator 130T or the third tuner/demodulator 130L. Further, in order to realize a more advanced function, the broadcast receiving apparatus may be configured so as to one or plural of the four tuner/demodulators described above in addition to one of the second tuner/demodulator 130T or the third tuner/demodulator 130L.

Further, the antenna 200C, the antenna 200T, and the antenna 200L may be used together appropriately. Further, among the first tuner/demodulator 130C, the second tuner/demodulator 130T, and the third tuner/demodulator 130L, a plurality of tuners/demodulators may be used together (or integrated) appropriately.

A packet stream outputted from the first tuner/demodulator 130C, the second tuner/demodulator 130T, the third tuner/demodulator 130L, and the fourth tuner/demodulator 130B or a packet stream obtained from each server apparatus on the Internet 800 via the LAN communication unit 121 is inputted into each of the first decoder 140S and the second decoder 140U. The packet stream inputted by each of the first decoder 140S and the second decoder 140U may be a packet stream with any form such as an MPEG (Moving Picture Experts Group)-2 TS (Transport Stream), an MPEG-2 PS (Program Stream), a TLV (Type Length Value), or an MMT (MPEG Media Transport).

Each of the first decoder 140S and the second decoder 140U executes a conditional access (Conditional Access: CA) process, a demultiplexing process of demultiplexing and extracting various kinds of information data, such as video data or audio data, from the packet stream on the basis of various kinds of control information contained in the packet stream, a decoding process for the video data and the audio data, a process of obtaining program information and generating an EPG (Electronic Program Guide: electronic program guide), a reproducing process of a data broadcasting screen or multimedia data, and the like. Further, each of the first decoder 140S and the second decoder 140U also executes a process of superimposing the generated EPG or the reproduced multimedia data onto the decoded video data or the decoded audio data.

The video data outputted from the first decoder 140S and the video data outputted from the second decoder 140U are inputted into the video selector 191, and the video selector 191 appropriately executes at least one of a selecting process or a superimposing process on the basis of a control of the main controller 101. Further, the video selector 191 appropriately executes a scaling process and a superimposing process of OSD (On Screen Display) data. The monitor 192 is a display device such as a liquid crystal panel for example. The monitor 192 displays video data that are subjected to the selecting/superimposing process in the video selector 191 to provide the user of the broadcast receiving apparatus 100 therewith. The video output unit 193 is a video output interface for outputting the video data that are subjected to the selecting/superimposing process in the video selector 191 to the outside. The video output interface is, for example, High-Definition Multimedia Interface (HDMI) (registered trademark).

The audio data outputted from the first decoder 140S and the audio data outputted from the second decoder 140U are inputted into the audio selector 194, and the audio selector 194 appropriately executes at least one of a selecting process or a mixing process on the basis of a control of the main controller 101. The speaker 195 outputs sound based on the audio data that are subjected to the selecting/mixing process in the audio selector 194 to provide the user of the broadcast receiving apparatus 100 therewith. The audio output unit 196 is an audio output interface for outputting the audio data that are subjected to the selecting/mixing process in the audio selector 194 to the outside. Examples of the audio output interface include an analog headphone jack, an optical digital interface, Bluetooth, and an audio return channel (ARC) assigned to an HDMI input terminal.

The digital interface 125 is an interface for outputting or inputting the packet stream including at least one of coded digital video data or coded digital audio data. The digital interface 125 can output the packet stream that is inputted from any of the first tuner/demodulator 130C, the second tuner/demodulator 130T, the third tuner/demodulator 130L, and the fourth tuner/demodulator 130B by the first decoder 140S or the second decoder 140U as it is. Further, the digital interface 125 may input the packet stream inputted from the outside via the digital interface 125 into the first decoder 140S or the second decoder 140U, or may control the storage (accumulator) 110 to store the packet stream. Alternatively, the digital interface 125 may output the video data or the audio data, which are demultiplexed and extracted in the first decoder 140S or the second decoder 140U. Further, the digital interface 125 may input the video data or the audio data inputted from the outside via the digital interface 125 into the first decoder 140S or the second decoder 140U, or may control the storage (accumulator) 110 to store the video data or the audio data.

The extension interface 124 is a group of interfaces for extending the function of the broadcast receiving apparatus 100, and is configured by a video/audio interface, a USB (Universal Serial Bus) interface, a memory interface, or the like. The video/audio interface executes an input of a video signal/audio signal from external video/audio output equipment, an output of a video signal/audio signal to the external video/audio input equipment. Examples of the video/audio interface include, for example, a pin jack and D terminal that handle an analog signal, and HDMI that handles a digital signal.

The USB interface executes transmission and reception of data by being connected to a PC or the like. The USB interface may execute recording of a broadcasting program or the other content data by being connected to the HDD. Further, the USB interface may execute connection to a keyboard or the other USB equipment. The memory interface executes transmission and reception of data by being connected to a memory card or the other memory medium.

The operation input unit 180 is an instruction input unit configured to execute an input of an operation instruction to the broadcast receiving apparatus 100, and is configured by a remote controller receiver for receiving a command transmitted from a remote controller (remote controller) (whose illustration is omitted) and an operation key configured by arranging button switches. The operation input unit 180 may be configured by any one of the remote controller receiver and the operation key. Further, the operation input unit 180 can be substituted by a touch panel or the like disposed so as to be overlapped on the monitor 192. The operation input unit 180 may be substituted by a keyboard or the like connected to the extension interface 124. The remote controller can be substituted by the portable information terminal 700 provided with a remote controller command transmitting function. Note that any “key” provided in the remote controller described in the following embodiments may be expressed as a “button”.

Note that in a case where the broadcast receiving apparatus 100 is the television receiver or the like, the video output unit 193 and the audio output unit 196 are not essential configuration. Further, the broadcast receiving apparatus 100 may be an optical disc drive recorder such as a DVD (Digital Versatile Disc) recorder, a magnetic disk drive recorder such as an HDD recorder, an STB (Set Top Box), or the like. The broadcast receiving apparatus 100 may be a PC (Personal Computer) provided with a receiving function of the digital broadcasting service, a tablet terminal, or the like. In a case where the broadcast receiving apparatus 100 is the DVD recorder, the HDD recorder, or the STB, the monitor 192 and the speaker 195 are not essential configuration. By connecting the video output unit 193 and the audio output unit 196 or the digital interface 125 to an external monitor and an external speaker, the broadcast receiving apparatus 100 can execute the similar operations to those of a television receiver or the like.

FIG. 2B is a block diagram illustrating one example of a detailed configuration of the first tuner/demodulator 130C.

An existing digital broadcasting wave received by the antenna 200C is inputted into the tuning/wave detector 131C, and the tuning/wave detector 131C executes channel selection on the basis of a channel selection control signal. A TMCC decoder 132C extracts a TMCC signal from an output signal of the tuning/wave detector 131C, and obtains various kinds of TMCC information. The obtained TMCC information is used for controlling respective latter processes. Details of the TMCC signal and the TMCC information will be described later.

A modulation wave modulated by using a method such as QPSK (Quadrature Phase Shift Keying), DQPSK (Differential QPSK), 16 QAM (Quadrature Amplitude Modulation), or 64 QAM is inputted into the demodulator 133C on the basis of the TMCC information and the like, and the demodulator 133C executes a demodulating process including frequency deinterleaving, time deinterleaving, and a carrier demapping process. The demodulator 133C may further be compatible with a modulation method different from the respective modulation methods described above.

A stream reproducer 134C executes a layer dividing process, an inner code error correcting process such as viterbi decoding, energy dispersal removal, a stream reproducing process, and an outer code error correcting process such as RS (Reed Solomon) decoding. Note that as the error correcting process, a method different from each method described above may be used. Further, a packet stream reproduced by and outputted from the stream reproducer 134C may be an MPEG-2 TS or the like, for example. The packet stream may be the other form of packet stream.

FIG. 2C is a block diagram illustrating one example of a detailed configuration of the second tuner/demodulator 130T.

The horizontal (H) polarization signal of the digital broadcasting wave received by the antenna 200T is inputted into a tuning/wave detector 131H, and the tuning/wave detector 131H executes channel selection on the basis of the channel selection control signal. The vertical (V) polarization signal of the digital broadcasting wave received by the antenna 200T is inputted into a tuning/wave detector 131V, and the tuning/wave detector 131V executes channel selection on the basis of the channel selection control signal. Note that an operation of the channel selecting process by the tuning/wave detector 131H and an operation of the channel selecting process by the tuning/wave detector 131V may be controlled in conjunction with each other, or may be controlled independently from each other. Namely, by assuming that the tuning/wave detector 131H and the tuning/wave detector 131V are one tuning/wave detector, it is possible to control the one tuning/wave detector to select one channel of the digital broadcasting service transmitted by using both horizontal/vertical polarized waves. By assuming that the tuning/wave detector 131H and the tuning/wave detector 131V are two independent tuning/wave detectors, it is possible to control the two independent tuning/wave detectors to respectively select two different channels of the digital broadcasting service transmitted by only the horizontal polarized wave (or only the vertical polarized wave).

Note that the horizontal (H) polarization signal and the vertical (V) polarization signal received by the second tuner/demodulator 130T of the broadcast receiving apparatus according to each embodiment of the present invention may be a polarization signal by a broadcast wave whose polarization direction is different by approximately 90 degrees, and a configuration regarding their reception between the horizontal (H) polarization signal and the vertical (V) polarization signal, which will be described below, may be reversed.

A TMCC decoder 132H extracts the TMCC signal from an output signal of the tuning/wave detector 131H to obtain various kinds of TMCC information. A TMCC decoder 132V extracts the TMCC signal from an output signal of the tuning/wave detector 131V to obtain various kinds of TMCC information. Any one of the TMCC decoder 132H and the TMCC decoder 132V may be provided. The obtained TMCC information is used for controlling respective latter processes.

A modulation wave modulated by using a method such as BPSK (Binary Phase Shift Keying), DBPSK (Differential BPSK), QPSK, DQPSK, 8PSK (Phase Shift Keying), 16APSK (Amplitude and Phase Shift Keying), 32 APSK, 16 QAM, 64 QAM, 256 QAM, or 1024 QAM is inputted into each of a demodulator 133H and a demodulator 133V on the basis of the TMCC information and the like, and each of the demodulator 133H and the demodulator 133V executes a demodulating process including frequency deinterleaving, time deinterleaving, and carrier demapping process. The demodulator 133H and the demodulator 133V may further be compatible with a modulation method different from the respective modulation methods described above.

Each of a stream reproducer 134H and a stream reproducer 134V executes a layer dividing process, an inner code error correcting process such as viterbi decoding or LDPC (Low Density Parity Check) decoding, energy dispersal removal, a stream reproducing process, and an outer code error correcting process such as RS decoding or BCH decoding. Note that as the error correcting process, one different from each of the methods described above may be used. Further, a packet stream reproduced by and outputted from the stream reproducer 134H is an MPEG-2 TS or the like, for example. A packet stream reproduced by and outputted from the stream reproducer 134V is a TLV including the MPEG-2 TS and an MMT packet stream, for example. Each of the packet streams may be the other form of packet stream.

Note that, in a case where a digital broadcasting wave of single-polarized terrestrial digital broadcasting is inputted into the second tuner/demodulator 130T, the tuning/wave detector 131V, the TMCC decoder 132V, and the demodulator 133V may not be included. Further, in a case where the existing terrestrial digital broadcasting service and the advanced terrestrial digital broadcasting service are simultaneously transmitted in different segments, among the signals outputted from the demodulator 133H, the signal of the segment transmitting the existing terrestrial digital broadcasting service is inputted into the stream reproducer 134H, and the signal of the segment transmitting the advanced terrestrial digital broadcasting service is inputted into the stream reproducer 134V.

FIG. 2D is a block diagram illustrating one example of detailed configuration of the third tuner/demodulator 130L.

A digital broadcasting wave subjected to a layered division multiplexing (Layered Division Multiplexing: LDM) process is inputted into a tuning/wave detector 131L from the antenna 200L, and the tuning/wave detector 131L executes channel selection on the basis of the channel selection control signal. The digital broadcasting wave subjected to the layered division multiplexing process may be used for transmission of a digital broadcasting service (or a different channel of the same broadcasting service) in which a modulation wave of an upper layer (Upper Layer: UL) is different from a modulation wave of a lower layer (Lower Layer: LL). Further, the modulation wave of the upper layer and the modulation wave of the lower layer are respectively outputted to a demodulator 133S and a demodulator 133L.

The modulation wave of the upper layer and the modulation wave of the lower layer outputted from the tuning/wave detector 131L is inputted into a TMCC decoder 132L, and the TMCC decoder 132L extracts the TMCC signal to obtain various kinds of TMCC information. A signal inputted into the TMCC decoder 132L may be any one of the modulation wave of the upper layer and the modulation wave of the lower layer.

The demodulator 133S and the demodulator 133L respectively execute the similar operations to those of the demodulator 133H and the demodulator 133V. For this reason, detailed explanation thereof is omitted. Further, a stream reproducer 134S and a stream reproducer 134L respectively execute the similar operations to those of the stream reproducer 134H and the stream reproducer 134V. For this reason, detailed explanation thereof is omitted.

FIG. 2E is a block diagram illustrating one example of a detailed configuration of the fourth tuner/demodulator 130B.

A digital broadcasting wave of an advanced BS digital broadcasting service or an advanced CS digital broadcasting service received by the antenna 200B is inputted into a tuning/wave detector 131B, and the tuning/wave detector 131B executes channel selection on the basis of the channel selection control signal. The other operations are similar to those of the tuning/wave detector 131H and the tuning/wave detector 131V. For this reason, detailed explanation thereof is omitted. Further, a TMCC decoder 132B, a demodulator 133B, and a stream reproducer 134B also execute the similar operations of the TMCC decoder 132H or the TMCC decoder 132V, the demodulator 133H or the demodulator 133V, and the stream reproducer 134V, respectively. For this reason, detailed explanation thereof is omitted.

FIG. 2F is a block diagram illustrating one example of a detailed configuration of the first decoder 140S.

A selector 141S selects, on the basis of a control of the main controller 101, one from the packet stream inputted from the first tuner/demodulator 130C, the packet stream inputted from the second tuner/demodulator 130T, and the packet stream inputted from the third tuner/demodulator 130L, and outputs the selected one. The packet stream inputted from each of the first tuner/demodulator 130C, the second tuner/demodulator 130T, and the third tuner/demodulator 130L is the MPEG-2 TS or the like, for example. A CA descrambler 142S executes a releasing process of encoding algorithm with a predetermined scramble method on the basis of various kinds of control information regarding conditional access superimposed onto the packet stream.

A demultiplexer 143S is a stream decoder, and demultiplexes and extracts video data, audio data, caption data, subtitle data, or program information data on the basis of various kinds of control information contained in the inputted packet stream. The demultiplexed and extracted video data are distributed to a video decoder 145S; the demultiplexed and extracted audio data are distributed to an audio decoder 146S; the demultiplexed and extracted caption data, subtitle data, and program information data are distributed to a data decoder 144S. The packet stream obtained from the server apparatus on the Internet 800 via the LAN communication unit 121 (for example, the MPEG-2 PS or the like) may be inputted into the demultiplexer 143S. Further, the demultiplexer 143S can output the packet stream inputted from each of the first tuner/demodulator 130C, the second tuner/demodulator 130T, and the third tuner/demodulator 130L via the digital interface 125 to the outside, and the packet stream obtained from the outside via the digital interface 125 can be inputted into the demultiplexer 143S.

The video decoder 145S executes a decoding process of video information subjected to compression coding, a colorimetry converting process to the decoded video information, and a dynamic range converting process with respect to the video data inputted from the demultiplexer 143S. Further, the video decoder 145S executes a process of resolution conversion (up/down conversion) based on a control of the main controller 101, and appropriately outputs video data with resolution such as UHD (3840 horizontal pixels×2160 vertical pixels), HD (1920 horizontal pixels×1080 vertical pixels), or SD (720 horizontal pixels×480 vertical pixels). The output of the video data may be executed with the other resolution. The audio decoder 146S executes a decoding process of audio information subjected to compression coding. Further, the audio decoder 146S executes a downmixing process based on a control of the main controller 101, and outputs the audio data by channel number such as 22.2 ch, 7.1 ch, 5.1 ch, or 2 ch. Note that the first decoder 140S may include a plurality of video decoders 145S and a plurality of audio decoders 146S in order to execute a plurality of decoding processes for video data and audio data at the same time.

The data decoder 144S executes a process of generating an EPG on the basis of the program information data, a data broadcasting screen generating process based on BML data, and a controlling process of a cooperation application based on a broadcasting/communication cooperating function. The data decoder 144S includes a BML browser function of executing a BML document, and the data broadcasting screen generating process is executed by the BML browser function. Further, the data decoder 144S executes a process of decoding the caption data and generating caption information, and a process of decoding the subtitle data and generating subtitle information.

Each of a superimposer 147S, a superimposer 148S, and a superimposer 149S executes a superimposing process for the video data outputted from the video decoder 145S, the EPG outputted from the data decoder 144S, and the data broadcasting screen. A composer 151S executes a process of synthesizing the audio data outputted from the audio decoder 146S and the audio data reproduced by the data decoder 144S. A selector 150S executes resolution selection of the video data based on a control of the main controller 101. Note that the functions of the superimposer 147S, the superimposer 148S, the superimposer 149S, and the selector 150S may be integrated with that of the video selector 191. The function of the composer 151S may be integrated with that of the audio selector 194.

FIG. 2G is a block diagram illustrating one example of a detailed configuration of the second decoder 140U.

A selector 141U selects one from the packet stream inputted from the second tuner/demodulator 130T, the packet stream inputted from the third tuner/demodulator 130L, and the packet stream inputted from the fourth tuner/demodulator 130B on the basis of a control of the main controller 101, and outputs the selected one. The packet stream inputted from each of the second tuner/demodulator 130T, the third tuner/demodulator 130L, and the fourth tuner/demodulator 130B is an MMT packet stream or TLV or the like including the MMT packet stream, for example. The packet stream may be a packet stream of an MPEG-2 TS form that adopts HEVC (High Efficiency Video Coding) to a video compressing method. A CA descrambler 142U executes a releasing process of encoding algorithm with a predetermined scramble method on the basis of various kinds of control information regarding conditional access superimposed onto the packet stream.

A demultiplexer 143U is a stream decoder, and demultiplexes and extracts video data, audio data, caption data, subtitle data, or program information data on the basis of various kinds of control information contained in the inputted packet stream. The demultiplexed and extracted video data are distributed to a video decoder 145U; the demultiplexed and extracted audio data are distributed to an audio decoder 146U; the demultiplexed and extracted caption data, subtitle data, and program information data are distributed to a multimedia decoder 144U. The packet stream obtained from the server apparatus on the Internet 800 via the LAN communication unit 121 (for example, the MPEG-2 PS, the MMT packet stream, or the like) may be inputted into the demultiplexer 143U. Further, the demultiplexer 143U can output the packet stream inputted from each of the second tuner/demodulator 130T, the third tuner/demodulator 130L, and the fourth tuner/demodulator 130B via the digital interface 125 to the outside, and the packet stream obtained from the outside via the digital interface 125 can be inputted into the demultiplexer 143U.

The multimedia decoder 144U executes a process of generating an EPG, a multimedia screen generating process based on multimedia data, and a controlling process of a cooperation application based on a broadcasting/communication cooperating function on the basis of the program information data. The multimedia decoder 144U includes an HTML browser function of executing an HTML document, and the multimedia screen generating process is executed by the HTML browser function.

The video decoder 145U, the audio decoder 146U, a superimposer 147U, a superimposer 148U, a superimposer 1490, a composer 1510, and a selector 150U are respectively components that have the similar functions to the video decoder 145S, the audio decoder 146S, the superimposer 147S, the superimposer 148S, the superimposer 149S, the composer 151S, and the selector 150S. By changing the end of each of the reference signs “S” into “U” in the explanation about the video decoder 145S, the audio decoder 146S, the superimposer 147S, the superimposer 148S, the superimposer 149S, the composer 151S, and the selector 150S illustrated in FIG. 2F, the video decoder 145U, the audio decoder 146U, the superimposer 147U, the superimposer 148U, the superimposer 1490, the composer 151U, and the selector 150U illustrated in FIG. 2G may respectively be explained. For this reason, further detailed explanation thereof is omitted.

### [Software Configuration of Broadcast Receiving Apparatus]

FIG. 2H is a software configuration diagram of the broadcast receiving apparatus 100, and illustrates one example of a software configuration of the storage (accumulator) 110 (or the ROM 103, the same applies hereinafter) and the RAM 104. A basic operating program 1001, a receiving function program 1002, a browser program 1003, a content managing program 1004, and the other operating program 1009 are stored in the storage (accumulator) 110. Further, the storage (accumulator) 110 includes: a content memory region 1011 configured to store content data such as moving images, still images, or audio; an authentication information memory region 1012 configured to store authentication information used when communicating or cooperating with external portable terminal equipment or the server apparatus; and a various kinds of information memory region 1019 configured to store various kinds of other information.

The basic operating program 1001 stored in the storage (accumulator) 110 is developed on the RAM 104, and the main controller 101 further executes the developed basic operating program, thereby constituting a basic operating controller 1101. Further, the receiving function program 1002, the browser program 1003, and the content managing program 1004, which are stored in the storage (accumulator) 110, are respectively developed on the RAM 104, and the main controller 101 further executes the developed operating programs, thereby constituting a receiving function controller 1102, a browser engine 1103, and a content manager 1104. Further, the RAM 104 includes a temporary memory region 1200 configured to temporarily hold data created at the time of execution of each of the operating programs as needed.

Note that, in the following, in order to simplify the explanation, the process in which the main controller 101 controls each operating block by developing the basic operating program 1001 stored in the storage (accumulator) 110 on the RAM 104 and executing the program will be described as a process in which the basic operating controller 1101 controls each operating block. The same description will be made for other operating programs.

The receiving function controller 1102 executes basic controls such as a broadcast receiving function or a broadcasting/communication cooperating function of the broadcast receiving apparatus 100. In particular, a tuning/demodulator 1102a mainly controls the channel selecting process, a TMCC information obtaining process, and the demodulating process in each of the first tuner/demodulator 130C, the second tuner/demodulator 130T, the third tuner/demodulator 130L, and the fourth tuner/demodulator 130B. A stream reproduction controller 1102b mainly controls the layer dividing process, the error correction decoding process, the energy dispersal removal, and the stream reproducing process in each of the first tuner/demodulator 130C, the second tuner/demodulator 130T, the third tuner/demodulator 130L, and the fourth tuner/demodulator 130B. An AV decoder 1102c mainly controls the demultiplexing process (or a stream decoding process), a video data decoding process, and an audio data decoding process in each of the first decoder 140S and a second decoder 140U. A multimedia (MM) data reproducer 1102d mainly controls a BML data reproducing process, a caption data decoding process, a subtitle data decoding process, and a controlling process of a communication cooperation application in the first decoder 140S, and an HTML data reproducing process, the multimedia screen generating process, and a controlling process of a communication cooperation application in the second decoder 140U. An EPG generator 1102e mainly controls an EPG generating process and a displaying process of the generated EPG in each of the first decoder 140S and the second decoder 140U. A presentation processor 1102f executes controls of the colorimetry converting process, the dynamic range converting process, a resolution converting process, and the downmixing process for audio in each of the first decoder 140S and the second decoder 140U, and controls of the video selector 191 and the audio selector 194.

At the time of the BML data reproducing process or the HTML data reproducing process described above, a BML browser 1103a and an HTML browser 1103b of the browser engine 1103 respectively execute interpretation of a BML document or an HTML document, and execute the data broadcasting screen generating process or the multimedia screen generating process.

The content manager 1104 executes time schedule management and execution control at the time of execution of video recording reservation or timer recording of a broadcasting program, copyright management when the broadcasting program or a recorded program is outputted from the digital interface 125 or the LAN communication unit 121, and expiration date management of the cooperation application obtained based on the broadcasting/communication cooperating function.

Each of the operating programs may be stored in advance in at least one of the storage (accumulator) 110 or the ROM 103 at the time of product shipment. Each of the operating programs may be obtained from the server apparatus on the Internet 800 via the LAN communication unit 121 or the like after the product shipment. Further, each of the operating programs stored in a memory card or an optical disc may be obtained via the extension interface 124. Each of the operating programs may be newly obtained or updated via the broadcast wave.

### [Configuration of Broadcast Station Server]

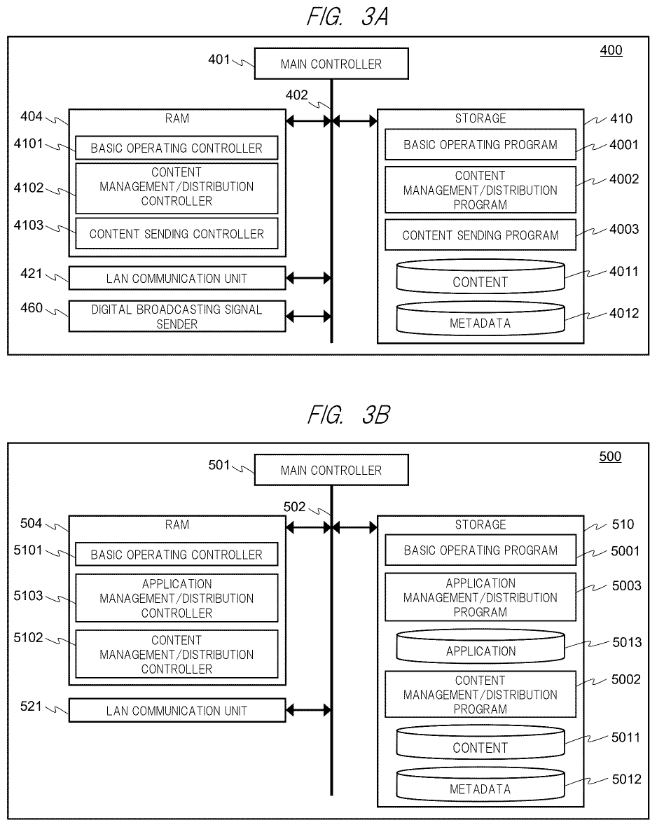

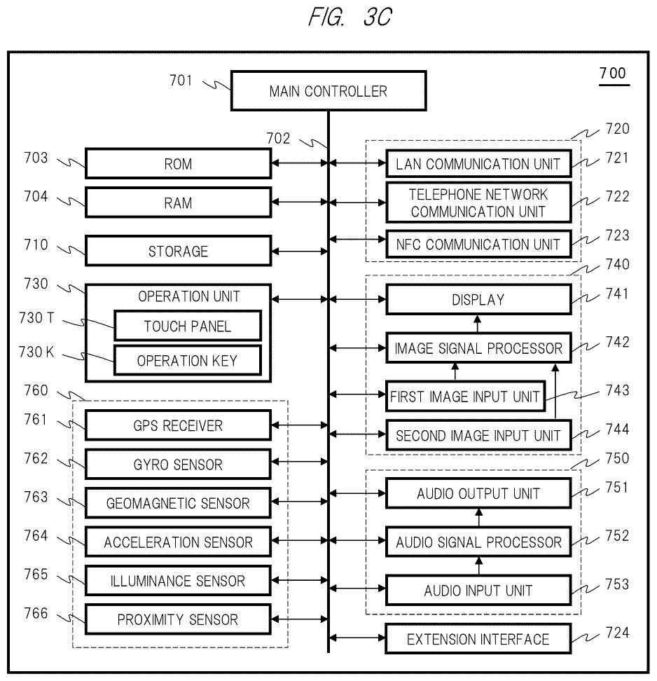

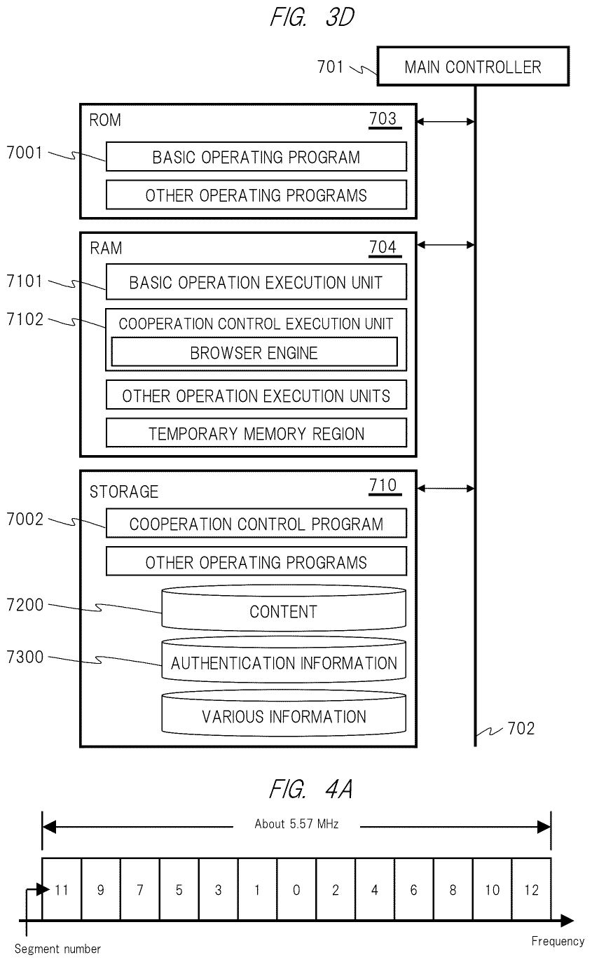

FIG. 3A is one example of an internal configuration of the broadcast station server 400. The broadcast station server 400 is configured by a main controller 401, a system bus 402, a RAM 404, a storage 410, a LAN communication unit 421, and a digital broadcasting signal sender 460.

The main controller 401 is a microprocessor unit configured to control the whole broadcast station server 400 in accordance with a predetermined operating program. The system bus 402 is a communication path for executing transmission and reception of various kinds of data or commands between the main controller 401 and each operating block in the broadcast station server 400. The RAM 404 serves as a work area at the time of execution of each of operating programs.

A basic operating program 4001, a content management/distribution program 4002, and a content sending program 4003 are stored in the storage 410, and the storage 410 further includes a content data memory region 4011 and a metadata memory region 4012. Content data of each broadcasting program broadcast by the broadcast station are stored in the content data memory region 4011. Metadata such as program titles of the respective broadcasting programs, program IDs, program summaries, casts, broadcasting dates, or the like are stored in the metadata memory region 4012.

Further, each of the basic operating program 4001, the content management/distribution program 4002, and the content sending program 4003 stored in the storage 410 is developed on the RAM 404, and the main controller 401 further executes the developed basic operating program, the developed content management/distribution program, the developed content sending program, thereby constituting a basic operating controller 4101, a content management/distribution controller 4102, and a content sending controller 4103.

Note that, in the following, in order to simplify the explanation, the process in which the main controller 401 controls each operating block by developing the basic operating program 4001 stored in the storage 410 on the RAM 404 and executing the program will be described as a process in which the basic operating controller 4101 controls each operating block. The same description will be made for other operating programs.

The content management/distribution controller 4102 executes management of the content data and the metadata respectively stored in the content data memory region 4011 and the metadata memory region 4012, and a control of the content data and the metadata at the time of provision of them to the service provider on the basis of contract. Moreover, the content management/distribution controller 4102 executes an authentication process of the service provider server 500 as needed at the time of provision of the content data or the metadata to the service provider.

The content sending controller 4103 executes time schedule management when the content data of the broadcasting program stored in the content data memory region 4011 and a stream containing a program title or a program ID of the broadcasting program stored in the metadata memory region 4012 and copy control information of program content are sent out via the digital broadcasting signal sender 460.

The LAN communication unit 421 is connected to the Internet 800, and executes communication with the service provider server 500 or another communication equipment on the Internet 800. The LAN communication unit 421 includes a coding circuit, a decoding circuit, and the like. The digital broadcasting signal sender 460 subjects a stream constituted by content data and program information data for each of the broadcasting programs stored in the content data memory region 4011 to a process such as modulation, and sends out the processed stream as a digital broadcasting wave via the radio tower 300.

### [Configuration of Service Provider Server]

FIG. 3B is one example of an internal configuration of the service provider server 500. The service provider server 500 is configured by a main controller 501, a system bus 502, a RAM 504, a storage 510, and a LAN communication unit 521.

The main controller 501 is a microprocessor unit configured to control the whole service provider server 500 in accordance with a predetermined operating program. The system bus 502 is a communication path for executing transmission and reception of various kinds of data or commands between the main controller 501 and each operating block in the service provider server 500. The RAM 504 serves as a work area at the time of execution of each of operating programs.

A basic operating program 5001, a content management/distribution program 5002, and an application management/distribution program 5003 are stored in the storage 510, and the storage 510 further includes a content data memory region 5011, a metadata memory region 5012, and an application memory region 5013. The content data and the metadata provided from the broadcast station server 400, or content created by the service provider and metadata regarding the content are stored in the content data memory region 5011 and the metadata memory region 5012. Applications to be distributed in response to a request from each television receiver (at least one of operating programs or various kinds of data), which are required to realize each service of the broadcasting/communication cooperation system, are stored in the application memory region 5013.

Further, the basic operating program 5001, the content management/distribution program 5002, and the application management/distribution program 5003, which are stored in the storage 510, are respectively developed on the RAM 504, and the main controller 501 further executes the developed basic operating program, the developed content management/distribution program, and the developed application management/distribution program, thereby constituting a basic operating controller 5101, a content management/distribution controller 5102, and an application management/distribution controller 5103.

Note that, in the following, in order to simplify the explanation, the process in which the main controller 501 controls each operating block by developing the basic operating program 5001 stored in the storage 510 on the RAM 504 and executing the program will be described as a process in which the basic operating controller 5101 controls each operating block. The same description will be made for other operating programs.

The content management/distribution controller 5102 executes acquisition of content data and metadata from the broadcast station server 400, management of the content data and the metadata respectively stored in the content data memory region 5011 and the metadata memory region 5012, and a control of distribution of the content data and the metadata to each television receiver. Further, the application management/distribution controller 5103 executes management of each application stored in the application memory region 5013, and control when each application is distributed in response to a request from each television receiver. Moreover, the application management/distribution controller 5103 also executes an authentication process of the corresponding television receiver as needed when each application is distributed to each television receiver.

The LAN communication unit 521 is connected to the Internet 800, and executes communication with the broadcast station server 400 or the other communication equipment on the Internet 800. Further, the LAN communication unit 521 executes communication with the broadcast receiving apparatus 100 or the portable information terminal 700 via the router device 800R. The LAN communication unit 521 includes a coding circuit, a decoding circuit, and the like.

### [Hardware Configuration of Portable Information Terminal]

FIG. 3C is a block diagram illustrating an example of an internal configuration of the portable information terminal 700. The portable information terminal 700 is configured by a main controller 701, a system bus 702, a ROM 703, a RAM 704, a storage 710, a communication processor 720, an extension interface 724, an operation unit 730, an image processor 740, an audio processor 750, and a sensor 760.

The main controller 701 is a microprocessor unit that controls the whole portable information terminal 700 in accordance with a predetermined operating program. The system bus 702 is a communication path for executing transmission and reception of various kinds of data or commands between the main controller 701 and each of operating blocks in the portable information terminal 700.

The ROM 703 is a non-volatile memory in which a basic operating program such as an operating system and other operating programs are stored, for example, and a rewritable ROM such as an EEPROM or a flash ROM is used. Further, the ROM 703 also stores operation setting values and the like necessary for the operation of the portable information terminal 700. The RAM 704 serves as a work area when the basic operating program or the other operating programs are executed. The ROM 703 and the RAM 704 may be configured integrally with the main controller 701. Further, instead of the independent configuration illustrated in FIG. 3C, a partial memory region in the storage 710 may be used as the ROM 703.

The storage the operating program and the operation setting values of the portable information terminal 700, personal information of the user of the portable information terminal 700, and the like. Further, an operating program downloaded via the Internet 800, various data generated by the operating program, and the like can be stored in the storage 710. Furthermore, contents such as moving images, still images, audio, and the like downloaded via the Internet 800 can also be stored in the storage 710. All or some of the functions of the ROM 703 may be substituted by a partial area of the storage 710. In addition, the storage 710 is required to hold stored information even in a state where power is not supplied to the portable information terminal 700 from the outside. Therefore, for example, a device including a semiconductor element memory such as a flash ROM or an SSD or a magnetic disk drive such as an HDD is used as the storage 710.

Note that each of the operating programs stored in the ROM 703 or the storage 710 can be added, updated, and functionally extended by a downloading process from each server apparatus on the Internet 800.

The communication processor 720 is configured by a LAN communication unit 721, a mobile phone network communication unit 722, and an NFC communication unit 723. The LAN communication unit 721 is connected to the Internet 800 via a router device 800R, and transmits and receives data to and from each server apparatus and other communication equipment on the Internet 800. The LAN communication unit 721 is connected to the router device 800R by wireless connection such as Wi-Fi (registered trademark). The mobile phone network communication unit 722 performs telephone communication (call) and data transmission and reception by wireless communication with the base station 600B of the mobile phone communication network. The NFC communication unit 723 performs wireless communication when approaching the corresponding reader or writer. Each of the LAN communication unit 721, the mobile phone network communication unit 722, and the NFC communication unit 723 includes a coding circuit, a decoding circuit, an antenna, and the like. Furthermore, the communication processor 720 may further include other communication units such as a Bluetooth (registered trademark) communication unit and an infrared communication unit.

The extension interface 724 is a group of interfaces for extending the function of the portable information terminal 700, and is configured by a video/audio interface, a USB interface, a memory interface, or the like in the present embodiment. The video/audio interface executes an input of a video signal/audio signal from external video/audio output equipment, an output of a video signal/audio signal to the external video/audio equipment, and the like. The USB interface executes transmission and reception of data to and from a PC by being connected to the PC. Further, the USB interface may execute connection to a keyboard or the other USB equipment. The memory interface executes transmission and reception of data by being connected to a memory card or the other memory medium.

The operation unit 730 is an instruction input unit that executes an input of an operation instruction to the portable information terminal 700. In the present embodiment, the operation unit 730 is configured by a touch panel 730T arranged to overlap the display 741 and an operation key 730K in which button switches are arranged. The operation input unit 730 may be configured by any one of the touch panel and the operation key. The operation of the portable information terminal 700 may be executed using a keyboard or the like connected to the extension interface 724. The operation of the portable information terminal 700 may be executed using a separate terminal device connected by wired communication or wireless communication. Namely, the operation of the portable information terminal 700 may be executed from the broadcast receiving apparatus 100. Further, the touch panel function may be included in the display 741.

The image processor 740 is configured by the display 741, an image signal processor 742, a first image input unit 743, and a second image input unit 744. The display 741 is, for example, a display device such as a liquid crystal panel and the like, and provides the user of the portable information terminal 700 with the image data processed by the image signal processor 742. The image signal processor 742 includes a video RAM (not illustrated), and the display 741 is driven based on image data inputted into the video RAM. In addition, the image signal processor 742 has a function of performing format conversion, a superimposition process of a menu or other OSD (On Screen Display) signals, and the like as necessary. The first image input unit 743 and the second image input unit 744 are camera units that input image data of surroundings or an object by converting light inputted from a lens into an electric signal by using an electronic device such as a CCD (charge coupled device) or a CMOS (complementary metal oxide semiconductor) sensor.

The audio processor 750 is configured by an audio output unit 751, an audio signal processor 752, and an audio input unit 753. The audio output unit 751 is a speaker, and provides the user of the portable information terminal 700 with the audio signal processed by the audio signal processor 752. The audio input unit 753 is a microphone, and converts a voice or the like of the user into audio data and inputs the audio data.

The sensor 760 is a group of sensors for detecting the state of the portable information terminal 700 and is configured by a GPS receiver 761, a gyro sensor 762, a geomagnetic sensor 763, an acceleration sensor 764, an illuminance sensor 765, and a proximity sensor 766 in the present embodiment. With the group of sensors, it is possible to detect the position, the inclination, the direction, the movement, and the brightness of the surroundings, the proximity status of the surrounding objects, and the like of the portable information terminal 700. Furthermore, the portable information terminal 700 may further include other sensors such as an atmospheric pressure sensor.

The portable information terminal 700 may be a mobile phone, a smartphone, a tablet terminal, or the like. A PDA (personal digital assistant) or a notebook PC may also be used. Further, the portable information terminal 700 may be a digital still camera, a video camera capable of capturing a moving image, a portable game machine, a navigation device, or the like, or other portable digital devices.

Note that the configuration example of the portable information terminal 700 illustrated in FIG. 3C includes many components that are not essential to the present embodiment, such as the sensor 760, but the effects of the present embodiment are not impaired even in the configuration in which these are not provided. Furthermore, other components such as a digital broadcasting receiving function and an electronic money payment function (not illustrated) may be further added.

### [Software Configuration of Portable Information Terminal]

FIG. 3D is a software configuration diagram of the portable information terminal 700, and illustrates an example of a software configuration in the ROM 703, the RAM 704, and the storage 710. A basic operating program 7001 and other operating programs are stored in the ROM 703. A cooperation control program 7002 and other operating programs are stored in the storage 710. In addition, the storage 710 includes a content storage region 7200 that stores content data such as moving images, still images, and audio, an authentication information storage region 7300 that stores authentication information and the like necessary for accessing a television receiver and each server apparatus, and various information storage regions that store other various types of information.

The basic operating program 7001 stored in the ROM 703 is developed on the RAM 704, and the main controller 701 further executes the basic operating developed program, thereby constituting a basic operation execution unit 7101. Further, the cooperation control program 7002 stored in the storage 710 is similarly developed on the RAM 704, and the main controller 701 further executes the developed cooperation control program, thereby constituting the cooperation control execution unit 7102. Further, the RAM 704 includes a temporary memory region configured to temporarily hold data created at the time of execution of each of the operating programs as needed.

Note that, in the following, in order to simplify the explanation, the process in which the main controller 701 controls each operating block by developing the basic operating program 7001 stored in the ROM 703 on the RAM 704 and executing the program will be described as a process in which the basic operating execution unit 7101 controls each operating block. The same description will be made for other operating programs.

The cooperation control execution unit 7102 executes management of device authentication and connection, transmission and reception of data, and the like when the portable information terminal 700 performs a cooperation operation with the television receiver. Further, the cooperation control execution unit 7102 has a browser engine function for executing an application linked with the television receiver.

Each of the operating programs may be stored in the ROM 703 and/or the storage 710 in advance at the time of product shipment. The programs may be obtained from a server apparatus on the Internet 800 via the LAN communication unit 721 or the mobile phone network communication unit 722 after the product is shipped. Further, each of the operating programs stored in a memory card, an optical disk, or the like may be obtained via the extension interface 724 or the like.

### [Broadcast Wave of Digital Broadcasting]

Here, one example of the broadcast wave of digital broadcasting received by the broadcast receiving apparatus according to the embodiment of the present invention will be described.

The broadcast receiving apparatus 100 can receive the terrestrial digital broadcasting service that shares at least a part of specifications with ISDB-T (Integrated Services Digital Broadcasting for Terrestrial Television Broadcasting) method. Specifically, the dual-polarized terrestrial digital broadcasting or the single-polarized terrestrial digital broadcasting that the second tuner/demodulator 130T can receive is advanced terrestrial digital broadcasting that shares the part of the specifications with the ISDB-T method. Further, the layered division multiplexing terrestrial digital broadcasting that the third tuner/demodulator 130L can receive is the advanced terrestrial digital broadcasting shares the part of the specifications with the ISDB-T method. Note that the existing terrestrial digital broadcasting that the first tuner/demodulator 130C can receive is terrestrial digital broadcasting with the ISDB-T method. Further, advanced BS digital broadcasting or advanced CS digital broadcasting that the fourth tuner/demodulator 130B can receive is digital broadcasting with a method different from the ISDB-T method.

Here, the dual-polarized terrestrial digital broadcasting, the single-polarized terrestrial digital broadcasting, and the layered division multiplexing terrestrial digital broadcasting according to the present embodiment adopts OFDM (Orthogonal Frequency Division Multiplexing: frequency division multiplexing) that is one of multi-carrier methods as a transmission method in the similar manner to the ISDB-T method. Since the OFDM is a multi-carrier method, a symbol length thereof is long, and it is effective to add a redundant portion in a time axis direction called a guard interval, and this makes it possible to reduce an influence on multipath within a range of the guard interval. For this reason, it is possible to realize an SEN (Single Frequency Network: single frequency network), and this makes it possible to use the frequency effectively.

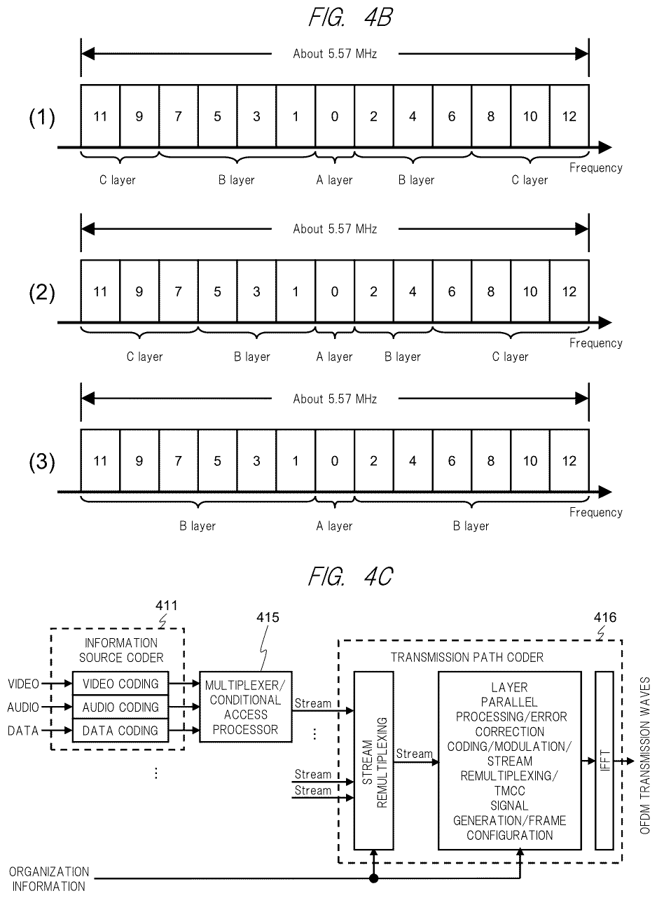

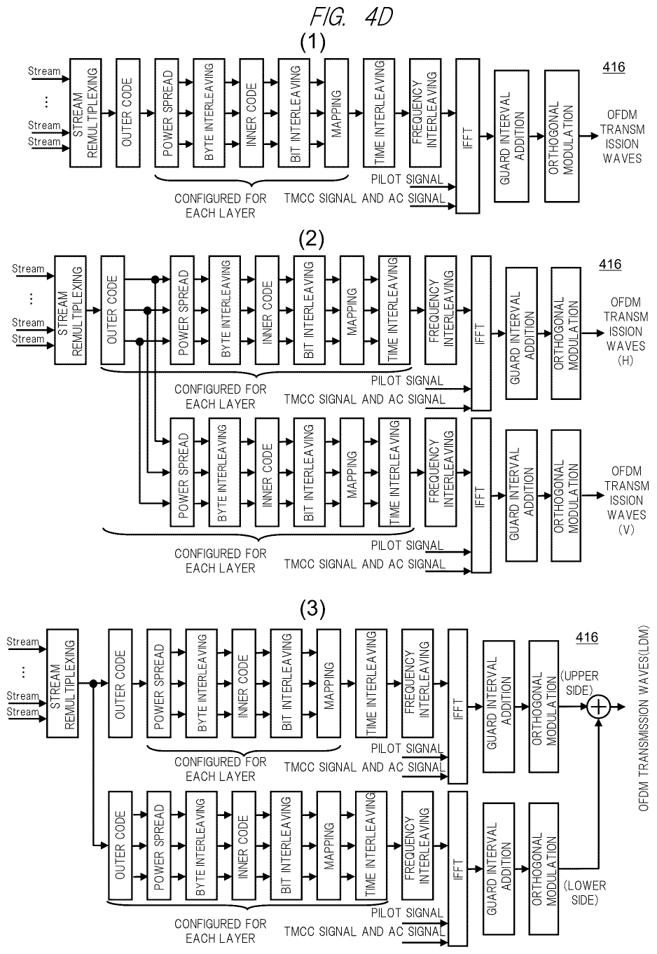

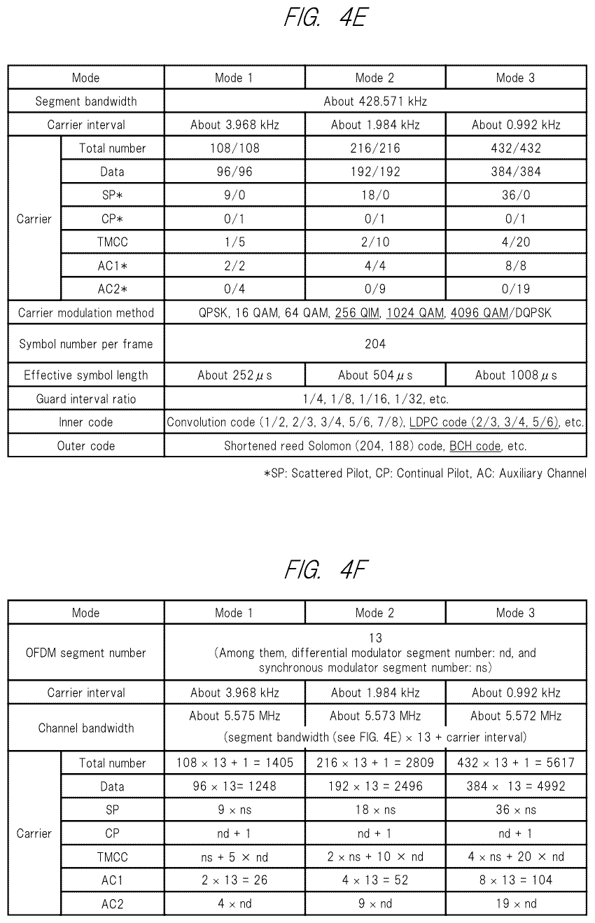

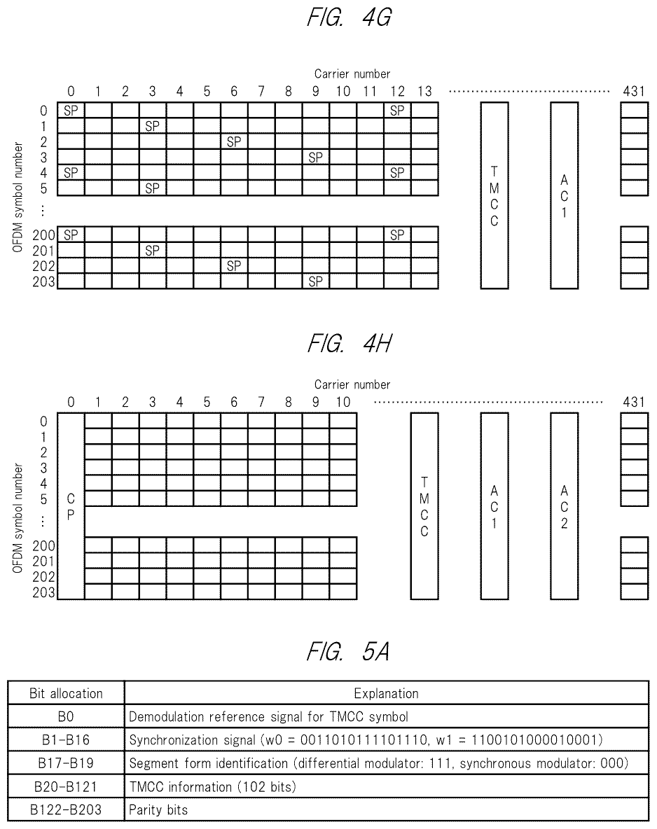

In the dual-polarized terrestrial digital broadcasting, the single-polarized terrestrial digital broadcasting, and the layered division multiplexing terrestrial digital broadcasting according to the present embodiment, a carrier of the OFDM is divided into groups called segments in the similar manner to the ISDB-T method. As illustrated in FIG. 4A, one channel bandwidth of the digital broadcasting service is configured by 13 segments. The central part of the band is set to a position of segment 0, and segment numbers (0 to 12) are allocated above and below this position in turn. Transmission path coding of the dual-polarized terrestrial digital broadcasting, the single-polarized terrestrial digital broadcasting, and the layered division multiplexing terrestrial digital broadcasting according to the present embodiment is executed in units of OFDM segments. For this reason, it is possible to define layer transmission. For example, in the bandwidth of one television channel, it is possible to allocate a part of the OFDM segments to a fixed receiving service, and allocate the remaining to a mobile receiving service. In the layer transmission, each layer is configured by one OFDM segment or a plurality of OFDM segments, and it is possible to set, for each layer, parameters such as a carrier modulation method, a coding rate of an inner code, or a length of time interleaving. Note that the number of layers may be set arbitrarily, for example, and the number of layers may be set up to three layers. FIG. 4B illustrates one example of a layer allocation of the OFDM segments in a case where the number of layers is three or two. In the example of (1) of FIG. 4B, the number of layers is three; an A layer is configured by one segment (segment 0); a B layer is configured by seven segments (segments 1 to 7); and a C layer is configured by five segments (segments 8 to 12). In the example of (2) of FIG. 4B, the number of layers is three; an A layer is configured by one segment (segment 0); a B layer is configured by five segments (segments 1 to 5); and a C layer is configured by seven segments (segments 6 to 12). In the example of (3) of FIG. 4B, the number of layers is two; an A layer is configured by one segment (segment 0); and a B layer is configured by 12 segments (segments 1 to 12). The number of OFDM segments and transmission path coding parameters of each layer are determined in accordance with organization information, and are transmitted by the TMCC signal that is control information for assisting the operation of the receiver.

Note that as one example of a usage example of segment layer allocation illustrated in (1), (2), and (3) of FIG. 4B, the following is possible.

For example, the layer allocation illustrated in (1) of FIG. 4B can be used in the dual-polarized terrestrial digital broadcasting according to the present embodiment, and the same segment layer allocation may be used for both a horizontal polarized wave and a vertical polarized wave. Specifically, the mobile receiving service of the existing terrestrial digital broadcasting may be transmitted by the above-described one segment of the horizontal polarized wave as the A layer. (Note that the mobile receiving service of the existing terrestrial digital broadcasting may transmit the same service by the above-described one segment of the vertical polarized wave. In this case, this is also treated as the A layer.) Further, the terrestrial digital broadcasting service in which video whose maximum resolution is 1920 horizontal pixels×1080 vertical pixels, which is the existing terrestrial digital broadcasting, is transmitted may be transmitted by the above-described seven segments of the horizontal polarized wave as the B layer. (Note that the terrestrial digital broadcasting service in which the video whose maximum resolution is 1920 horizontal pixels×1080 vertical pixels is transmitted may transmit the same service by the above-described seven segments of the vertical polarized wave. In this case, this is also treated as the B layer.) Moreover, the advanced terrestrial digital broadcasting service capable of transmitting the video whose maximum resolution is the number of pixels that exceeds 1920 horizontal pixels p×1080 vertical pixels may be transmitted by the above-described five segments of each of both the horizontal polarized wave and the vertical polarized wave, that is, by ten segments in total as the C layer. Details of the transmission will be described later. A transmission wave of the segment layer allocation can be received by the second tuner/demodulator 130T of the broadcast receiving apparatus 100, for example.

Further, the layer allocation illustrated in (1) of FIG. 4B can be used in the single-polarized terrestrial digital broadcasting according to the present embodiment. Specifically, the mobile receiving service of the existing terrestrial digital broadcasting may be transmitted by the above-described one segment as the A layer. Further, the terrestrial digital broadcasting service in which video whose maximum resolution is 1920 horizontal pixels×1080 vertical pixels, which is the existing terrestrial digital broadcasting, is transmitted may be transmitted by the above-described seven segments as the B layer. Moreover, the advanced terrestrial digital broadcasting service capable of transmitting the video whose maximum resolution is the number of pixels that exceeds 1920 horizontal pixels×1080 vertical pixels may be transmitted by the above-described five segments as the C layer. Note that, in this case, a carrier modulation method, an error correction coding method, a video coding method, or the like that is more efficient than that of the existing terrestrial digital broadcasting is used in the C layer. Details of the transmission will be described later. A transmission wave of the segment layer allocation can be received by the second tuner/demodulator 130T of the broadcast receiving apparatus 100, for example.

In addition, as another example (not illustrated), in the single-polarized terrestrial digital broadcasting according to the present embodiment, the mobile receiving service of the existing terrestrial digital broadcasting may be transmitted by the one segment of the A layer, the terrestrial digital broadcasting service in which video whose maximum resolution is 1920 horizontal pixels×1080 vertical pixels, which is the existing terrestrial digital broadcasting, is transmitted may be transmitted by the eight segments of the B layer, and the advanced terrestrial digital broadcasting service capable of transmitting the video whose maximum resolution is the number of pixels that exceeds 1920 horizontal pixels×1080 vertical pixels may be transmitted by the four segments of the C layer. Note that, in this case as well, a carrier modulation method, an error correction coding method, a video coding method, or the like that is more efficient than that of the existing terrestrial digital broadcasting is used in the C layer. Details of the transmission will be described later. A transmission wave of the segment layer allocation can be received by the second tuner/demodulator 130T of the broadcast receiving apparatus 100, for example.

For example, the layer allocation illustrated in (2) of FIG. 4B can be used as an example different from that illustrated in (1) of FIG. 4B in the dual-polarized terrestrial digital broadcasting according to the present embodiment, and the same segment layer allocation may be used for both the horizontal polarized wave and the vertical polarized wave. Specifically, the mobile receiving service of the existing terrestrial digital broadcasting may be transmitted by the above-described one segment of the horizontal polarized wave as the A layer. (Note that the mobile receiving service of the existing terrestrial digital broadcasting may transmit the same service by the above-described one segment of the vertical polarized wave. In this case, this is also treated as the A layer.) Further, the advanced terrestrial digital broadcasting service capable of transmitting the video whose maximum resolution is the number of pixels that exceeds 1920 horizontal pixels×1080 vertical pixels may be transmitted by the above-described five segments of each of both the horizontal polarized wave and the vertical polarized wave, that is, by ten segments in total as the B layer. Moreover, the terrestrial digital broadcasting service in which video whose maximum resolution is 1920 horizontal pixels×1080 vertical pixels, which is the existing terrestrial digital broadcasting, is transmitted may be transmitted by the above-described seven segments of the horizontal polarized wave as the B layer. (Note that the terrestrial digital broadcasting service in which the video whose maximum resolution is 1920 horizontal pixels×1080 vertical pixels is transmitted may transmit the same service by the above-described seven segments of the vertical polarized wave. In this case, this is also treated as the C layer.) A transmission wave of the segment layer allocation can be received by the second tuner/demodulator 130T of the broadcast receiving apparatus 100 according to the present embodiment, for example.

Also, the layer allocation illustrated in (2) of FIG. 4B can be used as an example different from that illustrated in (1) of FIG. 4B in the single-polarized terrestrial digital broadcasting according to the present embodiment. Specifically, the mobile receiving service of the existing terrestrial digital broadcasting may be transmitted by the above-described one segment as the A layer. Further, the advanced terrestrial digital broadcasting service capable of transmitting the video whose maximum resolution is the number of pixels that exceeds 1920 horizontal pixels×1080 vertical pixels may be transmitted by the above-described five segments as the B layer. Note that, in this case, a carrier modulation method, an error correction coding method, a video coding method, or the like that is more efficient than that of the existing terrestrial digital broadcasting is used in the B layer. Further, the terrestrial digital broadcasting service in which video whose maximum resolution is 1920 horizontal pixels×1080 vertical pixels, which is the existing terrestrial digital broadcasting, is transmitted may be transmitted by the above-described seven segments as the C layer. Details of the transmission will be described later. A transmission wave of the segment layer allocation can be received by the second tuner/demodulator 130T of the broadcast receiving apparatus 100 according to the present embodiment, for example.

For example, the layer allocation illustrated in (3) of FIG. 4B can be used in the layered division multiplexing terrestrial digital broadcasting or the existing terrestrial digital broadcasting according to the present embodiment. Specifically, in a case of the layered division multiplexing terrestrial digital broadcasting, the mobile receiving service of the existing terrestrial digital broadcasting may be transmitted by one segment illustrated in the drawing as the A layer. Further, the advanced terrestrial digital broadcasting service capable of transmitting the video whose maximum resolution is the number of pixels that exceeds 1920 horizontal pixels×1080 vertical pixels and the existing terrestrial digital broadcasting service for transmitting the video whose maximum resolution is 1920 horizontal pixels×1080 vertical pixels may be transmitted by the 12 segments in the drawing as the B layer. A transmission wave of the segment layer allocation can be received by the third tuner/demodulator 130L of the broadcast receiving apparatus 100 according to the present embodiment, for example. In a case of the existing terrestrial digital broadcasting, the mobile receiving service of the existing terrestrial digital broadcasting may be transmitted by one segment illustrated in the drawing as the A layer, and the terrestrial digital broadcasting service in which video whose maximum resolution is 1920 horizontal pixels×1080 vertical pixels, which is the existing terrestrial digital broadcasting, is transmitted may be transmitted by 12 segments illustrated in the drawing as the B layer. A transmission wave of the segment layer allocation can be received by the first tuner/demodulator 130C of the broadcast receiving apparatus 100 according to the present embodiment, for example.

FIG. 4C illustrates one example of a system at the broadcast station side, which realizes a generating process for an OFDM transmission wave that is a digital broadcast wave of the dual-polarized terrestrial digital broadcasting, the single-polarized broadcasting, and the layered division terrestrial digital multiplexing terrestrial digital broadcasting according to the present embodiment. An information source coder 411 codes each of video/audio/various kinds of data. A multiplexer/conditional access processor 415 multiplexes the video/audio/various kinds of data respectively coded in the information source coder 411; further executes a process corresponding to conditional access appropriately; and outputs them as a packet stream. A plurality of information source coders 411 and a plurality of multiplexer/conditional access processors 415 can be provided parallelly, thereby generating a plurality of packet streams. A transmission path coder 416 remultiplexes the plurality of packet streams to create one packet stream, and executes a transmission path coding process to output it as the OFDM transmission wave. In the configuration illustrated in FIG. 4C, details of a method of information source coding and transmission path coding are different, but a configuration of realizing the generating process for the OFDM transmission wave is common to the ISDB-T method. Therefore, a part of the plurality of information source coders 411 and the plurality of multiplexer/conditional access processors 415 may be configured for the terrestrial digital broadcasting service with the ISDB-T method, another part thereof may be configured for the advanced terrestrial digital broadcasting service, and packet streams of a plurality of different terrestrial digital broadcasting services may be multiplexed in the transmission path coder a 416. In case where the multiplexer/conditional access processor 415 is configured for the terrestrial digital broadcasting service with the ISDB-T method, the MPEG-2 TS that is a stream of a TSP (Transport Stream Packet) defined by MPEG-2 systems may be generated. Further, in a case where the multiplexer/conditional access processor 415 is configured for the advanced terrestrial digital broadcasting service, the MMT packet stream or a TLV stream including the MMT packet or the stream of the TSP defined by another system may be generated. Of course, all of the plurality of information source coders 411 and the plurality of multiplexer/conditional access processors 415 may be configured for the advanced terrestrial digital broadcasting service, and all of the packet streams to be multiplexed by the transmission path coder 416 may be a packet stream for the advanced terrestrial digital broadcasting service.

FIG. 4D illustrates one example of a configuration of the transmission path coder 416.

First, (1) of FIG. 4D will be described. (1) of FIG. 4D is a configuration of the transmission path coder 416 in a case where only the OFDM transmission wave of the digital broadcasting for the existing terrestrial digital broadcasting service is generated. The OFDM transmission wave transmitted by this configuration has a segment configuration illustrated in (3) of FIG. 4B, for example. Redundancy of error correction is added to the packet stream inputted from the multiplexer/conditional access processor 415 and subjected to a remultiplexing process, and various kinds of interleaving processes such as byte interleaving, bit interleaving, time interleaving, or frequency interleaving are also executed for the packet stream. Then, a process by IFFT (Inverse Fast Fourier Transform) is executed together with a pilot signal, the TMCC signal, and the AC signal, and it becomes the OFDM transmission wave through orthogonal modulation after a guard interval is added. Note that the processes of an outer coding process, a power spreading process, the byte interleaving, an inner coding process, a bit interleaving process, and a mapping process are configured so that the processes can be executed separately for each layer such as the A layer or the B layer. (Note that the digital broadcasting of the existing terrestrial digital broadcasting service has two layers in its operation, but it is possible to transmit up to three layers. For this reason, (1) of FIG. 4D illustrates an example of three layers.) The mapping process is a modulating process for a carrier. Further, in the packet stream inputted from the multiplexer/conditional access processor 415, information such as the TMCC information, a mode, or a guard interval ratio may be multiplexed. Note that as described above, the packet stream inputted into the transmission path coder 416 may be a stream of the TSP defined by the MPEG-2 systems. The OFDM transmission wave generated by the configuration illustrated in (1) of FIG. 4D can be received by the first tuner/demodulator 130C of the broadcast receiving apparatus 100 according to the present embodiment, for example.

Next, (2) of FIG. 4D will be described. (2) of FIG. 4D is a configuration of the transmission path coder 416 in a case where the OFDM transmission wave of the dual-polarized terrestrial digital broadcasting according to the present embodiment is generated. The OFDM transmission wave transmitted by this configuration has a segment configuration illustrated in (1) or (2) of FIG. 4B, for example. In (2) of FIG. 4D, various kinds of interleaving processes such as the byte interleaving, the bit interleaving, the time interleaving, or the frequency interleaving are also executed for the packet stream inputted from the multiplexer/conditional access processor 415 and subjected to the remultiplexing process in addition to addition of redundancy of error correction. Then, a process by the IFFT is executed together with the pilot signal, the TMCC signal, and the AC signal, and it becomes the OFDM transmission wave through the orthogonal modulation after a guard interval adding process is executed.

In the configuration example illustrated in (2) of FIG. 4D, processes of the outer coding process, the power spreading process, the byte interleaving, the inner coding process, the bit interleaving process, the mapping process, and the time interleaving are configured so that the processes can be executed separately for each layer such as the A layer, the B layer, or the C layer. However, in the configuration example illustrated in (2) of FIG. 4D, not only the OFDM transmission wave of a horizontal polarized wave (H) but also the OFDM transmission wave of a vertical polarized wave (V) is generated, and a processing flow thus branches to two lines. When branching from a processing system of the horizontal polarized wave (H) to a processing system of the vertical polarized wave (V), it is possible to differentiate, for each layer in accordance with the segment configuration explained with reference to (1) or (2) of FIG. 4B, whether the same data as that of the processing system of the horizontal polarized wave (H) is caused to branch to the processing system of the vertical polarized wave (V), different data from that of the processing system of the horizontal polarized wave (H) is caused to branch to the processing system of the vertical polarized wave (V), or any data is caused not to branch to the processing system of the vertical polarized wave (V).

As the processes indicated in the configuration of (2) of FIG. 4D, such as the outer code, the inner code, or the mapping, it is possible to use a more advanced process that is not adopted in each process of the configuration of (1) of FIG. 4D in addition to the processes compatible with the configuration of (1) of FIG. 4D. Specifically, in the configuration of (2) of FIG. 4D, for a portion where the process is executed for each layer, the processes compatible with (1) of FIG. 4D are executed in the layer in which the mobile receiving service of the existing terrestrial digital broadcasting or the existing terrestrial digital broadcasting service for transmitting the video whose maximum resolution is 1920 horizontal pixels×1080 vertical pixels is transmitted with respect to the processes such as the outer code, the inner code, or the mapping. On the other hand, in the configuration of (2) of FIG. 4D, for a portion where the process is executed for each layer, it may be configured so that more advanced process that is not adopted in each process of the configuration of (1) of FIG. 4D is used for the layer in which the advanced terrestrial digital broadcasting service capable of transmitting the video whose maximum resolution is the number of pixels that exceeds 1920 horizontal pixels×1080 vertical pixels is transmitted with respect to the processes such as the outer code, the inner code, or the mapping.

Note that in the dual-polarized terrestrial digital broadcasting according to the present embodiment, the TMCC information (will be described later) allows allocation of layer and the terrestrial digital broadcasting service to be transmitted to be switched. For this reason, it is desirable that it is configured so that the process such as the outer code, the inner code, or the mapping to be subjected to each layer can be switched by the TMCC information.

Note that with respect to the layer for transmitting the advanced terrestrial digital broadcasting service in which the video whose maximum resolution is the number of pixels that exceeds 1920 horizontal pixels×1080 vertical pixels can be transmitted, as the byte interleaving, the bit interleaving, and the time interleaving, a process compatible with the existing terrestrial digital broadcasting service may be executed, or more advanced different process may be executed. Alternatively, with respect to the layer for transmitting the advanced terrestrial digital broadcasting service, part of the interleavings may be omitted.

Further, in the configuration illustrated in (2) of FIG. 4D, an input stream that becomes a source of the layer in which the mobile receiving service of the existing terrestrial digital broadcasting or the existing terrestrial digital broadcasting service for transmitting the video whose maximum resolution is 1920 horizontal pixels×1080 vertical pixels is transmitted may be a stream of the TSP defined by the MPEG-2 systems that is adopted by the existing terrestrial digital broadcasting among the packet streams inputted into the transmission path coder 416. An input stream that becomes a source of the layer for transmitting the advanced terrestrial digital broadcasting service with the configuration illustrated in (2) of FIG. 4D may be a stream defined by a system different from the stream of the TSP defined by the MPEG-2 systems such as the MMT packet stream or the TLV including MMT packet among the packet streams inputted into the transmission path coder 416. However, a stream of the TSP defined by the MPEG-2 systems in the advanced terrestrial digital broadcasting service may be adopted.

In the configuration of (2) of FIG. 4D explained above, in the layer in which the mobile receiving service of the existing terrestrial digital broadcasting or the existing terrestrial digital broadcasting service for transmitting the video whose maximum resolution is 1920 horizontal pixels×1080 vertical pixels is transmitted, a stream form compatible with the existing terrestrial digital broadcasting and a process are maintained until the OFDM transmission wave is generated from the input stream. As a result, even in a case where the receiving apparatus for the existing terrestrial digital broadcasting service receives one of the OFDM transmission wave of the horizontal polarized wave and the OFDM transmission wave of the vertical polarized wave generated in the configuration illustrated in (2) of FIG. 4D, it becomes possible to receive and demodulate the broadcasting signal of the terrestrial digital broadcasting service correctly with respect to the layer in which the mobile receiving service of the existing terrestrial digital broadcasting or the existing terrestrial digital broadcasting service for transmitting the video whose maximum resolution is 1920 horizontal pixels×1080 vertical pixels is transmitted.

Further, in the configuration illustrated in (2) of FIG. 4D, it is possible to transmit the advanced terrestrial digital broadcasting service capable of transmitting the video whose maximum resolution is the number of pixels that exceeds 1920 horizontal pixels×1080 vertical pixels in the layer in which segments of both the OFDM transmission wave of the horizontal polarized wave and the OFDM transmission wave of the vertical polarized wave are used, and it becomes possible to receive and demodulate the broadcasting signal of the advanced terrestrial digital broadcasting service by the broadcast receiving apparatus 100 according to the embodiment of the present invention.

Namely, in the configuration illustrated in (2) of FIG. 4D, it is possible to generate a digital broadcast wave by which the digital broadcasting can be received and demodulated suitably in both the broadcast receiving apparatus that is compatible with the advanced terrestrial digital broadcasting service and the receiving apparatus for the existing terrestrial digital broadcasting service.

Note that when generating the OFDM transmission wave of the single-polarized terrestrial digital broadcasting according to the present embodiment, the transmission path coder 416 illustrated in (2) of FIG. 4D may be configured of only the processing system for generating the OFDM transmission wave of the horizontal polarized wave (H) or the processing system for generating the OFDM transmission wave of the vertical polarized wave (V). Also in this case, the OFDM transmission wave transmitted in this configuration has the segment configuration of (1) or (2) in FIG. 4B, but only one of the OFDM transmission wave of the horizontal polarized wave and the OFDM transmission wave of the vertical polarized wave is transmitted unlike the case of generating the OFDM transmission wave of the dual-polarized terrestrial digital broadcasting described above. The other configuration and operation are the same as those of the case of generating the OFDM transmission wave of the dual-polarized terrestrial digital broadcasting described above.

Next, (3) of FIG. 4D will be described. (3) of FIG. 4D is a configuration of the transmission path coder 416 in a case where the OFDM transmission wave of the layered division multiplexing terrestrial digital broadcasting according to the present embodiment is generated. In (3) of FIG. 4D as well, various kinds of interleaving processes such as the byte interleaving, the bit interleaving, the time interleaving, or the frequency interleaving are also executed for the packet stream inputted from the multiplexer/conditional access processor 415 and subjected to the remultiplexing process in addition to addition of redundancy of error correction. Then, a process by the IFFT is executed together with the pilot signal, the TMCC signal, and the AC signal, and it becomes the OFDM transmission wave through the orthogonal modulation after the guard interval is added.

However, in the configuration of (3) of FIG. 4D, each of a modulation wave transmitted by the upper layer and a modulation wave transmitted by the lower layer is generated and multiplexed, and then the OFDM transmission wave that is a digital broadcast wave is generated. A processing system indicated at an upper side of the configuration illustrated in (3) of FIG. 4D is a processing system for generating the modulation wave to be transmitted by the upper layer, and a processing system indicated at a lower side is a processing system for generating the modulation wave to be transmitted by the lower layer. Data for transmitting the processing system for the generating the modulation wave to be transmitted by the upper layer illustrated in (3) of FIG. 4D are the mobile receiving service of the existing terrestrial digital broadcasting and the existing terrestrial digital broadcasting service for transmitting the video whose maximum resolution is 1920 horizontal pixels×1080 vertical pixels, and various kinds of processes in the processing system for generating the modulation wave to be transmitted by the upper layer illustrated in (3) of FIG. 4D are processes that are the same as various kinds of processed of (1) of FIG. 4D or has compatibility therewith. The modulation wave to be transmitted by the upper layer illustrated in (3) of FIG. 4D has a segment configuration illustrated in (3) of FIG. 4B as well as the transmission wave illustrated in (1) of FIG. 4D, for example. Therefore, the modulation wave to be transmitted by the upper layer illustrated in (3) of FIG. 4D is a digital broadcast wave that has compatibility with the mobile receiving service of the existing terrestrial digital broadcasting or the existing terrestrial digital broadcasting service for transmitting the video whose maximum resolution is 1920 horizontal pixels×1080 vertical pixels. On the other hand, data for transmitting the processing system for generating the modulation wave to be transmitted by the lower layer illustrated in (3) of FIG. 4D are the advanced terrestrial digital broadcasting service capable of transmitting the video whose maximum resolution is the number of pixels that exceeds 1920 horizontal pixels×1080 vertical pixels, for example, and it may be configured so that a more advanced process that is not adopted in each process of the configuration illustrated in (1) of FIG. 4D is used with respect to the processes such as the outer code, the inner code, or the mapping.

The modulation wave to be transmitted by the lower layer illustrated in (3) of FIG. 4D may be allocated to the advanced terrestrial digital broadcasting service capable of transmitting the video whose maximum resolution is the number of pixels that exceeds 1920 horizontal pixels×1080 vertical pixels by using all of the 13 segments as the A layer, for example. Alternatively, the mobile receiving service of the existing terrestrial digital broadcasting having a segment configuration illustrated in (3) of FIG. 4B may be transmitted by the A layer of one segment, and the advanced terrestrial digital broadcasting service capable of transmitting the video whose maximum resolution is the number of pixels that exceeds 1920 horizontal pixels×1080 vertical pixels may be transmitted by the B layer of 12 segments. In the case of the latter, as well as (2) of FIG. 4D, it may be configured so that the processes are switched for each layer such as the A layer or the B layer from the outer coding process to time interleaving process. In the layer for transmitting the mobile receiving service of the existing terrestrial digital broadcasting, it is similar to explanation for (2) of FIG. 4D in that it is necessary to maintain the process compatible with the existing terrestrial digital broadcasting.

In the configuration illustrated in (3) of FIG. 4D, the OFDM transmission wave, which is a terrestrial digital broadcast wave obtained by multiplexing the modulation wave to be transmitted by the upper layer and the modulation wave to be transmitted by the lower layer, is generated. A technique of separating the modulation wave to be transmitted by the upper layer from the OFDM transmission wave is also installed in the receiving apparatus of the existing terrestrial digital broadcasting service. For this reason, the broadcasting signal, which is contained in the modulation wave to be transmitted by the upper layer, of the mobile receiving service of the existing terrestrial digital broadcasting or the existing terrestrial digital broadcasting service for transmitting the video whose maximum resolution is 1920 horizontal pixels×1080 pixels is correctly received and demodulated by the receiving apparatus of the existing terrestrial digital broadcasting service. On the other hand, the broadcasting signal, which is contained in the modulation wave to be transmitted by the lower layer, of the advanced d terrestrial digital broadcasting service capable of transmitting the video whose maximum resolution is the number of pixels that exceeds 1920 horizontal pixels×1080 vertical pixels can be received and demodulated by the broadcast receiving apparatus 100 according to the embodiment of the present invention.

Namely, in the configuration illustrated in (3) of FIG. 4D, it is possible to generate the digital broadcast wave by which the digital broadcasting can be received and demodulated suitably in both the broadcast receiving apparatus that is compatible with the advanced terrestrial digital broadcasting service and the receiving apparatus of the existing terrestrial digital broadcasting service. Further, in the configuration illustrated in (3) of FIG. 4D, unlike the configuration illustrated in (2) of FIG. 4D, it is possible to generate the OFDM transmission wave that can be received more easily without necessity to use the plurality of polarized waves.

In the OFDM transmission wave generating process illustrated in (1) of FIG. 4D, (2) of FIG. 4D, and (3) of FIG. 4D according to the present embodiment, three types of modes with the different number of carriers are prepared in consideration of the suitability of a distance between stations of the SFN and the resistance to Doppler shift in mobile reception. Note that another mode with the different number of carriers may further be prepared. In a mode with a large number of carriers, an effective symbol length becomes longer, and a guard interval length becomes longer if the guard interval ratio (guard interval length/effective symbol length) is the same. This makes it possible to have resistance to multipath with a long delay time difference. On the other hand, in a case of a mode with the small number of carriers, a carrier interval becomes wide, and it is possible to reduce an influence of inter-carrier interference due to the Doppler shift that occurs in a case of mobile reception or the like.

In the OFDM transmission wave generating process illustrated in (1) of FIG. 4D, (2) of FIG. 4D, and (3) of FIG. 4D according to the present embodiment, it is possible to set, for each layer configured by one OFDM segment or a plurality of OFDM segments, parameters such as a carrier modulation method, a code rate of an inner code, or a length of time interleaving. FIG. 4E illustrates one example of a transmission parameter in units of one segment of the OFDM segment identified in the mode of the system according to the present embodiment. Note that a carrier modulation method in FIG. 4E indicates a modulation method of a “data” carrier. An SP signal, a CP signal, a TMCC signal, and an AC signal adopt a modulation method different from the modulation method of the “data” carrier. These signals are signals whose resistance to noise is more important than the quantity of information. For this reason, a modulation method of executing mapping to a constellation with a small number of states (BPSK or DBPSK, that is, two states) than the modulation method of “data” carrier (all are QPSK or more, that is, four states or more) is adopted, and this heightens the resistance to noise.

Further, each numerical value of the number of carriers is a value in a case where numerical values at a left side of an oblique line set QPSK, 16 QAM, or 64 QAM as the carrier modulation method, and is a value in a case where numerical values at a right side of the oblique line set DQPSK as the carrier modulation method. In FIG. 4E, underlined parameters are parameters each of which is not compatible with the mobile receiving service of the existing terrestrial digital broadcasting. Specifically, 256 QAM, 1024 QAM, and 4096 QAM in the modulation method of the “data” carrier are not adopted in the existing terrestrial digital broadcasting service. Therefore, in a process in the layer that requires compatibility with the existing terrestrial digital broadcasting service in an OFDM broadcast wave generating process according to (1) of FIG. 4D, (2) of FIG. 4D, and (3) of FIG. 4D of the present embodiment, 256 QAM, 1024 QAM, and 4096 QAM of the modulation method of the “data” carrier are not used. Further multi-level modulation method such as 256 QAM (the number of states is 256), 1024 QAM (the number of states is 1024), or 4096 QAM (the number of states is 4096) may be applied to the “data” carrier transmitted by the layer corresponding to the advanced terrestrial digital broadcasting service in addition to the modulation method that has compatibility with the existing terrestrial digital broadcasting service, such as QPSK (the number of states is 4), 16 QAM (the number of states is 16), or 64 QAM (the number of states is 64). Further, a modulation method different from these modulation methods may be adopted.

Note that as the modulation method for a pilot symbol (SP or CP) carrier, BPSK (the number of states is two) compatible with the existing terrestrial digital broadcasting service may be used. As the modulation method for an AC carrier and a TMCC carrier, DBPSK (the number of states is 2) compatible with the existing terrestrial digital broadcasting service may be used.

Further, as a method of the inner coding process, an LDPC code is not adopted in the existing terrestrial digital broadcasting service. Therefore, in the process for the layer necessary for compatibility with the existing terrestrial digital broadcasting service in the OFDM broadcast wave generating process illustrated in (1) of FIG. 4D, (2) of FIG. 4D, and (3) of FIG. 4D according to the present embodiment, the LDPC code is not used. The LDPC code may be applied, as the inner code, to the data to be transmitted by the layer that is compatible with the advanced terrestrial digital broadcasting service. Further, as a method of the outer coding process, a BCH code is not adopted in the existing terrestrial digital broadcasting service. Therefore, in the process for the layer necessary for compatibility with the existing terrestrial digital broadcasting service in the OFDM broadcast wave generating process illustrated in (1) of FIG. 4D, (2) of FIG. 4D, and (3) of FIG. 4D according to the present embodiment, the BCH code is not used. The BCH code may be applied, as the outer code, to the data to be transmitted by the layer that is compatible with the advanced terrestrial digital broadcasting service.

Further, FIG. 4F illustrates one example of a transmission signal parameter in units of one physical channel (6 MHz bandwidth) of the OFDM broadcast wave generating process illustrated in (1) Of FIG. 4D, (2) of FIG. 4D, and (3) of FIG. 4D according to the present embodiment. In the OFDM broadcast wave generating process illustrated in (1) of FIG. 4D, (2) of FIG. 4D, and (3) of FIG. 4D according to the present embodiment, for compatibility with the existing terrestrial digital broadcasting service, parameters compatible with the existing terrestrial digital broadcasting service are basically adopted in the parameters illustrated in FIG. 4F as a general rule. However, in a case where all of the segments in the modulation wave to be transmitted by the lower layer illustrated in (3) of FIG. 4D are allocated to the advanced terrestrial digital broadcasting service, it is not necessary to maintain compatibility with the existing terrestrial digital broadcasting service in the modulation wave. Therefore, in this case, parameters other than the parameters illustrated in FIG. 4F may be used with respect to the modulation wave to be transmitted by the lower layer illustrated in (3) of FIG. 4D.

Next, carriers of the OFDM transmission wave according to the present embodiment will be described. In addition to carriers by which data such as video or audio are transmitted, a carrier by which the pilot signal (SP, CP, AC1, or AC2) that becomes a reference of demodulation is transmitted, and a carrier by which the TMCC signal that is information on a modulation form and a convolution code rate of the carrier is transmitted are included in the carriers of the OFDM transmission wave according to the present embodiment. A number of carriers corresponding to 1/9 of the number of carriers for each segment is used for these types of transmission. Further, a concatenate code is adopted for the error correction; a shortened reed Solomon (204, 188) code is adopted for the outer code; a constraint length of 7 is adopted for the inner code; and a punctured convolution code with a code rate of ½ as a mother code is adopted. Coding different from the above may be used for both the outer code and the inner code. Information rate differs depending upon parameters such as a carrier modulation form, a convolution code rate, or a guard interval ratio.

Further, 204 symbols are set as one frame, and the integer number of ISPs are included in one frame. Switching of transmission parameters is executed at the boundary of this frame.

There are an SP (Scattered Pilot), a CP (Continual Pilot), an AC (Auxiliary Channel) 1, and an AC2 as the pilot signals to be a reference of demodulation. FIG. 4G illustrates one example of an arrangement image of the pilot signals in the segments in a case of synchronous modulation (such as QPSK, 16 QAM, 64 QAM, 256 QAM, 1024 QAM, or 4096 QAM). The SP is inserted into the segment of the synchronous modulation; is transmitted once to 12 carriers in a carrier number (frequency axis) direction; and is transmitted once to four symbols in an OFDM symbol number (time axis) direction. Since an amplitude and a phase of the SP are known, the SP can be used as a reference of synchronous demodulation. FIG. 4H illustrates one example of an arrangement image of the pilot signals in the segment in a case of differential modulation (such as DQPSK). The CP is a continuous signal that is inserted at a left end of the segment for differential modulation, and is used for demodulation.

The AC1 and the AC2 carry information on the CP, and is also used for transmission of information for broadcasters in addition to a role of the pilot signal. They may be used for transmission of other information.

Note that each of the arrangement images illustrated in FIG. 4G and FIG. 4H is an example of in a case of mode 3, and carrier numbers are 0 to 431. However, in a case of each of mode 1 and mode 2, carrier numbers are 0 to 107 or 0 to 215. Further, the carrier for transmitting the AC1, the AC2, or the TMCC may be determined in advance for each segment. Note that the carrier for transmitting the AC1, the AC2, and the TMCC are arranged at random in a frequency direction in order to reduce an influence of periodic dip of transmission path characteristics by multipath.

### [TMCC Signal]

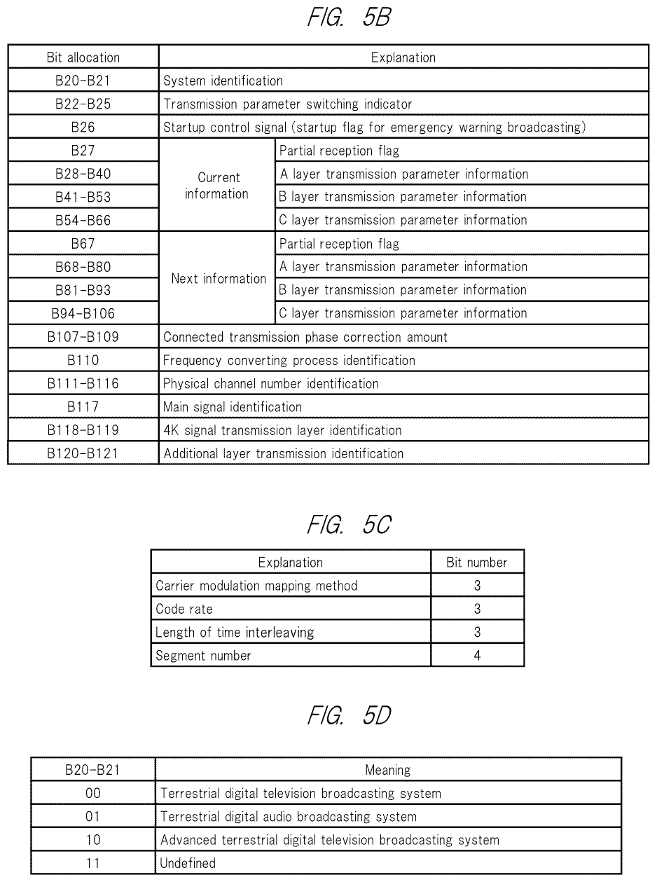

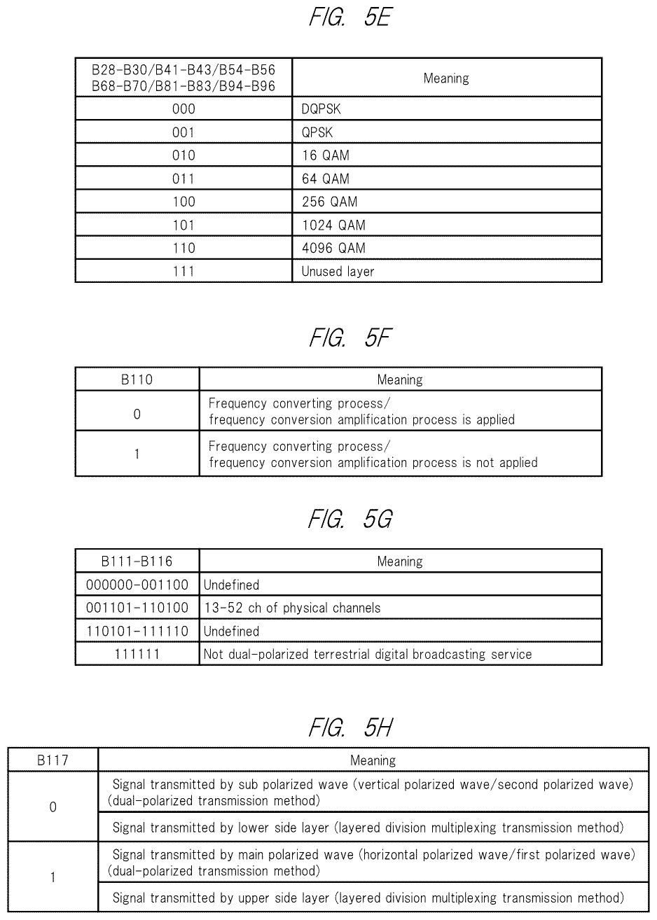

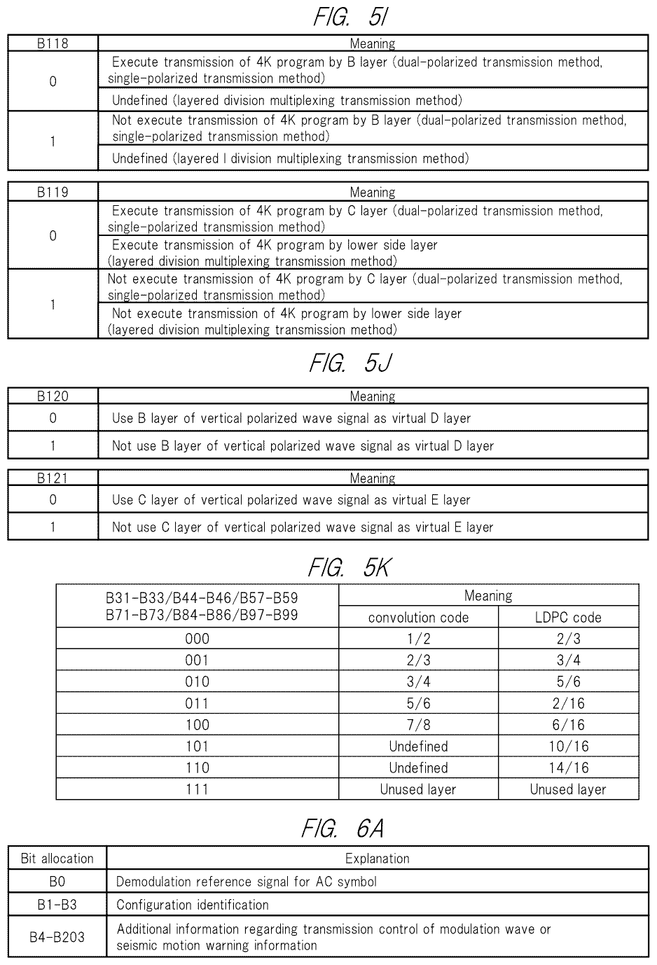

The TMCC signal transmits information (TMCC information) regarding a layer configuration, a transmission parameter of the OFDM segment, and a demodulation operation of the receiver. The TMCC signal is transmitted by a carrier for TMCC transmission defined in each segment. FIG. 5A illustrates one example of bit allocation of the TMCC carrier. The TMCC carrier is configured by 204 bits (B0 to B203). The B0 is a demodulation reference signal for a TMCC symbol, and has a predetermined amplitude and a predetermined phase reference. Each of the B1 to B16 is a synchronization signal, and is configured by words with 16 bits. As the synchronization signal, two types of w0 and w1 are defined, and the w0 and w1 are alternately sent out for each frame. The B17 to B19 are used for identification of a segment form, by which it is identified whether each segment is a differential modulator or a synchronous modulator. The TMCC information is described in the B20 to B121. The B122 to B203 are parity bits.

The TMCC information of the OFDM transmission wave according to the present embodiment may be configured so as to contain, as one example thereof, information for assisting demodulation and a decoding operation of the receiver, such as system identification, a transmission parameter switching indicator, a startup control signal (a startup flag for emergency warning broadcasting), current information, next information, frequency converting identification, physical channel number identification, process main transmission signal identification, 4K signal layer identification, or additional layer transmission identification, for example. The current information indicates a current layer configuration and a transmission parameter, and the next information indicates a layer configuration and a transmission parameter after switching. The switching of the transmission parameter is executed in units of frame. FIG. 5B illustrates one example of bit allocation of the TMCC information. Further, FIG. 5C illustrates one example of a configuration of transmission parameter information contained in the current information/next information. Note that a connected transmission phase correction amount is control information used in a case of terrestrial digital audio broadcasting ISDB-TSB (ISDB for Terrestrial Sound Broadcasting) having a common transmission method, and detailed explanation herein is omitted.

FIG. 5D illustrates one example of bit allocation of the system identification. Two bits are allocated to a signal for the system identification. In a case of an existing terrestrial digital television broadcasting system, “00” is set. In a case where the transmission method is a common terrestrial digital audio broadcasting system, “01” is set. Further, in a case of an advanced terrestrial digital television broadcasting system such as the dual-polarized terrestrial digital broadcasting, the single-polarized terrestrial digital broadcasting, or the layered division multiplexing terrestrial digital broadcasting according to the present embodiment, “10” is set. In the advanced terrestrial digital television broadcasting system, it is possible to transmit a 2K broadcasting program (that is, a broadcasting program of video with 1920 horizontal pixels×1080 vertical pixels, a broadcasting program of video with lower resolution than it) and a 4K broadcasting program (that is, a broadcasting program of video with resolution that exceeds 1920 horizontal pixels×1080 vertical pixels, not limited to a broadcasting program of video with resolution of 3840 horizontal pixels×2160 vertical pixels) in the same service at the same time by means of broadcast wave transmission by the dual-polarized transmission method, the single-polarized transmission method, or the layered division multiplexing method.

The transmission parameter switching indicator is used to notify the receiver of switching timing by counting down when the transmission parameters are switched. This indicator is a value of “1111” at a normal time. In a case where the transmission parameters are switched, this indicator is subtracted by one for each frame from 15 frames before switching. The switching timing is next frame synchronization in which “0000” is sent out. A value of the indicator returns to “1111” after “0000”. Countdown is executed in a case where any one or more of parameters such as the system identification of the TMCC information illustrated in FIG. 5B, the transmission parameter information contained in the current information/next information, the frequency converting process identification, the main signal identification, the 4K signal transmission layer identification, or the additional layer transmission identification is switched. Countdown is not executed in a case where only the startup control signal of the TMCC information is switched.

The startup control signal (that is, the startup flag for the emergency warning broadcasting) is set to “1” when a startup control to the receiver is executed in the emergency warning broadcasting. The startup control signal is set to “0” when the startup control is not executed.

A partial reception flag for each of the current information/next information is set to “1” in a case where a segment in the center of the transmission band is set to partial reception. Otherwise, the partial reception flag thereof is set to “0”. In a case where segment 0 is set for partial reception, the layer is defined as the A layer. In a case where the next information does not exist, the partial reception flag set to “1”.

FIG. 5E illustrates one example of bit allocation for a carrier modulation mapping method (a modulation method for the data carrier) in each layer transmission parameter for each of the current information/next information. In a case where this parameter is “000”, it indicates that the modulation method is DQPSK. In a case where this parameter is “001”, it indicates that the modulation method is QPSK. In a case where this parameter is “010”, it indicates that the modulation method is 16 QAM. In a case where this parameter is “011”, it indicates that the modulation method is 64 QAM. In a case where this parameter is “100”, it indicates that the modulation method is 256 QAM. In a case where this parameter is “101”, it indicates that the modulation method is 1024 QAM. In a case where this parameter is “110”, it indicates that the modulation method is 4096 QAM. In a case where any unused layer or the next information does not exist, this parameter is set to “111”.

For setting of the code rate or the length of the time interleaving, each parameter may be set in accordance with the organization information of each layer for each of the current information/next information. The number of segments indicates the number of segments of each layer by a numerical value of four bits. In a case where any unused layer or the next information does not exist, the number of segments is set to “1111”. Note that since settings of a mode or a guard interval ratio are independently detected at the receiver side, transmission by the TMCC information may not be executed.

FIG. 5F illustrates one example of bit allocation of the frequency converting process identification. The frequency converting process identification is set to “0” in a case where a frequency converting process (in a case of the dual-polarized transmission method) (will be described later) or a frequency conversion amplification process (in a case of the layered division multiplexing transmission method) is executed in the converter 201T or the converter 201L illustrated in FIG. 2A. In a case where the frequency converting process or the frequency conversion amplification process is not executed, the frequency converting process identification is set to “1”. This parameter may be configured so as to be set to “1” when it is sent out from the broadcast station, for example. This parameter may be configured so as to be rewritten into “0” in the converter 201T or the converter 201L when the frequency converting process or the frequency conversion amplification process is executed in the converter 201T or the converter 201L. In this manner, in a case where it is received by the second tuner/demodulator 130T or the third tuner/demodulator 130L of the broadcast receiving apparatus 100 and a bit of the frequency converting process identification is “0”, it is possible to identify that the frequency converting process was executed after the OFDM transmission wave was sent out from the broadcast station.

In the dual-polarized terrestrial digital broadcasting according to the present embodiment, the setting or rewriting of the frequency converting process identification bit may be executed in each of the plurality of polarized waves. For example, in a case where both of the plurality of polarized waves is not subjected to frequency conversion in the converter 201T of FIG. 2A, the frequency converting process identification bit contained in the OFDM transmission wave of each of the both may be left as “1”. Further, in a case where only one polarized wave of the plurality of polarized waves is subjected to frequency conversion in the converter 201T, the frequency converting process identification bit included in the OFDM transmission wave of the polarized wave subjected to the frequency conversion may be rewritten into “0” in the converter 201T. Further, in a case where both of the plurality of polarized waves is subjected to frequency conversion in the converter 201T, the frequency converting process identification bit included in the OFDM transmission wave of each of both of polarized waves subjected to the frequency conversion may be rewritten into “0” in the converter 201T. In this manner, it is possible to identify presence or absence of the frequency conversion for each polarized wave of the plurality of polarized waves in the broadcast receiving apparatus 100.

Note that since the frequency converting process identification bit is not defined in the existing terrestrial digital broadcasting, s ignored in a terrestrial digital broadcast receiving apparatus that has already been used by the user. However, the bit may be introduced into a new terrestrial digital broadcasting service obtained by improving the existing terrestrial digital broadcasting, in which the video whose maximum resolution is 1920 horizontal pixels×1080 vertical pixels is transmitted. In this case, the first tuner/demodulator 130C of the broadcast receiving apparatus 100 according to the embodiment of the present invention may also be configured as a first tuner/demodulator that is compatible with the new terrestrial digital broadcasting service.

Note that as a modification example, on the assumption that the frequency converting process or the frequency conversion amplification process is executed for the OFDM transmission wave in the converter 201T or the converter 201L illustrated in FIG. 2A, this parameter may be set to “0” in advance when it is sent out from the broadcast station. Note that in a case where the broadcast wave to be received is not the advanced terrestrial digital broadcasting service, this parameter may be configured so as to be set to “1”.

FIG. 5G illustrates one example of bit allocation of the physical channel number identification. The physical channel number identification is configured by a code with six bits, and identifies a physical channel number (13 ch to 52 ch) of the broadcast wave to be received. In a case where the broadcast wave to be received is not the advanced terrestrial digital broadcasting service, this parameter is set to “111111”. A bit of the physical channel number identification is not defined in the existing terrestrial digital broadcasting. Thus, the receiving apparatus of the existing terrestrial digital broadcasting could not obtain a physical channel number of a broadcast wave specified at the broadcast station side from the TMCC signal or the AC signal. In the broadcast receiving apparatus 100 according to the embodiment of the present invention, even though the carrier other than the TMCC signal or the AC signal is not demodulated by using the bit of the physical channel number identification of the received OFDM transmission wave, it is possible to grasp the physical channel number that the broadcast station sets for the OFDM transmission wave. Note that the physical channels 13 ch to 52 ch have a bandwidth of 6 MHz per one ch, and are allocated to a frequency band from 470 to 710 MHz in advance. Therefore, the fact that the broadcast receiving apparatus 100 can grasp the physical channel number of the OFDM transmission wave on the basis of the bit of the physical channel number identification means that the frequency band in which the OFDM transmission wave is transmitted in the air as the terrestrial digital broadcast wave can be grasped.

In the dual-polarized terrestrial digital broadcasting according to the present embodiment, in the OFDM transmission wave generating process at the broadcast station side, bits of the physical channel number identification may be arranged in each of the pair of polarized waves of the plurality of polarized waves in the bandwidth that originally constitutes one physical channel, and the same physical number may be given thereto. Here, depending upon installation environment of the broadcast receiving apparatus 100, only frequency of one polarized wave of the plurality of polarized waves may be converted in the converter 201T illustrated in FIG. 2A. As a result, in a case where the frequencies of the pair of polarized waves of the plurality of polarized waves are different from each other when they are received by the broadcast receiving apparatus 100, the broadcast receiving apparatus side cannot demodulate the advanced terrestrial digital broadcasting by using both of the polarized waves of the dual-polarized terrestrial digital broadcasting if it is impossible to grasp, by any method, that the plurality of polarized waves with different frequencies were originally the pair of polarized waves. Even in such a case, by using the bits of the physical channel number identification described above, in a case where the transmission wave in which the bits of the physical channel number identification indicate that the same value exists in a plurality of different frequencies in the broadcast receiving apparatus 100, it is possible to identify that it is a transmission wave transmitted as a pair of polarized waves that originally constitutes one physical channel at the broadcast station side. This makes it possible to realize demodulation of the advanced terrestrial digital broadcasting of the dual-polarized terrestrial digital broadcasting by using a plurality of transmission waves each indicating the same value.

FIG. 5H illustrates one example of bit allocation of the main signal identification. The present embodiment is an example in which a bit of the main signal identification is arranged in bit B117.

In a case where the OFDM transmission wave to be transmitted is a transmission wave of the dual-polarized terrestrial digital broadcasting, this parameter is set to “1” in the TMCC information of a transmission wave to be transmitted by a main polarized wave. This parameter is set to “0” in the TMCC information of a transmission wave to be transmitted by a sub polarized wave. Note that the transmission wave to be transmitted by the main polarized wave indicates a polarization signal in the same polarization direction as the polarization direction used for transmission of the existing terrestrial digital broadcasting service of vertical polarization signal and a horizontal polarization signal. Namely, in regions where transmission by the horizontal polarized wave is adopted in the existing terrestrial digital broadcasting service, in the dual-polarized terrestrial digital broadcasting service, the horizontal polarized wave is a main polarized wave, and the vertical polarized wave is a sub polarized wave. Further, in areas where transmission by the vertical polarized wave is adopted in the existing terrestrial digital broadcasting service, in the dual-polarized terrestrial digital broadcasting service, the vertical polarized wave is a main polarized wave, and the horizontal polarized wave is a sub polarized wave.

In the broadcast receiving apparatus 100 according to the embodiment of the present invention that receives the transmission wave of the dual-polarized terrestrial digital broadcasting, by using the bit of the main signal identification, it is possible to identify whether the received transmission wave is transmitted by the main polarized wave or is transmitted by the sub polarized wave at the time of transmission thereof. For example, by using an identifying process for the main polarized wave and the sub polarized wave, it becomes possible to execute a process in which at the time of an initial scan (will be described later), an initial scan is first executed for the transmission wave transmitted by the main polarized wave, and an initial scan is then executed for the transmission wave transmitted by the sub polarized wave after the initial scan for the transmission wave transmitted by the main polarized wave is completed.

Details of a configuration example of the digital broadcasting service for transmitting layers and segments of the dual-polarized terrestrial digital broadcasting according to the present embodiment will be described later. However, in a case where the existing terrestrial digital broadcasting service is transmitted by using a layer constituting a segment contained only in the main polarized wave and an advanced terrestrial digital service is transmitted by a layer containing a segment contained in both the main polarized wave and the sub polarized wave, the initial scan may first be executed for the transmission wave transmitted by the main polarized wave; the initial scan for the existing terrestrial digital broadcasting service may be completed; and then, the initial scan may be executed for the transmission wave transmitted by the sub polarized wave to execute the initial scan for the advanced terrestrial digital broadcasting service. In this manner, it is possible to execute the initial scan for the advanced terrestrial digital broadcasting service after the initial scan for the existing terrestrial digital broadcasting service is completed. This makes it possible to favorably reflect settings of the initial scan for the existing terrestrial digital broadcasting service to settings by the initial scan for the advanced terrestrial digital broadcasting service.

Note that the definition of meanings of “1” and “0” of the bit of the main signal identification may be the reverse of the explanation described above.

Further, in place of the bit of the main signal identification, a polarization direction identification bit may be used as one parameter of the TMCC information. Specifically, the polarization direction identification bit may be set to “1” at the broadcast station side for the transmission wave to be transmitted by the horizontal polarized wave, and the polarization direction identification bit is set to “0” at the broadcast station side for the transmission wave to be transmitted by the vertical polarized wave. In the broadcast receiving apparatus 100 according to the embodiment of the present invention that receives the transmission wave of the dual-polarized terrestrial digital broadcasting, by using the polarization direction identification bit, it is possible to identify whether the received transmission wave is transmitted in any polarization direction at the time of the transmission thereof. For example, by using an identifying process for the polarization direction, it becomes possible to execute a process in which at the time of an initial scan (will be described later), an initial scan is first executed for the transmission wave transmitted by the horizontal polarized wave, and an initial scan is then executed for the transmission wave transmitted by the vertical polarized wave after the initial scan for the transmission wave transmitted by the horizontal polarized wave is completed. With respect to explanation of effects of the process, the “main polarized wave” in the part regarding the initial scan in the explanation described above for the bit of the main signal identification may be read as the “horizontal polarized wave”, and the “sub polarized wave” may be read as the “vertical polarized wave”. For this reason, repeated explanation thereof is omitted.

Note that the definition of meanings of “1” and “0” of the polarization direction identification bit may be the reverse of the explanation described above.

Further, in place of the bit of the main signal identification described above, a first signal/second signal identification bit may be used as one parameter of the TMCC information. Specifically, one polarized wave of the horizontal polarized wave and the vertical polarized wave may be defined as a first polarized wave; a broadcasting signal of the transmission wave to be transmitted by the first polarized wave may be defined as a first signal; and the first signal/second signal identification bit may be set to “1” at the broadcast station side.

Further, the other polarized wave may be defined as a second polarized wave; a broadcasting signal of the transmission wave to be transmitted by the second polarized wave may be defined as a second signal; and the first signal/second signal identification bit may be set to “0” at the broadcast station side. In the broadcast receiving apparatus 100 according to the embodiment of the present invention that receives the transmission wave of the dual-polarized terrestrial digital broadcasting, by using the first signal/second signal identification bit, it is possible to identify whether the received transmission wave is transmitted in any polarization direction at the time of the transmission thereof. Note that in the first signal/second signal identification bit, concepts of the “main polarized wave” and the “sub polarized wave” from the definition of the bit of the main signal identification described above are merely replaced by the “first polarized wave” and the “second polarized wave”. With respect to the process and the effects of the broadcast receiving apparatus 100, the “main polarized wave” in the part regarding the process of the broadcast receiving apparatus 100 in the explanation described above for the bit of the main signal identification may be read as the “first polarized wave”, and the “sub polarized wave” may be read as the “second polarized wave”. For this reason, repeated explanation thereof is omitted.

Note that the definition of meanings of “1” and “0” of the first signal/second signal identification bit may be the reverse of the explanation described above.

Note that the main signal identification, the polarization direction identification, and the first signal/second signal identification described above are not essential when the broadcast wave is the service of the single-polarized terrestrial digital broadcasting according to the present embodiment and when the broadcast wave is not the service of the advanced terrestrial digital broadcasting according to the present embodiment, and this parameter may be set to “1”.

Next, in the transmission wave of the layered division multiplexing terrestrial digital broadcasting according to the present embodiment, in place of the bit of the main signal identification described above, an upper/lower layer identification bit may be used as one parameter of the TMCC information. Specifically, the upper/lower layer identification bit described above may be set to “1” in the TMCC information of the modulation wave to be transmitted by the upper layer, and the upper/lower layer identification bit described above may be set to “0” in the TMCC information of the transmission wave to be transmitted by the lower layer. Further, in a case where the broadcast wave is not the advanced terrestrial digital broadcasting service, this parameter may be set to “1”.

In the layered division multiplexing terrestrial digital broadcasting according to the present embodiment, in the generating process for the OFDM transmission wave at the broadcast station, with respect to a lower layer of a plurality of modulation waves originally transmitted by an upper layer and a lower layer of one physical channel, frequency conversion and signal amplification may be executed by the converter 201L illustrated in FIG. 2A depending upon installation environment of the broadcast receiving apparatus 100. In a case where the broadcast receiving apparatus 100 receives the transmission wave of the layered division multiplexing terrestrial digital broadcasting, it is possible to identify, on the basis of the upper/lower layer identification bit described above, whether it is the modulation wave originally transmitted by the upper layer or the modulation wave transmitted by the lower layer. For example, by means of the identifying process, it is possible to execute the initial scan for the advanced terrestrial digital broadcasting service to be transmitted by the lower layer after the initial scan for the existing terrestrial digital broadcasting service to be transmitted by the upper layer is completed, and this makes it possible to reflect the settings of the initial scan for the existing terrestrial digital broadcasting service to the settings by the initial scan for the advanced terrestrial digital broadcasting service. Further, in the third tuner/demodulator 130L of the broadcast receiving apparatus 100, it is possible to use the identification result for switching between the demodulator 133S and the demodulator 133L.

Note that in description of the dual-polarized transmission method according to each embodiment described below, unless otherwise specified, an example in which the horizontal polarized wave is the main polarized wave and the vertical polarized wave is the sub polarized wave will be described as one example. However, with respect to the horizontal polarized wave and the vertical polarized wave, the relation between the main and the sub may be reversed.

FIG. 5I illustrates one example of bit allocation of the 4K signal transmission layer identification.

In a case where the broadcast wave to be transmitted is the transmission wave of the dual-polarized terrestrial digital broadcasting service according to the present embodiment, a bit of the 4K signal transmission layer identification may indicate whether transmission of the 4K broadcasting program is executed for each of the B layer and the C layer by using both the horizontal polarization signal and the vertical polarization signal or not. One bit is allocated to each of setting of the B layer and setting of the C layer. For example, in a case where the bit of the 4K signal transmission layer identification for each of the B layer and the C layer is “0”, it may indicate that the transmission of the 4K broadcasting program is executed by using both the horizontal polarization signal and the vertical polarization signal in the layer. In a case where the bit of the 4K signal transmission layer identification for each of the B layer and the C layer is “1”, it may indicate that transmission of the 4K broadcasting program using both the horizontal polarization signal and the vertical polarization signal in the layer is not executed. In this manner, it is possible to identify whether the transmission of the 4K broadcasting program is executed by using both the horizontal polarization signal and the vertical polarization signal for each of the B layer and the C layer or not by using the bit of the 4K signal transmission layer identification in the broadcast receiving apparatus 100.

Also, in a case where the broadcast wave to be transmitted is the transmission wave of the single-polarized terrestrial digital broadcasting service according to the present embodiment, a bit of the 4K signal transmission layer identification may indicate whether transmission of the 4K broadcasting program is executed for each of the B layer and the C layer or not. One bit is allocated to each of setting of the B layer and setting of the C layer. For example, in a case where the bit of the 4K signal transmission layer identification for each of the B layer and the C layer is “0”, it may indicate that the transmission of the 4K broadcasting program is executed in the layer. In a case where the bit of the 4K signal transmission layer identification for each of the B layer and the C layer is “1”, it may indicate that transmission of the 4K broadcasting program in the layer is not executed. In this manner, it is possible to identify whether the transmission of the 4K broadcasting program is executed for each of the B layer and the C layer or not by using the bit of the 4K signal transmission layer identification in the broadcast receiving apparatus 100.

Further, in a case where the broadcast wave to be transmitted is a broadcast wave of the layered division multiplexing terrestrial digital broadcasting service according to the present embodiment, the bit of the 4K signal transmission layer identification may indicate whether transmission of the 4K broadcasting program by the lower layer is to be executed or not. In a case where B119 of this parameter is “0”, transmission of the 4K broadcasting program by the lower layer is executed. In a case where B119 of this parameter is “1”, transmission of the 4K broadcasting program by the lower layer is not executed. In this manner, it is possible to identify whether the transmission of the 4K broadcasting program by the lower layer is executed or not by using the bit of the 4K signal transmission layer identification in the broadcast receiving apparatus 100. Note that in a case where the broadcast wave to be transmitted is a broadcast wave of the layered division multiplexing terrestrial digital broadcasting service according to the present embodiment, B118 of this parameter may be undefined.

Note that in a case where this parameter is “0”, it is possible to adopt a modulation method of NUC (Non-Uniform Constellation) in addition to a basic modulation method illustrated in FIG. 5E as the carrier modulation mapping method. In this case, it is possible to transmit the current information/next information of transmission parameter additional information regarding the B layer/C layer by using the AC1 and the like.

Further, in a case where the broadcast wave to be transmitted is not the advanced terrestrial digital broadcasting service, each of these parameters may be set to “1”.

Note that the definition of “0” and “1” of the bit of the 4K signal transmission layer identification explained above may be the reverse of the explanation described above.

FIG. 5J illustrates one example of bit allocation of the additional layer transmission identification. A bit of the additional layer transmission identification may indicate that the broadcast wave to be transmitted is the dual-polarized terrestrial digital broadcasting service according to the present embodiment and whether each of the B layer and the C layer of the transmission wave to be transmitted by the sub polarized wave is used as a virtual D layer or a virtual E layer or not.

For example, in the example of FIG. 5J, a bit arranged in B120 is a D layer transmission identification bit. In a case where this parameter is “0”, the B layer to be transmitted by the sub polarized wave is used as the virtual D layer. This means that to be expressed precisely, a group of segments each having the same segment number as the segment belonging to the B layer to be transmitted by the main polarized wave among the segments to be transmitted by the sub polarized wave is treated as the D layer that is a different layer from the B layer to be transmitted by the main polarized wave. In a case where this parameter is “1”, the B layer to be transmitted by the sub polarized wave is not used as the virtual D layer, but is used as the B layer.

Further, for example, a bit arranged in B121 is an E layer transmission identification bit. In a case where this parameter is “0”, the C layer to be transmitted by the sub polarized wave is used as the virtual E layer. This means that to be expressed precisely, a group of segments each having the same segment number as the segment belonging to the C layer to be transmitted by the main polarized wave among the segments to be transmitted by the sub polarized wave is treated as the E layer that is a different layer from the C layer to be transmitted by the main polarized wave. In a case where this parameter is “1”, the C layer to be transmitted by the sub polarized wave is not used as the virtual E layer, but is used as the C layer.

In this manner, it is possible to identify presence or absence of the D layer and the E layer to be transmitted by the sub polarized wave by using the bit of the additional layer transmission identification (the D layer transmission identification bit and/or the E layer transmission identification bit) in the broadcast receiving apparatus 100. Namely, in terrestrial digital broadcasting according to the present embodiment, by using a parameter of the additional layer transmission identification illustrated in FIG. 5J, it is possible to operate a new layer (in the example of FIG. 5J, the D layer and the E layer) beyond the number of layers that is limited to three layers including the A layer, the B layer, and the C layer in the existing terrestrial digital broadcasting.

Note that in a case where this parameter is “0”, it is possible to differentiate parameters such as the carrier modulation mapping method illustrated in FIG. 5C, the code rate, or the length of the time interleaving between the virtual D layer/virtual E layer and the B layer/C layer. In this case, in a case where the current information/next information of the parameters such as the carrier modulation mapping method regarding the virtual D layer/virtual E layer, the convolution code rate, or the length of the time interleaving is transmitted by using AC information (for example, the AC1), it is possible to grasp the parameters such as the carrier modulation mapping method regarding the virtual D layer/virtual E layer, the convolution code rate, or the length of the time interleaving at the broadcast receiving apparatus 100 side.

Note that as a modification example, in a case where the bit of the additional layer transmission identification (at least one of the D layer transmission identification bit or the E layer transmission identification bit) is “0”, it may be configured so that the transmission parameter of at least one of the B layer or the C layer of the current information/next information of the TMCC information to be transmitted by the sub polarized wave is switched to the meaning of the transmission parameter of at least one of the virtual D layer or the virtual E layer. In this case, in a case where at least one of the virtual D layer or the virtual E layer is used, the A layer, the B layer, and the C layer may be used in the main polarized wave, and the transmission parameter of these layers may be transmitted by the current information/next information of the TMCC information to be transmitted by the main polarized wave. Further, the A layer, the D layer, and the E layer may be used in the sub polarized wave, and the transmission parameter of these layers may be transmitted by the current information/next information of the TMCC information to be transmitted by the sub polarized wave. Even in this case, it is possible to grasp the parameters such as the carrier modulation mapping method regarding the virtual D layer/virtual E layer, the convolution code rate, or the length of the time interleaving at the broadcast receiving apparatus 100 side.

Further, in a case where the broadcast wave to be transmitted is not the advanced terrestrial digital broadcasting service or in a case where the single-polarized transmission method or the layered division multiplexing transmission method is used even in the advanced terrestrial digital broadcasting service, this parameter may be respectively set to “1”.

Note that the parameter of the additional layer transmission identification may be stored in both the TMCC information of the main polarized wave and the TMCC information of the sub polarized wave. However, any of the processes described above can be realized as long as the parameter is stored at least in the TMCC information of the sub polarized wave.

Further, the definition of “0” and “1” of the bit of the additional layer transmission identification explained above may be the reverse of the explanation described above.

Note that in a case where a parameter of the 4K signal transmission layer identification described above indicates that transmission of the 4K broadcasting program is executed by the B layer, the broadcast receiving apparatus 100 may ignore the D layer transmission identification bit even though the D layer transmission identification bit described above indicates that the B layer is used as the virtual D layer. Similarly, in a case where the parameter of the 4K signal transmission layer identification indicates that the transmission of the 4K broadcasting program is executed by the C layer, the broadcast receiving apparatus 100 may be configured so as to ignore the E layer transmission identification bit even though the E layer transmission identification bit indicates that the C layer is used as the virtual E layer. By clarifying a priority order of the bits used in a determining process, it is possible to prevent conflict of the determining process in the broadcast receiving apparatus 100.

Further, in the broadcast wave to be transmitted, all of the bit of the frequency converting process identification described above, the bit of the physical channel number identification, the bit of the main signal identification, a bit of 4K signal transmission identification, and the bit of the additional layer transmission identification may be set to “1” in principle in a case where the parameter of the system identification described above is not “10”. Even in a case where the parameter of the system identification is not “10” but exceptionally due to a certain problem, any of the bit of the frequency converting process identification, the bit of the physical channel number identification, the bit of the main signal identification, the bit of the 4K signal transmission identification, and the bit of the additional layer transmission identification is not “1”, the broadcast receiving apparatus 100 may be configured so as to ignore the bit that is not “1”, and determine that all of these bits are “1”.

FIG. 5K illustrates one example of a “code rate” bits illustrated in FIG. 5C, that is, bit allocation of code rate identification in the error correction.

Here, in a terrestrial digital broadcasting method for an existing 2K broadcasting, an identification bit for transmitting the code rate dedicated to the “convolution code” is transmitted. However, in the digital broadcasting according to the present embodiment, it is possible to broadcast an advanced terrestrial digital broadcasting service of 4K broadcasting and the terrestrial digital broadcasting service of the 2K broadcasting so as to be mixed with each other. As have already been described, the LDPC code can be used as the inner code in the advanced terrestrial digital broadcasting service of the 4K broadcasting.

Therefore, unlike the terrestrial digital broadcasting method of the existing 2K broadcasting, a bit of the code rate identification in the error correction according to the present embodiment illustrated in FIG. 5K is configured so as not to correspond to the code rate identification bit dedicated for the convolution code, but is configured so as to correspond to the LDPC code.

Here, even in a case where the inner code of the target terrestrial digital broadcasting service is the convolution code or the LDPC code, by using bits arranged in a common range as the identification bit for code rate transmission, the number of bits can be saved. Moreover, even though the identification bits are the same as each other, by respectively setting the code rate independently between a case where the inner code of the target terrestrial digital broadcasting service is the convolution code and a case where the inner code is the LDPC code, it is possible to adopt a group of choices of the code rate suitable for each coding method as a digital broadcasting system.

Specifically, in the example illustrated in FIG. 5K, in a case where the identification bit is “000”, it indicates that the code rate is 1/2 if the inner code is the convolution code, and the code rate is 2/3 if the inner code is the LDPC code. In a case where the identification bit is “001”, it indicates that the code rate is 2/3 if the inner code is the convolution code, and the code rate is 3/4 if the inner code is the LDPC code. In a case where the identification bit is “010”, it indicates that the code rate is 3/4 if the inner code is the convolution code, and the code rate is 5/6 if the inner code is the LDPC code. In a case where the identification bit is “011”, it indicates that the code rate is 5/6 if the inner code is the convolution code, and the code rate is 2/16 if the inner code is the LDPC code. In a case where the identification bit is “100”, it indicates that the code rate is 7/8 if the inner code is the convolution code, and the code rate is 6/16 if the inner code is the LDPC code. In a case where the identification bit is “101”, it indicates that the code rate is undefined if the inner code is the convolution code, and the code rate is 10/16 if the inner code is the LDPC code. In a case where the identification bit is “110”, it indicates that the code rate is undefined if the inner code is the convolution code, and the code rate is 14/16 if the inner code is the LDPC code. In a case where there is unused layer or no next information, “111” is set to this parameter. Note that the code rate of 2/3 described above may be replaced by the code rate of 81/120. The code rate of 3/4 may be replaced by the code rate of 89/120. The code rate of 5/6 may be replaced by the code rate of 101/120. Further, the code rate of 8/16 or the code rate of 12/16 may be allocated.

Note that identification of whether the inner code of the target terrestrial digital broadcasting service is the convolution code or the LDPC code may be executed by using a result of identifying whether the terrestrial digital broadcasting service is the existing terrestrial digital broadcasting service or the advanced terrestrial digital broadcasting service. The identification may be executed by using the identification bit explained with reference to FIG. 5D or FIG. 5I. Here, in a case where the target terrestrial digital broadcasting service is the existing terrestrial digital broadcasting service, it may be identified that the inner code is the convolution code. Further, in a case where the target terrestrial digital broadcasting service is the advanced terrestrial digital broadcasting service, it may be identified that the inner code is the LDPC code.

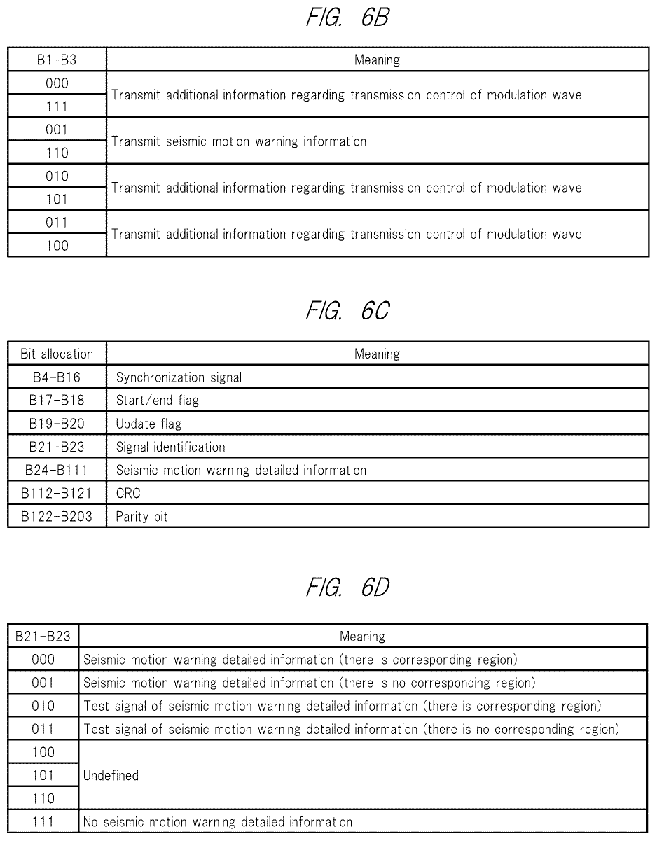

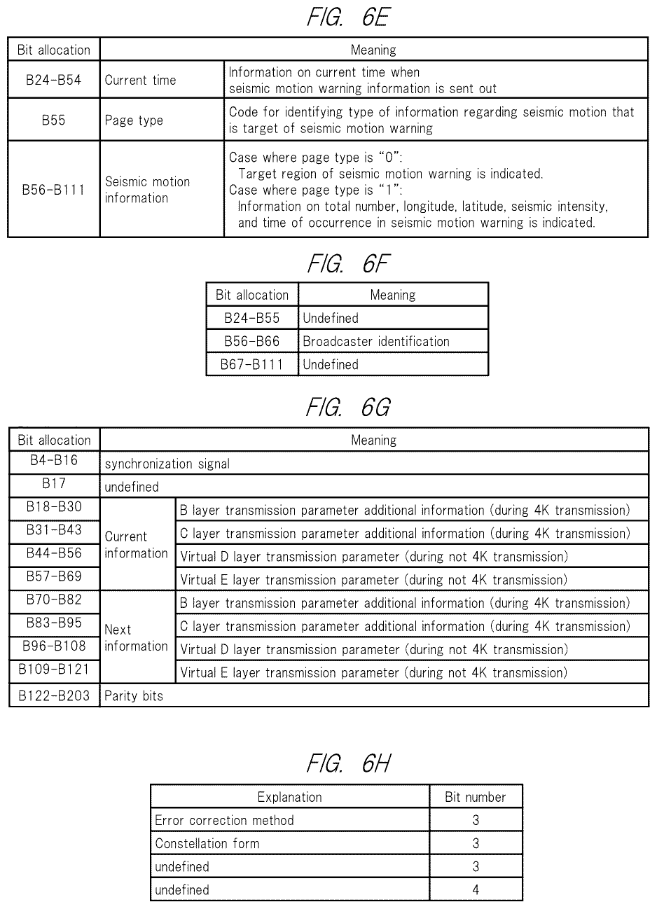

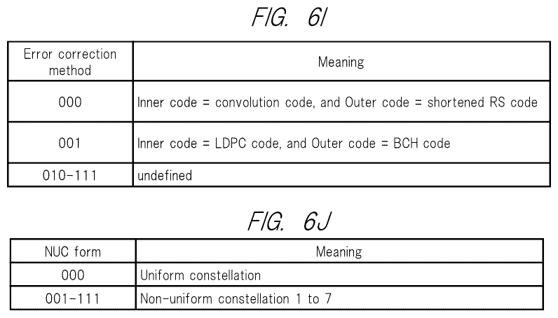

Further, as another example of the identification of whether the inner code of the target terrestrial digital broadcasting service is the convolution code or the LDPC code, it may be identified on the basis of an identification bit of an error correcting method, which will be described later with reference to FIG. 6I.

According to the bit of the code rate identification of the error correction illustrated in FIG. 5K described above, it is possible to favorably prevent the number of bits of the identification bit from increasing while supporting a plurality of inner code methods.

Further, in the advanced terrestrial digital broadcasting service of the dual-polarized transmission method, the TMCC information of the transmission wave to be transmitted by the horizontal polarized wave and the TMCC information of the transmission wave to be transmitted by the vertical polarized wave may be the same as each other, or may be different from each other. Similarly, in the advanced terrestrial digital broadcasting service of the layered division multiplexing transmission method, the TMCC information of the transmission wave to be transmitted by the upper layer and the TMCC information of the transmission wave to be transmitted by the lower layer may be the same as each other, or may be different from each other. Further, the parameter of the frequency converting process identification described above, the parameter of the main signal identification, the parameter of the additional layer transmission identification may be described only in the TMCC information of the transmission wave to be transmitted by the sub polarized wave or the transmission wave to be transmitted by the lower layer.

Note that in the explanation described above, the example in which the parameter of the frequency converting process identification, the parameter of the main signal identification, the parameter of the polarization direction identification, the parameter of the first signal/second signal identification, the parameter of the upper/lower layer identification, the parameter of the 4K signal transmission layer identification, and the parameter of the additional layer transmission identification are transmitted so as to be included in the TMCC signal (or the TMCC carrier) has been explained. However, these parameters may be transmitted so as to be included in the AC signal (or the AC carrier). Namely, these parameters may be transmitted by a signal of a carrier (such as the TMCC carrier or the AC carrier) modulated by a modulation method that executes mapping with a smaller number of states than that of the modulation method for the data carrier.

### [AC Signal]

The AC signal is an additional information signal regarding the broadcast, and includes additional information or seismic motion warning information regarding a transmission control of a modulation wave. Note that the seismic motion warning information is transmitted by using an AC carrier with segment 0. On the other hand, the additional information regarding the transmission control of the modulation wave can be transmitted by using an arbitrary AC carrier. FIG. 6A illustrates one example of bit allocation of the AC signal. The AC signal is configured by 204 bits (B0 to B203). B0 is a demodulation reference signal for an AC symbol, and has a predetermined amplitude and a phase reference. B1 to B3 are signals for identifying a configuration of the AC signal. B4 to B203 are used for transmission of the additional information or transmission of the seismic motion warning information regarding the transmission control of the modulation wave.

FIG. 6B illustrates one example of bit allocation of configuration identification of the AC signal. In a case where the seismic motion warning information is transmitted by using B4 to B203 of the AC signal, this parameter is set to “001” or “110”. A parameter of the configuration identification (“001” or “110”) in a case of transmission of the seismic motion warning information has the same code as leading three bits (B1 to B3) of a synchronization signal of the TMCC signal, and is sent out alternately for each frame at the same timing as the TMCC signal. Further, in a case where this parameter is a value other than the value described above, it indicates that the additional information regarding the transmission control of the modulation wave is transmitted by using B4 to B203 of the AC signal. In this case, as the parameter of the configuration identification of the AC signal, “000” and “111”, “010” and “101”, or “011” and “100” are sent out alternately for each frame.

B4 to B203 of the AC signal are used for transmission of the additional information or transmission of the seismic motion warning information regarding the transmission control of the modulation wave.

The transmission of the additional information regarding the transmission control of the modulation wave may be executed by various bit configurations. For example, the frequency converting process identification, the physical channel number identification, the main signal identification, the 4K signal transmission layer identification, and the additional layer transmission identification, which have been described in the explanation of the TMCC signal, may be transmitted by allocating the bit to the additional information regarding the transmission control of the modulation wave of the AC signal in place of the TMCC signal or in addition to the TMCC signal. In this manner, in the broadcast receiving apparatus 100, it is possible to execute various kinds of identifying processes using these parameters, which have already been described in the explanation of the TMCC signal.

Further, the transmission parameter additional information regarding the transmission layer of the 4K broadcasting program when any parameter of the 4K signal transmission layer identification is “0” or the current/next information of the transmission parameter regarding the virtual D layer/virtual E layer when any parameter of the additional layer transmission identification is “0” may be allocated. In this manner, in the broadcast receiving apparatus 100, it is possible to obtain the transmission parameter of each layer by using these parameters, and this makes it possible to control the demodulating process for each layer.

Transmission of the seismic motion warning information may be executed by bit allocation illustrated in FIG. 6C. The seismic motion warning information is configured by a synchronization signal, a start/end flag, update flag, signal identification, seismic motion warning detailed information, CRC, and parity bits. The synchronization signal is configured by a code with 13 bits, and has the same code as 13 bits (B4 to B16) obtained by removing the leading three bits from the synchronization signal of the TMCC signal. In a case where the configuration identification of the AC signal indicates that the seismic motion warning information is to be transmitted, a code with 16 bits obtained by combining the configuration identification with the synchronization signal becomes the same synchronization words with 16 bits as the synchronization signal of the TMCC. The start/end flag is configured by a code with two bits as a flag of start timing/end timing of the seismic motion warning information. The start/end flag is changed from “11” to “00” when sending of the seismic motion warning information is started, and is changed from “00” to “11” when the sending of the seismic motion warning information is ended. The update flag is configured by a code with two bits, and is increased by “1” from “00” used as an initial value every time the content of a series of seismic motion warning detailed information to be transmitted when the start/end flag is “00” is changed. After “11”, it returns to “00”. In a case where the start/end flag is “11”, the update flag is also “11”.

FIG. 6D illustrates one example of bit allocation of the signal identification. The signal identification is configured by a code of three bits, and is used for identifying a type of the seismic motion warning detailed information. In a case where this parameter is “000”, it means the “seismic motion warning detailed information (there is a corresponding region)”. In a case where this parameter is “001”, it means the “seismic motion warning detailed information (there is no corresponding region)”. In a case where this parameter is “010”, it means “a test signal of the seismic motion warning detailed information (there is a corresponding region)”. In a case where this parameter is “011”, it means “the test signal of the seismic motion warning detailed information (there is no corresponding region)”. In a case where this parameter is “111”, it means “no seismic motion warning detailed information”. Note that in a case where the start/end flag is “00”, the signal identification becomes any of “000”, “001”, “010”, and “011”. In a case where the start/end flag is “11”, the signal identification becomes “111”.

The seismic motion warning detailed information is configured by a code with 88 bits. In a case where the signal identification is any of “000”, “001”, “010”, and “011”, information such as information regarding a current time when the seismic motion warning information is sent out, information indicating a region that becomes a target of seismic motion warning, or latitude/longitude/earthquake intensity of a seismic center of earthquake that becomes a target of the seismic motion warning is transmitted as the seismic motion warning detailed information. FIG. 6E illustrates one example of bit allocation of the seismic motion warning detailed information in a case where the signal identification is any of “000”, “001”, “010”, and “011”. Further, in a case where the signal identification is “111”, it is possible to transmit a code or the like for identifying a broadcaster by using a bit of the seismic motion warning detailed information. FIG. 6F illustrates one example of bit allocation of the seismic motion warning detailed information in a case where the signal identification is “111”.

The CRC is a code generated by using a predetermined generator polynomial with respect to B21 to B111 of the seismic motion warning information. The parity bit is a code generated by a shortened code (187, 105) of a difference set cyclic code (273, 191) with reference to B17 to B121 of the seismic motion warning information.

In the broadcast receiving apparatus 100, it is possible to execute various kinds of controls for addressing an emergency situation by using the parameters regarding the seismic motion warning, which have been described in FIG. 6C, FIG. 6D, FIG. 6E, and FIG. 6F. For example, it is possible to execute a presentation control of information regarding the seismic motion warning, a control to switch display content with low priority into display regarding the seismic motion warning, and a control to terminate display of an application and switch into display regarding the seismic motion warning or broadcasting program video.

FIG. 6G illustrates one example of bit allocation of the additional information regarding the transmission control of the modulation wave. The additional information regarding the transmission control of the modulation wave is configured by the synchronization signal, the current information, the next information, the parity bit, and the like. The synchronization signal is configured by a code with 13 bits, and has the same code as 13 bits (B4 to B16) obtained by removing the leading three bits from the synchronization signal of the TMCC signal. The synchronization signal may not have the same code as 13 bits (B4 to B16) obtained by removing the leading three bits from the synchronization signal of the TMCC signal. In a case where the configuration identification of the AC signal indicates that the additional information regarding the transmission control of the modulation wave is to be transmitted, a code with 16 bits obtained by combining the configuration identification and the synchronization signal becomes synchronization words with 16 bits equivalent to the synchronization signal of the TMCC. It may be the synchronization words with 16 bits different from the synchronization signal of the TMCC. The current information indicates current information of the transmission parameter additional information when the 4K broadcasting program is transmitted by the B layer or the C layer and the transmission parameter regarding the virtual D layer or the virtual E layer. The next information indicates information after switching of the transmission parameter additional information when the 4K broadcasting program is transmitted by the B layer or the C layer and the transmission parameter regarding the virtual D layer or the virtual E layer.

In the example of FIG. 6G, B18 to B30 of the current information are current information of the B layer transmission parameter additional information, and indicate current information of the transmission parameter additional information when the 4K broadcasting program is to be transmitted by the B layer. Further, B31 to B43 of the current information are current information of the C layer transmission parameter additional information, and indicate current information of the transmission parameter additional information when the 4K broadcasting program is to be transmitted by the C layer. Further, B70 to B82 of the next information are information after switching of the transmission parameters of the B layer transmission parameter additional information, and indicate information after switching of the transmission parameters of the transmission parameter additional information when the 4K broadcasting program is to be transmitted by the B layer. Further, B83 to B95 of the next information are information after switching of the transmission parameters of the C layer transmission parameter additional information, and indicate information switching of after the transmission parameters of the transmission parameter additional information when the 4K broadcasting program is to be transmitted by the C layer. Here, the transmission parameter additional information is a transmission parameter regarding modulation, which is added to the transmission parameter of the TMCC information illustrated in FIG. 5C to extend the specifications. The concrete content of the transmission parameter additional information will be described later.

In the example illustrated in FIG. 6G, B44 to B56 of the current information are current information of the transmission parameter for the virtual D layer in a case where the virtual D layer is operated. B57 to B69 of the current information are current information of the transmission parameter for the virtual E layer in a case where the virtual E layer is operated. Further, B96 to B108 of the next information are information after switching of the transmission parameters for the virtual D layer in a case where the virtual D layer is operated. B109 to B121 of the current information are information after switching of the transmission parameters for the virtual E layer in a case where the virtual E layer is operated. The parameters stored in the transmission parameter for the virtual D layer and the transmission parameter for the virtual E layer may be the same as those illustrated in FIG. 5C.

The virtual D layer and the virtual E layer are layers that do not exist in the existing terrestrial digital broadcasting. It is not easy to increase the number of bits of the TMCC information illustrated in FIG. 5B because it is necessary to maintain compatibility with the existing terrestrial digital broadcasting. Therefore, in the embodiment according to the present invention, the transmission parameters for the virtual D layer and the virtual E layer are stored in the AC information as illustrated in FIG. 6G instead of the TMCC information.

This makes it possible to transmit, to the receiving apparatus, information regarding the modulation for the new virtual D layer and the new virtual E layer while maintaining compatibility of the TMCC information with the existing terrestrial digital broadcasting. As a result, in a case where the B layer/C layer of the transmission wave that is the broadcast wave of the dual-polarized terrestrial digital broadcasting service according to the present embodiment and is transmitted by the sub polarized wave is used as the virtual D layer/virtual E layer, it is possible to set the transmission parameter of the virtual D layer/virtual E layer of the transmission wave to be transmitted by the sub polarized wave so as to be differentiated from the transmission parameter of the B layer/C layer of the transmission wave to be transmitted by the main polarized wave.

Note that in a case where the virtual D layer or the virtual E layer is not used, information of the transmission parameter for the unused layer may be ignored in the broadcast receiving apparatus 100 without any problem. For example, in a case where the parameter of the additional layer transmission identification of the TMCC information illustrated in FIG. 5J indicates “1” for the virtual D layer or the virtual E layer (in a case of indicating that the virtual D layer/virtual E layer is not used), the broadcast receiving apparatus 100 may be configured so as to ignore the information of the transmission parameter even though any value is contained in the transmission parameter illustrated in FIG. 6G for the unused virtual D layer or the unused virtual E layer.

Next, details of the transmission parameter additional information, which has been explained with reference to FIG. 6G, will be described.

FIG. 6H illustrates one concrete example of the transmission parameter additional information. It is possible to contain a parameter of an error correcting method, a parameter of a constellation form, and the like in the transmission parameter additional information.

The error correcting method indicates setting of what kind of coding method is used as the error correcting method for the inner code and the outer code when the 4K broadcasting program (the advanced terrestrial digital broadcasting service) is to be transmitted by the B layer or the C layer. FIG. 6I illustrates one example of bit allocation of the error correcting method. In a case where this parameter is “000”, a convolution code is used as the inner code and a shortened RS code is used as the outer code when the 4K broadcasting program is to be transmitted by the B layer or the C layer. In a case where this parameter is “001”, the LDPC code is used as the inner code and the BCH code is used as the outer code when the 4K broadcasting program is to be transmitted by the B layer and the C layer. Moreover, the other combinations may be set so that they can be selected.

Further, when the 4K broadcasting program is transmitted by the B layer or the C layer, it is possible to adopt not only a uniform constellation but also a non-uniform constellation (Non Uniform Constellation: NUC) as the carrier modulation mapping method. FIG. 6J illustrates one example of bit allocation of the constellation form. In a case where this parameter is “000”, the carrier modulation mapping method selected in the transmission parameter of the TMCC information is applied to the uniform constellation. In a case where this parameter is any of “001” to “111”, the carrier modulation mapping method selected in the transmission parameter of the TMCC information is applied to the non-uniform constellation. Note that in a case where the non-uniform constellation is to be applied, the optimum value of the non-uniform constellation differs depending upon the type of the error correcting method and a code rate thereof. Therefore, in a case where the parameter of the constellation form is any of “001” to “111”, the broadcast receiving apparatus 100 according to the present embodiment may determine the non-uniform constellation used in the demodulating process on the basis of the parameter of the carrier modulation mapping method, the parameter of the error correcting method, and the parameter of the code rate thereof. This determination may be made by referring to a predetermined table that the broadcast receiving apparatus 100 stores in advance.

### [Transmission Method 1 of Advanced Terrestrial Digital Broadcasting Service]

In order to realize 4K (3840 horizontal pixels×2160 vertical pixels) broadcasting while maintaining viewing environment of the existing terrestrial digital broadcasting service, the dual-polarized transmission method will be described as one example of the transmission method of the advanced terrestrial digital broadcasting service according to the embodiment of the present invention. The dual-polarized transmission method according to the embodiment of the present invention is a method that has some specifications common to the existing terrestrial digital broadcasting method. For example, 13 segments in about 6 MHz band corresponding to one physical channel are divided, and seven segments, five segments, and one segment are respectively allocated to transmission of a 2K (1920 horizontal pixels×1080 vertical pixels) broadcasting program, transmission of a 4K broadcasting program, and mobile reception (so-called one-segment broadcasting). Moreover, the five segments for the 4K broadcasting use not only the horizontal polarization signal but also the vertical polarization signal to secure a transmission capacity for ten segments in total by a MIMO (Multiple-Input Multiple-Output) technique. Note that the 2K broadcasting program maintains image quality by optimization of the latest MPEG-2 Video compression technique, and can be received even by an existing television receiver. For the 4K broadcasting program, image quality is secured by optimization of a more high-efficient HEVC compression technique than MPEG-2 Video and multi-valued modulation. Note that the number of segments allocated for each broadcast may be different from the above.

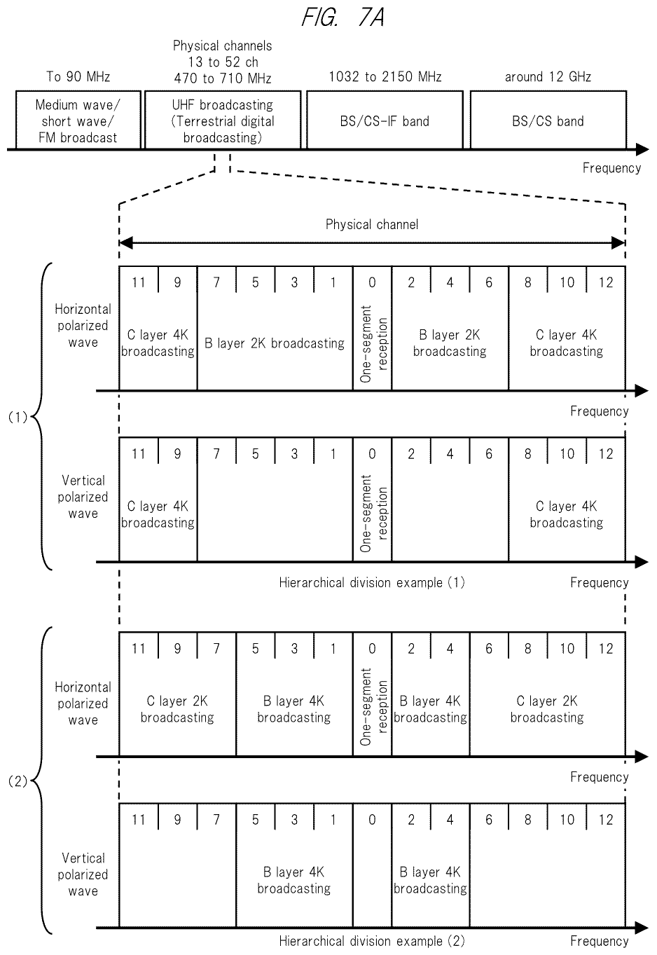

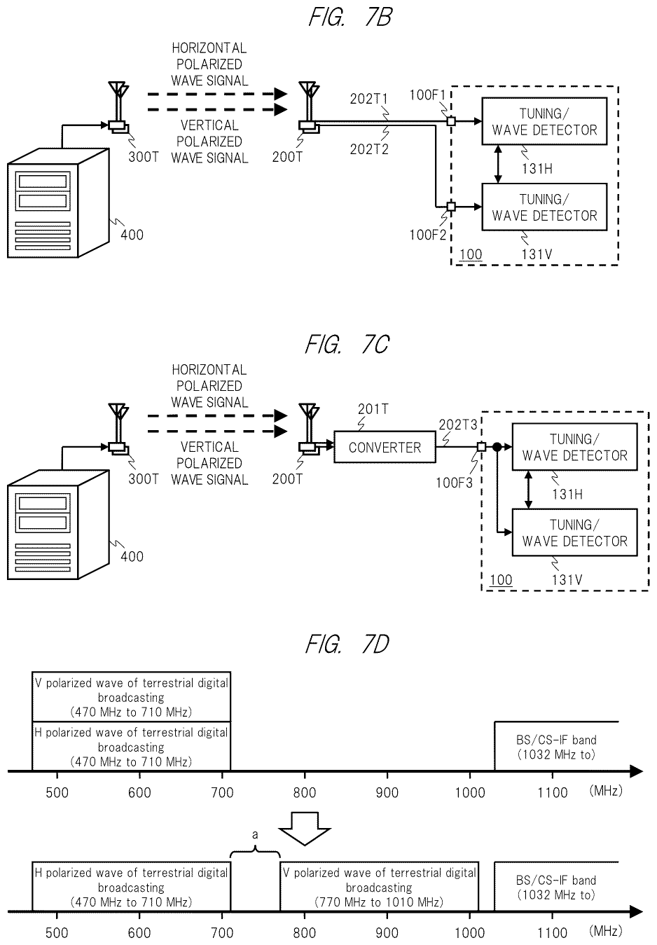

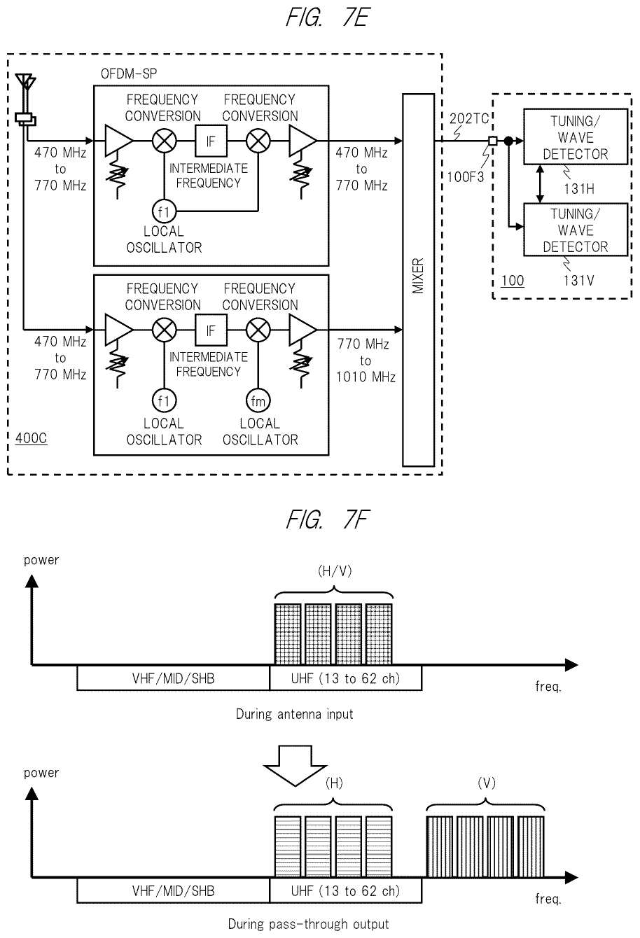

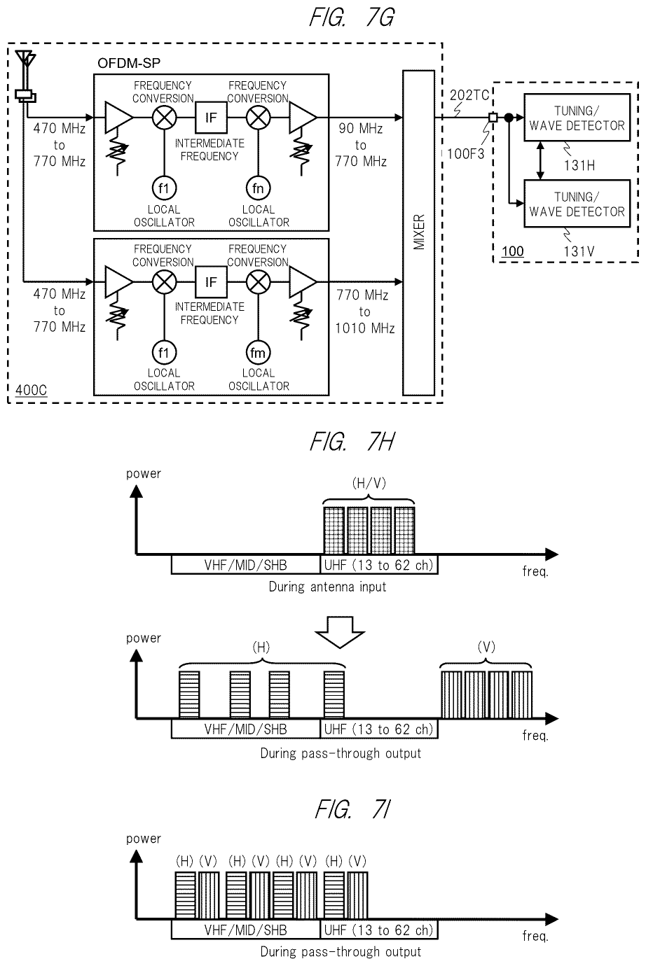

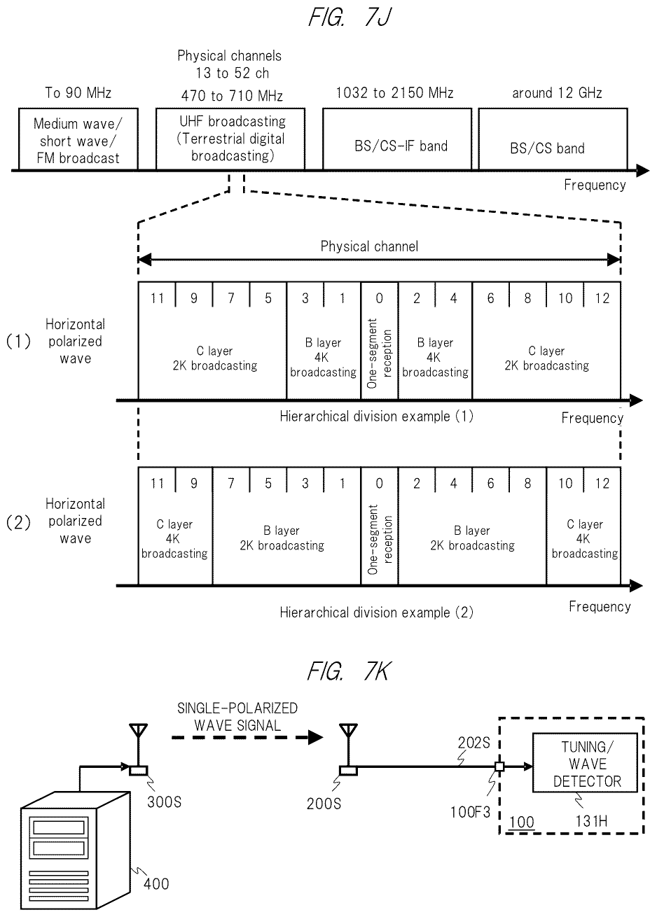

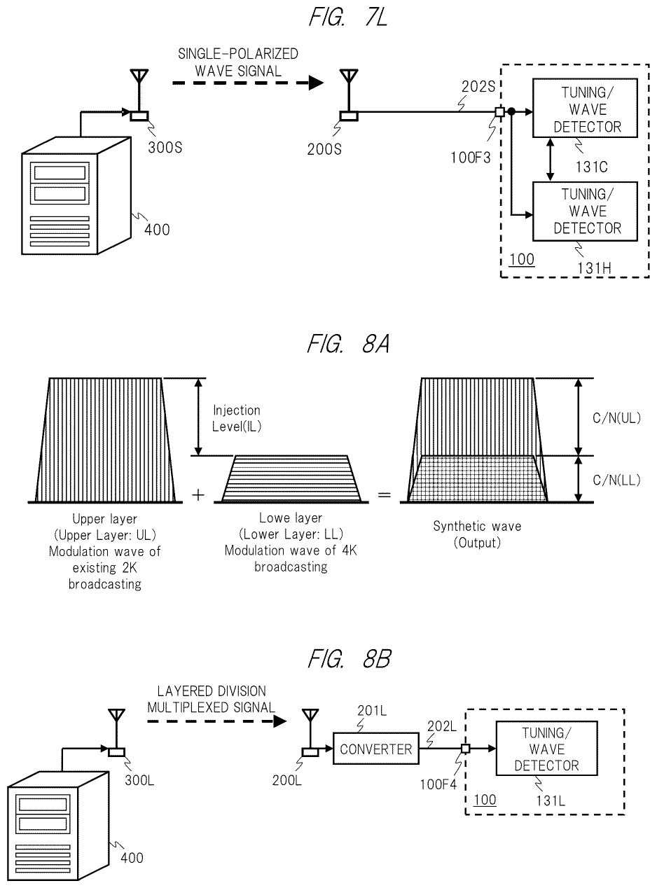

FIG. 7A illustrates one example of the dual-polarized transmission method in the advanced terrestrial digital broadcasting service according to the embodiment of the present invention. A frequency band of 470 to 710 MHz is used for transmission of the broadcast wave of the terrestrial digital broadcasting service. The number of physical channels in the frequency band is 40 channels of 13 to 52 ch, and each of the physical channels has a bandwidth of 6 MHz. In the dual-polarized transmission method according to the embodiment of the present invention, both the horizontal polarization signal and the vertical polarization signal are used in one physical channel.

FIG. 7A illustrates two examples of (1) and (2) as an allocation example of 13 segments. In the example of (1), transmission of a 2K broadcasting program is executed by using segments 1 to 7 (the B layer) of the horizontal polarization signal. Transmission of a 4K broadcasting program is executed by using total ten segments of segments 8 to 12 (the C layer) of the horizontal polarization signal and segments 8 to 12 (the C layer) of the vertical polarization signal. The segments 1 to 7 (the B layer) of the vertical polarization signal may be used for transmission of the same broadcasting program as the 2K broadcasting program to be transmitted by the segments 1 to 7 (the B layer) of the horizontal polarization signal. Alternatively, the segments 1 to 7 (the B layer) of the vertical polarization signal may be used for transmission of a different broadcasting program from the 2K broadcasting program to be transmitted by the segments 1 to 7 (the B layer) of the horizontal polarization signal. Alternatively, the segments 1 to 7 (the B layer) of the vertical polarization signal may be used for the other data transmission, or may not be used. Identification information of how to use the segments 1 to 7 (the B layer) of the vertical polarization signal can be transmitted to the receiving apparatus side by the parameter of the 4K signal transmission layer identification or the parameter of the additional layer transmission identification of the TMCC signal, which has already been explained. In the broadcast receiving apparatus 100, it is possible to identify handling of the segments 1 to 7 (the B layer) of the vertical polarization signal by these parameters. Further, the 2K broadcasting program to be transmitted by using the B layer of the horizontal polarization signal and the 4K broadcasting program to be transmitted by using the C layers of both horizontal/vertical polarization signals may be simultaneous broadcasting in which a broadcasting program with the same content is transmitted with different resolutions, or may be broadcasting in which broadcasting programs with different contents are transmitted. The segments 0 of both horizontal/vertical polarization signals transmit the same one-segment broadcasting program.

The example illustrated in (2) of FIG. 7A is a modification example different from (1). In the example of (2), transmission of a 4K broadcasting program is executed by using total ten segments of segments 1 to 5 (the B layer) of the horizontal polarization signal and segments 1 to 5 (the B layer) of the vertical polarization signal. Transmission of a 2K broadcasting program is executed by using segments 6 to 12 (the C layer) of the horizontal polarization signal. Even in the example of (2), the segments 6 to 12 (the C layer) of the vertical polarization signal may be used for transmission of the same broadcasting program as the 2K broadcasting program to be transmitted by the segments 6 to 12 (the C layer) of the horizontal polarization signal. The segments 6 to 12 (the C layer) of the vertical polarization signal may be used for transmission of a different broadcasting program from the 2K broadcasting program to be transmitted by the segments 6 to 12 (the C layer) of the horizontal polarization signal. Further, the segments 6 to 12 (the C layer) of the vertical polarization signal may be used for the other data transmission, or may not be used. These kinds of identification information are similar to those in the example of (1). For this reason, repeated explanation thereof is omitted.

Note that in any of the examples illustrated in (1) and (2) of FIG. 7A, a case where the horizontal polarized wave is the main polarized wave has been described as an example, but the horizontal polarized wave and the vertical polarized wave may be reversed depending upon the operation thereof.

FIG. 7B illustrates one example of a configuration of a broadcasting system for the advanced terrestrial digital broadcasting service using the dual-polarized transmission method according to the embodiment of the present invention. This illustrates both a system at a transmission side and a system at a reception side of the advanced terrestrial digital broadcasting service using the dual-polarized transmission method. A configuration of the broadcasting system of the advanced terrestrial digital broadcasting service using the dual-polarized transmission method is basically the same as the configuration of the broadcasting system illustrated in FIG. 1. However, a radio tower 300T that is facility of the broadcast station is a dual polarized transmission antenna capable of sending out the horizontal polarization signal and the vertical polarization signal at the same time. Further, in the example of FIG. 7B, only the tuning/wave detector 131H and the tuning/wave detector 131V of the second tuner/demodulator 130T in the broadcast receiving apparatus 100 are extracted and illustrated, and illustrations of the other operating units are omitted.

The horizontal polarization signal sent out from the radio tower 300T is received by a horizontal polarized wave receiving element of the antenna 200T that is a dual polarized reception antenna, and is inputted into the tuning/wave detector 131H from a connector 100F1 via a coaxial cable 202T1. On the other hand, the vertical polarization signal sent out from the radio tower 300T is received by a vertical polarized wave receiving element of the antenna 200T, and is inputted into the tuning/wave detector 131V from a connector 100F2 via a coaxial cable 202T2. An F type connector is generally used as a connector that connects an antenna (for example, a coaxial cable) and a television receiver.

Here, the user may mistakenly connect the coaxial cable 202T1 to the connector 100F2, and connect the coaxial cable 202T2 to the connector 100F1. In this case, there is a possibility that a defect such as being unable to identify whether the inputted broadcasting signal is the horizontal polarization signal or the vertical polarization signal occurs in the tuning/wave detector 131H and the tuning/wave detector 131V. In order to prevent the defect described above, it is conceivable that one of the connectors each of which connects the antenna (coaxial cable) to the television receiver, for example, the connector between the coaxial cable 202T2 and the connector 100F2 via which the vertical polarization signal is to be transmitted is made to have a different shape from that of the F type connector of the connector between the coaxial cable 202T1 and the connector 100F1 via which the horizontal polarization signal is to be transmitted. Alternatively, each of the tuning/wave detector 131H and the tuning/wave detector 131V may be controlled to operate by identifying whether the inputted broadcasting signal is the horizontal polarization signal or the vertical polarization signal with reference to the main signal identification of the TMCC information of each input signal. Further, the antenna 200T and the broadcast receiving apparatus 100 may be connected by one multicore coaxial cable in place of two coaxial cables of the coaxial cable 202T1 and the coaxial cable 202T2.

FIG. 7C illustrates one example of a configuration example different from the configuration of the broadcasting system described above for the advanced terrestrial digital broadcasting service using the dual-polarized transmission method according to the embodiment of the present invention. The configuration illustrated in FIG. 7B in which the broadcast receiving apparatus 100 includes two connectors for inputting broadcasting signals and two coaxial cables are used to connect the antenna 200T to the broadcast receiving apparatus 100 may not always be favorable in terms of the cost of facility and handling at the time of cable wiring. Therefore, in the configuration illustrated in FIG. 7C, the horizontal polarization signal received by the horizontal polarized wave receiving element of the antenna 200T and the vertical polarization signal received by the vertical polarized wave receiving element of the antenna 200T are inputted into the converter (converting unit) 201T, and connection between the converter 201T and the broadcast receiving apparatus 100 is executed by a single coaxial cable 202T3. A broadcasting signal inputted from a connector 100F3 is demultiplexed and inputted into the tuning/wave detector 131H and the tuning/wave detector 131V. The connector 100F3 may have a function to supply operating power to the converter 201T.

The converter 201T may belong to facility in an environment (for example, an apartment house or the like) in which the broadcast receiving apparatus 100 is installed. Alternatively, the converter 201T may be configured as a device integrated with the antenna 200T, and installed in a house or the like. The converter 201T executes a frequency converting process for any one of the horizontal polarization signal received by the horizontal polarized wave receiving element of the antenna 200T and the vertical polarization signal received by the vertical polarized wave receiving element of the antenna 200T. By this process, the horizontal polarization signal and the vertical polarization signal transmitted from the radio tower 300T to the antenna 200T can be separated into different frequency bands from each other by using the horizontal polarized wave and the vertical polarized wave of the same frequency band, and may be transmitted to the broadcast receiving apparatus 100 by the single coaxial cable 202T3 at the same time. Note that, if necessary, the frequency converting process may be executed for both the horizontal polarization signal and the vertical polarization signal, but in this case, the frequency bands of the both after frequency conversion have to be different from each other. Further, the broadcast receiving apparatus 100 may include one connector 100F3 for inputting the broadcasting signal.

FIG. 7D illustrates one example of the frequency converting process. In this example, the frequency converting process is executed for the vertical polarization signal. Specifically, of a horizontal polarization signal and a vertical polarization signal transmitted by a frequency band of 470 to 710 MHz (that is, a band corresponding to 13 ch to 52 ch of UHF), a frequency band of the vertical polarization signal is converted from the frequency band of 470 to 710 MHz to a frequency band of 770 to 1010 MHz. By this process, it is possible to transmit signals transmitted by using the horizontal polarized wave and the vertical polarized wave with the same frequency band to the broadcast receiving apparatus 100 through the single coaxial cable 202T3 at the same time without interfering with each other. Note that the frequency converting process may be executed for the horizontal polarization signal.

Further, it is preferable that the frequency converting process is executed for the signal transmitted by the sub polarized wave in accordance with a result obtained by referring to the main signal identification of the TMCC information. As explained with reference to FIG. 5H, the signal transmitted by the main polarized wave is more likely to be transmitted so as to include the existing terrestrial digital broadcasting service in comparison with the signal transmitted by the sub polarized wave. Therefore, in order to maintain compatibility with the existing terrestrial digital broadcasting service more favorably, it is preferable that a frequency of the signal transmitted by the sub polarized wave is converted without converting a frequency of the signal transmitted by the main polarized wave.

Further, in a case where the frequency of the signal transmitted by the sub polarized wave is converted, it is desirable that a frequency band of the signal transmitted by the sub polarized wave is set to be higher than a frequency band of the signal transmitted by the main polarized wave in the signals after conversion. As a result, by starting a scan from a low frequency side and causing the scan to proceed to a high frequency side in the initial scan of the broadcast receiving apparatus 100, it is possible to execute the initial scan for the signal transmitted by the main polarized wave prior to that for the signal transmitted by the sub polarized wave. This makes it possible to execute a process of reflecting settings by the initial scan of the existing terrestrial digital broadcasting service to settings by the initial scan of the advanced terrestrial digital broadcasting service more favorably.

Further, the frequency converting process may be executed for all physical channels used in the advanced terrestrial digital broadcasting service, but may be executed only for a physical channel using signal transmission by the dual-polarized transmission method.

Note that it is preferable that the frequency band after conversion by the frequency converting process is between 710 and 1032 MHz. Namely, in a case where the terrestrial digital broadcasting service and a BS/CS digital broadcasting service are to be received at the same time, it is conceivable that the broadcasting signal of the terrestrial digital broadcasting service received by the antenna 200T and the broadcasting signal of the BS/CS digital broadcasting service received by the antenna 200B are mixed and transmitted to the broadcast receiving apparatus 100 with a single coaxial cable. In this case, a BS/CS-IF signal uses a frequency band of about 1032 to 2150 MHz. For this reason, by setting the frequency band after conversion by the frequency converting process to be between 710 and 1032 MHz, it becomes possible to avoid interference between the broadcasting signal of the terrestrial digital broadcasting service and the broadcasting signal of the BS/CS digital broadcasting service while avoiding interference between the horizontal polarization signal and the vertical polarization signal. Further, in a case of considering reception of a retransmission broadcasting signal by a cable television (Community Antenna TV or Cable TV: CATV) station, since a frequency band of 770 MHz or less (a band corresponding to 62 ch or less of the UHF) is used in television broadcasting distribution by the cable television station, it is more preferable that the frequency band after conversion by the frequency converting process is set to be between 770 and 1032 MHz, which exceeds the band corresponding to 62 ch of the UHF.

Further, it is preferable that a bandwidth of a range between the frequency band before conversion by the frequency converting process and the frequency band after conversion (that is, “a” portion in FIG. 7D) is set to be an integral multiple of the bandwidth (6 MHz) of one physical channel. In this manner, in the broadcast receiving apparatus 100, there is an advantage that a frequency setting control becomes easy in a case where a frequency of the broadcasting signal of the frequency band before conversion by the frequency converting process and a frequency of the broadcasting signal of the frequency band after conversion are collectively scanned.

Note that as described above, in the dual-polarized transmission method according to the embodiment of the present invention, both the horizontal polarization signal and the vertical polarization signal are used for transmission of the 4K broadcasting program. Therefore, in order to reproduce the 4K broadcasting program correctly, it is necessary to correctly grasp a combination of physical channels of the broadcasting signal transmitted by the horizontal polarized wave and the broadcasting signal transmitted by the vertical polarized wave at the reception side. Even in a case where the frequency converting process is executed and the broadcasting signal transmitted by the horizontal polarized wave and the broadcasting signal transmitted by the vertical polarized wave for the same physical channel are inputted into the receiving apparatus as signals of different frequency bands, it is possible to correctly grasp the combination of the broadcasting signal transmitted by the horizontal polarized wave and the broadcasting signal transmitted by the vertical polarized wave for the same physical channel by referring to the parameters of the TMCC information illustrated in FIG. 5F to FIG. 5J (for example, the main signal identification and the physical channel number identification) as appropriate in the broadcast receiving apparatus 100 according to the present embodiment. This makes it possible to favorably receive, demodulate, and reproduce the 4K broadcasting program in the broadcast receiving apparatus 100 according to the present embodiment.

Note that in any of the examples illustrated in FIG. 7B, FIG. 7C, and FIG. 7D, a case where the horizontal polarized wave is the main polarized wave has been described as an example, but the horizontal polarized wave and the vertical polarized wave may be reversed depending upon the operation thereof.

Note that the broadcast wave of the terrestrial digital broadcasting to be transmitted by the dual-polarized transmission method explained above can be received and reproduced by the second tuner/demodulator 130T of the broadcast receiving apparatus 100 as described above, but it can be received even by the first tuner/demodulator 130C of the broadcast receiving apparatus 100. In a case where the broadcast wave of the terrestrial digital broadcasting is received by the first tuner/demodulator 130C, the broadcasting signal transmitted by the layer for the advanced terrestrial digital broadcasting service of the broadcasting signals of the broadcast wave of the terrestrial digital broadcasting is ignored, but the broadcasting signal transmitted by the layer for the existing terrestrial digital broadcasting service is reproduced.

### <Pass-Through Transmission Method of Advanced Terrestrial

### Digital Broadcasting Service>

The broadcast receiving apparatus 100 can receive a signal transmitted by a pass-through transmission method. The pass-through transmission method is a method in which a broadcasting signal received by the cable television station or the like is sent out to a distribution system of a CATV at the same frequency or via frequency conversion by a signal method as it is.

The pass-through transmission method includes: (1) a method of executing transmission signal band extraction and level adjustment for each terrestrial digital broadcasting signal outputted from a terrestrial reception antenna, and transmitting the terrestrial digital broadcasting signal to a CATV facility at the same frequency as a transmission signal frequency; and (2) a method of executing the transmission signal band extraction and the level adjustment for each terrestrial digital broadcasting signal outputted from the terrestrial reception antenna, and transmitting the terrestrial digital broadcasting signal to the CATV facility at a frequency of any of a VHF band, a MID band, a SHB band, and a UHF band, which is set by a CATV facility manager. Equipment constituting a reception amplifier for executing the signal processing of the first method or equipment constituting a reception amplifier and a frequency converter for executing the signal processing of the second method is an OFDM signal processor (OFDM Signal Processor: OFDM-SP).

FIG. 7E illustrates one example of a system configuration in a case where the first method of the pass-through transmission method is applied to the advanced terrestrial digital broadcasting service of the dual-polarized transmission method. FIG. 7E illustrates a headend facility 400C of the cable television station and the broadcast receiving apparatus 100. Further, FIG. 7F illustrates one example of the frequency converting process at that time. A notation (H.V) in FIG. 7F indicates a state where both a broadcasting signal transmitted by a horizontal polarized wave and a broadcasting signal transmitted by a vertical polarized wave exist in the same frequency band. A notation (H) indicates the broadcasting signal transmitted by the horizontal polarized wave, and a notation (V) indicates the broadcasting signal transmitted by the vertical polarized wave. Notations in FIG. 7H and FIG. 7I described below respectively have the similar meanings.

In a case where the pass-through transmission of the first method is applied to the advanced terrestrial digital broadcasting service of the dual-polarized transmission method according to the embodiment of the present invention, the transmission signal band extraction and the level adjustment executed for the broadcasting signal transmitted by the horizontal polarized wave in the headend facility 400C of the cable television station, and the broadcasting signal is sent out at the same frequency as the transmission signal frequency. On the other hand, the transmission signal band extraction and the level adjustment are executed for the broadcasting signal transmitted by the vertical polarized wave in the headend facility 400C of the cable television station, and the broadcasting signal is sent out after the similar frequency converting process to that described with reference to FIG. 7D (that is, the process of converting the broadcasting signal transmitted by the vertical polarized wave into a frequency band higher than the frequency band of 470 to 770 MHz, which is the band corresponding to 13 ch to 62 ch of the UHF) is executed. Since this process causes frequency bands of the broadcasting signal transmitted by the horizontal polarized wave and the broadcasting signal transmitted by the vertical polarized wave not to be overlapped, signal transmission by one coaxial cable (or one optical fiber cable) becomes possible. The transmitted signal can be received by the broadcast receiving apparatus 100 according to the present embodiment. Since the process of receiving and demodulating the broadcasting signal transmitted by the horizontal polarized wave and the broadcasting signal transmitted by the vertical polarized wave included in the signal in the broadcast receiving apparatus 100 according to the present embodiment is similar to that described with reference to FIG. 7D, repeated explanation thereof is omitted.

FIG. 7G illustrates one example of a system configuration in a case where the second method of the pass-through transmission method is applied to the advanced terrestrial digital broadcasting service of the dual-polarized transmission method. FIG. 7G illustrates the headend facility 400C of the cable television station and the broadcast receiving apparatus 100. Further, FIG. 7H illustrates one example of the frequency converting process at that time.

In a case where the pass-through transmission of the second method is applied to the advanced terrestrial digital broadcasting service of the dual-polarized transmission method according to the embodiment of the present invention, the transmission signal band extraction and the level adjustment are executed for the broadcasting signal transmitted by the horizontal polarized wave in the headend facility 400C of the cable television station, and the broadcasting signal is sent out after the frequency converting process into the frequency set by the CATV facility manager is executed. On the other hand, the transmission signal band extraction and the level adjustment are executed for the broadcasting signal transmitted by the vertical polarized wave in the headend facility 400C of the cable television station, and the broadcasting signal is sent out after the similar frequency converting process to that described with reference to FIG. 7D (that is, the process of converting the broadcasting signal transmitted by the vertical polarized wave into the frequency band higher than the frequency band of 470 to 770 MHz, which is the band corresponding to 13 ch to 62 ch of the UHF) is executed. The frequency converting process illustrated in FIG. 7H is different from that illustrated in FIG. 7F, and the frequency of the broadcasting signal transmitted by the horizontal polarized wave is converted so as to be rearranged in a range of 90 to 770 MHz, which is expanded to a lower frequency band without limiting to the frequency band of 470 to 770 MHz that is the band of 13 ch to 62 ch of the UHF. Since this process causes frequency bands of the broadcasting signal transmitted by the horizontal polarized wave and the broadcasting signal transmitted by the vertical polarized wave not to be overlapped, signal transmission by one coaxial cable (or one optical fiber cable) becomes possible. The transmitted signal can be received by the broadcast receiving apparatus 100 according to the present embodiment. Since the process of receiving and demodulating the broadcasting signal transmitted by the horizontal polarized wave and the broadcasting signal transmitted by the vertical polarized wave included in the signal in the broadcast receiving apparatus 100 according to the present embodiment is similar to that described with reference to FIG. 7D, repeated explanation thereof is omitted.

Further, as another modification example of the frequency converting process of the headend facility 400C of the cable television station illustrated in FIG. 7G, the broadcasting signal at the time of pass-through output after the frequency conversion may be changed from the state illustrated in FIG. 7H to the state illustrated in FIG. 7I. In this case, the transmission signal band extraction and the level adjustment may be executed for both the broadcasting signal transmitted by the horizontal polarized wave and the broadcasting signal transmitted by the vertical polarized wave, and the broadcasting signals may be sent out after the frequency converting process into the frequency set by the CATV facility manager is executed. In the example of FIG. 7I, frequency conversion is executed so that both the broadcasting signal transmitted by the horizontal polarized wave and the broadcasting signal transmitted by the vertical polarized wave are rearranged in a range of 90 to 770 MHz (that is, a range from VHF 1 ch to UHF 62 ch), and frequency band utilization efficiency of the broadcasting signal can be heightened in comparison with the case illustrated in FIG. 7H because frequency band in a range that exceeds UHF 62 ch is not used.

Further, since the band in which the broadcasting signals are rearranged is wider than the frequency band of 470 to 710 MHz that is the band of 13 ch to 52 ch of the UHF at the time of reception by the antenna, it is possible to alternately rearrange the broadcasting signal transmitted by the horizontal polarized wave and the broadcasting signal transmitted by the vertical polarized wave as illustrated in the example of FIG. 7I. At this time, if pairs of the broadcasting signal transmitted by the horizontal polarized wave and the broadcasting signal transmitted by the vertical polarized wave, which were in the same physical channel at the time of reception by the antenna, are alternately rearranged in the order of the physical channels at the time of reception by the antenna as illustrated in the example of FIG. 7I, in a case where the broadcast receiving apparatus 100 according to the present embodiment executes the initial scan from the low frequency side, the initial settings for the pairs of the broadcasting signal transmitted by the horizontal polarized wave and the broadcasting signal transmitted by the vertical polarized wave, which were originally in the same physical channel, can be executed sequentially in units of the same physical channel, and this makes it possible to execute the initial scan efficiently.

Note that in any of the examples illustrated in FIG. 7E, FIG. 7F, FIG. 7G, FIG. 7H, and FIG. 7I, a case where the horizontal polarized wave is the main polarized wave has been described as an example, but the horizontal polarized wave and the vertical polarized wave may be reversed depending upon the operation thereof.

Note that the broadcast wave of the terrestrial digital broadcasting of the dual-polarized transmission method, to which the pass-through transmission method explained above is applied, can be received and reproduced by the second tuner/demodulator 130T of the broadcast receiving apparatus 100 as described above, but it can be received even by the first tuner/demodulator 130C of the broadcast receiving apparatus 100. In a case where the broadcast wave of the terrestrial digital broadcasting is received by the first tuner/demodulator 130C, the broadcasting signal transmitted by the layer for the advanced terrestrial digital broadcasting service of the broadcasting signals of the broadcast wave of the terrestrial digital broadcasting is ignored, but the broadcasting signal transmitted by the layer for the existing terrestrial digital broadcasting service is reproduced.

### [Transmission Method 2 of Advanced Terrestrial Digital Broadcasting Service]

In order to realize 4K broadcasting while maintaining viewing environment of the existing terrestrial digital broadcasting service, the single-polarized transmission method will be described as another example of the transmission method of the advanced terrestrial digital broadcasting service according to the embodiment of the present invention. The single-polarized transmission method according to the embodiment of the present invention is a method that has some specifications common to the existing terrestrial digital broadcasting method, and data transmission is executed by using either a horizontal polarization signal or a vertical polarization signal based on the SISO (Single-Input Single-Output) technique. For example, 13 segments in about 6 MHz band corresponding to one physical channel are divided, and eight segments, four segments, and one segment are respectively allocated to transmission of a 2K broadcasting program, transmission of a 4K broadcasting program, and mobile reception. Note that the 2K broadcasting program maintains image quality by optimization of the latest MPEG-2 Video compression technique, and can be received even by an existing television receiver. For the 4K broadcasting program, image quality is secured by adopting the HEVC compression technique and the VVC compression technique more efficient than the MPEG-2 Video and further adopting techniques such as the multi-valued modulation and the NUC. Note that the number of segments allocated for each broadcast may be different from the above.

FIG. 7J illustrates one example of the single-polarized transmission method in the advanced terrestrial digital broadcasting service according to the embodiment of the present invention. A frequency band of 470 to 710 MHz is used for transmission of the broadcast wave of the terrestrial digital broadcasting service. The number of physical channels in the frequency band is 40 channels of 13 to 52 ch, and each of the physical channels has a bandwidth of 6 MHz. In the single-polarized transmission method according to the embodiment of the present invention, transmission of the 2K broadcasting service and transmission of the 4K broadcasting service are simultaneously executed in one physical channel.

FIG. 7J illustrates two examples of (1) and (2) as an allocation example of 13 segments. In the example of (1), transmission of a 4K broadcasting program is executed by using segments 1 to 4 (the B layer) and transmission of a 2K broadcasting program is executed by using segments 5 to 12 (the C layer). The 4K broadcasting program to be transmitted by using the B layer and the 2K broadcasting program to be transmitted by using the C layer may be simultaneous broadcasting in which a broadcasting program with the same content is transmitted with different resolutions, or may be broadcasting in which broadcasting programs with different contents are transmitted. The example of (2) is a modification example different from the example of (1). In the example of (2), transmission of a 2K broadcasting program is executed by using segments 1 to 8 (the B layer) and transmission of a 4K broadcasting program is executed by using segments 9 to 12 (the C layer).

FIG. 7K illustrates one example of a configuration of a broadcasting system for the advanced terrestrial digital broadcasting service using the single-polarized transmission method according to the embodiment of the present invention. This illustrates both a system at a transmission side and a system at a reception side of the advanced terrestrial digital broadcasting service using the single-polarized transmission method. A configuration of the broadcasting system of the advanced terrestrial digital broadcasting service using the single-polarized transmission method is basically similar to the configuration of the broadcasting system illustrated in FIG. 1. However, a radio tower 300S that is facility of the broadcast station is a single-polarized transmission antenna capable of sending out either the horizontal polarization signal or the vertical polarization signal. Further, in the example of FIG. 7K, only the tuning/wave detector 131H of the second tuner/demodulator 130T in the broadcast receiving apparatus 100 is extracted and illustrated, and illustrations of the other operating units are omitted.

The single polarization signal sent out from the radio tower 300S is received by an antenna 200S that is a single-polarized reception antenna, and is inputted into the tuning/wave detector 131H from a connector 100F3 via a coaxial cable 202S. An F type connector is generally used as a connector that connects an antenna (coaxial cable) and a television receiver. The configuration of the broadcasting system of the advanced terrestrial digital broadcasting service using the single-polarized transmission method is favorable because the antenna 200S and the broadcast receiving apparatus 100 can be connected by one coaxial cable 202S and the frequency converting process (converter) is not required.

Note that the broadcast wave of the terrestrial digital broadcasting to be transmitted by the single-polarized transmission method explained above can be received and reproduced by the second tuner/demodulator 130T of the broadcast receiving apparatus 100, but it can be received even by the first tuner/demodulator 130C of the broadcast receiving apparatus 100. In a case where the broadcast wave of the terrestrial digital broadcasting is received by the first tuner/demodulator 130C, the broadcasting signal transmitted by the layer for the advanced terrestrial digital broadcasting service of the broadcasting signals of the broadcast wave of the terrestrial digital broadcasting is ignored, but the broadcasting signal transmitted by the layer for the existing terrestrial digital broadcasting service is reproduced.

As described above, in the broadcast receiving apparatus 100, among the broadcasting waves of the terrestrial digital broadcasting transmitted by the single-polarized transmission method, the broadcasting signal transmitted by the layer for the existing terrestrial digital broadcasting service (the layer transmitting the 2K broadcasting in FIG. 7J) can also be received by the first tuner/demodulator 130C. Therefore, by adopting a configuration of a double tuner that simultaneously uses the second tuner/demodulator 130T and the first tuner/demodulator 130C, it is possible to simultaneously receive/reproduce the broadcasting signal transmitted by the layer for the advanced terrestrial digital broadcasting service and the broadcasting signal transmitted by the layer for the existing terrestrial digital broadcasting service.

FIG. 7L illustrates an example of a configuration of the broadcasting system of the advanced terrestrial digital broadcasting service using the single-polarized transmission method according to the embodiment of the present invention and a configuration of the above-described double tuner. This illustrates both a system at a transmission side and a system at a reception side of the advanced terrestrial digital broadcasting service using the single-polarized transmission method. A configuration of the broadcasting system of the advanced terrestrial digital broadcasting service using the single-polarized transmission method is basically similar to the configuration of the broadcasting system illustrated in FIG. 1. However, a radio tower 300S that is facility of the broadcast station is a single-polarized transmission antenna capable of sending out either the horizontal polarization signal or the vertical polarization signal. Further, in the example of FIG. 7L, only the tuning/wave detector 131C of the first tuner/demodulator 130C and the tuning/wave detector 131H the of second tuner/demodulator 130T in the broadcast receiving apparatus 100 are extracted and illustrated, and illustrations of the other operating units are omitted.

The single-polarization signal sent out from the radio tower 300S is received by the antenna 200S that is a single-polarized reception antenna, and is inputted from the connector 100F3 to the broadcast receiving apparatus 100 via the coaxial cable 202S. The single-polarization signal inputted into the broadcast receiving apparatus 100 is demultiplexed and inputted into the tuning/wave detector 131C and tuning/wave detector 131H, respectively. The tuning/wave detector 131C executes tuning/wave detection process of the broadcasting wave of the existing terrestrial digital broadcasting service, and the tuning/wave detector 131H executes tuning/wave detection process of the broadcasting wave of the advanced terrestrial digital broadcasting service.

With this configuration, in the broadcasting system in which the existing terrestrial digital broadcasting service and the advanced terrestrial digital broadcasting service are provided, the existing terrestrial digital broadcasting service and the advanced terrestrial digital broadcasting service can be simultaneously received. In particular, efficient processing can be executed in a channel setting process or the like. Note that the existing terrestrial digital broadcasting service and the advanced terrestrial digital broadcasting service may be transmitted using the same physical channel, or may be transmitted using different physical channels. In addition, the existing terrestrial digital broadcasting service and the advanced terrestrial digital broadcasting service may be or may not be a pair of simultaneous broadcasting services.

Further, the example of FIG. 7L is an example of a case of receiving the broadcasting service of the advanced terrestrial digital broadcasting service using the single-polarized transmission method, but the similar configuration can also be applied to a case of receiving the broadcasting service of the advanced terrestrial digital broadcasting service using the dual-polarized transmission method. In this case, the dual-polarization signal received by the antenna 200T that is a dual-polarized reception antenna and inputted from the connector 100F3 into the broadcast receiving apparatus 100 via the converter 201T may be demultiplexed and inputted into the tuning/wave detector 131C, the tuning/wave detector 131H, and the tuning/wave detector 131V, respectively. The tuning/wave detector 131C executes a tuning/wave detection process of the broadcasting wave of the existing terrestrial digital broadcasting service transmitted by either the horizontal polarization signal or the vertical polarization signal, and the tuning/wave detector 131H and the tuning/wave detector 131V execute a tuning/wave detection process of the broadcasting wave of the advanced terrestrial digital broadcasting service transmitted by the horizontal polarization signal and the vertical polarization signal.

### [Transmission Method 3 of Advanced Terrestrial Digital Broadcasting Service]

In order to realize the 4K broadcasting while maintaining the viewing environment of the existing terrestrial digital broadcasting service, as one example different from that described above of the transmission method of the advanced terrestrial digital broadcasting service according to the embodiment of the present invention, the layered division multiplexing transmission method will be described. The layered division multiplexing transmission method according to the embodiment of the present invention is a method that has some specifications common to the existing terrestrial digital broadcasting method. For example, a broadcast wave of a 4K broadcasting service whose signal level is a low level is multiplexed into the same channel as the broadcast wave of the existing 2K broadcasting service, and then is transmitted. Note that the 2K broadcasting is received as before by suppressing a reception level of the 4K broadcasting to a required C/N or less. With respect to the 4K broadcasting, a 2K broadcast wave is cancelled by using a receiving technique compatible with an LDM (layered division multiplexing) technique while expanding a transmission capacity by multi-valued modulation or the like, and the 4K broadcasting is received through the remaining 4K broadcast wave.

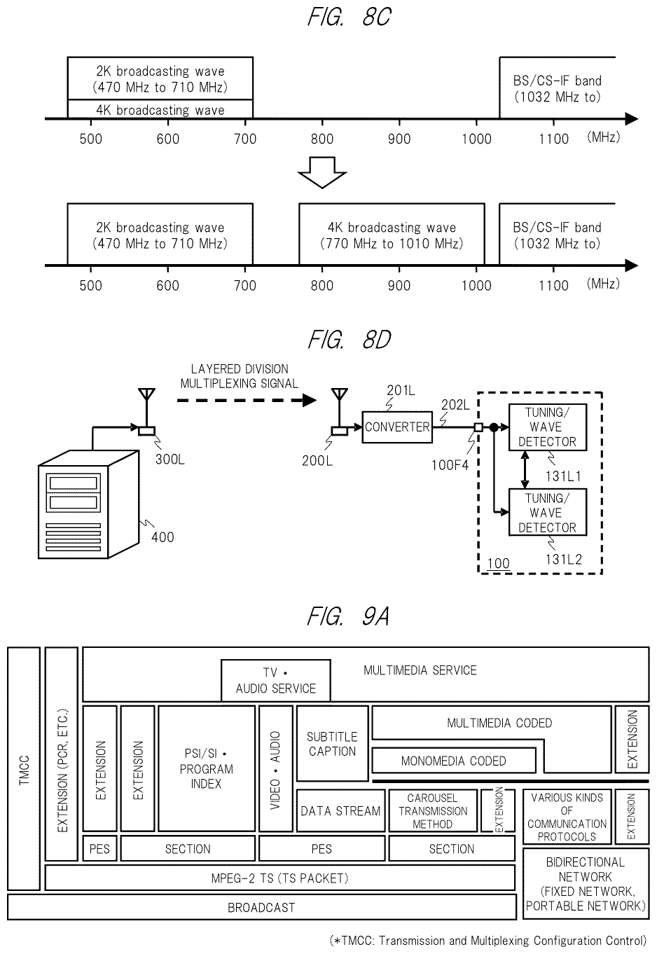

FIG. 8A illustrates one example of the layered division multiplexing transmission method in the advanced terrestrial digital broadcasting service according to the embodiment of the present invention. An upper layer is configured by a modulation wave of the existing 2K broadcasting, and a lower layer is configured by a modulation wave of the 4K broadcasting. Then, the upper layer and the lower layer are multiplexed, and are outputted as a synthetic wave with the same frequency band. For example, 64 QAM or the like is used as the modulation method in the upper layer and 256 QAM or the like is used as the modulation method in the lower layer. Note that a 2K broadcasting program to be transmitted by using the upper layer and a 4K broadcasting program to be transmitted by using the lower layer may be the simultaneous broadcasting in which a broadcasting program with the same content is transmitted with different resolutions, or may be broadcasting in which broadcasting programs with different contents are transmitted. Here, the upper layer is transmitted with high electric power, and the lower layer is transmitted with low electric power. Note that a difference between a modulation wave level of the upper layer and a modulation wave level of the lower layer (that is, a difference between the electric powers) is called an injection level (IL: Injection Level), which is a value that is set at the broadcast station side. The injection level generally indicates the difference between the modulation wave levels (the difference between the electric powers) as a relative ratio of logarithmic representation (dB).

FIG. 8B illustrates one example of a configuration of a broadcasting system for the advanced terrestrial digital broadcasting service using the layered division multiplexing transmission method according to the embodiment of the present invention. The configuration of the broadcasting system of the advanced terrestrial digital broadcasting service using the layered division multiplexing transmission method is basically similar to the configuration of the broadcasting system illustrated in FIG. 1. However, a radio tower 300L that is facility of the broadcast station is a transmission antenna configured to send out broadcasting signal obtained by multiplexing the 2K broadcasting of the upper layer and the 4K broadcasting of the lower layer. Further, in the example of FIG. 8B, only the tuning/wave detector 131L of the third tuner/demodulator 130L in the broadcast receiving apparatus 100 is extracted and illustrated, and illustrations of the other operating units are omitted.

A broadcasting signal received by the antenna 200L is inputted from a connector 100F4 into the tuning/wave detector 131L via a converter (converter) 201L and a coaxial cable 202L. Here, in the configuration, when the broadcasting signal is transmitted from the antenna 200L to the broadcast receiving apparatus 100, the converter 201L may subject a frequency conversion amplification process to the broadcasting signal as illustrated in FIG. 8C. Namely, in a case where the antenna 200L is installed at the roof of an apartment building or the like and transmission of the broadcasting signal is executed to the broadcast receiving apparatus 100 of each room by the coaxial cable 202L with a long cable length, it is conceivable that the broadcasting signal will be attenuated, and there is a possibility that a defect that particularly the 4K broadcast wave of the lower layer cannot be correctly received by the tuning/wave detector 131L occurs.

Therefore, in order to prevent the defect described above, the converter 201L executes the frequency conversion amplification process for the 4K broadcasting signal of the lower layer. In the frequency conversion amplification process, a frequency band of the 4K broadcasting signal of the lower layer is converted from a frequency band of 470 to 710 MHz (that is, a band corresponding to 13 ch to 52 ch of the UHF) to a frequency band of 770 to 1010 MHz that exceed a band corresponding to 62 ch of the UHF, for example. Moreover, a process of amplifying the 4K broadcasting signal of the lower layer to a signal level at which an influence of attenuation by the cable does not cause a problem is executed. By executing such a process, it becomes possible to avoid an influence of attenuation of the broadcasting signal during coaxial cable transmission while avoiding interference between the 2K broadcasting signal and the 4K broadcasting signal. Note that in a case where the influence of attenuation does not cause a problem, such as in a case where the cable length of the coaxial cable 202L is short, the converter 201L and the frequency conversion amplification process may be unnecessary.

Further, as illustrated in FIG. 8D, the tuning/wave detector provided in the third tuner/demodulator 130L of the broadcast receiving apparatus 100 may be configured by the tuning/wave detector 131L1 that executes process such as tuning/wave detection for the modulation wave of the upper layer (2K broadcasting) and the tuning/wave detector 131L2 that executes process such as tuning/wave detection for the modulation wave of the lower layer (4K broadcasting). With this configuration, with respect to the signals subjected to the frequency conversion amplification process in the converter 201L, the process such as tuning/wave detection can be executed simultaneously for the 2K broadcasting signal and the 4K broadcasting signal sent out from the broadcast station by using the same physical channel, and the process particularly suitable for the simultaneous broadcasting can be executed.

Further, it is preferable that the frequency band after conversion by the frequency conversion amplification process is between 710 and 1032 MHz which exceeds the band corresponding to 52 ch of the UHF or between 770 and 1032 MHz which exceeds the band corresponding to 62 ch of the UHF (in a case of retransmission by the cable television station); it is preferable that a bandwidth of a range between a frequency band before conversion by the frequency conversion amplification process and a frequency band after conversion is set to be an integral multiple of the bandwidth (6 MHz) of one physical channel; and the frequency conversion amplification process may be executed only for a physical channel using signal transmission by the layered division multiplexing transmission method. Since all of them are similar to those explained for the frequency conversion according to the present embodiment described above, repeated explanation thereof is omitted.

Note that the broadcast receiving apparatus 100 according to the present embodiment can identify whether the received broadcasting signal is the broadcasting signal transmitted by the lower layer or the broadcasting signal transmitted by the upper layer by using the upper/lower layer identification bit of the TMCC information explained with reference to FIG. 5H. Further, the broadcast receiving apparatus 100 according to the present embodiment can identify whether the received broadcasting signal is the broadcasting signal subjected to the frequency conversion after reception by the antenna or not by using the frequency converting process identification bit of the TMCC information, which has been explained with reference to FIG. 5F. Further, the broadcast receiving apparatus 100 according to the present embodiment can identify whether a 4K program is transmitted by the lower layer in the received broadcasting signal or not by using the 4K signal transmission layer identification bit of the TMCC information, which has been explained with reference to FIG. 5I. It is not impossible to execute these identifying processes by demodulating a data carrier and referring to control information contained in a stream. However, it is necessary to demodulate the data carrier, and this causes the process to become complicated. It is easier and faster to identify them by referring to the parameters of the TMCC information described above. For this reason, it is possible to further speed up the initial scan of the broadcast receiving apparatus 100, for example.

Note that the tuning/wave detector 131L of the third tuner/demodulator 130L in the broadcast receiving apparatus 100 according to the embodiment of the present invention has the receiving function compatible with the LDM (layered division multiplexing) technique as explained above. For this reason, the converter 201L illustrated in FIG. 8B is not always required between the antenna 200L and the broadcast receiving apparatus 100.

Note that the broadcast wave of the terrestrial digital broadcasting transmitted by the layered division multiplexing transmission method explained above can be received and reproduced by the third tuner/demodulator 130L of the broadcast receiving apparatus 100 as described above, but it can also be received by the first tuner/demodulator 130C of the broadcast receiving apparatus 100. In a case where the broadcast wave of the terrestrial digital broadcasting is received by the first tuner/demodulator 130C, the broadcasting signal transmitted by the layer for the transmitted advanced terrestrial digital broadcasting service of the broadcasting signals of the broadcast wave of the terrestrial digital broadcasting is ignored, but the broadcasting signal transmitted by the layer for the existing terrestrial digital broadcasting service is reproduced.

### [MPEG-2 TS Method]

The broadcasting system according to the present embodiment is compatible with an MPEG-2 TS, which is adopted in the existing terrestrial digital broadcasting service, as a media transport method of transmitting data such as video or audio. Specifically, the method of the stream transmitted by the OFDM transmission wave illustrated in (1) of FIG. 4D is the MPEG-2 TS, and the method of the stream transmitted by the layer, by which the existing terrestrial digital broadcasting service is transmitted, of the OFDM transmission waves illustrated in (2) of FIG. 4D and (3) of FIG. 4D is the MPEG-2 TS. Further, the method of the stream obtained by demodulating the transmission wave by the first tuner/demodulator 130C of the broadcast receiving apparatus 100 illustrated in FIG. 2A is the MPEG-2 TS. Further, the method of the stream, which corresponds to the layer by which the existing terrestrial digital broadcasting service is transmitted, among the streams obtained by demodulating the transmission wave by the second tuner/demodulator 130T is the MPEG-2 TS. Similarly, the method of the stream, which corresponds to the layer by which the existing terrestrial digital broadcasting service is transmitted, among the streams obtained by demodulating the transmission wave by the third tuner/demodulator 130L is the MPEG-2 TS.

The MPEG-2 TS is characterized in that components constituting a program such as video or audio is multiplexed into one packet stream together with a control signal and a clock. Since it is treated as one packet stream including the clock, it is suitable to transmit one content via one transmission path in which transmission quality is secured, and the MPEG-2 TS is adopted in many existing digital broadcasting systems. Further, it is possible to realize bidirectional communication via a bidirectional network such as a fixed network/portable network, and it is possible to be compatible with the broadcasting/communication cooperation system in which a digital broadcasting service is caused to cooperate with a function using a broadband network and acquisition of additional content via the broadband network, arithmetic processing by a server apparatus, and a presenting process in cooperation with portable terminal equipment are combined with the digital broadcasting service.

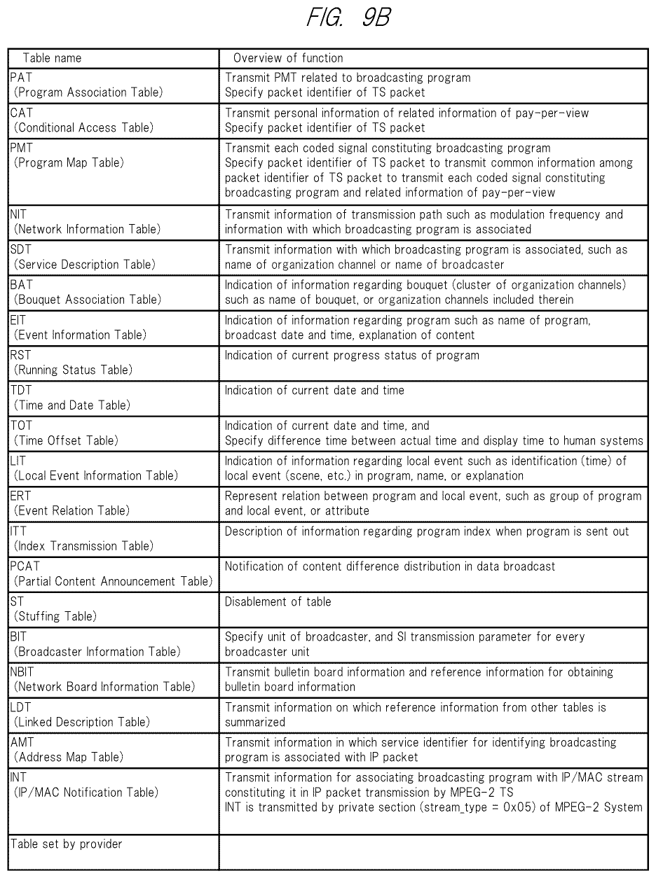

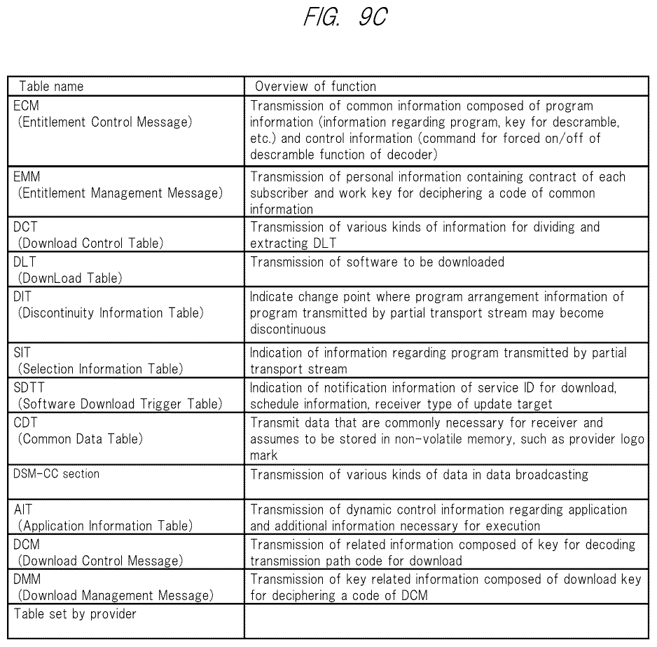

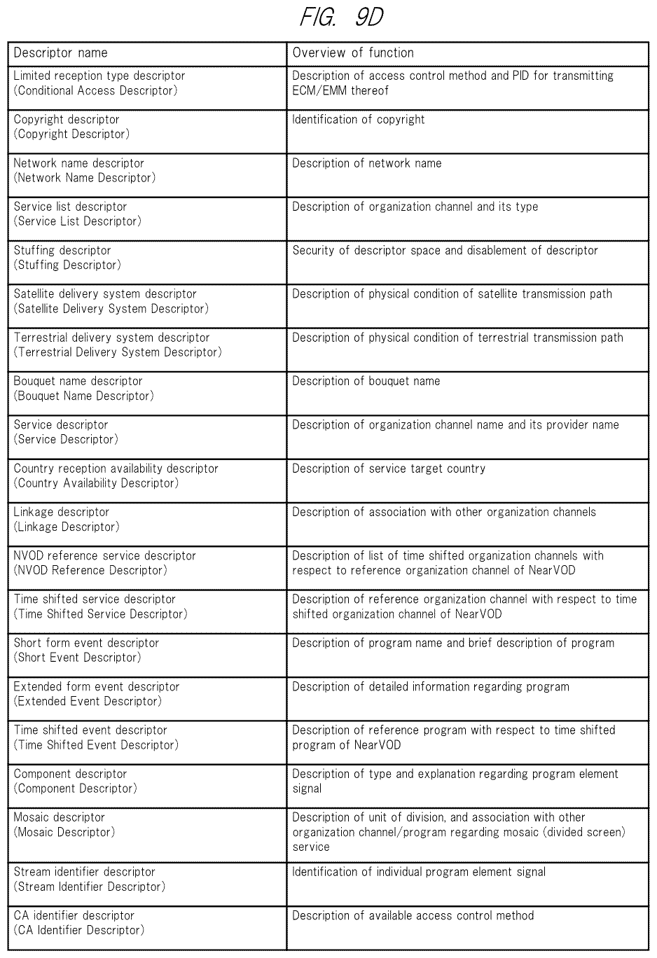

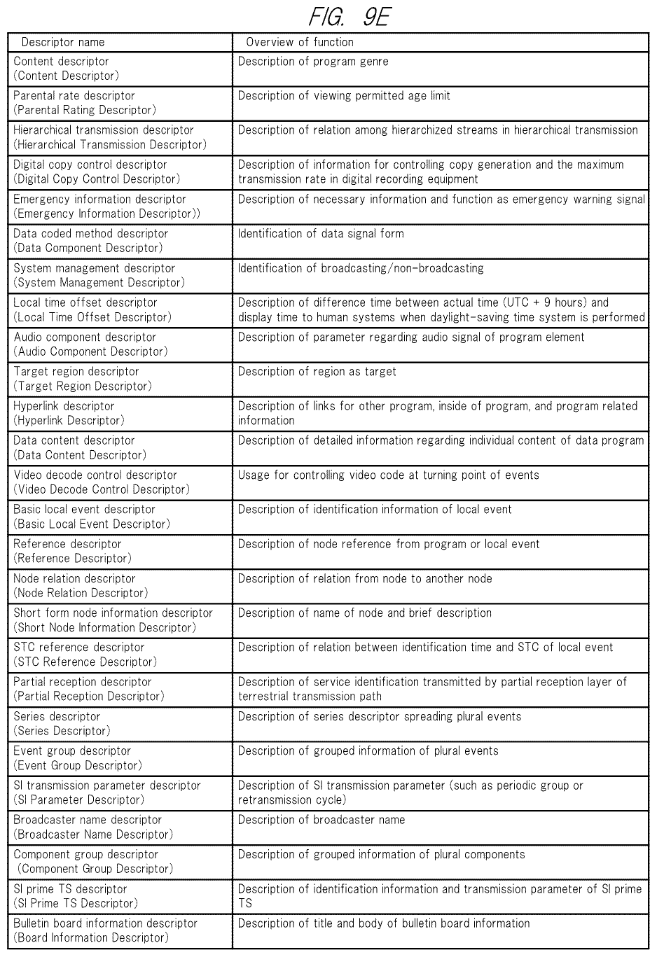

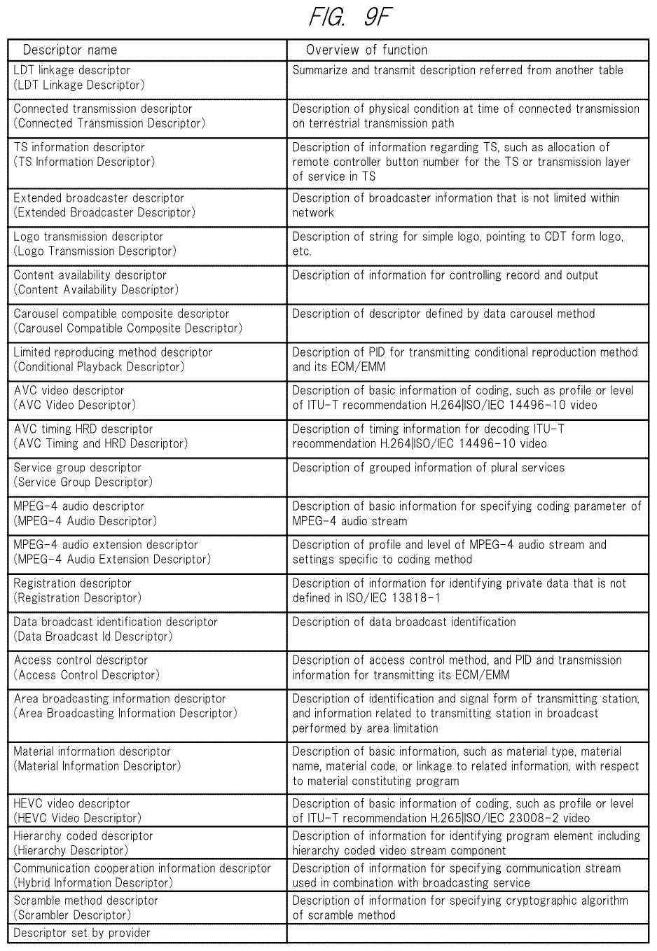

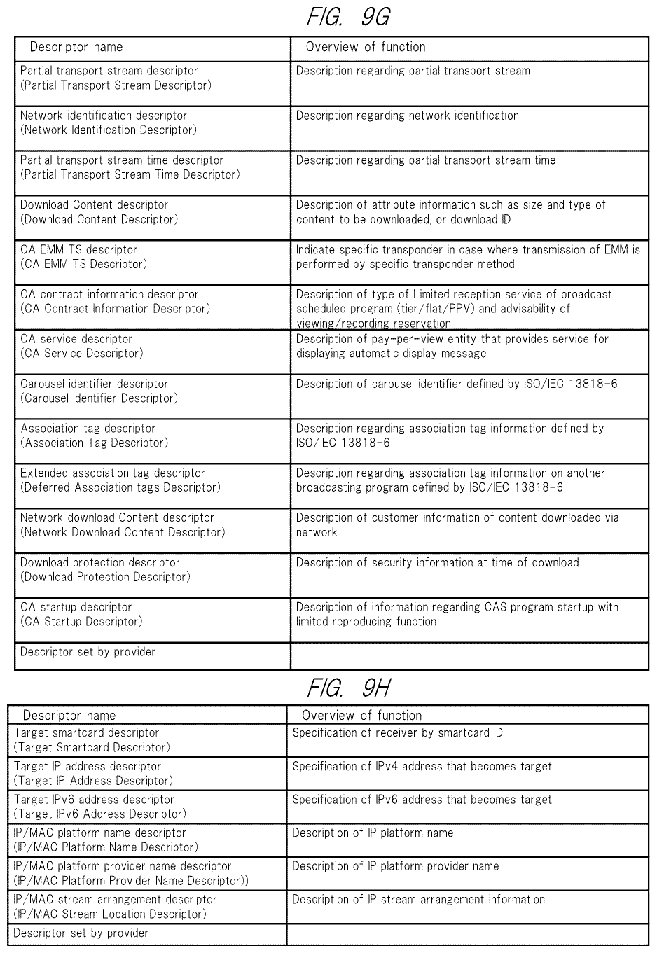

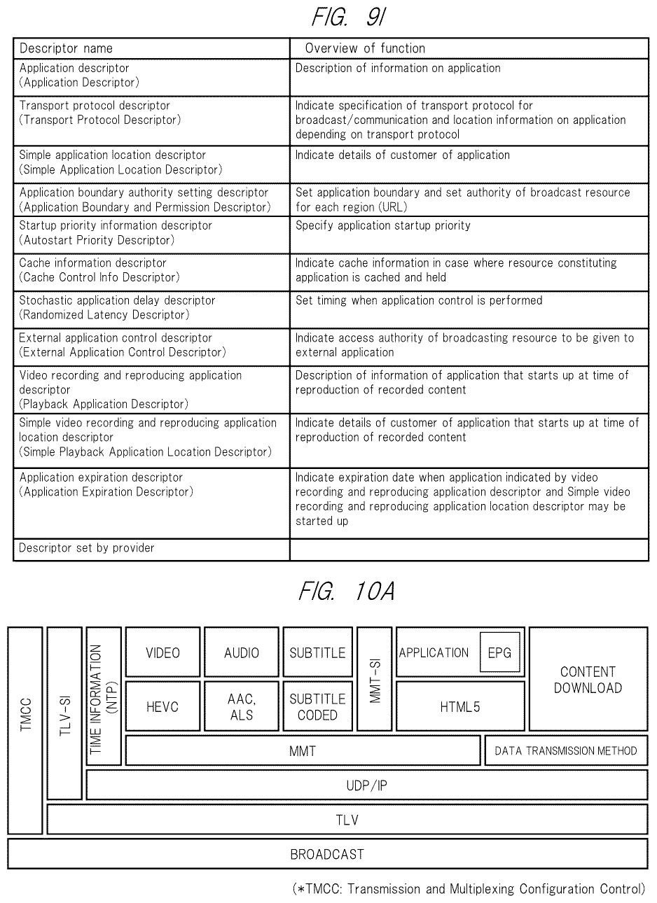

FIG. 9A illustrates one example of a protocol stack of a transmission signal in the broadcasting system using the MPEG-2 TS. In the MPEG-2 TS, PSI, SI, and the other control signals are transmitted by a section form.

### [Control Signal of Broadcasting System Using MPEG-2 TS Method]

As control information of a MPEG-2 TS method, there are a table mainly used for program arrangement information and a table used for other than the program arrangement information. Each of the tables is transmitted in a section form, and descriptors are arranged in the corresponding table.

### <Tables Used in Program Arrangement Information>

FIG. 9B illustrates a list of tables used in the program arrangement information of the broadcasting system of the MPEG-2 TS method. In the present embodiment, the following is used as the tables used in the program arrangement information.
(1) PAT (Program Association Table)
(2) CAT (Conditional Access Table)
(3) PMT (Program Map Table)
(4) NIT (Network Information Table)
(5) SDT (Service Description Table)
(6) BAT (Bouquet Association Table)
(7) EIT (Event Information Table)
(8) RST (Running Status Table)
(9) TDT (Time and Date Table)
(10) TOT (Time Offset Table)
(11) LIT (Local Event Information Table)
(12) ERT (Event Relation Table)
(13) ITT (Index Transmission Table)
(14) PCAT (Partial Content Announcement Table)
(15) ST (Stuffing Table)
(16) BIT (Broadcaster Information Table)
(17) NBIT (Network Board Information Table)
(18) LDT (Linked Description Table)
(19) AMT (Address Map Table)
(20) INT (IP/MAC Notification Table)
(21) table set by provider

### <Tables Used in Digital Broadcasting>

FIG. 9C illustrates a list of tables used for other than the program arrangement information of the broadcasting system of the MPEG-2 TS method. In the present embodiment, the following is used as the tables used for other than the program arrangement information.
(1) ECM (Entitlement Control Message)
(2) EMM (Entitlement Management Message)
(3) DCT (Download Control Table)
(4) DLT (DownLoad Table)
(5) DIT (Discontinuity Information Table)
(6) SIT (Selection Information Table)
(7) SDTT (Software Download Trigger Table)
(8) CDT (Common Data Table)
(9) DSM-CC section
(10) AIT (Application Information Table)
(11) DCM (Download Control Message)
(12) DMM (Download Management Message)
(13) table set by provider

### <Descriptors Used in Program Arrangement Information>

FIG. 9D, FIG. 9E, and FIG. 9F illustrate a list of descriptors used in the program arrangement information of the broadcasting system of the MPEG-2 TS method. In the present embodiment, the following is used as the descriptors used in the program arrangement information.
(1) conditional access descriptor (Conditional Access Descriptor)
(2) copyright descriptor (Copyright Descriptor)
(3) network name descriptor (Network Name Descriptor)
(4) service list descriptor (Service List Descriptor)
(5) stuffing descriptor (Stuffing Descriptor)
(6) satellite delivery system descriptor (Satellite Delivery System Descriptor)
(7) terrestrial delivery system descriptor (Terrestrial Delivery System Descriptor)
(8) bouquet name descriptor (Bouquet Name Descriptor)
(9) service descriptor (Service Descriptor)
(10) country reception availability descriptor (Country Availability Descriptor)
(11) linkage descriptor (Linkage Descriptor)
(12) NVOD reference service descriptor (NVOD Reference Descriptor)
(13) time shifted service descriptor (Time Shifted Service Descriptor)
(14) short form event descriptor (Short Event Descriptor)
(15) extended form event descriptor (Extended Event Descriptor)
(16) time shifted event descriptor (Time Shifted Event Descriptor)
(17) component descriptor (Component Descriptor)
(18) mosaic descriptor (Mosaic Descriptor)
(19) stream identifier descriptor (Stream Identifier Descriptor)
(20) CA identifier descriptor (CA Identifier Descriptor)
(21) content descriptor (Content Descriptor)
(22) parental rate descriptor (Parental Rating Descriptor)
(23) hierarchical transmission descriptor (Hierarchical Transmission Descriptor)
(24) digital copy control descriptor (Digital Copy Control Descriptor)
(25) emergency information descriptor (Emergency Information Descriptor)
(26) data coded method descriptor (Data Component Descriptor)
(27) system management descriptor (System Management Descriptor)
(28) local time offset descriptor (Local Time Offset Descriptor)
(29) audio component descriptor (Audio Component Descriptor)
(30) target region descriptor (Target Region Descriptor)
(31) hyperlink descriptor (Hyperlink Descriptor)
(32) data content descriptor (Data Content Descriptor)
(33) video decode control descriptor (Video Decode Control Descriptor)
(34) basic local event descriptor (Basic Local Event Descriptor)
(35) reference descriptor (Reference Descriptor)
(36) node relation descriptor (Node Relation Descriptor)
(37) short form node information descriptor (Short Node Information Descriptor)
(38) STC reference descriptor (STC Reference Descriptor)
(39) partial reception descriptor (Partial Reception Descriptor)
(40) series descriptor (Series Descriptor)
(41) event group descriptor (Event Group Descriptor)
(42) SI transmission parameter descriptor (SI Parameter Descriptor)
(43) broadcaster name descriptor (Broadcaster Name Descriptor)
(44) component group descriptor (Component Group Descriptor)
(45) SI prime TS descriptor (SI Prime TS Descriptor)
(46) bulletin board information descriptor (Board Information Descriptor)
(47) LDT linkage descriptor (LDT Linkage Descriptor)
(48) connected transmission descriptor (Connected Transmission Descriptor)
(49) TS information descriptor (TS Information Descriptor)
(50) extended broadcaster descriptor (Extended Broadcaster Descriptor)
(51) logo transmission descriptor (Logo Transmission Descriptor)
(52) content availability descriptor (Content Availability Descriptor)
(53) carousel compatible composite descriptor (Carousel Compatible Composite Descriptor)
(54) limited reproduction method descriptor (Conditional Playback Descriptor)
(55) AVC video descriptor (AVC Video Descriptor)
(56) AVC timing HRD descriptor (AVC Timing and HRD Descriptor)
(57) service group descriptor (Service Group Descriptor)
(58) MPEG-4 audio descriptor (MPEG-4 Audio Descriptor)
(59) MPEG-4 audio extension descriptor (MPEG-4 Audio Extension Descriptor)
(60) registration descriptor (Registration Descriptor)
(61) data broadcast identification descriptor (Data Broadcast Id Descriptor)
(62) access control descriptor (Access Control Descriptor)
(63) area broadcasting information descriptor (Area Broadcasting Information Descriptor)
(64) material information descriptor (Material Information Descriptor)
(65) HEVC video descriptor (HEVC Video Descriptor)
(66) hierarchy coded descriptor (Hierarchy Descriptor)
(67) communication cooperation information descriptor (Hybrid Information Descriptor)
(68) scramble method descriptor (Scrambler Descriptor)
(69) descriptor set by provider

### <Descriptors Used in Digital Broadcasting>

FIG. 9G illustrates a list of descriptors used for other than the program arrangement information of the broadcasting system of the MPEG-2 TS method. In the present embodiment, the following is used as the descriptors other than the program arrangement information.
(1) partial transport stream descriptor (Partial Transport Stream Descriptor)
(2) network identification descriptor (Network Identification Descriptor)
(3) partial transport stream time descriptor (Partial Transport Stream Time Descriptor)
(4) download content descriptor (Download Content Descriptor)
(5) CA EMM TS descriptor (CA EMM TS Descriptor)
(6) CA contract information descriptor (CA Contract Information Descriptor)
(7) CA service descriptor (CA Service Descriptor)
(8) carousel identifier descriptor (Carousel Identifier Descriptor)
(9) association tag descriptor (Association Tag Descriptor)
(10) extended association tag descriptor (Deferred Association tags Descriptor)
(11) network download content descriptor (Network Download Content Descriptor)
(12) download protection descriptor (Download Protection Descriptor)
(13) CA startup descriptor (CA Startup Descriptor)
(14) descriptor set by provider

### <Descriptors Used in INT>

FIG. 9H illustrates a list of descriptors used in INT of the broadcasting system of the MPEG-2 TS method. In the present embodiment, the following is used as the descriptors used in the INT. Note that the descriptors used in the program arrangement information described above and the descriptors used for other than the program arrangement information described above are not used in the INT.
(1) target smartcard descriptor (Target Smartcard Descriptor)
(2) target IP address descriptor (Target IP Address Descriptor)
(3) target IPV6 address descriptor (Target IPV6 Address Descriptor)
(4) IP/MAC platform name descriptor (IP/MAC Platform Name Descriptor)
(5) IP/MAC platform provider name descriptor (IP/MAC Platform Provider Name Descriptor)
(6) IP/MAC stream arrangement descriptor (IP/MAC Stream Location Descriptor)
(7) descriptor set by provider

### <Descriptors Used in AIT>

FIG. 9I illustrates a list of descriptors used in the AIT of the broadcasting system of the MPEG-2 TS method. In the present embodiment, the following is used as descriptors used in the AIT. Note that the descriptors used in the program arrangement information described above and the descriptors used for other than the program arrangement information described above are not used in the INT.
(1) application descriptor (Application Descriptor)
(2) transport protocol descriptor (Transport Protocol Descriptor)
(3) simple application location descriptor (Simple Application Location Descriptor)
(4) application boundary authority setting descriptor (Application Boundary and Permission Descriptor)
(5) startup priority information descriptor (Autostart Priority Descriptor)
(6) cache information descriptor (Cache Control Info Descriptor)
(7) stochastic application delay descriptor (Randomized Latency Descriptor)
(8) external application control descriptor (External Application Control Descriptor)
(9) video recording and reproducing application descriptor (Playback Application Descriptor)
(10) simple video recording and reproducing application location descriptor (Simple Playback Application Location Descriptor)
(11) application expiration date descriptor (Application Expiration Descriptor)
(12) descriptor set by provider

### [MMT Method]

The broadcasting system according to the present embodiment can also address an MMT method as the media transport method of transmitting data such as video or audio. Specifically, the method of the stream to be transmitted by the layer by which the advanced terrestrial digital broadcasting service is transmitted in the stream corresponding to the OFDM transmission wave illustrated in (2) of FIG. 4D and (3) of FIG. 4D is the MMT method in principle. Further, the method of the stream corresponding to the layer by which the advanced terrestrial digital broadcasting service is transmitted in the stream obtained by demodulating the transmission wave by the second tuner/demodulator 130T of the broadcast receiving apparatus 100 illustrated in FIG. 2 is an MMT in principle. Similarly, the method of the stream corresponding to the layer by which the advanced terrestrial digital broadcasting service is transmitted in the stream obtained by demodulating the transmission wave by the third tuner/demodulator 130L is the MMT method in principle. Further, the method of the stream obtained by demodulating the transmission wave by the fourth tuner/demodulator 130B is also the MMT method. Note that as a modification example, the stream of the MPEG-2 TS may be operated by the advanced terrestrial digital broadcasting service.

The MMT method is a newly formulated media transport method because functions of the MPEG-2 TS method are limited with respect to a change in environment regarding content distribution such as diversification of content in recent years, diversification of equipment that utilizes content, diversification of a transmission path for distributing content, or diversification of content storage environment.

A code of a video signal and an audio signal of a broadcasting program is an MFU (Media Fragment Unit)/MPU (Media Processing Unit); is put on MMTP (MMT Protocol) payload to be converted into an MMTP packet; and is transmitted by an IP packet. Further, data content and a signal of a subtitle related to the broadcasting program are also in an MFU/MPU form; are put on MMTP payload to be converted into an MMTP packet; and are transmitted by an IP packet.

UDP/IP (User Datagram Protocol/Internet Protocol) is used for transmission of the MMTP packet in a broadcast transmission path, and the UDP/IP or TCP/IP (Transmission Control Protocol/Internet Protocol) is used in a communication line. Further, in the broadcast transmission path, a TLV multiplex method may be used for efficient transmission of the IP packet.

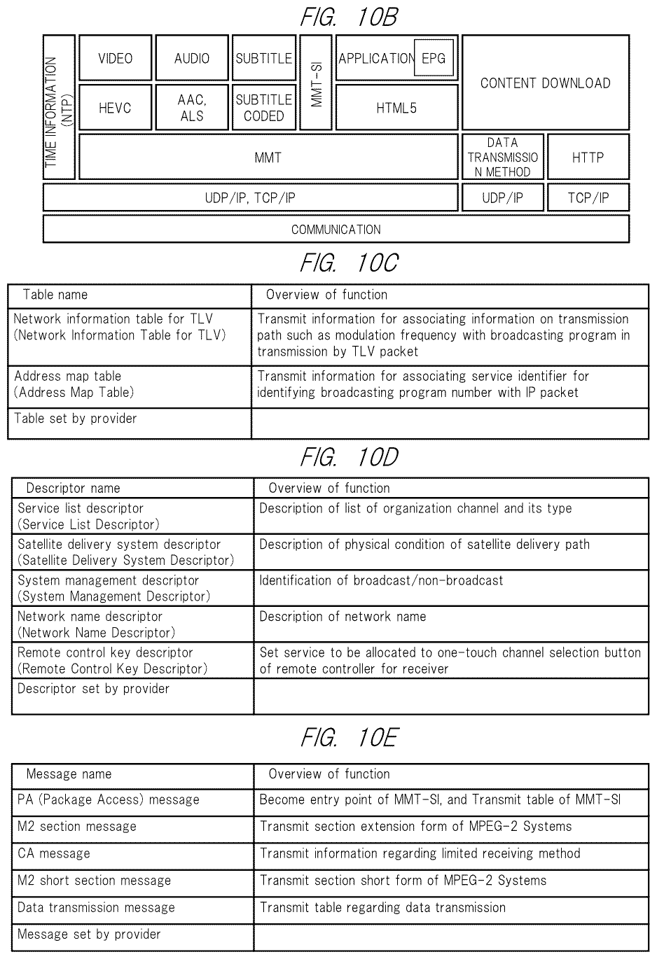

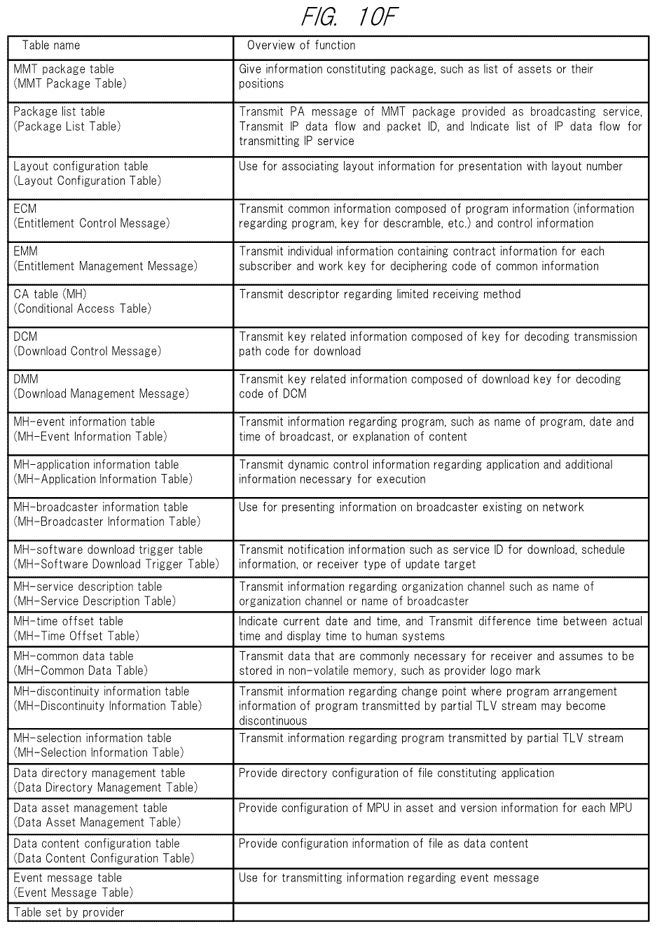

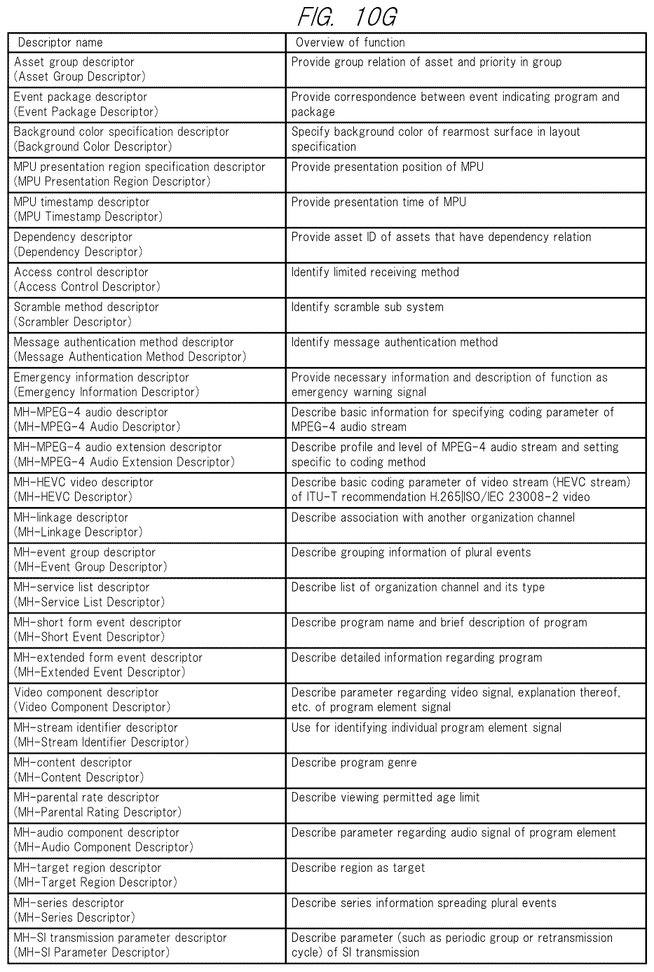

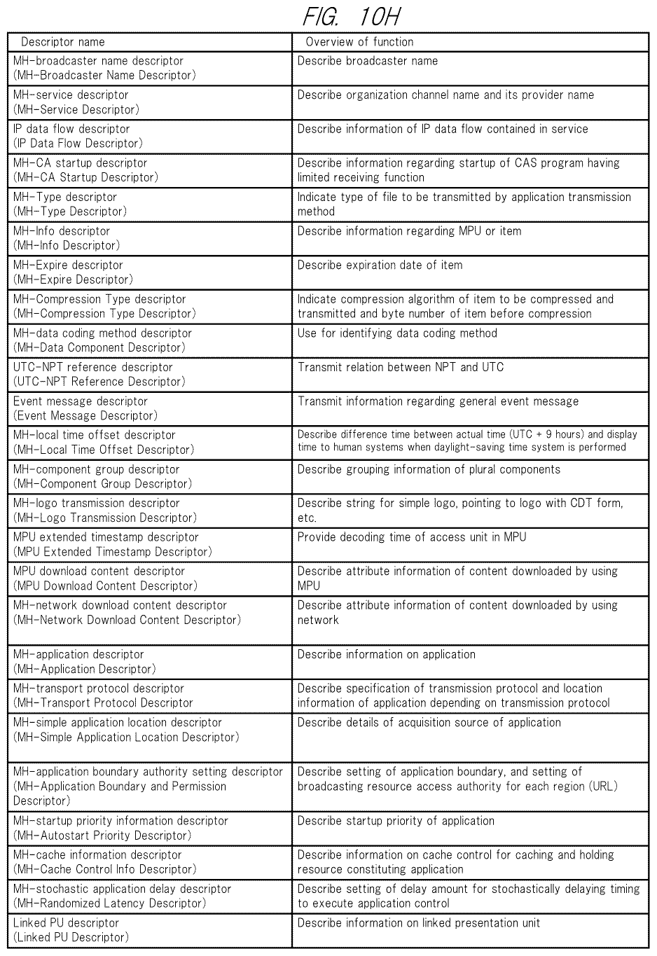

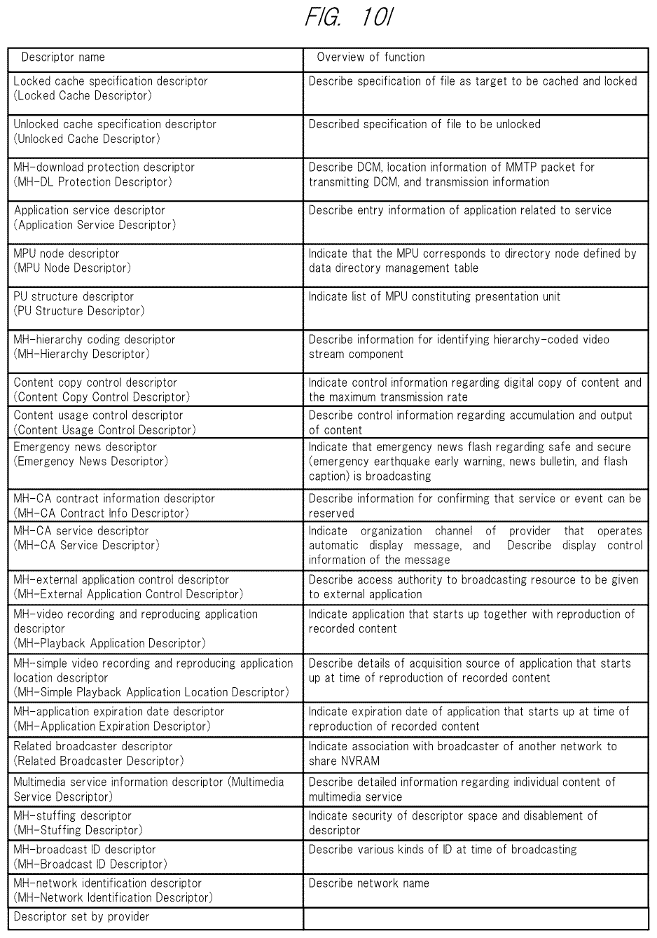

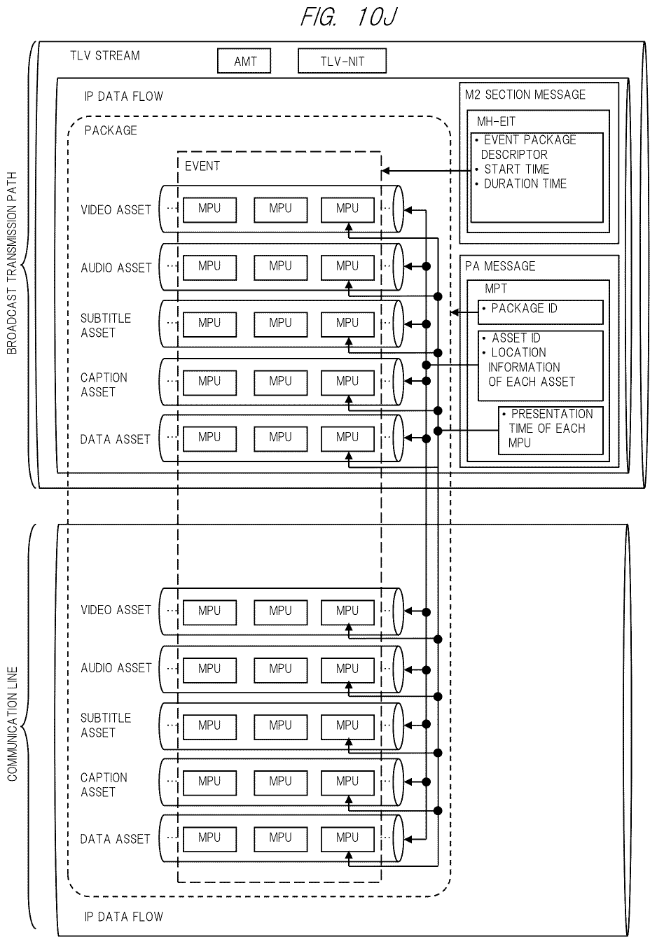

FIG. 10A illustrates a protocol stack of the MMT in the broadcast transmission path. Further, FIG. 10B illustrates a protocol stack of the MMT in the communication line. In the MMT method, a mechanism for transmitting two types of control information including MMT-SI and TLV-SI is prepared. The MMT-SI is control information indicating a configuration of a broadcasting program. The MMT-SI is formed as a control message of the MMT; is put on the MMTP payload to become an MMTP packet; and is transmitted by the IP packet. The TLV-SI is control information regarding multiplexing of the IP packet, and provides information for channel selection and correspondence information between an IP address and a service.

### [Control Signal of Broadcasting System Using MMT Method]

As described above, in the MMT method, the TLV-SI and the MMT-SI are prepared as the control information. The TLV-SI is configured by a table and descriptors. The table is transmitted in a section form, and the descriptors are arranged in the table. The MMT-SI is configured by three layers including a message that stores the table and the descriptors, a table having an element indicate specific information, and a and an attribute that descriptor that indicates more detailed information.

### <Tables Used in TLV-SI>

FIG. 10C illustrates a list of tables used in the TLV-SI of the broadcasting system of the MMT method. In the present embodiment, the following is used as the tables of the TLV-SI. Further, tables synonymous with each table illustrated in FIG. 9B and FIG. 9C may be used.
(1) network information table for TLV (Network Information Table for TLV)
(2) address map table (Address Map Table)
(3) table set by provider

### <Descriptors Used in TLV-SI>

FIG. 10D illustrates a list of descriptors used in the TLV-SI of the broadcasting system of the MMT method. In the present embodiment, the following is used as the descriptors of the TLV-SI. Further, descriptors synonymous with each descriptor illustrated in FIG. 9D, FIG. 9E, FIG. 9F, FIG. 9G, FIG. 9H, and FIG. 9I may be used.
(1) service list descriptor (Service List Descriptor)
(2) satellite delivery system descriptor (Satellite Delivery System Descriptor)
(3) system management descriptor (System Management Descriptor)
(4) network name descriptor (Network Name Descriptor)
(5) remote control key descriptor (Remote Control Key Descriptor)
(6) descriptor set by provider

### <Messages Used in MMT-SI>

FIG. 10E illustrates a list of messages used in the MMT-SI of the broadcasting system of the MMT method. In the present embodiment, the following is used as the messages of the MMT-SI.
(1) PA (Package Access) message
(2) M2 section message
(3) CA message
(4) M2 short section message
(5) data transmission message
(6) message set by provider

### <Tables Used in MMT-SI>

FIG. 10F illustrates a list of tables used in the MMT-SI of the broadcasting system of the MMT method. In the present embodiment, the following is used as the tables of the MMT-SI. Further, tables synonymous with each table illustrated in FIG. 9B and FIG. 9C may be used.
(1) MPT (MMT Package Table)
(2) PLT (Package List Table)
(3) LCT (Layout Configuration Table)
(4) ECM (Entitlement Control Message)
(5) EMM (Entitlement Management Message)
(6) CAT (MH) (Conditional Access Table (MH))
(7) DCM (Download Control Message)
(8) DMM (Download Management Message)
(9) MH-EIT (MH-Event Information Table)
(10) MH-AIT (MH-Application Information Table)
(11) MH-BIT (MH-Broadcaster Information Table)
(12) MH-SDTT (MH-Software Download Trigger Table)
(13) MH-SDT (MH-Service Description Table)
(14) MH-TOT (MH-Time Offset Table)
(15) MH-CDT (MH-Common Data Table)
(16) MH-DIT (MH-Discontinuity Information Table)
(17) MH-SIT (MH-Selection Information Table)
(18) DDM table (Data Directory Management Table)
(19) DAM table (Data Asset Management Table)
(20) DCC table (Data Content Configuration Table)
(21) EMT (Event Message Table)
(22) table set by provider

### <Descriptors Used in MMT-SI>

FIG. 10G, FIG. 10H, and FIG. 10I illustrate a list of descriptors used in the MMT-SI of the broadcasting system of the MMT method. In the present embodiment, the following is used as the descriptors of the MMT-SI. Further, descriptors synonymous with each descriptor illustrated in FIG. 9D, FIG. 9E, FIG. 9F, FIG. 9G, FIG. 9H, and FIG. 9I may be used.
(1) asset group descriptor (Asset Group Descriptor)
(2) event package descriptor (Event Package Descriptor)
(3) background color specification descriptor (Background Color Descriptor)
(4) MPU presentation region specification descriptor (MPU Presentation Region Descriptor)
(5) MPU timestamp descriptor (MPU Timestamp Descriptor)
(6) dependency descriptor (Dependency Descriptor)
(7) access control descriptor (Access Control Descriptor)
(8) scramble method descriptor (Scrambler Descriptor)
(9) message authentication method descriptor (Message Authentication Method Descriptor)
(10) emergency information descriptor (Emergency Information Descriptor)
(11) MH-MPEG-4 audio descriptor (MH-MPEG-4 Audio Descriptor)
(12) MH-MPEG-4 audio extension descriptor (MH-MPEG-4 Audio Extension Descriptor)
(13) MH-HEVC descriptor (MH-HEVC Descriptor)
(14) MH-linkage descriptor (MH-Linkage Descriptor)
(15) MH-event group descriptor (MH-Event Group Descriptor)
(16) MH-service list descriptor (MH-Service List Descriptor)
(17) MH-short form event descriptor (MH-Short Event Descriptor)
(18) MH-extended form event descriptor (MH-Extended Event Descriptor)
(19) video component descriptor (Video Component Descriptor)
(20) MH-stream identifier descriptor (MH-Stream Identifier Descriptor)
(21) MH-content descriptor (MH-Content Descriptor)
(22) MH-parental rate descriptor (MH-Parental Rating Descriptor)
(23) MH-audio component descriptor (MH-Audio Component Descriptor)
(24) MH-target region descriptor (MH-Target Region Descriptor)
(25) MH-series descriptor (MH-Series Descriptor)
(26) MH-SI transmission parameter descriptor (MH-SI Parameter Descriptor)
(27) MH-broadcaster name descriptor (MH-Broadcaster Name Descriptor)
(28) MH-service descriptor (MH-Service Descriptor)
(29) IP data flow descriptor (IP Data Flow Descriptor)
(30) MH-CA startup descriptor (MH-CA Startup Descriptor)
(31) MH-Type descriptor (MH-Type Descriptor)
(32) MH-Info descriptor (MH-Info Descriptor)
(33) MH-Expire descriptor (MH-Expire Descriptor)
(34) MH-Compression Type descriptor (MH-Compression Type Descriptor)
(35) MH-data coding method descriptor (MH-Data Component Descriptor)
(36) UTC-NPT reference descriptor (UTC-NPT Reference Descriptor)
(37) event message descriptor (Event Message Descriptor)
(38) MH-local time offset descriptor (MH-Local Time Offset Descriptor)
(39) MH-component group descriptor (MH-Component Group Descriptor)
(40) MH-logo transmission descriptor (MH-Logo Transmission Descriptor)
(41) MPU extended timestamp descriptor (MPU Extended Timestamp Descriptor)
(42) MPU download content descriptor (MPU Download Content Descriptor)
(43) MH-network download content descriptor (MH-Network Download Content Descriptor)
(44) MH-application descriptor (MH-Application Descriptor)
(45) MH-transport protocol descriptor (MH-Transport Protocol Descriptor)
(46) MH-simple application location descriptor (MH-Simple Application Location Descriptor)
(47) MH-application boundary authority setting descriptor (MH-Application Boundary and Permission Descriptor)
(48) MH-startup priority information descriptor (MH-Autostart Priority Descriptor)
(49) MH-cache information descriptor (MH-Cache Control Info Descriptor)
(50) MH-stochastic application delay descriptor (MH-Randomized Latency Descriptor)
(51) linked PU descriptor (Linked PU Descriptor)
(52) locked cache specification descriptor (Locked Cache Descriptor)
(53) unlocked cache specification descriptor (Unlocked Cache Descriptor)
(54) MH-download protection descriptor (MH-DL Protection Descriptor)
(55) application service descriptor (Application Service Descriptor)
(56) MPU node descriptor (MPU Node Descriptor)
(57) PU structure descriptor (PU Structure Descriptor)
(58) MH-hierarchy coding descriptor (MH-Hierarchy Descriptor)
(59) content copy control descriptor (Content Copy Control Descriptor)
(60) content usage control descriptor (Content Usage Control Descriptor)
(61) emergency news descriptor (Emergency News Descriptor)
(62) MH-CA contract information descriptor (MH-CA Contract Info Descriptor)
(63) MH-CA service descriptor (MH-CA Service Descriptor)
(64) MH-external application control descriptor (MH-External Application Control Descriptor)
(65) MH-video recording and reproducing application descriptor (MH-Playback Application Descriptor)
(66) MH-simple video recording and reproducing application location descriptor (MH-Simple Playback Application Location Descriptor)
(67) MH-application expiration date descriptor (MH-Application Expiration Descriptor)
(68) related broadcaster descriptor (Related Broadcaster Descriptor)
(69) multimedia service information descriptor (Multimedia Service Descriptor)
(70) MH-stuffing descriptor (MH-Stuffing Descriptor)
(71) MH-broadcast ID descriptor (MH-Broadcast ID Descriptor)
(72) MH-network identification descriptor (MH-Network Identification Descriptor)
(73) descriptor set by provider

### <Relation Between Data Transmission and Each Control Information in MMT Method>

FIG. 10J illustrates a relation between data transmission and representative tables in the broadcasting system of the MMT method.

In the broadcasting system of the MMT method, data transmission can be executed via a plurality of routes such as the TLV stream via the broadcast transmission path or an IP data flow via the communication line. The TLV-SI such as a TLV-NIT or an AMT and the IP data flow that is a data flow of the IP packet are contained in the TLV stream. A video asset including a series of video MPUs and an audio asset including a series of audio MPUs are contained in the IP data flow. Moreover, any of a subtitle asset including a series of subtitle MPUs, a caption asset including a series of caption MPUs, and a data asset including a series of data MPUs may be contained therein. Various kinds of assets are associated with each other in units of package by an MPT (an MMT package table) stored in a PA message and to be transmitted. Specifically, a package ID and an asset ID of each asset included in a package may be described in the MPT so as to be associated with each other.

The assets constituting the package can be only the assets in the TLV stream. However, as illustrated in FIG. 10J, the assets to be transmitted by the IP data flow of the communication line can also be included. This can be realized by containing location information of each asset included in the package in the MPT so that the broadcast receiving apparatus 100 can grasp a reference destination of each asset. As the location information of each asset, it is possible to specify various kinds of data to be transmitted by various transmission routes as follows:
(1) data multiplexed into the same IP data flow as the MPT
(2) data multiplexed into an IPV4 data flow
(3) data multiplexed into an IPV6 data flow
(4) data multiplexed into MPEG2-TS of broadcast
(5) data multiplexed into the IP data flow in an MPEG2-TS form
(6) data at a specified URL.

The broadcasting system of the MMT method further has a concept of an event. The event is a concept indicating a so-called program, which is treated by an MH-EIT that is transmitted while being included in an M2 section message. Specifically, in a package indicated by an event package descriptor stored in the MH-EIT, a series of data included in a period for a duration time from a disclosure time stored in the MH-EIT is data contained in the concept of the event. The MH-EIT can be used for various kinds of processes (for example, a generating process for a program guide, a control of video recording reservation or timer recording, a copyright management process such as temporary storage, and the like) in units of event in the broadcast receiving apparatus 100.

### [Channel Setting Process of Broadcast Receiving Apparatus]

### <Initial Scan>

In the existing terrestrial digital broadcasting, the network ID is different in units of sending master, and it is general that information of the other stations is not described in an NIT. Therefore, with respect to the terrestrial digital broadcasting according to the embodiment of the present invention (advanced terrestrial digital broadcast or terrestrial digital broadcast in which the advanced terrestrial digital broadcasting and the existing terrestrial digital broadcasting are transmitted by the other layers at the same time), the broadcast receiving apparatus 100 according to the embodiment of the present invention which has compatibility with the existing terrestrial digital broadcasting needs to have a function to search (or scan) all receivable channels at a reception spot and create a service list (that is, a receivable frequency table) based on a service ID. Note that in regions where the same network ID can be received on different physical channels by an MFN (Multi Frequency Network: multi frequency network), the broadcast receiving apparatus 100 may basically operate so as to select a channel with a good reception C/N or a good BER (Bit Error Rate) and store it in the service list.

Note that in the advanced BS digital broadcasting or the advanced CS digital broadcasting received by the fourth tuner/demodulator 130B of the broadcast receiving apparatus 100 according to the embodiment of the present invention, the broadcast receiving apparatus 100 may obtain and store the service list to be stored in the TLV-NIT, and it is thus unnecessary to create the service list. Therefore, the initial scan and rescan (will be described later) are not required for the advanced BS digital broadcasting or the advanced CS digital broadcasting received by the fourth tuner/demodulator 130B.

### <Rescan>

The broadcast receiving apparatus 100 according to the embodiment of the present invention has a rescan function prepared for a case of open of a new station, installation of a new relay station, or change in a reception spot of a television receiver. In a case where information that has already been set is to be changed, the broadcast receiving apparatus 100 can notify the user of that effect.

### <Operation Example at Time of Initial Scan/Rescan>

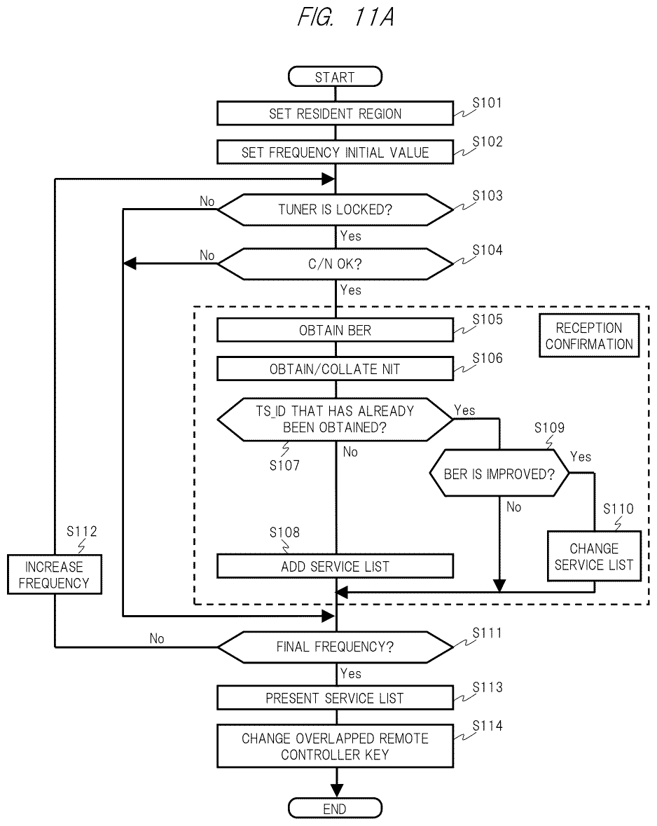

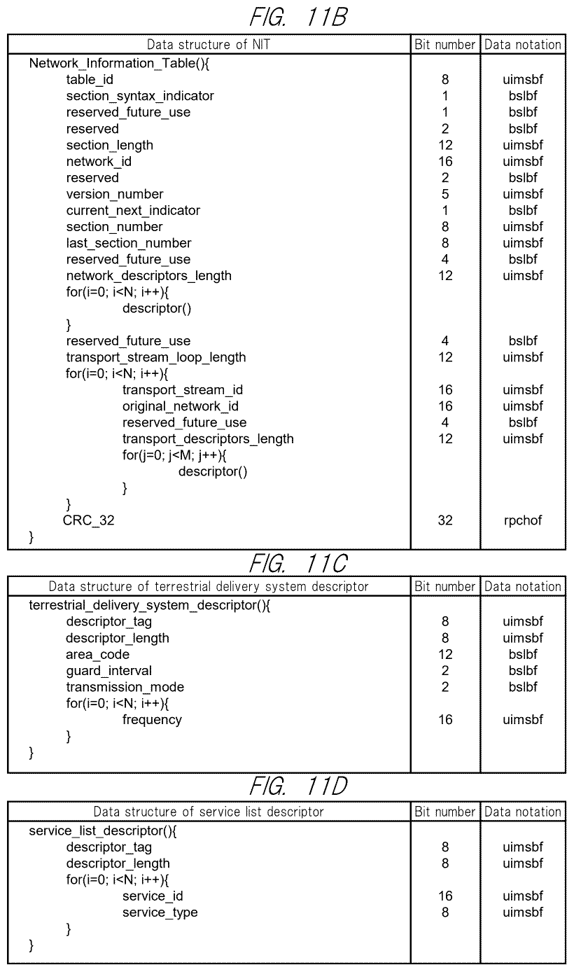

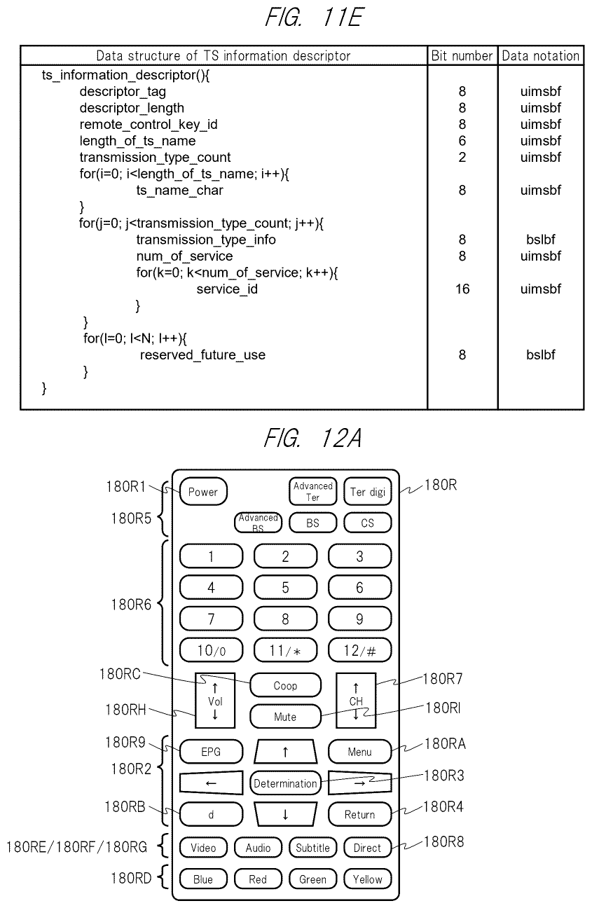

FIG. 11A illustrates one example of an operation sequence of a channel setting process (initial scan/rescan) by the broadcast receiving apparatus 100 according to the embodiment of the present invention. Note that in this drawing, an example of a case where the MPEG-2 TS is adopted as the media transport method is illustrated, but the process is basically the same even in a case where the MMT method is adopted.

In the channel setting process, the receiving function controller 1102 first executes setting of a resident region (selection of a region where the broadcast receiving apparatus 100 is installed) on the basis of an instruction of the user (S101). At this time, in place of the instruction of the user, the setting of the resident region may be executed automatically on the basis of installation location information of the broadcast receiving apparatus 100, which is obtained by a predetermined process. As an example of an obtaining process of the installation location information, such information may be obtained from a network to which the LAN communication unit 121 is connected, or information regarding an installation location may be obtained from external equipment to which the digital interface 125 is connected. Next, an initial value of a frequency range to be scanned is set, and a tuner/demodulator (described in this manner in a case where the first tuner/demodulator 130C, the second tuner/demodulator 130T, and the third tuner/demodulator 130L are not distinguished. The same applies hereinafter.) is instructed so as to execute tuning to the set frequency (S102).

The tuner/demodulator executes the tuning on the basis of the instruction (S103). In a case where the lock to the set frequency is successful (S103: Yes), the processing flow proceeds to a process at S104. In a case where the lock is not successful (S103: No), the processing flow proceeds to a process at S111. In the process at S104, confirmation of a C/N is executed (S104). In a case where a predetermined number of C/N or more is obtained (S104: Yes), the processing flow proceeds to a process at S105, and a reception confirming process is executed. In a case where the predetermined number of C/N or more is not obtained (S104: No), the processing flow proceeds to a process at S111.

In the reception confirming process, the receiving function controller 1102 first obtains a BER of the received broadcast wave (S105). Next, an NIT is obtained and collated, whereby it is confirmed whether the NIT is effective data or not (S106). In a case where the NIT obtained in the process at S106 is effective data, the receiving function controller 1102 obtains, from the NIT, information such as a transport stream ID or an original network ID. Further, the receiving function controller 1102 obtains, from a terrestrial delivery system descriptor, delivery system information regarding a physical condition of a broadcast transmission path corresponding to each transport stream ID/original network ID. Further, the receiving function controller 1102 obtains a list of service IDs from a service list descriptor.

Next, by confirming the service list stored in the receiving apparatus, the receiving function controller 1102 confirms whether the transport stream ID obtained in the process at S106 has already been obtained or not (S107). In a case where the transport stream ID obtained in the process at S106 has not already been obtained (S107: No), the receiving function controller 1102 adds the various kinds of information obtained in the process at S106 to the service list so as to be associated with the transport stream ID (S108). In a case where the transport stream ID obtained in the process at S106 has already been obtained (S107: Yes), the receiving function controller 1102 compares the BER obtained in the process at S105 with the BER when the transport stream ID, which has been described in the service list, is obtained (S109). As a result, in a case where the BER obtained in the process at S105 is better (S109: Yes), the receiving function controller 1102 updates the service list on the basis of the various kinds of information obtained in the process at S106 (S110). In a case where the BER obtained in the process at S105 is not better (S109: No), the receiving function controller 1102 discards the various kinds of information obtained in the process at S106.

Further, at the time of the service list creating (adding/updating) process described above, a remote controller key ID may be obtained from a TS information descriptor, and a representative service for each transport stream may be associated with the remote controller key. By this process, it becomes possible to execute one-touch channel selection (will be described later).

When the reception confirming process is terminated, the receiving function controller 1102 confirms whether a current frequency setting is a final value in the frequency range to be scanned or not (S111). In a case where the current frequency setting is not the final value in the frequency range to be scanned (S111: No), the receiving function controller 1102 increases the frequency value set to the tuner/demodulator (S112), and repeats the processes at S103 to S110. In a case where the current frequency setting is the final value in the frequency range to be scanned (S111: Yes), the processing flow proceeds to a process at S113.

In the process at S113, the service list created (or added or updated) in the processes described above is presented to the user as a result of the channel setting process (S113). Further, in a case where there is overlap of the remote controller keys, the user may be informed of that effect to encourage the user to change the setting for the remote controller key (S114). The service list created or updated in the processes described above is stored in a non-volatile memory such as the ROM 103 or the storage (accumulator) 110 of the broadcast receiving apparatus 100.

FIG. 11B illustrates one example of a data structure of the NIT. In FIG. 11B, “transpotrt_stream_id” corresponds to the transport stream ID described above, and “original_network_id” corresponds to the original network ID. Further, FIG. 11C illustrates one example of a data structure of the terrestrial delivery system descriptor. In FIG. 11C, “guard_interval”, “transmission_mode”, “frequency”, and the like correspond to the delivery system information described above. FIG. 11D illustrates one example of a data structure of the service list descriptor. In FIG. 11D, “service_id” corresponds to the service ID described above. FIG. 11E illustrates one example of a data structure of the TS information descriptor. In FIG. 11E, “remote_control_key_id” corresponds to the remote controller key ID described above.

Note that the broadcast receiving apparatus 100 may control the receiving function controller 1102 so as to appropriately change the frequency range to be scanned described above in accordance with a broadcasting service to be received. For example, in a case where the broadcast receiving apparatus 100 receives the broadcast wave of the existing terrestrial digital broadcasting service, the broadcast receiving apparatus 100 controls the receiving function controller 1102 so as to scan a frequency range of 470 to 770 MHz (corresponding to 13 ch to 62 ch of the physical channel). Namely, the broadcast receiving apparatus 100 sets an initial value of the frequency range to 470 to 476 MHz (central frequency: 473 MHz); sets a final value of the frequency range to 764 to 770 MHz (central frequency: 767 MHz); and controls the receiving function controller 1102 so as to increase the frequency value by +6 MHz in the process at S112.

Further, in a case where the broadcast receiving apparatus 100 receives the broadcast wave including the advanced terrestrial digital broadcasting service, the broadcast receiving apparatus 100 controls the receiving function controller 1102 so as to scan a frequency range of 470 to 1010 MHz (because there is a possibility that the frequency converting process illustrated in FIG. 7D or the frequency conversion amplification process illustrated in FIG. 8C is executed). Namely, the broadcast receiving apparatus 100 sets an initial value of the frequency range to 470 to 476 MHz (central frequency: 473 MHz); sets a final value of the frequency range to 1004 to 1010 MHz (central frequency: 1007 MHz); and controls serviced the receiving function controller 1102 so as to increase the frequency value by +6 MHz in the process at S112. Note that even in a case where the broadcast receiving apparatus 100 receives the advanced terrestrial digital broadcasting service but it is determined that the frequency converting process or the frequency conversion amplification process described above is not executed, the broadcast receiving apparatus 100 may control the receiving function controller 1102 so as to scan only the frequency range of 470 to 770 MHz. The broadcast receiving apparatus 100 can execute a selection control of the frequency range to be scanned on the basis of the system identification of the TMCC information, the frequency converting process identification, and the like.

Further, in a case where the broadcasting system according to the embodiment of the present invention has the configuration illustrated in FIG. 7C, for example, and the broadcast receiving apparatus 100 receives the advanced terrestrial digital broadcasting service of the dual-polarized transmission method, one of the tuning/wave detector 131H and the tuning/wave detector 131V may scan the frequency range of 470 to 770 MHz, and the other may scan the frequency range of 770 to 1010 MHz (in a case where the frequency converting process is applied to the transmission wave by the polarized wave detected by the other tuning/wave detector). By controlling it in this manner on the basis of the system identification of the TMCC information and the frequency converting process identification, it is possible to omit scanning in an unnecessary frequency range, and this makes it possible to reduce the time required for channel setting. Moreover, in this case, both the tuning/wave detector 131H and the tuning/wave detector 131V may cause the operation sequence illustrated in FIG. 11A to proceed in parallel to synchronize the loop of frequency increase at S112 in the operation sequence illustrated in FIG. 11A. At this time, in the loop of the same timing in the loop of the frequency increase in the operation sequence illustrated in FIG. 11A, in a case where the broadcast receiving apparatus 100 is configured so as to receive a pair of the horizontal polarization signal and the vertical polarization signal transmitted by the same physical channel in parallel, it becomes possible to decode the control information inside the packet stream of the advanced terrestrial digital service to be transmitted by the pair of the horizontal polarization signal and the vertical polarization signal to obtain the decoded control information during the loop process. This is preferable because the scanning and the creation of the service list proceed efficiently.

Similarly, in a case where the broadcast receiving apparatus 100 further has a configuration of so-called double tuners in which a plurality of tuners/demodulators (tuning/wave detectors) is provided (for example, a configuration in which a plurality of third tuner/demodulators 130L is provided or configuration illustrated in FIG. 8D) in addition to the configuration illustrated in FIG. 8B and the broadcast receiving apparatus 100 receives the advanced terrestrial digital broadcasting service of the layered division multiplexing transmission method, one of the double tuners may scan the frequency range of 470 to 770 MHz, and the other may scan the frequency range of 770 to 1010 MHz (in a case where the frequency conversion amplification process is applied thereto). By controlling it in this manner, it becomes possible to reduce the time required for the channel setting in the similar manner to the above.

Note that as explained with reference to FIG. 8A, FIG. 8B, and FIG. 8C, the terrestrial digital broadcasting service transmitted by any one of the upper layer and the lower layer in the configuration illustrated in FIG. 8B is the existing terrestrial digital broadcasting service. Therefore, for example, the first tuner/demodulator 130C may scan the frequency range in which the existing terrestrial digital broadcasting service is transmitted of the frequency range of 470 to 770 MHz and the frequency range of 770 to 1010 MHz, and the third tuner/demodulator 130L may scan the other frequency range in parallel. In this case, it is also possible to reduce the time required for the channel setting in the similar manner to the parallel scanning by the double tuners of the third tuner/demodulator 130L described above. Whether the existing terrestrial digital broadcasting service is transmitted in any of the frequency range of 470 to 770 MHz and the frequency range of 770 to 1010 MHz and whether the advanced terrestrial digital broadcasting service is transmitted in any of the frequency range of 470 to 770 MHz and the frequency range of 770 to 1010 MHz can be identified by receiving each one point in respective frequency ranges (two points in total), for example, two points of 470 to 476 MHz (central frequency: 473 MHz) and 770 to 776 MHz (central frequency: 773 MHz) by means of the third tuner/demodulator 130L before the operation sequence for the initial scan/rescan is started, obtaining the TMCC information transmitted at each frequency, and referring to the parameters stored in the TMCC information (for example, the parameter of the system identification).

Note that in a case of a channel that has a broadcasting program to be transmitted by using both the horizontal polarization signal and the vertical polarization signal like the 4K broadcasting program of the C layer illustrated in the layer division example of (1) of FIG. 7A, for example, in the advanced terrestrial digital broadcasting service of the dual-polarized transmission method, the same transport ID is detected by scanning both the frequency range of 470 to 770 MHz and the frequency range of 770 to 1010 MHz. However, this is described as one channel in the service list. Further, in a case where the same broadcasting program is transmitted by the B layer of the horizontal polarization signal and the B layer of the vertical polarization signal in the 2K broadcasting program of the B layer illustrated in this drawing, it may be stored as one channel in the service list even though the same transport ID is detected. Namely, in a case where the same broadcasting program is transmitted in the same layers transmitted by different polarized waves, they are merged into one channel and recognized, and are not recognized as different channels. In this manner, it is possible to avoid the user from being confused due to existence of exactly the same broadcasting program in the different channels in the channel selecting process using the service list.

On the other hand, in a case where different broadcasting programs are transmitted between the B layer of the horizontal polarization signal and the B layer of the vertical polarization signal in the advanced terrestrial digital broadcasting service of the dual-polarized transmission method (in a case where the B layer of the vertical polarization signal is treated as the virtual D layer), they are stored as different channels in the service list. It is possible to identify whether the same broadcasting program is transmitted by the B layer of the horizontal polarization signal and the B layer of the vertical polarization signal or not by determining it with reference to the additional layer transmission identification parameter of the TMCC information in the broadcast receiving apparatus 100.

### [Channel Selecting Process of Broadcast Receiving Apparatus]

The broadcast receiving apparatus 100 according to the embodiment of the present invention has, as program selecting functions, such functions as one-touch channel selection by a one-touch key of a remote controller, channel up/down selection by a channel up/down key of the remote controller, and direct channel selection by a direct input of a triple-digit number using ten keys of the remote controller. Any channel selecting function may be executed by using information stored in the service list generated by the initial scan/rescan described above. Further, after channel selection, information on the selected channel (a triple-digit number used for direct channel selection, a branch number, a TS name, a service name, a logo, video resolution information (distinguishing among UHD, HD, and SD), presence or absence of video resolution up/down conversion, the number of audio channels, presence or absence of audio downmix, and the like) is displayed by a banner display or the like. In this manner, the user visually obtains information of the channel after channel selection, and confirm whether the desired channel can be selected or not. Hereinafter, one example of a process in each channel selecting method is described.

### <Process Example of One-Touch Channel Selection>

(1) A service of “service_id” specified by “remote_control_key_id” is selected by pressing the one-touch key of the remote controller.
(2) A last mode is set, and channel information display after channel selection is executed.

### <Process Example of Up/Down Channel Selection by Channel Up/Down Button>

(1) Channel selection is executed in the order of the triple-digit number using the direct channel selection by pressing the channel up/down key of the remote controller.
(1-1) In a case where an up key is pressed, an upper adjacent service in the triple-digit number is selected. However, in a case where a value of a current triple-digit number is the maximum value in the service list, a service with a number of the minimum value is selected.
(1-2) In a case where a down key is pressed, a lower adjacent service in the triple-digit number is selected. However, in a case where a value of a current triple-digit number is the minimum value in the service list, a service with a number of the maximum value is selected.
(3) A last mode is set, and channel information display after channel selection is executed.

### <Process Example of Direct Channel Selection>

(1) When direct channel selection is selected, it becomes a state of waiting for an input of triple-digit number.
(2-1) In a case where the input of the triple-digit number is not completed within a predetermined time (about five seconds), the mode is returned to a normal mode, and channel information display of the currently selected service is executed.
(2-2) In a case where an input of a triple-digit number is completed, it is determined whether the channel exists in the service list of a receivable frequency table or not. In a case where the channel does not exist, a message such as “this channel does not exist” is displayed.
(3) In a case where the channel exists, a channel selecting process is executed, a last mode is set, and channel information display after channel selection is executed.

Note that the channel selecting operation is executed on the basis of SI, and the broadcast receiving apparatus 100 may also have a function to inform the user of the suspension of the broadcasting by displaying that effect if it is determined that the broadcast is suspended.

### <Remote Controller of Broadcast Receiving Apparatus>

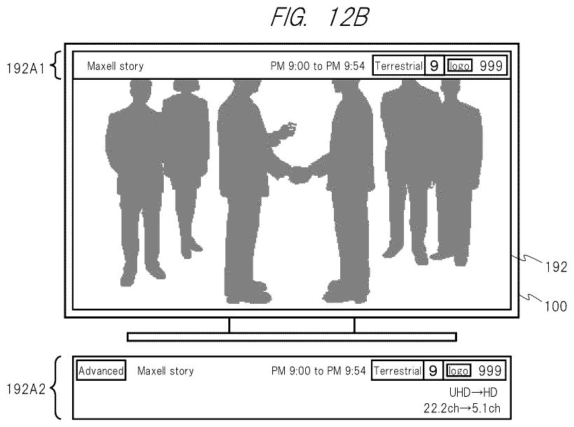

FIG. 12A illustrates one example of an appearance view of the remote controller (remote controller) used for inputting an operation instruction to the broadcast receiving apparatus 100 according to the embodiment of the present invention.

A remote controller 180R includes a power key 180R1 for turning on/off (standby on/off) of a power of the broadcast receiving apparatus 100, cursor keys (up, down, left, and right) 180R2 for moving a cursor up, down, right, and left, a determination key 180R3 for determining an item at a cursor position as a selection item, and a return key 180R4.

Further, the remote controller 180R also includes network switching keys (advanced terrestrial digital, terrestrial digital, advanced BS, BS, and CS) 180R5 for switching a broadcasting network received by the broadcast receiving apparatus 100. Further, the remote controller 180R also includes one-touch keys (1 to 12) 180R6 used for one-touch channel selection, a channel up/down key 180R7 used for channel up/down selection, and ten keys used for inputting a triple-digit number at the time of direct channel selection. Note that in the example illustrated in FIG. 12A, the ten keys are also used as the one-touch keys 180R6, and a triple-digit number can be inputted by operating the one-touch keys 180R6 after pressing a direct key 180R8 at the time of direct channel selection.

Further, the remote controller 180R also includes an EPG key 180R9 for displaying a program guide and a menu key 180RA for displaying a system menu. The program guide and the system menu can be operated in detail by any of the cursor keys 180R2, the determination key 180R3, and the return key 180R4.

Further, the remote controller 180R also includes a d key 180RB used for a data broadcasting service or a multimedia service, a cooperation key 180RC for displaying a broadcasting/communication cooperation service and a list of corresponding applications, and color keys (blue, red, green, and yellow) 180RD. In each of the data broadcasting service, the multimedia service, and the broadcasting/communication cooperation service, detailed operations can be carried out by using any of the cursor keys 180R2, the determination key 180R3, the return key 180R4, and the color keys 180RD.

Further, the remote controller 180R also includes a video key 180RE for selecting related video, an audio key 180RF for switching of audio ES or switching of two languages, and a subtitle key 180RG for switching of on/off of a subtitle or switching of a subtitle language. Further, the remote controller 180R also includes a volume key 180RH for increasing or decreasing volume of audio output, and a mute key 180RI for switching on/off of the audio output.

### <Process Example of Network Switching by Advanced Terrestrial Digital Key>

The remote controller 180R of the broadcast receiving apparatus 100 according to the embodiment of the present invention includes an “advanced terrestrial digital key”, a “terrestrial digital key”, an “advanced BS key”, a “BS key”, and a “CS key” as the network switching keys 180R5. Here, with respect to the “advanced terrestrial digital key” and the “terrestrial digital key”, the broadcast receiving apparatus 100 may be configured so that in the advanced terrestrial digital broadcasting service, for example, in a case where the simultaneous broadcasting of a 4K broadcasting program and a 2K broadcasting program by different layers is performed, selection of the 4K broadcasting program is prioritized at the time of channel selection in a state where the “advanced terrestrial digital key” is pressed; and selection of the 2K broadcasting program is prioritized at the time of channel selection in a state where the “terrestrial digital key” is pressed. By controlling the broadcast receiving apparatus 100 in this manner, in a case where there are many errors in the transmission wave of the 4K broadcasting program in a situation where the 4K broadcasting program can be received, for example, it becomes possible to control the broadcast receiving apparatus 100 so that the 2K broadcasting program can be selected forcibly by pressing the “terrestrial digital key”. Also, in a case where the simultaneous broadcasting of a 4K broadcasting program and a 2K broadcasting program by different layers is performed and there are many errors in the transmission wave of the 4K broadcasting program in a situation where the 4K broadcasting program can be received, the 2K broadcasting program (simultaneous broadcasting of the 4K broadcasting program being selected) may be selected even in a state where the “advanced terrestrial digital key” is pressed.

### <Screen Display Example at Time of Channel Selection>

As described above, the broadcast receiving apparatus 100 according to the embodiment of the present invention has a function to display information on selected channel by a banner display or the like when channel selection by the one-touch channel selection, the channel up/down selection, or the direct channel selection is executed.

FIG. 12B illustrates one example of the banner display at the time of channel selection. A banner display 192A1 is an example of a banner display that is displayed when a 2K broadcasting program is selected. For example, a program name, a start time and an end time of a program, a network type, a number of a direct channel selection key of a remote controller, a service logo, and a triple-digit number may be displayed. Further, a banner display 192A2 is an example of a banner display that is displayed when a 4K broadcasting program is selected. For example, in addition to similar information as those of the banner display 192A1 described above, a mark symbolizing “advanced”, which indicates that a program being receives is a 4K broadcasting program, is further displayed. Further, in a case where a resolution converting process or a downmixing process is executed, a display indicating that effect may be executed. In the example of the banner display 192A2, as one example, it is displayed that the down-converting process from UHD resolution to HD resolution and the downmixing process from 22.2 ch to 5.1 ch have been executed.

In the broadcast receiving apparatus 100, by executing these displays, in a case where the same content is broadcast as broadcasting programs with different quality such as a 2K broadcasting program or a 4K broadcasting program at the same time by the simultaneous broadcasting or the like, the user can suitably grasp which broadcasting program is displayed.

According to the system of the advanced digital broadcasting service, which includes a part or all of the functions of each function according to the embodiment of the present invention described above, it becomes possible to provide a transmission technique and a reception technique for an advanced digital broadcasting service with higher functionality in consideration of compatibility with an existing digital broadcasting service. Namely, it is possible to provide a technique for more suitably transmitting or receiving the advanced digital broadcasting service.

### Second Embodiment

### [Advanced Audio Signal]

The present embodiment relates to handling of an advanced audio signal. The audio signal of the current system is a channel-based signal corresponding to a speaker. The channel-based signal includes a 5.1 ch signal and a 22.2 ch signal (here, “ch” is an abbreviation of “channel”). On the other hand, in the present embodiment, in addition to the channel-based signal, an audio signal including an object-based signal and a Higher Order Ambisonics (HOA) method signal is handled.

The object-based signal is an audio signal whose reproduction position can be changed on the receiver side, for example, to the right side or the left side, such as the voice of a narrator. The reproduction position may be changed dynamically without being fixed.

The HOA method signal is a signal obtained by expanding a sound field as a sum of spherical harmonics. Since the transmission capacity has an upper limit, expansion up to a finite degree is used. Since the channel-based signal is basically recorded with a microphone position corresponding to a standard speaker arrangement, the channel-based signal is suitable for audio reproduction with a speaker group having a standard or a nearly standard arrangement. On the other hand, the HOA method, which records spatial sound field information independently of a specific speaker arrangement, is suitable in the case of handling an arbitrary speaker arrangement.

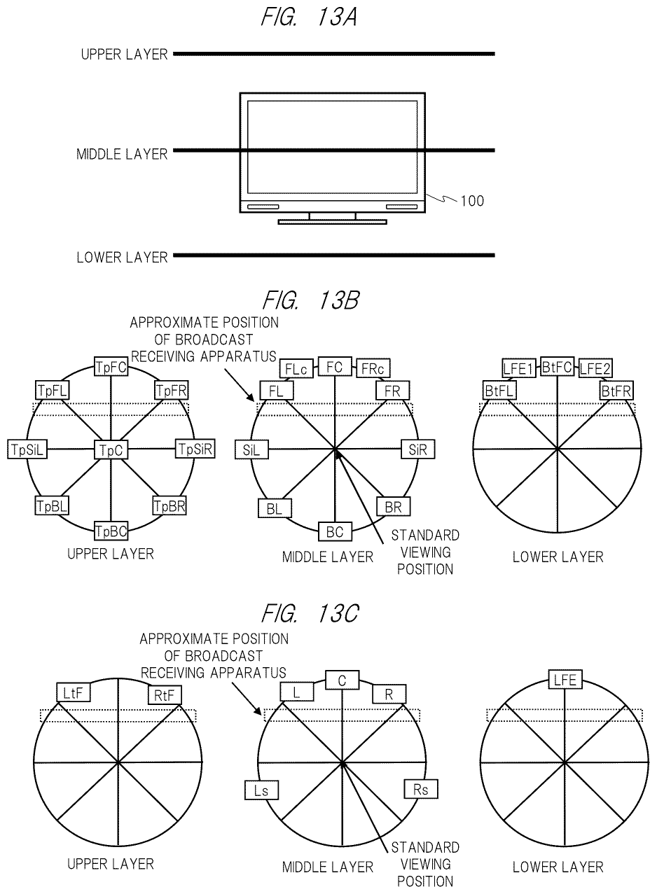

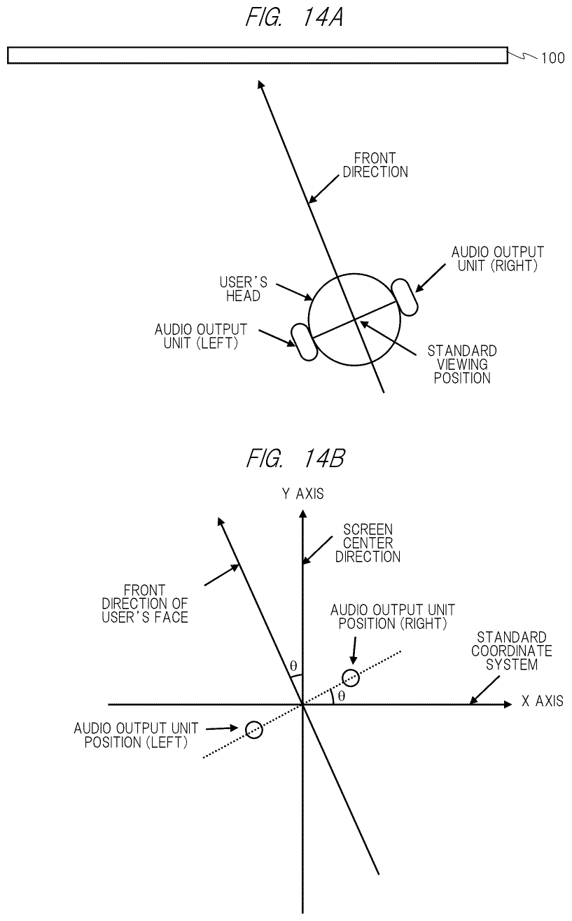

Examples of the standard speaker arrangement are illustrated in FIGS. 13A, 13B and 13C. As illustrated in FIG. 13A, the speaker group is divided into three groups of an upper layer, a middle layer, and a lower layer according to the height of the installation position. The arrangement of each group is as illustrated in FIGS. 13B and 13C. FIG. 13B illustrates an arrangement of a 22.2 ch speaker system, and FIG. 13C illustrates an arrangement of a 7.1 ch speaker system. The number after the decimal point in the ch number indication represents the number of channels of a low-frequency signal, and the corresponding speakers are LFE1, LFE2, and LFE. The channels of the other signals are referred to as main channels. A 5.1 ch speaker system is obtained by removing the speakers in the upper layer from the 7.1 ch speaker system.

In the current system, audio is reproduced as is in the case of a speaker system having the same number of speakers as the number of channels of the channel-based audio signal, and in a case where the number of channels of the channel-based audio signal is different from the number of speakers of the speaker system, format conversion is performed for reproduction in accordance with the number of speakers of the speaker system. In particular, in a case where the number of speakers is smaller than the number of channels of the audio signal, the format conversion is referred to as downmixing. The format conversion is also performed in a case where the position of the speaker system assumed when creating the audio signal is different from the position of the actual speaker system. The sound to be output from the actual speaker position is synthesized by weighting and adding the audio signals of the respective channels. In the arrangement of the standard speaker system, since each speaker is arranged at an equal distance from the standard viewing position of the assumed viewer, it is not necessary to adjust the reproduction time. However, in a case where the actual speaker is not arranged at an equal distance from the position of the viewer, the reproduction time may also be adjusted. The format conversion is as in the following Formula 1.

$$\begin{matrix}[ Formula 1 ] & \\ {p}_{m}^{( ch )} ( t ) = {\sum }_{n = 1}^{{N}^{( ch )}} {g}_{mn}^{( ch )} {s}_{n}^{( ch )} ( t + Δ {t}_{m} ) & ( For mula 1 )\end{matrix}$$

Here, s^{(ch)}ₙ(t) is a channel-based audio signal transmitted by broadcasting and communication, n is a signal number, and the number of signals of the channel-based signal is N^{(ch)}. t is a time. p^{(ch)}ₘ(t) is an audio signal input to the speaker, m is a speaker number, and the number of speakers is M. g^{(ch)}ₘₙ is a weighting coefficient for the channel-based signal. Δtₘ is a time for adjusting a delay time corresponding to a deviation from a distance Rₒ between a speaker farthest from the reference viewing position and the standard viewing position. When a distance between the position of the m-th speaker and the standard viewing position is Rₘ and the sound speed is c, Δtₘ is given by the following Formula 2.

[Formula 2]

Δtₘ=(Rₘ−R₀)/c (Formula 2)

Note that the weighting coefficient g^{(ch)}ₘₙ when each speaker is not at an equal distance may be corrected so that the weighting coefficient g^{(ch)}ₘₙ when the speakers are at an equal distance is (Rₘ/Rₒ) times to obtain the sound volume balance between the speakers.

Next, in the case of the advanced audio signal, the object-based signal and the HOA method signal are included, and each of the signals is converted into a signal to be input to the speaker by weighting and adding the transmitted signals, as in the format conversion formula of the channel-based signal, as illustrated in Formulas 3 and 4.

$$\begin{matrix}[ Formula 3 ] & \\ {p}_{m}^{( obj )} ( t ) = {\sum }_{n = 1}^{{N}^{( obj )}} {g}_{mn}^{( obj )} {s}_{n}^{( obj )} ( t + Δ {t}_{m} ) & ( Formula 3 )\end{matrix}$$

$$\begin{matrix}[ Formula 4 ] & \\ {p}_{m}^{( HOA )} ( t ) = {\sum }_{n = 1}^{{N}^{( HOA )}} {g}_{mn}^{( HOA )} {s}_{n}^{( HOA )} ( t + Δ {t}_{m} ) & ( Formula 4 )\end{matrix}$$

Here, the meaning of the symbols is the same as that of the channel-based signal, and the superscript (ch) indicates that the symbol is for the channel-based signal, (obj) indicates that the symbol is for the object-based signal, and (HOA) indicates that the symbol is for the HOA method signal. In a system that handles advanced audio signals, the audio signal pₘ (t) to be input to the speaker system, which includes the signals above, is given by the following Formula 5.

$$\begin{matrix}[ Formula 5 ] & \\ {p}_{m} ( it = {p}_{m}^{( ch )} ( t ) + {p}_{m}^{( obj )} ( t ) + {p}_{m}^{( HOA )} ( t ) & ( Formula 5 )\end{matrix}$$

Here, the weighting coefficient g^{(*)}ₘₙ is determined by the relationship between the speaker arrangement and the standard viewing position, but the weighting coefficient g^{(obj)}ₘₙ related to the object-based signal is determined in consideration of the reproduction position of the individual object. Note that content common to all the signals is expressed using a superscript (*) of a symbol.

Also, in the case where audio is listened to with the headphone, the above format conversion is performed with M=2. However, in the case of the headphone, since the position of the audio output unit with respect to the receiver screen changes depending on the orientation of the viewer's face, the weighting coefficient g^{(*)}ₘₙ is determined in consideration of the factor. FIG. 14A illustrates a positional relationship with the broadcast receiving apparatus 100 when the headphone is used. The middle point of the line segment connecting the left and right audio output units of the headphone is the viewing position in this case. Note that Δtₘ=0 because the audio output unit is made bilaterally symmetrical in the case of a typical headphone.

The sound field generated by the audio signal is based on a reference coordinate system with the center direction of the receiver screen as a reference direction. On the other hand, the audio output unit of the headphone changes its position within the reference coordinate system when the user's head rotates (FIG. 14B). Therefore, the weighting coefficient g^{(*)}ₘₙ for synthesizing the input signals to the audio output unit of the headphone is calculated in consideration of the position of the audio output unit of the headphone in the reference coordinate system at that time. The position of the audio output unit of the headphone can be obtained, for example, by recording a position where the user faces the center of the receiver screen from a user input, and then detecting a change in the orientation of the user's face with a gyro sensor or the like mounted on the headphone. Note that, although the planar arrangement is illustrated in FIG. 14B, the position in the height direction may be considered.

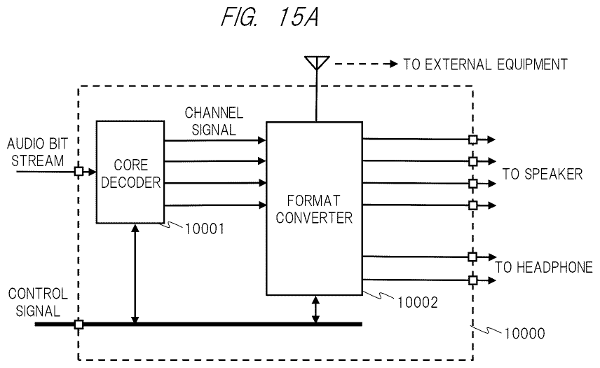

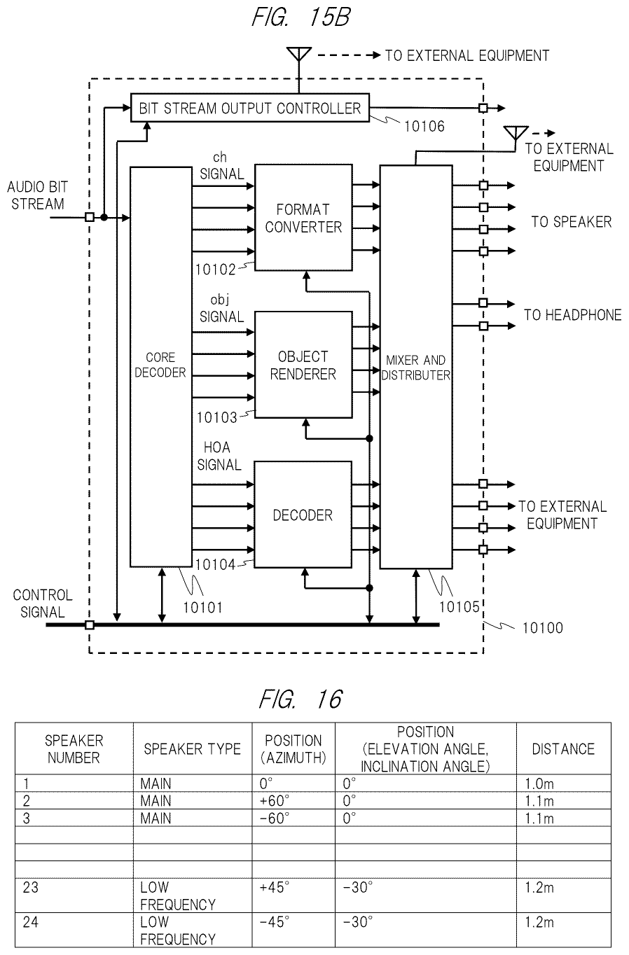

Next, a configuration example of the audio decoder will be described. The audio decoder is incorporated in the audio decoders 146S and 146U of FIGS. 2F and 2G in the overall configuration. FIG. 15A illustrates a configuration example of an audio decoder 10000 in a case where the audio signal to be transmitted is only the channel-based signal. First, an audio bit stream multiplexed and transmitted by broadcasting or communication is decoded into a signal for each channel by a core decoder 10001. Next, the above-described format conversion is performed by a format converter 10002, and the audio signal for the speaker and the audio signal for the headphone are output. Output to the external equipment may be performed wirelessly.

FIG. 15B is a configuration example of an audio decoder 10100 for the advanced audio signal. In the case of the advanced audio signal, first, an audio bit stream multiplexed and transmitted by broadcasting or communication is decoded into each signal by the core decoder 10101. Here, each signal is the channel-based signal, the object-based signal, and the HOA method signal. Also, in the case of the advanced audio signal, the output to the external equipment may be performed wirelessly.

### [Processing of Channel-Based Signal]

First, processing of the channel-based signal will be described. Similarly to the current audio signal, the channel-based signal is converted into a signal for each speaker by a format converter 10102 using Formula 1 according to the speaker arrangement. At the same time, the channel-based signal is also converted into a signal for the headphone. For speaker arrangement information, arrangement information stored in the receiver is used.

FIG. 16 illustrates an example of the speaker arrangement information. The arrangement information includes a speaker type (for the main channel or the low frequency channel), an azimuth position, a position in the height direction (elevation angle, inclination angle), and a distance from the viewer's head position in correspondence with a number for distinguishing the speakers. Here, the azimuth position is an angular position when a positive value turns in the left direction and an angular position when a negative value turns in the right direction, with the front direction as viewed from the viewing position as 0°. In addition, the position in the height direction includes a positive value representing the elevation angle, and a negative value representing the inclination angle, with the horizontal direction defined as 0° as viewed from the position of the viewer's head. The above-described weighting coefficient g^{(ch)}ₘₙ is set based on the information and the configuration of the channel-based signal. In addition, the delay time adjustment of Δtₘ is performed based on distance information, but in a case where there is no distance information, the delay time adjustment is not performed. Note that the speaker arrangement information herein is indicated in polar coordinates, but may be indicated in orthogonal coordinates.

For the speaker arrangement information, standard arrangement information of the 5.1 ch speaker system or the like may be used, or speaker arrangement information specific to the receiver may be used. In addition, the speaker arrangement information may be arrangement information of the speaker system customized by the receiver user. At that time, the user-customized arrangement information is registered before program viewing so that the user can set which arrangement information is to be used. In addition, the speaker system provided in the receiver and the speaker system customized by the user may be used by switching between them. Furthermore, the setting for a speaker system to be used for each program may be reserved. Alternatively, a speaker system to be used for each program type, each time zone, and each viewer may be set. This enables audio reproduction corresponding to a program content and a viewing environment at that time, thus improving convenience for the user.

Here, an example of weighting coefficients in a case where a 22.2 ch channel-based signal, which is a standard signal configuration, is output to a 5.1 ch speaker system, which is a standard speaker arrangement, will be described below. The format conversion formula is as follows:

C′=FC+g1*FLc+g1*FRc+g3*(TpFC+g4*TpC+BtFC) (Formula 6)

L′=FL+g1*FLc+g2*SiL+g3*(TpFL+g2*TpSiL+BtFL) (Formula 7)

R′=FR+g1*FRc+g2*SiR+g3*(TpFR+g2*TpSiR+BtFR) (Formula 8)

Ls′=BL+g5*BC+g2*SiL+g3*(TpBL+g5*TpBC+g2*TpSiL+g4*TpC) (Formula 9)

Rs′=BR+g5*BC+g2*SiR+g3*(TpBR+g5*TpBC+g2*TpSiR+g4*TpC) (Formula 10)

LFE′=g6*(LFE1+LFE2) (Formula 11)

The g1, g2, g3, g4, g5, and g6 above are the weighting coefficients (downmix coefficients), and the default values are illustrated in FIG. 17A. The downmix coefficient is transmitted as metadata of the audio signal, and the default value is used until the metadata is received. The conversion formula and the default value of the weighting coefficient are the same as those used in the system that handles an audio signal including only the channel-based signal. By making the processing common among the systems, it is also possible to share the signal processor, and in the case of a shared receiver, it leads to a reduction in the scale of the entire system.

In a case where an audio signal having a larger number of channels than 5.1 ch is converted into a signal to be output to a 2 ch speaker system, the signal is once downmixed into a 5.1 ch signal, and then downmixed into a 2 ch signal. An example of the conversion formula for downmixing from 5.1 ch to 2 ch will be described below.

Lt′=L+g7*C+g8*Ls (Formula 12)

Rt′=R+g7*C+g8*Rs (Formula 13)

The g7 and g8 above are the weighting coefficients (downmix coefficients), and the default values are illustrated in FIG. 17B. The downmix coefficient is transmitted as metadata of the audio signal, and the default value is used until the metadata is received. The conversion formula and the default value of the weighting coefficient are the same as those used in the system that handles an audio signal including only the channel-based signal. By making the processing common among the systems, it is also possible to share the signal processor, and in the case of a shared receiver, it leads to a reduction in the scale of the entire system.

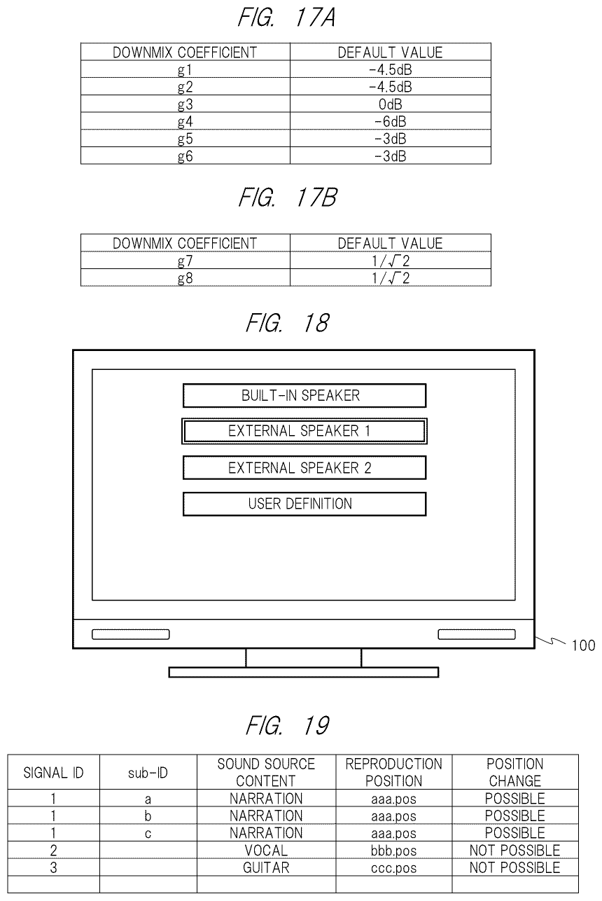

Next, a method of setting a speaker system to be used at the time of viewing will be described. Examples of the speaker system to be used include a built-in speaker incorporated in a receiver, a wired external speaker, a wireless external speaker, and the like. The speaker to be used may be selected with a remote controller operation (for example, selection using an arrow button), or may be selected by a cooperation terminal such as a smartphone. FIG. 18 illustrates an example of a speaker setting selection menu. FIG. 18 illustrates a state where the “external speaker 1” system has been selected. The connection to the external speaker system may be a mixture of wired connection and wireless connection. In addition, user definition refers to a speaker system that combines the speakers of each system. For example, the system combines the built-in speaker with an external speaker for extension. By preparing the selection menu, it is possible to easily select an optimum speaker system according to the viewer's preference and the viewing environment at that time, thus improving convenience of the viewer.

When the above speaker system is used, the arrangement information of FIG. 16 is required. The arrangement information may be input by the viewer, or may be downloaded from a website of a receiver manufacturer or a speaker manufacturer. The downloading of the arrangement information may be performed by the receiver in response to an input of identification information such as a speaker system model number. Alternatively, the arrangement information recorded in the speaker body may be transmitted to the receiver. Furthermore, t the arrangement information may be created and corrected by measuring the actual arrangement state of the speaker through a cooperation operation between the receiver and the speaker. For the measurement of the arrangement state, for example, a camera or a distance measuring device such as an ultra wideband (UWB) included in the receiver, the speaker, or both may be used. In a case where the arrangement information is changed by the measurement or user input, the superimposition coefficient may be changed even during viewing, or the superimposition coefficient may be changed after waiting for a break in the program, a break in the audio output, or a channel change. By appropriately setting and processing the arrangement information of the speaker system, the state of audio reproduction is improved.

Furthermore, when the external speaker system is used, the weighting coefficient used for the format conversion may be given from the outside. The weighting coefficient may be input by the user himself/herself, may be input from the speaker system to the receiver through communication, or may be acquired by the receiver from the server.

In the case of the external speaker system, an audio conversion function may be provided on the speaker system side. In this case, the receiver may adjust the signal to be output to the speaker system in response to a request from the speaker system side. The adjustment of the signal to be output is, for example, adjustment of the number of channels of the channel-based signal, the number of signals of the object-based signal, the number of signals of the HOA method signal, the range of metadata necessary for reproduction thereof, and the like. When there is a limitation on the signal that can be output depending on the program (for example, the number of channels), the output signal may be adjusted for each program. In addition, in a case where the external speaker system also includes an audio bit stream decoder, the audio bit stream may be output to the externally connected speaker system through a bit stream output controller 10106 illustrated in FIG. 15B. By appropriately adjusting the output signal, the operation of the audio output is guaranteed.

### [Processing of Object-Based Signal]

Next, processing of the object-based signal will be described. The object-based signal is a signal of each sound source, and is separated from a bit stream signal into the signal of each sound source by the core decoder 10101. Subsequently, an output signal for each speaker is calculated by an object renderer 10103 based on the accompanying reproduction position information. At that time, the arrangement information of the actual speaker system is also considered. When the output signal for each speaker is calculated, the output signal may be directly calculated, or the output signal to a 22.2 ch standard speaker system may be once calculated, and then the output signal to the actual speaker system may be calculated in accordance with the format conversion of the channel-based signal. This can make a part of processing common.

In addition, when the external speaker is used, the weighting coefficient for calculating the output signal to the speaker may be given from the outside. The weighting coefficient may be set by the user, may be acquired through communication with the speaker system, or may be acquired from the server. At this time, since the weighting coefficient also varies depending on the sound source position, the weighting coefficient is given in a tabular form or a functional form. Alternatively, only the conversion coefficient for converting the signal for 22.2 ch into the signal for the external speaker may be given on the assumption that the processing up to conversion to the signal for 22.2 ch considering the sound source position is performed inside the receiver.

The object-based signal is divided into one in which the viewer can specify the reproduction position of the sound source and one in which the viewer cannot specify the reproduction position of the sound source. The possibility to specify the position and to change the specified position is transmitted as metadata for each sound source, and the receiver changes the processing depending on the designation of the possibility. A parameter that describes information on whether or not to permit the user to set the reproduction position for each object-based signal is transmitted to the receiver. FIG. 19 illustrates an example of the metadata. FIG. 19 illustrates a case where there are three types of sound sources of narration, vocal, and guitar as the sound sources.

In this example, the position of the narration voice can be changed, and a replacement sound source is also prepared. The replacement sound source is distinguished by a sub-ID. For example, “a” of the sub-ID represents Japanese, “b” represents English, and “c” represents French. The default is set as Japanese, and is replaced with another language in response to the user's instruction. The user's instruction may be given for each program, or the setting for replacing with a specific language at any time may be performed. The replacement signal may be transmitted using a general-purpose user region.

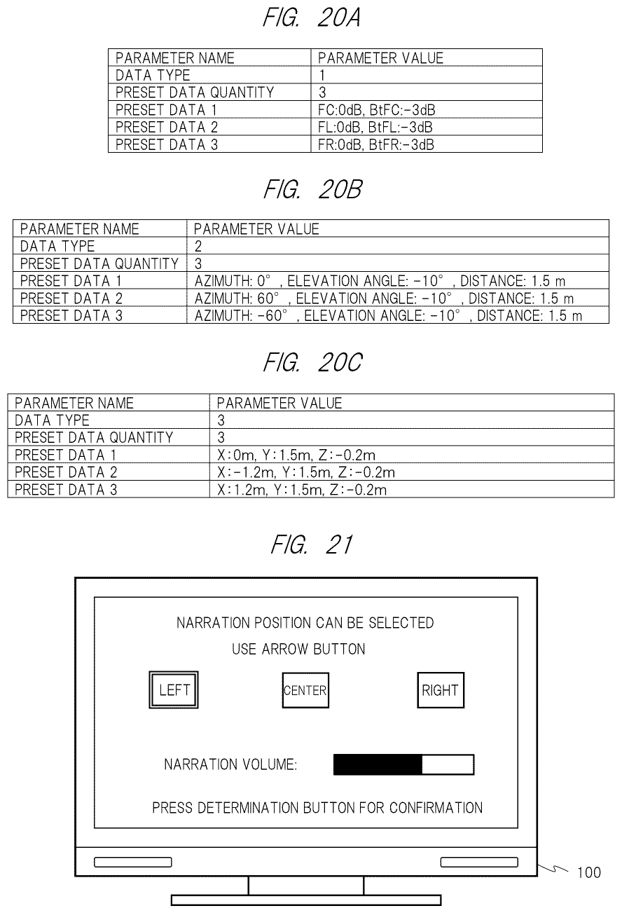

The default reproduction position of the narration voice may be set at an output level for each speaker of the standard speaker system, for example, the 22.2 ch system, or may be set as a direction viewed from a standard viewer position. FIGS. 20A, 20B, and 20C illustrate data examples of the reproduction position. First, a data type indicating a format expressing the reproduction position is set. Examples of the format expressing the reproduction position include the indication of the output level of the speaker (FIG. 20A), the indication of polar coordinates with a standard viewing position as the origin (FIG. 20B), the indication of orthogonal coordinates with the standard viewing position as the origin (FIG. 20C), and the like. Although FIG. 20A illustrates the output levels of the two speakers, the output levels of three or more speakers may be set. The indication of polar coordinates in FIG. 20B is a combination of an azimuth angle and an elevation angle viewed from the origin and a distance from the origin, and the azimuth angle is such that a direction toward the center of the screen as viewed from the origin is a 0° azimuth, and an azimuth turning to the left is a positive angle. In addition, the elevation angle means an angle in the vertical direction as viewed from the origin, and a positive angle is the elevation angle while a negative angle is the inclination angle. The indication of orthogonal coordinates in FIG. 20C is such that a rightward direction parallel to the screen is a positive direction of the X axis, a direction perpendicular to the screen from the origin toward the screen is a positive direction of the Y axis, and a vertically upward direction is a positive direction of the Z axis. Next, the number of preset data is set, and the preset data is set. Regarding the preset data, preset data 1 represents the default reproduction position, and is changed to other preset data according to the user's instruction. Alternatively, the configuration may be such that the reproduction position defined by the user may be used according to the user's instruction.

As a setting example of the reproduction position of the object-based signal, FIG. 21 illustrates an example of selection of the narration voice reproduction position by the user. On the setting screen, for example, the preset position is indicated by the button and is selected by the arrow key of the remote controller. The example of FIG. 21 illustrates a state where the left position has been selected. Note that the reproduction position of the narration voice may be selected in the perspective direction. In addition, a narration voice corresponding to the button selection state may be reproduced. Furthermore, the sound volume of the narration may be set independently. For example, the sound volume is set by a volume change button of the remote controller on a narration volume setting screen.

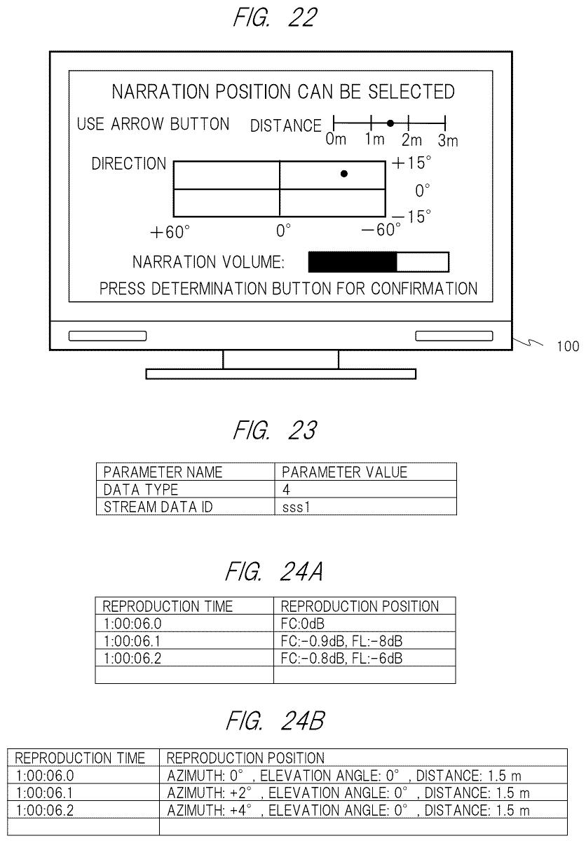

FIG. 22 illustrates an example of setting of the narration position by the user. This example is an example of a case where the reproduction position is freely set within a predetermined range instead of selection from the preset position. The black circle in the figure represents the set position, and the user adjusts the position with the arrow button of the remote controller. The narration sound volume setting is the same as that in FIG. 21. The range that can be set by the user may be set for each sound source type, and the indication of the setting scale may be limited to the range that can be set by the user. In addition, in a case where there is a possibility that the sound volume becomes large depending on the reproduction position, the range of the sound volume setting may also be limited. By allowing the user to change the reproduction position and the sound volume of the object-based signal as described above, it is possible to achieve audio reproduction more suitable for the user.

Next, a sound source that is desirably reproduced at a reproduction position corresponding to an image, such as vocal and guitar, will be described. The reproduction positions of these sound sources are prohibited from being changed by the user, and the flag is set as such. The reproduction positions of these sound sources are transmitted as stream data in which the audio positions at each reproduction time have been recorded. In a case where the reproduction position is provided as stream data in this manner, the information on the reproduction position in FIG. 19 is information indicating the stream data (FIG. 23). The data type in FIG. 23 represents the expression format of the reproduction position, and “4”, “5”, and “6” represent that the reproduction position is provided as stream data. Furthermore, “4” represents the use of the speaker output level to specify the reproduction position, “5” represents the polar coordinate indication, and “6” represents the orthogonal coordinate indication. FIG. 24A illustrates an example of stream data that specifies the reproduction position as the output level of the speaker, FIG. 24B illustrates an example of stream data that specifies the reproduction position as the polar coordinate indication, and FIG. 24C illustrates an example of stream data that specifies the reproduction position as the orthogonal coordinate indication. The reproduction time on the stream data may be arbitrarily set, or may be synchronized with the frame of the program image. In addition, sound volume adjustment for each sound source may be performed separately from the entire sound volume adjustment. By specifying the reproduction position and the sound volume for each sound source in this manner, it is possible to perform audio reproduction that is excellent in sound image localization and suitable for the user's preference.

### [Processing of HOA Method Signal]

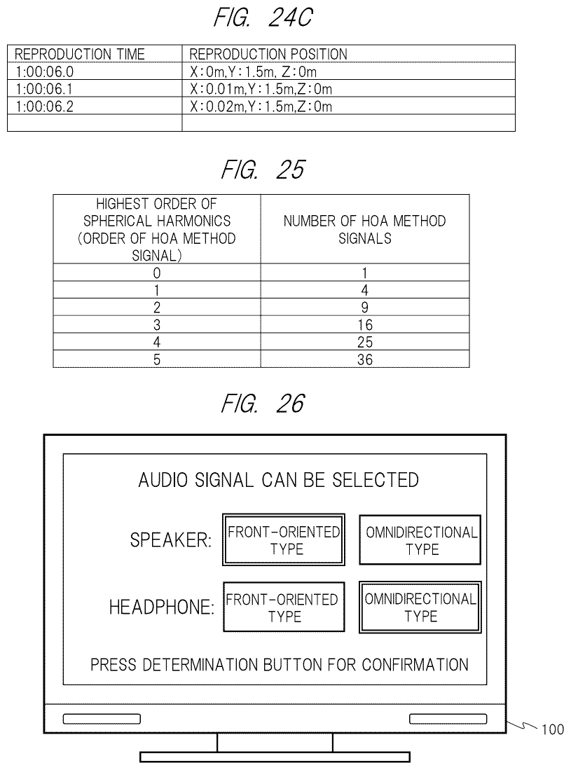

Next, processing of the HOA method signal will be described. The HOA method signal is a signal obtained by expanding a sound field using spherical harmonics of the 0th to a certain order. The order of the spherical harmonics is a non-negative integer, and there are 2n+1 nth-order spherical harmonics. Therefore, the number of HOA method signals obtained from expansion with the spherical harmonics of up to the n-th order is (n+1)². The highest order of the spherical harmonics used for the expansion and the number of HOA method signals are listed in FIG. 25. Here, the highest order of the spherical harmonics used for the expansion is referred to as the order of the HOA method signal. As can be seen from the figure, the number of HOA method signals increases rapidly as the order increases. Since the number of signals of the channel-based signal corresponding to the 22.2 ch speaker system is 24, the fourth-order HOA method signal including 25 signals has almost a comparable amount of information.

The HOA method signal is first separated into signals of a form expanded with the spherical harmonics by the core decoder 10101, and then converted into signals to be output to the speaker using a decoder 10104 dedicated to the HOA method based on the arrangement information of the speaker. In this conversion, the output signal to the speaker system to be used may be directly generated, or the conversion may be performed in accordance with the conversion of the channel-based signal after the first conversion into the 22.2 ch signal. This can make a part of processing common.

In addition, when the external speaker is used, the weighting coefficient for calculating the output signal to the speaker may be given from the outside. The weighting coefficient may be set by the user, may be acquired through communication with the speaker system, or may be acquired from the server.

Incidentally, a difference between the HOA method signal and the channel-based signal is a difference in the density of information in the viewing space. The HOA method signal has an isotropic and uniform information density, whereas the channel-based signal has a high information density in the front direction in which more speakers are arranged. In the normal viewing environment, there is no problem with audio reproduction of the channel-based signal, but in the case of a speaker system whose arrangement is greatly different from the standard arrangement or a headphone that can cause the direction in space to greatly change, using the HOA method signal allows the user to enjoy more suitable reproduced audio. In particular, in a program viewed on a head-mounted display, it is desirable that the audio information amount is isotropic because video in a 360° space is viewed, and it is thus desirable to use the HOA method signal.

It is desirable that either the HOA method signal or the channel-based signal can be selected according to the viewing system or user's preference. FIG. 26 illustrates an audio signal selection screen for each output device. In the example of FIG. 26, the channel-based signal is expressed as “front-oriented type”, and the HOA method signal is expressed as “omnidirectional type”. The example of FIG. 26 indicates the state where the channel-based signal has been selected for the signal of audio output from the speaker and the HOA method signal has been selected for the signal of audio output from the headphone. This setting may be performed for each program, or a common setting may be used regardless of the program. In addition, default setting may be performed such that the channel-based signal is used for the speaker and the HOA method signal is used for the headphone. In addition, in a program where the signal set for the output device is not provided, processing of using another signal may be performed.

Although the more precise sound field reproduction is possible as the order of the HOA method signal becomes higher, since the transmission capacity by broadcasting is limited, the method in which low-order signals are transmitted by broadcasting and high-order signals are transmitted via the Internet in the expanded form of the spherical harmonics is also possible. In an example of such a method, the 0th to 4th order signals are transmitted by broadcasting, and the 5th or higher order signals are transmitted via the Internet. Even if the signals via the Internet are interrupted due to some circumstances, all of the audio does not disappear, and thus it does not cause a major obstacle. In addition, the signals via the Internet may be collectively downloaded to the receiver before broadcasting starts. This can eliminate the influence of an Internet failure during viewing.

Alternatively, the method in which the HOA method signal is transmitted only via the Internet and is not transmitted by broadcasting is also possible. Even in a case where the HOA method signal is interrupted due to an Internet failure, it is possible to prevent all of the audio from disappearing by using the channel-based signal instead. Also, in this case, the signals via the Internet may be collectively downloaded to the receiver before broadcast starts. This can eliminate the influence of an Internet failure during viewing.

The method that transmits a part of the audio signal via the Internet may be used for the channel-based signal and the object-based signal. For example, in the case of the channel-based signal, a 24-channel signal corresponding to 22.2 ch may be transmitted by broadcasting, additional channel signal may be transmitted via the Internet. This enables the information density to be more isotropic and can make the signal a substitute for the HOA method signal. In addition, in the case of the object-based signal, some of the signals for the plurality of sound sources may be transmitted via the Internet. The various signal transmission patterns have been described above, and it is thus possible to respond to various viewing environments and user's preferences and to realize suitable audio reproduction.

### [Accompanying Output to Cooperation Device]

The above-described audio output is based on the assumption that the audio output is performed to the system to be used as a main system, whether it is an internal speaker system or an external speaker system. However, for example, in a case where a plurality of users use the system, some users may desire to listen to secondary audio that is different from audio the others listen to. To respond to such a desire, audio reproduction may be performed by another output device in addition to the main system. For example, the secondary audio is listened to with a smartphone in hand or the like serving as a cooperation device. The output device at that time may be appropriately selected from the speaker, a normal earphone, an open-air earphone, and the like.

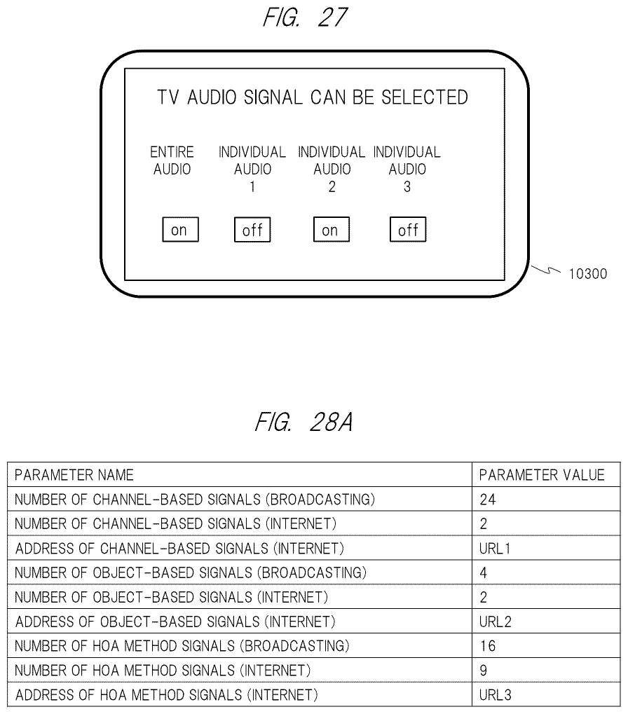

FIG. 27 illustrates an example of selecting, with a smartphone 10300 serving as the cooperation device, audio to be reproduced by the smartphone. “on” represents reproduction, and “off” represents non-reproduction. Reproduction and non-reproduction are switched according to the user's preference. Here, the entire audio is audio of the channel-based signal, and the individual audio is audio of the object-based signal. For example, in a sports program, it is also possible to select neutral commentary audio or commentary audio from a position of a fan of either team, which are transmitted by the object-based signal. The entire audio is a voice of spectators or the like, and may be reproduced by the receiver or may be reproduced by the individual cooperation device according to the user's preference. In addition, the selectable audio setting is not limited to this example, and the audio may be appropriately selected. By freely selecting audio reproduction by the reproduction device in the vicinity of the user in this manner, it is possible to perform audio reproduction more suitable for the user's preference.

### [Display Related to Audio Signal]

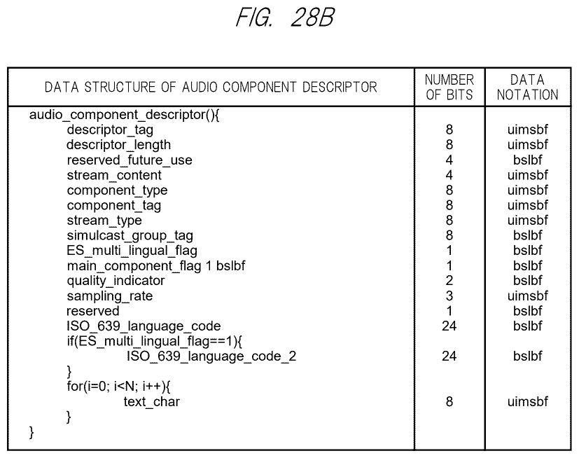

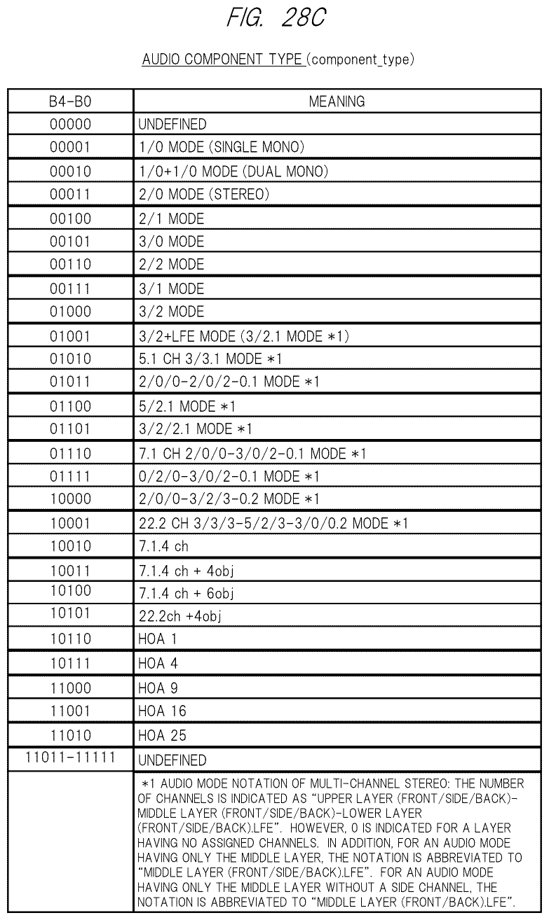

A display example related to the audio signal to be transmitted will be described. First, FIG. 28A illustrates an example of the number of signals to be transmitted and parameters related to a signal acquisition destination. For each of the channel-based signal, the object-based signal, and the HOA method signal, there are parameters that describe the number of signals and an acquisition destination address (URL) in the case of acquisition from the Internet. By combining transmission via the Internet, it is possible to complement transmission by broadcasting with a limited transmission capacity.

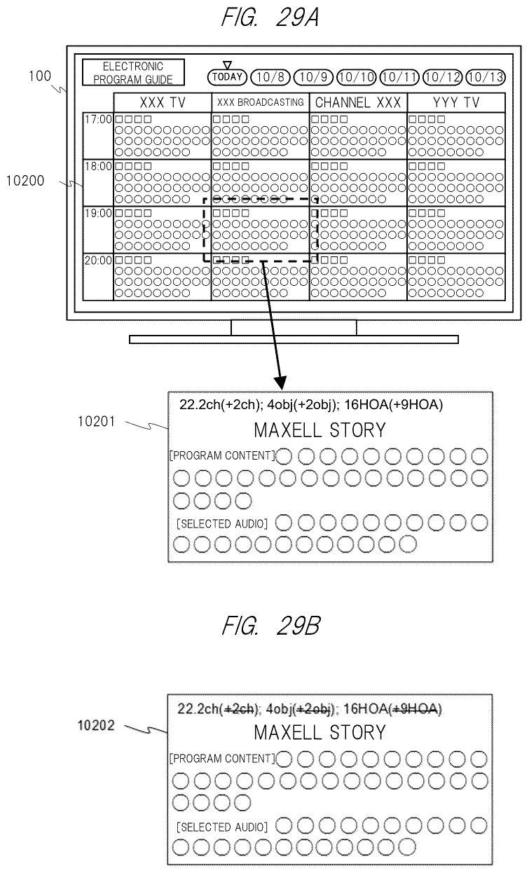

FIG. 29A illustrates an example in which the audio signal to be transmitted is displayed for each program of the electronic program guide. In FIG. 29A, the number of signals is indicated for each audio signal type. In FIG. 29A, the signal in parentheses represents a signal acquired via the Internet. In a case where information cannot be acquired from the Internet, a display is made so as to report such a state. FIG. 29B illustrates an example in which, when information cannot be acquired from the Internet, a strike-through is superimposed on the audio signal transmitted via the Internet. Alternatively, when the information cannot be acquired, the audio signal via the Internet may not be displayed. Furthermore, the electronic program guide may describe explanatory information on sound sources that can be selected by the user for reproduction. By displaying the configuration of the audio signal for each program as described above, it is possible to allow the user to know the fullness of the program audio, and use it as auxiliary information for program selection. In addition, the setting of audio reproduction to be used when viewing the program may be able to be reserved before the program starts. Furthermore, the setting content of the frequently used setting may be recorded in the receiver and the recording may be called so that the audio reproduction setting at the time of program viewing or reservation can be easily performed. This improves usability for the user.

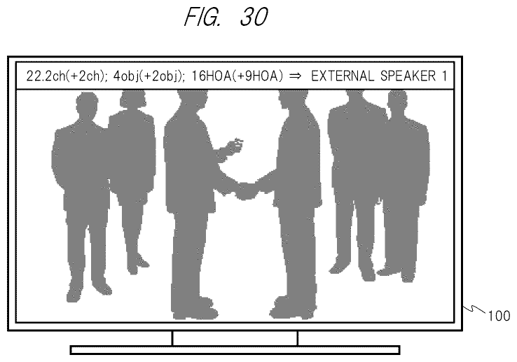

The selection of the speaker system, the source type of the signal being reproduced, and the number of signals may be displayed on the screen (FIG. 30). The display may be performed all the time, or may be displayed for a predetermined time only when the power is turned on, when the channel is changed, or when the state is changed. In addition, the display may be prohibited by the user. By indicating the current state in this manner, it is possible to allow the user to appropriately grasp the state.

[Viewing with Headphone]

In some special headphones, processing is applied to the audio signal in consideration of sound transmission characteristics of the user's head. The processing may be performed by the external equipment, or may be performed by the receiver by providing the processing function to a mixer and a distributor 10105 illustrated in FIG. 15B. At this time, a program, a parameter, and the like necessary for the processing may be acquired from the server of the headphone manufacturer. This can realize more precise audio reproduction.

### [Processing in Emergency Broadcasting]

In the case of emergency broadcasting, all the user settings related to audio reproduction are invalidated at the time when the emergency broadcasting is started, and the setting is changed to the setting for emergency broadcasting viewing so that the emergency broadcasting content can be reliably recognized by the user. After the emergency broadcasting ends, the setting is returned to the user setting before the emergency broadcasting was started. This can reliably transmit the content of the emergency broadcasting while minimizing the change to the user's preference.

### [Exceptional Processing]

Some exception processing will be described. First, when the receiver is turned on or when the channel is changed, a speaker system that is normally used may be used, or a speaker system that was used before the power was turned off or before the channel was changed may be used. Furthermore, in a case where the speaker system to be used has been set for a program received when power is turned on or when the channel is changed, the set speaker system is used. The speaker system that is normally used may be unique to the receiver or set by the user.

In a case where the external speaker system is used, if it is detected that the power of the external speaker system is turned off, such a state is displayed on the screen, and the switched speaker system such as the internal speaker is displayed. By setting the exception processing as described above, it is possible to favorably maintain the viewing state of the user.

### [Copyright Protection Processing]

Next, copyright protection processing (content protection processing) in the broadcasting system according to the present embodiment will be described.

### [Copyright Protection Function]

In the digital broadcasting system of the present embodiment, control information indicating copy control of the content such as first control information (digital_recoding_control_data) and second control information (copy_restriction_mode) is stored in control information such as program sequence information (e.g., a PMT) in MPEG-2 TS and an MPT in MMT, and transmitted from the broadcast station side to the broadcast receiving apparatus 100. The first control information (digital_recoding_control_data) is, for example, 2-bit data, and may be configured to indicate “copying is possible without restrictions” for 00, indicate “copying is possible for only one generation” for 10, and indicate “copying is prohibited” for 11. Note that, in a case where the first control information (digital_recoding_control_data) is 00 and “copying is possible without restrictions”, two types of states “copying is possible without restrictions and encryption processing is required at the time of accumulation and output” and “copying is possible without restrictions and encryption processing is not required at the time of accumulation and output” may be identified in combination with another 1-bit control information. In addition, the second control information (copy_restriction_mode) is, for example, 1-bit data, and may be configured to indicate “copying is possible for only one generation” for 0 and indicate “copying is possible in a limited number” for 1. Note that “copying is possible in a limited number” is a copy control state where copying is permitted for a predetermined number of times, and for example, when copying is possible for nine times+moving is possible once, the state is a so-called “dubbing 10”. Note that the second control information (copy_restriction_mode) functions only in a case where the first control information (digital_recoding_control_data) is 10 and indicates “copying is possible for only one generation”. That is, the second control information is the control information to identify whether the copy control of the content is “copying is possible in a limited number” or “copying is possible for only one generation” in the case where the first control information (digital_recoding_control_data) is 10 and indicates “copying is possible for only one generation”. Therefore, in a case where the first control information (digital_recoding_control_data) is 00 and indicates “copying is possible without restrictions” and in a case where the first control information (digital_recoding_control_data) is 11 and indicates “copying is prohibited”, the broadcast receiving apparatus 100 does not use the second control information to identify the copy control even when the second control information (copy_restriction_mode) indicates either 0 or 1. In other words, in the case where the first control information (digital_recoding_control_data) is 00 and indicates “copying is possible without restrictions” and in the case where the first control information (digital_recoding_control_data) is 11 and indicates “copying is second control information prohibited”, the (copy_restriction_mode) is handled as a Don't_Care state in the broadcast receiving apparatus 100. In this case, the broadcast receiving apparatus 100 of the present embodiment may be configured to control accumulation of the content in the storage (accumulator) 110, recording of the content in a removable recording medium, output to the external equipment, copy to the external equipment, move processing to the external equipment, and the like according first information to the control (digital_recoding_control_data) and the second control information (copy_restriction_mode). Note that accumulation processing is not limited to that in the storage (accumulator) 110 inside the broadcast receiving apparatus 100 and may include recording with protection processing such as encryption processing to enable reproduction only by the broadcast receiving apparatus 100. Specifically, the accumulation processing includes processing in an external recording device or the like for setting a state where recording and reproduction are enabled only by the broadcast receiving apparatus 100.

A specific example of video content processing based on the control information such as the first control information (digital_recoding_control_data) and the second control information (copy_restriction_mode) will be described below.

First, for the content indicated as “copying is possible without restrictions” by the first control information (digital_recoding_control_data) included in the PMT in MPEG-2 TS or the MPT in MMT, the broadcast receiving apparatus 100 of the present embodiment may perform, without any limitations, the accumulation in the storage (accumulator) 110, the recording in the removable recording medium, the output to the external equipment, the copy to the external equipment, and the move processing to the external equipment. However, in a case where the control information is separated into “copying is possible without restrictions and encryption processing is required at the time of accumulation and output” and “copying is possible without restrictions and encryption processing is not required at the time of accumulation and output”, the accumulation in the storage (accumulator) 110, recording in the removable recording medium, output to the external equipment, copy to the external equipment, and move processing to the external equipment can be performed without restrictions in the number of times when “copying is possible without restrictions and encryption processing is required at the time of accumulation and output”, but the encryption processing is required for all.

In addition, for the content indicated as “copying is possible for only one generation” by the combination of the first control information (digital_recoding_control_data) and the second control information (copy_restriction_mode) included in the PMT in MPEG-2 TS or the MPT in MMT, the broadcast receiving apparatus 100 of the present embodiment may perform the accumulation in the storage (accumulator) 110 with encryption, but in a case where the accumulated content is output to the external equipment for viewing, the content is encrypted and output together with copy control information of “re-copying is prohibited”. However, the so-called move processing (processing of copying the content to the external equipment and disabling the reproduction of the content in the storage (accumulator) 110 of the broadcast receiving apparatus 100 through erasing processing or the like) to the external equipment is possible.

In addition, for the content indicated as “copying is possible in a limited number” by the combination of the first control information (digital_recoding_control_data) and the second control information (copy_restriction_mode) included in the PMT in MPEG-2 TS or the MPT in MMT, the broadcast receiving apparatus 100 of the present embodiment may perform the accumulation in the storage (accumulator) 110 with encryption, but in a case where the accumulated content is output to the external equipment for viewing, the content is encrypted and output together with the copy control information of “re-copying is prohibited”. However, a predetermined number of copies and move processing to the external equipment may be possible. In the case of the so-called “dubbing 10” state, it is possible to perform copying to the external equipment nine times and move processing once.

In addition, for the content indicated as “copying is prohibited” the first control information by (digital_recoding_control_data) included in the PMT in MPEG-2 TS or the MPT in MMT, the broadcast receiving apparatus 100 of the present embodiment prohibits copying in the storage (accumulator) 110. However, in a case where the broadcast receiving apparatus 100 is configured to have a “temporary accumulation” mode that enables the content to be held in the storage (accumulator) 110 only for a predetermined time or a predetermined time specified by the control information included in the broadcast signal, the content can be temporarily held in the storage (accumulator) 110 even when the first control information (digital_recoding_control_data) included in the PMT in MPEG-2 TS or the MPT in MMT indicates “copying is prohibited”. In a case where the content indicated as “copying is prohibited” by the first control information (digital_recoding_control_data) included in the PMT in MPEG-2 TS or the MPT in MMT is output to the external equipment for viewing, the content is encrypted and output together with the copy control information of “copying is prohibited”.

Note that the above-described output to the external equipment for viewing may be performed via a video output unit 193, a digital I/F 125, a LAN communication unit 121, or the like in FIG. 2A. The above-described copying or move processing to the external equipment may be performed via the digital I/F 125, the LAN communication unit 121, or the like in FIG. 2A.

According to the processing described above, it is possible to realize appropriate content protection according to the copy control information associated with the video content.

Next, a specific example of processing of audio content based on the copy control information will be described below. As described above, the digital broadcasting system of the present embodiment can transmit and receive an audio content including the advanced audio signal. Therefore, it is desirable that the broadcast receiving apparatus 100 of the present embodiment be equipped with the function of performing more suitable copyright protection processing (content protection processing) corresponding to the audio content including the advanced audio signal.

First, FIG. 28B illustrates a data structure of an audio component descriptor (audio_component_descriptor) included in the PMT in MPEG-2 TS or the MPT in MMT in the digital broadcasting system of the present embodiment. In the audio component descriptor in FIG. 28B, data describing various types of information related to the audio component of the content transmitted in the digital broadcasting system of the present embodiment is stored. Herein, information on the type of the audio component included in the target content can be stored in the data of “component_type” (component type) illustrated in FIG. 28B. Note that, although “audio” is not indicated in the data notation of “component_type” illustrated in FIG. 28B, since “component_type” is stored in the audio component descriptor, it can be understood that the data stores information indicating the audio component type.

Next, values of the audio component type data that can be transmitted in the digital broadcasting system of the present embodiment will be described with reference to FIG. 28C.

FIG. 28C illustrates a list of types of audio signals that can be indicated by some bits in the audio component type data. For example, the same definitions as the definitions used in the conventional digital broadcasting are used for 00000 to 10001 and the like. These definitions include the definitions of relatively popular audio signals such as single mono (single monaural), stereo, 5.1 ch, 7.1 ch, and 22.2 ch. Note that LFE (Low Frequency Effect) illustrated in FIG. 28C indicates a channel enhancing a low sound.

Furthermore, in the audio component type data according to the present embodiment, definitions of 10010 to 11010 are newly added as the audio signal type that can be indicated by some bits in the audio component type data. Specifically, as illustrated in FIG. 28C, 7.1.4 ch obtained by adding 4 channels arranged at an upper side to 7.1 ch is defined as data 10010. 7.1.4 ch+4 obj including 4 object signals in 7.1.4 ch is defined as data 10011. 7.1.4 ch+6 obj including 6 object signals in 7.1.4 ch is defined as data 10100. 22.2 ch+4 obj including 4 object signals in 22.2 ch is defined as data 10101. HOA1 that is an HOA method signal having one signal is defined as data 10110. HOA4 that is an HOA method signal having four signals is defined as data 10111. HOA9 that is an HOA method signal having nine signals is defined as data 11000. HOA16 that is an HOA method signal having 16 signals is defined as data 11001. In addition, HOA25 that is an HOA method signal having 25 signals is defined as data 11010.

As described above in the present embodiment, the digital broadcasting system of the present embodiment can transmit and receive an audio content including the advanced audio signal. Here, among the audio signal types illustrated in FIG. 28C, audio signals from the single monaural signal with the audio component type data of 00001 to the 7.1.4 ch signal with the audio component type data of 10010 are channel-based signals. On the other hand, audio signals from the 7.1.4 ch+4 obj signal with the audio component type data of 10011 to the 22.2 ch+4 obj signal with the audio component type data of 10101 are object-based audio signals. The object-based signal is included in the advanced audio signal in the present embodiment. In addition, audio signals from the HOA1 signal with the audio component type data of 10110 to the HOA25 signal with the audio component type data of 11010 are HOA method audio signals. The HOA method audio signal is included in the advanced audio signal in the present embodiment.

Therefore, in the digital broadcasting system of the present embodiment, when transmitting the content, the audio component type data is stored in the audio component descriptor included in the PMT in MPEG-2 TS or the MPT in MMT, and is transmitted from the broadcasting station side to the broadcast receiving apparatus 100, whereby it is possible to identify whether or not the audio signal of the transmitted content is the advanced audio signal in the broadcast receiving apparatus 100.

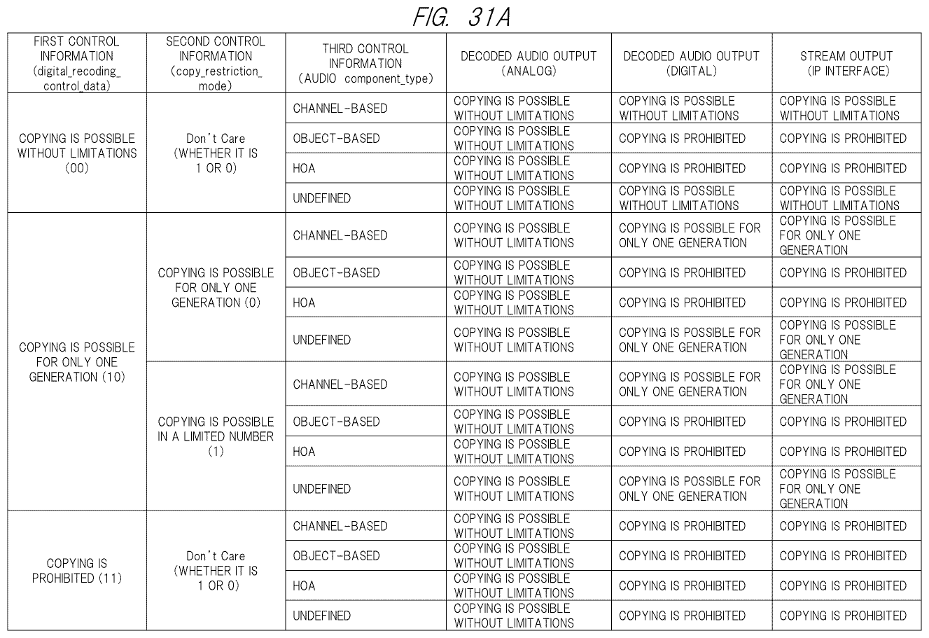

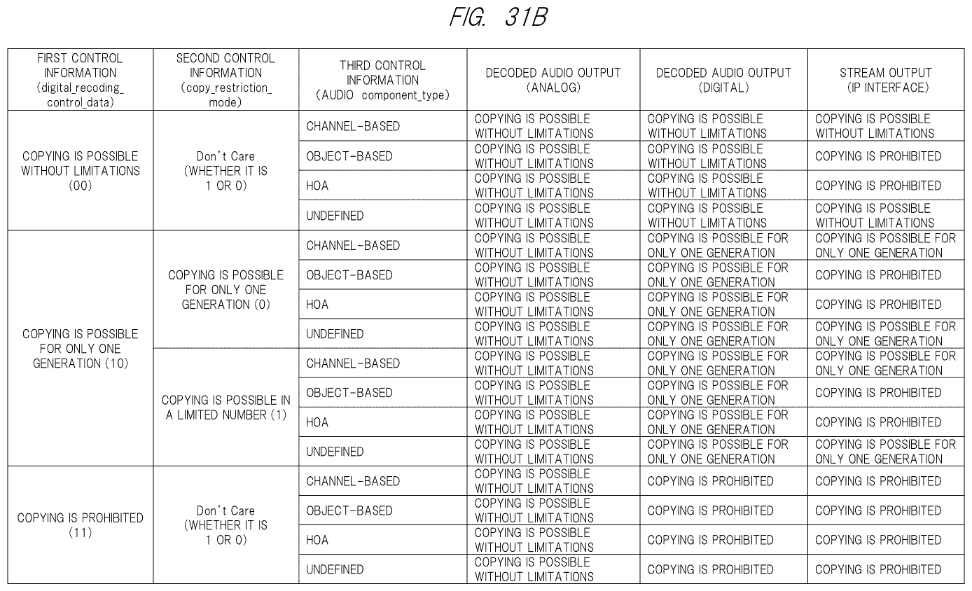

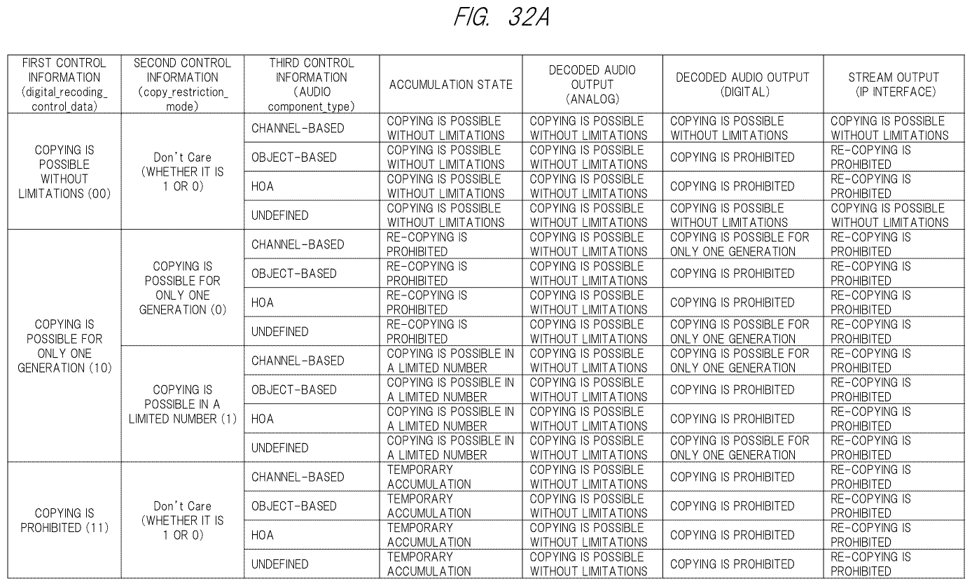

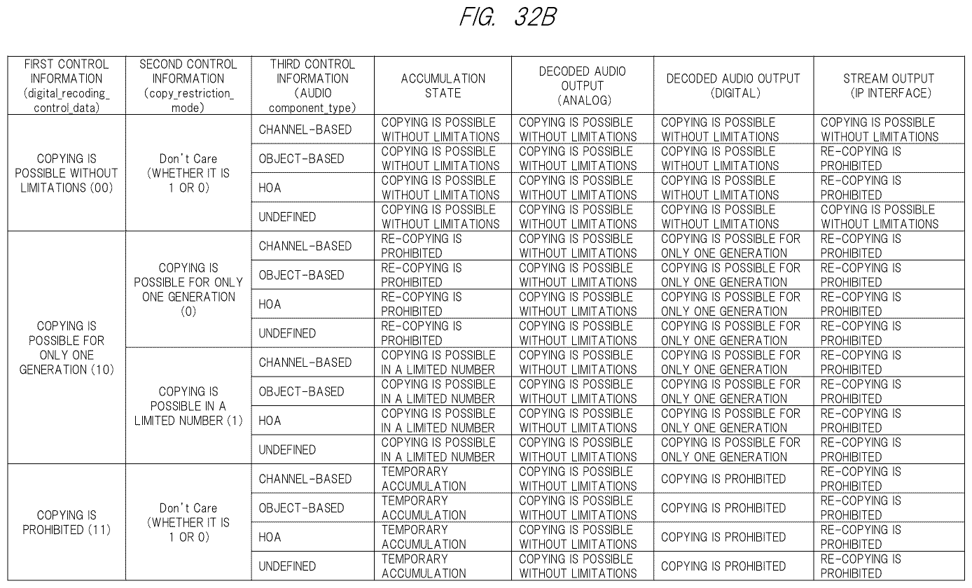

Here, a control example of the copyright protection processing (content protection processing) for the audio content in the broadcast receiving apparatus 100 will be described with reference to FIGS. 31A to 32B.

Note that the first control information (digital_recoding_control_data) and the second control information (copy_restriction_mode) illustrated in FIGS. 31A to 32B are the control information indicating the copy control of the content, and the definitions of the first control information (digital_recoding_control_data) and the second control information (copy_restriction_mode) for the content are as described above.

Note that decoded audio output (analog) illustrated in FIGS. 31A to 32B is audio signal output processing in a decoded analog signal state. This is, for example, a procedure in which an audio signal decoded by the core decoder in FIG. 15B is converted into an analog signal by a D/A converter (digital-analog converter) (not illustrated) and is output to the external equipment or the like in the analog signal state via the analog video/audio interface or the like included in the extension interface 124 in FIG. 2A.

In addition, decoded audio output (digital) illustrated in FIGS. 31A to 32B is audio signal output processing in a decoded digital signal state. This is, for example, processing in which the audio signal decoded by the core decoder in FIG. 15B is output to the external equipment or the like in the digital signal state via the audio output unit 196 in FIG. 2A. Note that the decoded audio signal may be output to the external equipment or the like in the digital signal state via the digital I/F 125, the LAN communication unit 121, or the like.

In addition, stream output (IP interface) illustrated in FIGS. 31A to 32B is audio signal output processing in the digital signal state in a stream format. This is, for example, processing of output to the external equipment in the digital signal state in the stream format via the bit stream output controller 10106 without performing decoding in the core decoder in FIG. 15B. In this case, the output from the broadcast receiving apparatus 100 to the external equipment may be output to the external equipment as the IP interface output via the LAN communication unit 121 in FIG. 2A, for example.

Here, FIG. 31A is a table illustrating a control example of copyright protection processing in a case where the audio component of the content is output as it is without being receiving apparatus 100. The information definitions of the first control accumulated in the broadcast (digital_recoding_control_data) and the second control information (copy_restriction_mode) for the content are as described above. In addition, third control information (audio component_type) is the information on the audio component type described with reference to FIG. 28C, and the broadcast receiving apparatus 100 identifies whether the audio signal type of the audio component included in the content is the channel-based signal, the object-based signal, or the HOA method signal according to the information on the audio component type. In addition, the broadcast receiving apparatus 100 also identifies that the information on the audio component type indicates a value corresponding to “undefined”.

Here, in the control example of FIG. 31A, the decoded audio in the analog signal state is controlled to be output in a state where copying is possible without restrictions, regardless of the states of the first control information, the second control information, and the third control information. This is because the analog signal, which is more likely to deteriorate due to copying than the digital signal, does not need to be restricted from being copied as strictly as the digital signal.

Here, in the control example of FIG. 31A, for the decoded audio output in the digital signal state, the audio is controlled to be output in a state where copying is prohibited, in a case where the third control information indicates the advanced audio signal, that is, in a case where the third control information indicates the object-based signal or the HOA method signal, regardless of the combination of the value of the first control information and the value of the second control information. The content of the advanced audio signal is more valuable than the content of the channel-based audio signal. Therefore, in the control example of FIG. 31A, in a case where the combination of the value of the first control information and the value of the second control information indicates “copying is possible without restrictions”, in a case where the combination indicates “copying is possible for only one generation”, in a case where the combination indicates “copying is possible in a limited number”, or the like, the copy control of the decoded audio output in the digital signal state for the content of the object-based audio signal or the HOA method audio signal is set to be stricter than that for the content of the channel-based audio signal. This makes it possible to realize copy control corresponding to the value of the content according to the audio signal type. Note that, for the decoded audio output in the digital signal state, the content for which the third control information indicates the channel-based audio signal and the content for which the third control information indicates “undefined” are controlled to be output in the state where copying is possible without restrictions, in the case where the first control information indicates “copying is possible without restrictions”, as illustrated in FIG. 31A. In addition, for the decoded audio output in the digital signal state, the content for which the third control information indicates the channel-based audio signal and the content for which the third control information indicates “undefined” are controlled to be output in the state where copying is possible again for only one generation, in the case where the first control information indicates “copying is possible for only one generation”, regardless of the value of the second control information, as illustrated in FIG. 31A. In addition, for the decoded audio output in the digital signal state, the content for which the third control information indicates the channel-based audio signal and the content for which the third control information indicates “undefined” are controlled to be output in the state where copying is prohibited, in the case where the first control information indicates “copying is prohibited”, as illustrated in FIG. 31A.

Note that the control example illustrated in FIG. 31A for the decoded audio output in the digital signal state is performed in a case where the output unit of the decoded audio output is an output unit compatible with a copy control system such as a serial copy management system (SCMS). In a case where the output unit of the decoded audio output is not compatible with the copy control, output without copying restrictions is permitted regardless of the combination of the value of the first control information, the value of the second control information, and the value of the third control information.

In addition, the setting of the copy control state in the control example for the audio signal output in the digital signal state in the stream format via the IP interface illustrated in FIG. 31A is the same as the control example for the decoded audio output in the digital signal state as illustrated in FIG. 31A, and thus repeated description is omitted. Also, in the control example for the audio signal output in the digital signal state in the stream format via the IP interface, in the case where the combination of the value of the first control information and the value of the second control information indicates “copying is possible without restrictions”, in the case where the combination indicates “copying is possible for only one generation”, in the case where the combination indicates “copying is possible in a limited number”, or the like, the copy control of the content of the object-based audio signal or the HOA method audio signal is set to be stricter than that for the content of the channel-based audio signal. This makes it possible to realize copy control corresponding to the value of the content according to the audio signal type. Note that, in the audio signal output in the digital signal state in the stream format via the IP interface illustrated in FIG. 31A, DTCP or DTCP2 is used as the copy control method. For the content for which the values of the first control information and the second control information indicate that there is a copy restriction, such as “copying is possible for only one generation”, “copying is possible in a limited number”, or “copying is prohibited”, control is performed so as to prohibit output to external equipment that is not compatible with DTCP and DTCP2. The control in this aspect is different from the control example for the decoded audio output in the digital signal state.

According to the control example of FIG. 31A of the present embodiment described above, it is possible to realize more suitable copy control corresponding to the value of the content according to the audio signal type.

Next, a control example of FIG. 31B will be described. The control example of FIG. 31B is a control example of copyright protection processing in the case where the audio component of the content is output as it is without being accumulated in the broadcast receiving apparatus 100, and is a modification of the control example of FIG. 31A. Hereinafter, in order to omit repeated description, description of the same points as those of the control example of FIG. 31A will be omitted, and only differences from the control example of FIG. 31A will be described.

In the control example of FIG. 31B, the control of the decoded audio output in the analog signal state and the control of the audio signal output in the digital signal state in the stream format via the IP interface are the same as those in the control example of FIG. 31A. On the other hand, in the control example of FIG. 31B, the control of the decoded audio output in the digital signal state is different from the control example of FIG. 31A.

Specifically, in the control of the decoded audio output in the digital signal state in the control example of FIG. 31B, the decoded audio in the digital signal state can be output in the state where copying is possible without restrictions, in the case where the combination of the value of the first control information and the value of the second control information indicates “copying is possible without restrictions”, regardless of the value the third control information indicates. In addition, in both cases where the combination of the value of the first control information and the value of the second control information indicates “copying is possible for only one generation” and indicates “copying is possible in a limited number”, the decoded audio in the digital signal state is output in a state where copying is possible for only one generation, regardless of the value the third control information indicates. In addition, in a case where the combination of the value of the first control information and the value of the second control information indicates “copying is prohibited”, the decoded audio in the digital signal state is output in a state where copying is prohibited, regardless of the value the third control information indicates. That is, in the control of the decoded audio output in the digital signal state in the control example of FIG. 31B, there is no difference in the copying limitation at the time of audio output between the copy control of the content of the channel-based audio signal and the copy control of the content of the object-based audio signal or the HOA method audio signal, which is the advanced audio signal. This is because it is considered that, even in the case of the decoded audio output in the digital signal state of the content of the object-based audio signal or the HOA method audio signal, which is the advanced audio signal, it is difficult to reproduce the state of the content of the audio signal at the time of reception by the broadcast receiving apparatus 100 in the external equipment that is the output destination, for example, if the output has undergone processing by a mixer and distributor 10105 in FIG. 15B. Therefore, based on this idea, even in the case of the decoded audio output in the digital signal state for the content of the advanced audio signal, it is considered that copy control equivalent to that of the decoded audio output in the digital signal state for the content of the channel-based audio signal suffices. On the other hand, in the audio signal output in the digital signal state in the stream format via the IP interface, since the output has not undergone processing by the mixer and the distributor 10105, the content of the advanced audio signal in the state at the time of reception by the broadcast receiving apparatus 100 can be acquired at the external equipment that is the output destination. Therefore, as illustrated in the control example of FIG. 31B, for the audio signal output in the digital signal state in the stream format via the IP interface, it is preferable to set the copy control of the content of the object-based audio signal or the HOA method audio signal to be stricter than the copy control of the content of the channel-based audio signal.

According to the control example of FIG. 31B of the present embodiment described above, it is possible to realize more suitable copy control corresponding to the value of the content according to the audio signal type.

Next, FIG. 32A is a table illustrating a control example of copyright protection processing in a case where the audio component of the content is accumulated in the broadcast receiving apparatus 100 and is then output. The accumulation processing is performed by accumulating the content including the audio component in the storage (accumulator) 110 of the broadcast receiving apparatus 100.

Here, in the control example of FIG. 32A, the copy control state of the content in the accumulation state is controlled to be different from each other depending on the combination of the value of the first control information and the value of the second control information. Specifically, in the case where the first control information indicates “copying is possible without restrictions”, the content is accumulated in the state where copying is possible without restrictions, regardless of the value of the second control information. At this time, the content may be accumulated in the state where copying is possible without restrictions regardless of the value of the third information. In addition, in a case where the first control information indicates “copying is possible for only one generation” and the second control information indicates “copying is possible for only one generation”, the content is accumulated in the state where re-copying is prohibited. At this time, the content may be accumulated in the state where re-copying is prohibited regardless of the value of the third information. In addition, in a case where the first control information indicates “copying is possible for only one generation” and the second control information indicates “copying is possible in a limited number”, the content is accumulated in the state where copying is possible in a limited number. At this time, the content may be accumulated in the state where copying is possible in a limited number regardless of the value of the third information. In addition, in the case where the first control information indicates “copying is prohibited”, the content may be able to be accumulated in the state of temporary accumulation regardless of the value the second control information. At this time, the content may be accumulated in the state of temporary accumulation regardless of the value of the third information. Next, in the control example of FIG. 32A, the copy control state of the content in the accumulation state is controlled to be different from each other depending on the combination of the value of the first control information and the value of the second control information. However, the decoded audio of the accumulated content in the analog signal state is controlled to be output in the state where copying is possible without restrictions, regardless of the copy control state in the accumulation state and regardless of the state of the third control information. This is because the analog signal, which is more likely to deteriorate due to copying than the digital signal, does not need to be restricted from being copied as strictly as the digital signal.

In addition, in the control example of FIG. 32A, for the decoded audio output of the accumulated content in the digital signal state, the audio is controlled to be output in the state where copying is prohibited, in the case where the third control information indicates the advanced audio signal, that is, in the case where the third control information indicates the object-based signal or the HOA method signal, regardless of the copy control state in the accumulation state. The content of the advanced audio signal is more valuable than the content of the channel-based audio signal. Therefore, in the control example of FIG. 32A, in a case where the copy control state in the accumulation state indicates “copying is possible without restrictions”, in a case where the copy control state indicates “re-copying is prohibited”, in a case where the copy control state indicates “copying is possible in a limited number”, or the like, the copy control of the decoded audio output of the accumulated content in the digital signal state for the content of the object-based audio signal or the HOA method audio signal is set to be stricter than that for the content of the channel-based audio signal. This makes it possible to realize copy control corresponding to the value of the content according to the audio signal type. Note that, for the decoded audio output of the accumulated content in the digital signal state, the content for which the third control information indicates the channel-based audio signal and the content for which the third control information indicates “undefined” are controlled to be output in the state where copying is possible without restrictions, in a case where the copy control state in the accumulation state is the control state where copying is possible without restrictions, as illustrated in FIG. 32A. In addition, for the decoded audio output of the accumulated content in the digital signal state, the content for which the third control information indicates the channel-based audio signal and the content for which the third control information indicates “undefined” are controlled to be output in the state where copying is possible for only one generation, in a case where the copy control state in the accumulation state is the control state where re-copying is prohibited or copying is possible in a limited number, as illustrated in FIG. 32A. In addition, for the decoded audio output of the accumulated content in the digital signal state, the content for which the third control information indicates the channel-based audio signal and the content for which the third control information indicates “undefined” are controlled to be output in the state where copying is prohibited, in a case where the copy control state in the accumulation state is the control state of temporary accumulation, as illustrated in FIG. 32A.

Note that the control example illustrated in FIG. 32A for the decoded audio output of the accumulated content in the digital signal state is performed in a case where the output unit of the decoded audio output is an output unit compatible with a copy control system such as a serial copy management system (SCMS). In a case where the output unit of the decoded audio output is not compatible with the copy control, output without copying restrictions is permitted regardless of the copy control state in the accumulation state and regardless of the value of the third control information.

Next, in the control example of the audio signal output of the accumulated content in the digital signal state in the stream format via the IP interface illustrated in FIG. 32A, the output is performed in the state where re-copying is prohibited, in a case where the copy control state in the accumulation state is a control state with copying restrictions, such as the control state where re-copying is prohibited, the control state where copying is possible in a limited number, or the control state of temporary accumulation, regardless of the value of the third control information. In the control example of the audio signal output of the accumulated content in the digital signal state in the stream format via the IP interface illustrated in FIG. 32A, in a case where the copy control state in the accumulation state is the one where copying is possible without restrictions, the copy control state at the time of output is switched according to the third control information. Specifically, the content for which the third control information indicates the channel-based audio signal or the content for which the third control information indicates “undefined” are permitted to be output in the state where copying is possible without restrictions. On the other hand, the content for which the third control information indicates the object-based audio signal or the HOA method audio signal, which is the advanced audio signal, is controlled to be output in the state where re-copying is prohibited.

Note that, in the audio signal output of the accumulated content in the digital signal state in the stream format via the IP interface illustrated in FIG. 32A, DTCP or DTCP2 is used as the copy control method. For the content for which the copy control state in the accumulation state is the control state with copying restrictions, such as the control state where re-copying is prohibited, the control state where copying is possible in a limited number, or the control state of temporary accumulation, control is performed so as to prohibit output to external equipment that is not compatible with DTCP and DTCP2.

According to the control example of FIG. 32A of the present embodiment described above, it is possible to realize more suitable copy control corresponding to the value of the content according to the audio signal type also in the output of the accumulated content.

Next, a control example of FIG. 32B will be described. The control example of FIG. 32B is a control example of copyright protection processing in the case where the audio component of the content is accumulated in the broadcast receiving apparatus 100 and is then output, and is a modification of the control example of FIG. 32A. Hereinafter, in order to omit repeated description, description of the same points as those of the control example of FIG. 32A will be omitted, and only differences from the control example of FIG. 32A will be described.

In the control example of FIG. 32B, the control of the decoded audio output of the accumulated content in the analog signal state and the control of the audio signal output of the accumulated content in the digital signal state in the stream format via the IP interface are the same as those in the control example of FIG. 32A. On the other hand, in the control example of FIG. 32B, the control of the decoded audio output of the accumulated content in the digital signal state is different from the control example of FIG. 32A. Specifically, in the control of the decoded audio output of the accumulated content in the digital signal state in the control example of FIG. 32B, the decoded audio of the accumulated content in the digital signal state can be output in the state where copying is possible without restrictions, in the case where the copy control state in the accumulation state is the control state where copying is possible without restrictions, regardless of the value the third control information indicates. In addition, in the case where the copy control state in the accumulation state is the control state where re-copying is prohibited or the control state where copying is possible in a limited number, the decoded audio of the accumulated content in the digital signal state is output in the state where copying is possible for only one generation, regardless of the value the third control information indicates. In addition, in the case where the copy control state in the accumulation state is the control state of temporary accumulation, the decoded audio of the accumulated content in the digital signal state is output in the state where copying is prohibited, regardless of the value the third control information indicates. That is, in the control of the decoded audio output in the digital signal state in the control example of FIG. 32B, there is no difference in the copying limitation at the time of audio output between the copy control of the content of the channel-based audio signal and the copy control of the content of the object-based audio signal or the HOA method audio signal, which is the advanced audio signal. The reason for this control is the same as the already described reason for the control of the decoded audio output in the digital signal state in the control example of FIG. 31B, and thus the repeated description will be omitted.

According to the control example of FIG. 32B of the present embodiment described above, it is possible to realize more suitable copy control corresponding to the value of the content according to the audio signal type also in the output of the accumulated content.

According to the processing described above, it is possible to realize appropriate content protection according to the copy control information associated with the audio content.

Note that, for both the video content and the audio content, the following control may be performed in addition to the above-described control of the output via the IP interface. Specifically, the copy processing to the external equipment via the LAN communication unit 121 of the content for which copy restrictions such as “copying is possible for only one generation”, “copying is possible in a limited number”, or “copying is prohibited” are indicated by the first control information (digital_recoding_control_data) and the second control information (copy_restriction_mode) included in the PMT in MPEG-2 TS or the MPT in MMT may be enabled only when the IP address of the external equipment that is the destination of the transmission packet from the broadcast receiving apparatus 100 is within the same subnet as the IP address of the broadcast receiving apparatus 100, and may be prohibited when the IP address of the external equipment is outside the same subnet as the IP address of the broadcast receiving apparatus 100. The content for which the copy control information is “copying is possible without restrictions and encryption processing is required at the time of accumulation and output” may also be handled in the same manner.

Similarly, the move processing to the external equipment via the LAN communication unit 121 of the content for which the copy control information indicates copy restrictions such as “copying is possible for only one generation”, “copying is possible in a limited number”, or “copying is possible without restrictions and encryption processing is required at the time of accumulation and output” after once accumulated in the storage (accumulator) 110 may be enabled only when the IP address of the external equipment that is the destination of the transmission packet from the broadcast receiving apparatus 100 is within the same subnet as the IP address of the broadcast receiving apparatus 100, and may be prohibited when the IP address of the external equipment is outside the same subnet as the IP address of the broadcast receiving apparatus 100.

Viewing video output and audio output of the content accumulated in the storage (accumulator) 110 of the broadcast receiving apparatus 100 are, in principle, enabled only when the IP address of the external equipment that is the destination of the transmission packet from the broadcast receiving apparatus 100 is within the same subnet as the IP address of the broadcast receiving apparatus 100, and are prohibited when the IP address of the external equipment is outside the same subnet as the IP address of the broadcast receiving apparatus 100. However, in the case where the external equipment is connected within the same subnet as the IP address of the broadcast receiving apparatus 100 and the equipment has undergone registration processing (pairing) as equipment where viewing is possible even outside the same subnet as the IP address of the broadcast receiving apparatus 100 within a predetermined period, viewing video output and audio output for the content accumulated in the storage (accumulator) 110 of the broadcast receiving apparatus 100 to the external equipment may be enabled even if the IP address of the external equipment is outside the same subnet as the IP address of the broadcast receiving apparatus 100. In this case, the viewing video output and the audio output are performed while the content being encrypted.

### [Reverberant Sound Addition Function]

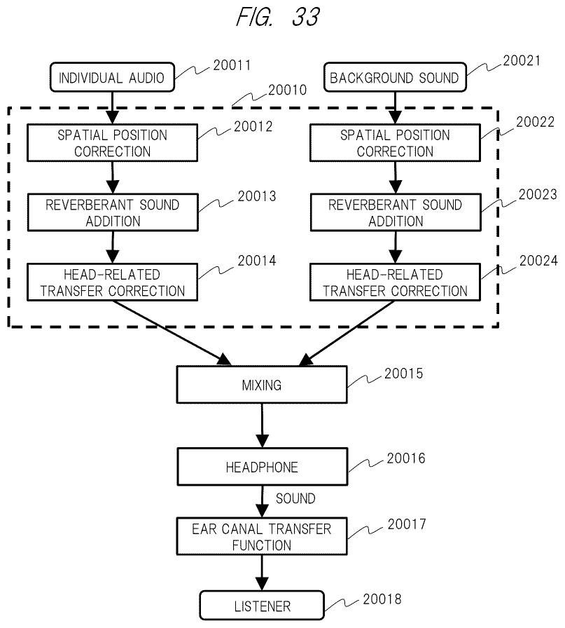

Next, the reverberant sound addition function of the broadcast receiving apparatus 100 will be described. FIG. 33 is a diagram illustrating an example of a reverberant processing flow when the headphone is used. The example illustrated in FIG. 33 is an example in which the broadcast receiving apparatus 100 obtains the signal of the reverberant sound of each audio based on a sound field characteristic, generates a signal of the reverberant sound added audio in which the reverberant sound is added to the original sound, mixes the signal of the reverberant sound added audio of each sound source, transmits the signal to the headphone, and reproduces the sound. Note that the sound field characteristic is an acoustic characteristic in a sound field that is an audio recording location, that is, a characteristic indicated by a spatial transfer function of a sound including a reverberant sound, or the like. In addition, the sound field characteristic is not limited to a method that directly indicates the spatial transfer function of the sound, and may be reference data for estimating the spatial transfer function of the sound, such as a shape of a structure such as a wall of the recording location or reflection characteristics and absorption characteristics of the sound depending on each structure.

In the present control example, information indicating the sound field characteristic and information indicating the position of each sound source in the sound field are described in broadcasting metadata included in the broadcasting wave, for example, metadata of each object-based sound signal included in the broadcasting wave. The broadcast receiving apparatus 100 acquires the sound field characteristic from the broadcasting metadata included in the received broadcasting wave, reflects the sound field characteristic at the time of audio rendering to generate the signal of the reverberant sound added audio, and enables sound reproduction with high realistic feeling. When the audio of a concert or a live performance is recorded and broadcast on an object basis, the reverberation characteristic of the concert hall, the theater, or the like is unlikely to be reflected in the audio reproduced by receiving the broadcasting wave, which may cause a lack of realistic feeling. This control example is particularly effective for solving such a problem.

Note that the broadcast receiving apparatus 100 may obtain the sound field characteristic via a network such as the Internet using, as a clue, information that can identify the name of the recording location such as the hall or the theater obtained from a broadcasting program name, additional information thereof, or the like. For example, information in which a hall name or a theater name and the sound field characteristic thereof are associated with each other is stored in advance in the information server 900 illustrated in FIG. 1. The broadcast receiving apparatus 100 acquires the sound field characteristic associated with the identified hall name or theater name from the information server 900 via the network through the communication unit. In addition, the broadcast receiving apparatus 100 may receive the reverberant sound as the object-based sound source, adjust the intensity, frequency characteristics, and the like according to the viewer's preference and viewing environment, and synthesize the reverberant sound with other sounds.

Note that the headphone is an example of an audio output device including a plurality of speakers. The audio output device may be the head-mounted display, the speaker system, or the like as described later. The audio recording location is a place where a sound is converted into an electric signal by a microphone, a pickup, or the like and recorded, and is, for example, a concert hall, a theater, or the like where a performance or a play takes place.

Hereinafter, reverberant sound processing flow the illustrated in FIG. 33 will be described in detail. 20010 corresponds to the object renderer 10103. The processing when the headphone is used described in (Second Embodiment) [Advanced Audio Signal] above corresponds to spatial position corrections 20012 and 20022. Furthermore, reverberant sound additions 20013 and 20023 and head-related transfer corrections 20014 and 20024 are performed.

An individual audio 20011 is recorded with an individual microphone or the like and has a small reverberant sound, and a background sound 20021 may include a reverberant sound. Therefore, in the present control example, the amount of the added reverberant sound may be reduced or the reverberant sound addition may be eliminated in the reverberant sound addition to the background sound 20021, relative to the reverberant sound addition to the individual audio 20011.

The reverberant sound additions 20013 and 20023 are performed by a calculation based on the sound field characteristic extracted from the broadcasting metadata, for example, metadata of an object audio (individual audio of each sound source) signal or a calculation using a spatial transfer function simulated from the structure of the recording location. More specifically, the reverberant sound additions 20013 and 20023 are performed by, for example, convolution integration of an impulse response to each object audio or background sound, filtering processing of frequency attenuation characteristics for each delay time, or the like. Note that, in a case where the sound field characteristic is not described in the metadata of the object audio signal, the theater name may be extracted from additional information or the like of the program to obtain the sound field characteristic of the theater from the information server 900.

When sound source position information in the theater is acquired from the metadata of the object audio signal and a viewing position that is a virtual viewer's position in the theater is specified, the broadcast receiving apparatus 100 can obtain the spatial transfer function based on the sound source and the viewing position in the theater. Based on the obtained spatial transfer function, the broadcast receiving apparatus 100 generates the signal of the reverberant sound added audio such that the reverberant sound added audio is close to audio in a case where the audio of each sound source is listened to at the viewing position. By generating the signal of the reverberant sound added audio in this manner, audio with higher realistic feeling can be reproduced. When the sound field characteristic cannot be directly obtained, the spatial transfer function may be obtained by simulation from the internal structure/material information of the theater. The internal structure/material information of the theater includes, for example, elements such as the size and shape of the room, the height of the ceiling, and the material of the interior.

The head-related transfer function indicates the relationship between a sound coming from each direction and a sound reaching the entrances of the ear canals of both ears. The head-related transfer characteristic varies for each listener depending on the pinna shape and the like. If there is no individually registered head-related transfer function, the audio is converted in the head-related transfer correction 20014 based on a standard head-related transfer function.

The sound output from the headphone reaches the eardrum through the ear canal, and the listener recognizes the audio. The ear canal transfer function from the headphone to the eardrum may vary depending on not only the individual listener but also whether the headphone is in a closed shape covering the pinna or an earphone shape to be inserted into the ear hole. For the head-related transfer correction 20014, not only correction processing based on the head-related transfer function but also correction processing based on the ear canal transfer function may be performed. In this case, for example, it is desirable to identify the head-related transfer function by acquiring headphone type information and listener identification information and perform the correction processing based on the identified head-related transfer function. Assuming a case where these types of information cannot be obtained, a plurality of types of head-related transfer functions considered to be typical may be prepared in advance so that the listener can select a head-related transfer function considered to be suitable by allowing the listener to listen to and compare audios that have undergone correction processing based on each head-related transfer function.

Note that FIG. 33 illustrates a case where there is one individual audio and one background sound, but in a case where there are a plurality of individual audios or background sounds, the same processing may be performed individually and each processed audio may be mixed. In addition, for the individual voice of narration, the strength or presence or absence of the reverberant sound addition processing may be changed depending on the type of the individual audio by reducing or eliminating reverberation to make it easier to hear or the like. In addition, although the example in which the spatial position correction 20012, the reverberant sound addition 20013, and the head-related transfer correction 20014 are sequentially performed has been described, a composite transfer function obtained by combining them together may be calculated, and the individual voice may be processed using the composite transfer function. In addition, in a case where the sound signal is a sound signal maintaining sound directivity information, for example, a sound signal in the HOA format, the sound signals may be collectively processed after the processing of mixing 20015 or may be processed by the headphone 910. In a case of being processed by the headphone 910, since the broadcast receiving apparatus 100 does not need to grasp the format and orientation of the headphone 910, it is easy to individually deal with each viewer in a case where there are a plurality of viewers.

Note that the wall of the theater that causes the reverberant sound is often relatively far from the sound source and the viewer. Considering this, the influence of the sound source position on the reverberant sound may be reduced. Therefore, instead of transmitting the sound field characteristic as metadata, the reverberant sound may be approximated and transmitted as one sound source of the object audio. In addition, the intensity of the reverberant sound may be adjusted separately from the background sound according to the viewer's preference.

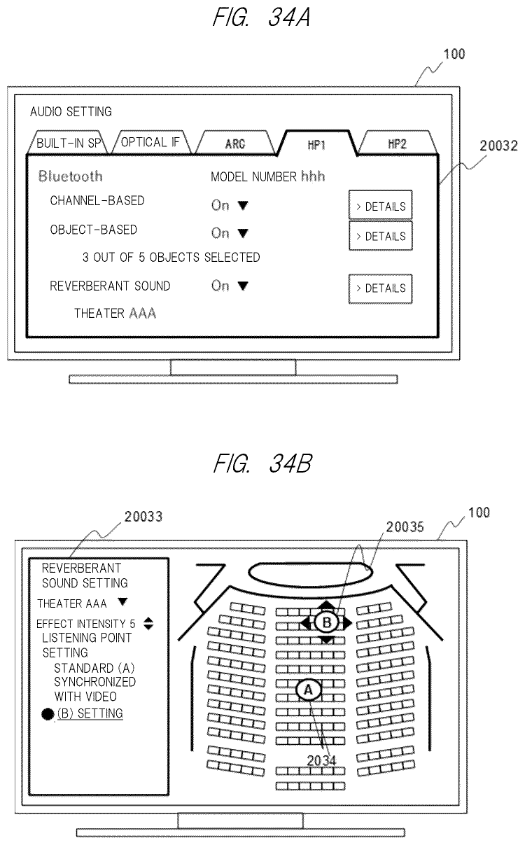

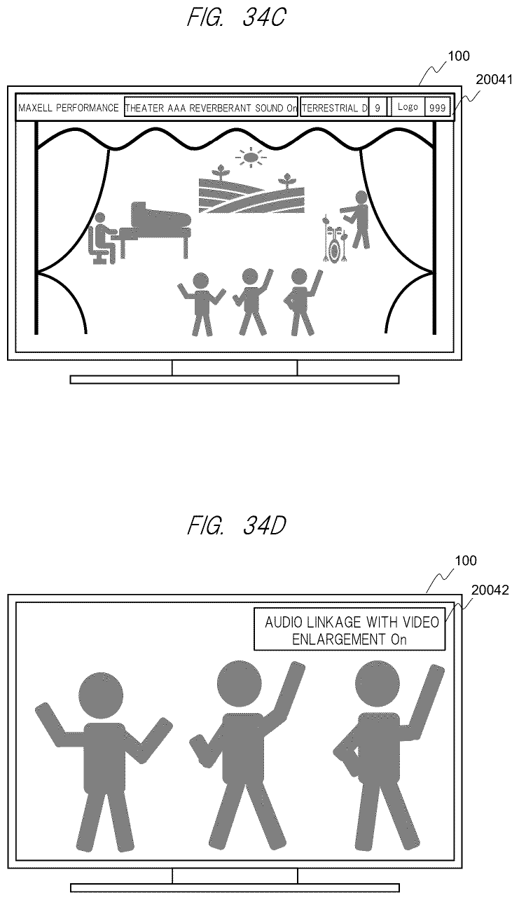

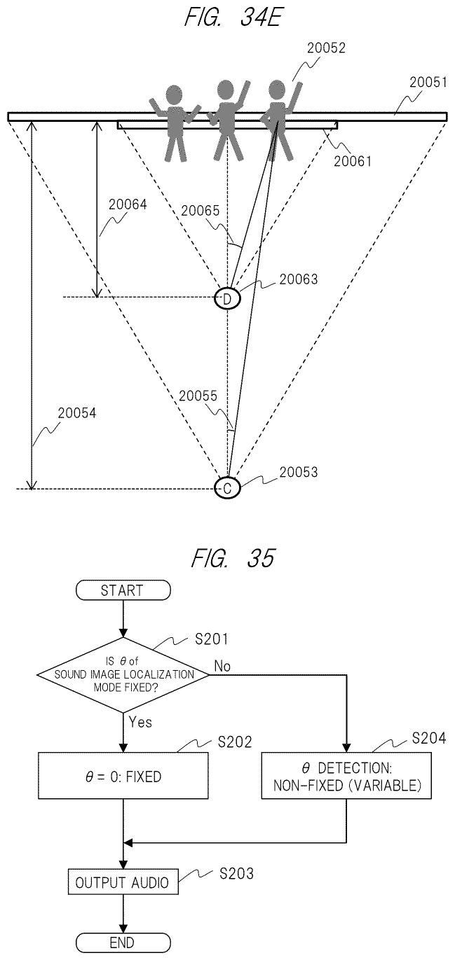

FIG. 34A is a diagram illustrating an example of an audio output setting menu. In the audio setting menu in FIG. 34A, each tag indicates a setting target. By selecting a tag, the viewer can open the setting menu of the setting target associated with the tag. The tag “built-in SP” is associated with the setting of a TV built-in speaker, the tag “optical IF” is associated with the setting of an optical digital interface, the tag “ARC” is associated with the setting of Audio Return Chanel of HDMI, the tag “HP1” is associated with the setting of a Head Phone 1 (Bluetooth (registered trademark) connection), and the tag “HP2” is associated with the setting of a Head Phone 2 (assuming a 3.5φ mini jack). FIG. 34A illustrates a state where the tag “HP1” has been selected and a setting menu 20032 of the Head Phone 1 has been opened.

In the setting menu 20032 of HP1, “model number hhh” represents the model number of the headphone. Based on the model number of the headphone, the broadcast receiving apparatus 100 may obtain the standard head-related transfer function information used for the head-related transfer correction 20014 in FIG. 33 from the information server 900. “channel-based On” indicates that the channel-based audio signal is On. The “▾” mark is a mark for setting On/Off, and when the cursor is placed on this mark, options “On” and “Off” appear so that the viewer can set On/Off. “>Details” is a button for opening a detailed settings menu, and the detailed settings menu for the corresponding setting target is opened when this button is pressed.

“Object-based On” indicates that the object-based audio signal is On. In a case where the object-based audio signal is On, a summary display indicating how many object audios are in total and how many audios are On is made. In the example of FIG. 34A, “3 out of 5 objects selected” is displayed, indicating that there are five object audios in total and three audios out of the five are On. In a case where “object-based Off” is displayed, it means that all the object audios are Off.

The detailed menu illustrated in FIG. 27 is an example of the detailed setting menu of the object-based signal. In the detailed menu illustrated in FIG. 27, On/Off can be set for each individual audio.

“Reverberant sound On” indicates that the reverberant sound addition is On. “Theater AAA” is the name of a theater subject to the reverberant sound addition.

FIG. 34B is a diagram illustrating an example of a detailed menu for reverberant sound setting. In the detailed menu for reverberant sound setting, detailed settings of the loudness of the reverberant sound and the listening point (position where the sound is listened to) can be made. It is natural that a viewing position for viewing the content is such that the listening point that is the position where the sound is listened to and the position for viewing the video are at the same position. However, the positions may be different, for example, when the display size changes. Hereinafter, in the description about sound reproduction, the listening point is used instead of the viewing position.

In the example of the detailed menu for the reverberant sound illustrated in FIG. 34B, a reverberant sound detailed setting field 20033 is displayed on the left side of the screen, and a seat arrangement diagram of the theater that is the performance venue viewed from the above is displayed on the right side of the screen. In the reverberant sound detailed setting field 20033, a reverberant sound setting area for performing the reverberant sound setting and a listening point setting area for performing listening point setting are provided.

In the reverberant sound setting area, a selected theater name and the effect intensity of the reverberant sound are displayed, and a desired one can be selected from options with the “▴” and “▾” marks. In a case where the theater name can be extracted from program information, for example, program metadata, it is automatically selected based on the program information. FIG. 34B illustrates an example in which a theater AAA has been set. An alternative theater other than the theater AAA may also be selected. The alternative theater is another theater, for example, a BBB theater other than the AAA theater where the performance takes place. When the alternative theater is selected, an acoustic effect of the alternative theater is simulated and reproduced. Since the sound field characteristic of the alternative theater, for example, the BBB theater, cannot be obtained from the broadcast program, it may be set by searching a theater name that can be obtained from the information server 900.

In addition, as the effect intensity of the reverberant sound, a default setting is initially used or a stored previous setting is used. The effect intensity of the reverberant sound can be selected in, for example, 10 levels and a default value recommended by the program or the audio metadata is 5. The value 0 of the effect intensity means no reverberation. FIG. 34B illustrates an example in which 5 has been set as the value of the effect intensity. Note that, in a case where the metadata of the reverberant sound information cannot be obtained, for example, “-” is displayed.

In the listening point setting area, the setting of the selected listening point is displayed. The setting of the listening point can be selected from, for example, three types of “standard (A)”, “synchronized with video”, and “(B) setting”. “Standard (A)” is a setting for selecting the default setting indicated by the program information or the audio metadata. “Synchronized with video” is a setting for synchronizing the sound field with the partially enlarged video illustrated in FIG. 34D to be described later. Note that the “synchronized with video” is referred to also as a “image-sound image linkage” mode. “(B) setting” is a setting that allows the user to determine the listening point by moving the cursor (B) on the seat arrangement diagram on the right. FIG. 34B illustrates an example in which a listening point 20034 (indicated by a mark A) of the default setting is displayed at the center position of the seat arrangement diagram. In addition, FIG. 34B illustrates an example in which “(B) setting” has been selected and a listening point 20035 (indicated by a mark B) in this case is displayed in the front area of the seat arrangement diagram. The listening point is moved by, for example, operating the “▴” and “▾” marks or the like displayed in the vicinity of the cursor of the listening point.

FIG. 34C is a diagram illustrating an example of banner display indicating a reverberant sound processing state. FIG. 34C illustrates an example in which the entire stage of a program called Maxell Performance is displayed as a broadcast image, and illustrates a banner display 20041 in a case where a reverberant sound assuming the AAA theater has been added.

FIG. 34D is a diagram illustrating an example of banner display in partially enlarged display of a broadcast image with a predetermined remote controller operation or the like. FIG. 34D illustrates an example in which the broadcast image in FIG. 34C has been partially enlarged to zoom the dancers included in the broadcast image. The enlarged part may be moved with the upper, lower, left, and right buttons of the remote controller. In a case where “synchronized with video” is not selected as the setting of the listening point, that is, in a case where the “image-sound image linkage” mode is Off, the spatial position correction of the sound is not operated in cooperation with the partial enlargement of the broadcast image and the sound field does not change. On the other hand, in a case where “synchronized with video” is selected as the setting of the listening point, that is, in a case where the “image-sound image linkage” mode is On, the spatial position correction is operated in cooperation with the partial enlargement of the broadcast image. For example, in a case where the broadcast image is partially enlarged twice at a constant viewing angle, the distance between the listening point and the sound source is halved, while processing of changing the direction in which the sound comes and the loudness of the sound is also performed.

Therefore, in the case where the “image-sound image linkage” mode is On, the direction and loudness of the sound also change when the image is enlarged, and thus, for example, the viewer obtains a feeling of approaching the stage. On the other hand, in the case where the “image-sound image linkage” mode is Off, the direction and loudness of the sound do not change even when the image is enlarged, and thus, for example, the viewer obtains a feeling of wearing binoculars while sitting on the seat.

Note that the “image-sound image linkage” mode may be set independently for the partial image enlargement and entire image display. It is also possible to set the “image-sound image linkage” mode to On at a predetermined magnification or less and to set the “image-sound image linkage” mode to Off at the predetermined magnification (for example, twice) or more.

FIG. 34E is a diagram for explaining a viewing condition before and after the partially enlarged display of the broadcast image. FIG. 34E illustrates an example of a view of a performance venue of a broadcast program as viewed from above. FIG. 34E illustrates, as an example, a region 20051 displayed on the screen before the partially enlarged display and a region 20061 displayed on the screen after the partially enlarged display. Note that performers 20052 are expressed by a diagram viewed from the front in order to facilitate understanding of the description.

Based on the displayed performers 20052, the region 20061 of the screen after the partially enlarged display apparently has a smaller display region in the real space than the region 20051 of the screen before the partially enlarged display, and the viewer can be regarded as being in a state of approaching from a viewing point 20053 (indicated by a mark C) to a viewing point 20063 (indicated by a mark D). That is, the distance from the viewer to a position corresponding to the display region can be regarded as being reduced from a distance 20054 before the partially enlarged display to a distance 20064 after the partially enlarged display.

Considering the viewing angle based on the rightmost performer among the performers 20052, a viewing angle 20065 after the partially enlarged display of the broadcast image is larger than a viewing angle 20055 before the partially enlarged display. Here, the state in the processing mode that changes the direction in which the sound comes in accordance with the change in the viewing angle is referred to as the state where the “image-sound image linkage” mode is On. In a case where the “image-sound image linkage” mode is On, the performer can be seen more largely by the partially enlarged display of the broadcast image, and the direction in which the sound comes changes in conjunction therewith. That is, in this case, the viewer can obtain the feeling of approaching the stage, that is, the performer, and thus the experience of moving in the theater can be reproduced.

On the other hand, the state out of the processing mode that changes the direction in which the sound comes in accordance with the change in the viewing angle is referred to as the state where the “image-sound image linkage” mode is Off. In a case where the “image-sound image linkage” mode is Off, the performer can be seen more largely by the partially enlarged display of the broadcast image, but the direction in which the sound comes does not change. That is, in this case, the viewer can obtain the feeling of looking at the stage with binoculars, and thus the experience at a fixed position in the theater can be reproduced.

Note that switching between On and Off of the “image-sound image linkage” mode may be directly performed with a remote controller button or may be performed in menu setting.

### <Speaker Sound Output>

Although the description has been given above assuming a case where the sound is output with the headphone 910, but the same processing can be performed also in a case where the sound is output while adding the reverberant sound with the speaker. In the case where the sound is output with the speaker, a sound obtained from the head-related transfer function based on the sound of each speaker and the direction of the speaker reaches the ears of the viewer. Therefore, also in the case where the sound is output with the speaker, the same processing as that in FIG. 33 may be performed by applying the head-related transfer corrections 20014 and 20024 such that a desired sound reaches the ears of the viewer. Furthermore, in a case where the reverberant sound of the viewing environment cannot be ignored, the sound field characteristic of the viewing environment is measured, and correction to suppress the reverberant sound of the viewing environment based on the measured sound field characteristic is performed in the head-related transfer correction, thus making it possible to further enhance the realistic feeling in the theater.

### <HMD Viewing>

The same processing can be performed also in the case of viewing with the HMD. In the case of viewing with the HMD by the viewer, the HMD 920 receives video and audio data from the broadcast receiving apparatus 100, reproduces the video and audio, and provides a viewing environment where the viewer feels as if to look at the monitor 192 of the broadcast receiving apparatus 100 and listen to the sound from the headphone 910. When the viewer wears the HMD 920 or when the viewer initializes the settings related to viewing, a standard viewing state of television broadcasting, that is, a state where the video is displayed in front of the viewer may be set.

As the mode for setting the viewing state of the viewer, the broadcast receiving apparatus 100 may be provided with a mode that obtains posture information of the HMD 920 from the HMD 920, generates a video based on the posture information, and transmits the video to the HMD 920, and a mode that fixes the viewing state to the standard viewing state. In this case, the mode setting may be switched in the menu setting or with a remote controller button instruction. The broadcast receiving apparatus 100 may be provided with a mode for synchronizing the display of the monitor 192 with the HMD display, and may switch between the synchronous and asynchronous modes in response to a menu operation.

In addition, the broadcast receiving apparatus 100 may receive position information or acceleration information of the HMD 920, detect a change in the position of the HMD 920 to grasp the movement of the viewer, and enlarge and reduce the display video according to the movement to extract realistic feeling. For example, in a case where it is detected that the viewer approaches the display video or moves forward, the display video is enlarged, and in a case where it is detected that the viewer moves away from the display video or moves backward, the display video is reduced.

In the case where the display video is controlled to be enlarged and reduced in this manner, the viewer may set the enlargement/reduction rate of the display video according to the distance by which the viewer approaches or moves away from the display video. In addition, it is also possible to provide a user interface (for example, a remote control operation button, detection of a gesture operation, or the like) for stopping the video enlargement/reduction or setting the video enlargement/reduction rate to a default in a case where the viewer moves and changes the viewing location.

In addition, the broadcast receiving apparatus 100 may be provided with a mode for changing the direction in which the sound comes and a feeling of distance in accordance with the enlargement and reduction of the display video, that is, a mode for linking the video and the sound image, and may be provided with a user interface capable of switching On/Off the mode.

In addition, the conversion processing of the video and the sound image according to the position information, the acceleration information, the posture information, and the like of the HMD 920 may be performed not on the broadcast receiving apparatus 100 side but on the HMD 920 side. When the conversion processing of the video and the sound image is performed at the HMD 920, even if the broadcast receiving apparatus 100 provides the same video and audio data to the HMD 920 of each of a plurality of viewers, there is the effect of allowing each viewer to independently view and listen to the video and the sound according to the position and posture of the viewer.

### Third Embodiment

### [Switching of Sound Image Localization Mode]

The present embodiment relates to handling of switching of a sound image localization mode. In the above-described embodiment, the broadcast receiving apparatus 100 executes the audio processing by taking in information related to the front direction of the user's face to cause the sound to be emitted from the audio output unit of the HMD (Head Mounted Display), earphone, headphone, or the like worn by the user such that the sound image is localized in the image displayed on the screen of the broadcast receiving apparatus 100 in accordance with a change in the front direction of the user's face. A mode in which the sound image is localized in the image displayed on the screen of the broadcast receiving apparatus 100 in accordance with the change in the front direction of the user's face in this manner is referred to as a variable sound image localization mode in the present embodiment. On the other hand, a mode in which the broadcast receiving apparatus 100 executes the audio output processing assuming that the front direction of the user's face is fixed is referred to as a fixed sound image localization mode in the present embodiment.

FIG. 14A is a diagram illustrating a planar positional relationship among the broadcast receiving apparatus 100, the audio output unit of the HMD, the headphone, the earphone, or the like, and the user's head. The middle point of the line segment connecting the left and right audio output units is the standard viewing position in this case. The frontward direction of the straight line passing through the middle point of the line segment connecting the left and right audio output units perpendicular to the line segment connecting the left and right audio output units is the front direction of the user's face.

In addition, FIG. 14B illustrates a case where the standard viewing position is on a line (Y axis) orthogonal to a longitudinal direction (X axis) of the screen from the center of the screen of the broadcast receiving apparatus 100. “θ” is an angle formed by the front direction of the user's face described in FIG. 14A and the screen center direction of the broadcast receiving apparatus 100, and indicates how much the user's face is sideways from the screen center direction. Note that the above “θ” is an example of an “azimuth angle” in the present invention.

In a case of the variable sound image localization mode described above, the broadcast receiving apparatus 100 receives the input of the position information of the left and right audio output units, calculates the “θ”, and adjusts sound information such as audio information output from the left and right audio output units. In addition, in a case of the fixed sound image localization mode described above, the broadcast receiving apparatus 100 calculates the “θ” as a fixed value (for example, “θ”=0), and adjusts the sound information such as the audio information output from the left and right audio output units.

Here, the position of the audio output unit of the HMD, the earphone, the headphone, or the like can be acquired by, for example, recording the position where the user faces the center of the receiver screen from the user input and then detecting the change in the orientation of the user's face with the gyro sensor or the like mounted on the headphone. In addition, the position of the audio output unit of the HMD, the earphone, the headphone, or the like can also be acquired by receiving position information from a GPS or other systems via the left and right audio output units in the broadcast receiving apparatus 100 and then calculating the position information in the broadcast receiving apparatus 100. Note that the audio output unit may be configured to calculate the position of the audio output unit based on the position information from the GPS or other systems and output the calculated position information to the broadcast receiving apparatus 100. In addition, the broadcast receiving apparatus 100 and the audio output unit can communicate the position information by including another communication unit such as a BlueTooth (registered trademark) communication unit, an NFC communication unit, and an infrared communication unit.

However, in a case where an error occurs in the position information of the audio output unit or the like, the audio of the audio output unit may not be appropriately emitted with respect to the orientation of the user's face. For example, if the orientation of the user's face is the right side with respect to the front of the screen and the user feels that the audio is strongly heard from the audio output unit on the right side of the user, the user may feel uncomfortable in the sound emission direction of the audio. Therefore, in the present embodiment, in a case where the user feels uncomfortable in the sound emission direction or the like, the broadcast receiving apparatus 100 is configured to be able to calculate and output the sound information including the audio information by setting “θ” in FIG. 14B to 0 degrees. That is, assuming that the front direction of the user is directed toward the screen center direction, the broadcast receiving apparatus 100 calculates the sound information including the audio information and outputs the calculated sound information to the audio output unit of the earphone, the headphone, or the like.

Note that, for the object-based signal and the HOA method signal, the signal to be output to the audio output unit is determined by setting “θ” to a predetermined fixed value (for example, “0”) and executing the calculation according to each of the above-described formulas.

FIG. 35 is a flowchart illustrating a switching operation of the sound image localization mode of the present embodiment.

In step S201, it is determined whether the angle “θ” formed by the screen center direction and the front direction of the user's face is fixed or non-fixed. The flow proceeds to step S202 in a case where the angle “θ” is fixed (step S201: Yes), and the flow proceeds to step S204 in a case where the angle “θ” is non-fixed (step S201: No).

Whether the angle “θ” formed by the screen center direction and the front direction of the user's face is fixed or non-fixed can be set and determined by various methods. The details will be described later.

In step S202, as an example of a case where the angle “θ” formed by the screen center direction and the front direction of the user's face is fixed, the broadcast receiving apparatus 100 receives information of “θ”=“0”, and the broadcast receiving apparatus 100 calculates the sound information including the audio information using “θ”=“0”. The calculation may be executed at the audio decoders 146S and 146U in FIGS. 2F and 2G in the broadcast receiving apparatus 100. More specifically, the calculation may be executed at the audio decoder 10100 in FIG. 15B to be incorporated in the audio decoders 146S and 146U.

In step S203, the broadcast receiving apparatus 100 outputs calculation information calculated at the audio decoders 146S and 146U or the like to the audio output unit of the HMD, the earphone, the headphone, or the like and the audio output unit emits the calculation information to the auditory sense of the user.

In step S204, the broadcast receiving apparatus 100 receives information indicating that the angle “θ” formed by the screen center direction and the front direction of the user's face is non-fixed, and the broadcast receiving apparatus 100 calculates “θ” and adds the calculated value of “θ” to attribute information of the sound information including the audio information, thereby calculating the calculation information to be output to the audio output unit of the earphone, the headphone, or the like. As described above, the calculation may be executed at the audio decoders 146S and 146U in FIGS. 2F and 2G in the broadcast receiving apparatus 100. More specifically, the calculation may be executed at the audio decoder 10100 in FIG. 15B to be incorporated in the audio decoders 146S and 146U.

### [Setting of Sound Image Localization Mode]

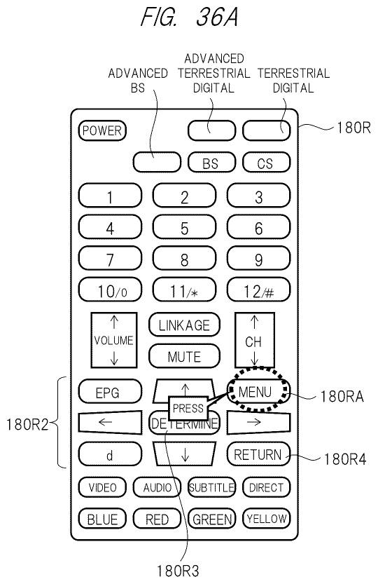

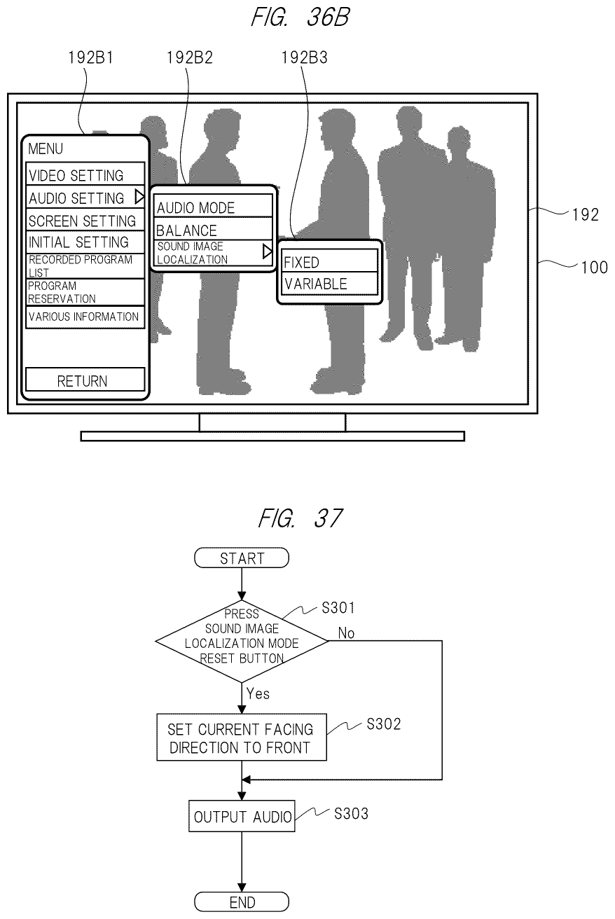

As an example of a method of setting the sound image localization mode, a case of using the remote controller 180R will be described. FIG. 36A illustrates an example of an appearance diagram of the remote controller 180R used to input a setting instruction of the sound image localization mode to the broadcast receiving apparatus 100 of the present embodiment. The key arrangement of the remote controller 180R illustrated in FIG. 36A is the same as that of the remote controller 180R illustrated in FIG. 12B. However, the remote controller 180R illustrated in FIG. 36A according to the present embodiment has the function of outputting a mode screen for selecting whether the angle “θ” formed by the screen center direction and the front direction of the user's face is fixed or non-fixed.

The remote controller 180R includes the power key 180R1 for turning on/off (standby on/off) the power of the broadcast receiving apparatus 100, the cursor keys (up, down, left, and right) 180R2 for moving the cursor upward, downward, leftward, and rightward, the determination key 180R3 for determining the item at the cursor position as the selection item, and the return key 180R4. To switch the audio mode, the menu key 180RA is pressed.

FIG. 36B is a diagram illustrating an example of banner display for setting the sound image localization mode displayed on the monitor 192 of the broadcast receiving apparatus 100 when the menu key 180RA is pressed. When the menu key 180RA is pressed, a banner display 192B1 indicating a menu type is displayed on the monitor 192. The shape of the banner display 192B1, the display position on the monitor 192, and the items of the banner display 192B1 can be arbitrarily set by the broadcast receiving apparatus 100. However, the items of the banner display 192B1 include at least an item for setting the sound image localization mode (as an example, there is item information of “audio setting”, but the name is not limited thereto).

In a state where the banner display 192B1 is displayed, the cursor position is moved so as to select “audio setting” using the cursor key (up, down, left, and right) 180R2 and the determination key 180R3 is pressed, whereby a banner display 192B2 is displayed. Items related to audio setting are displayed on the banner display 192B2. The items of the banner display 192B2 include at least an item for setting the sound image localization mode (as an example, there is item information of “sound image localization”, but the name is not limited thereto). In a state where the banner display 192B2 is displayed, the cursor position is moved so as to select “sound image localization” using the cursor key (up, down, left, and right) 180R2 and the determination key 180R3 is pressed, whereby a banner display 192B3 is displayed. Items related to sound image localization are displayed on the banner display 192B3. The items of the banner display 192B3 include at least an item for setting whether the sound image localization mode is “fixed” or “non-fixed” (as an example, there is item information of “fixed” and “non-fixed”, but the name is not limited thereto. For example, it is possible to change the name of “non-fixed” to “variable”, but the function of the sound image localization mode is the same).

In a state where the banner display 192B3 is displayed, the cursor position is moved so as to select “fixed” using the cursor key (up, down, left, and right) 180R2 and the determination key 180R3 is pressed, whereby the remote controller 180R executes the following operation. That is, the remote controller 180R transmits, to the broadcast receiving apparatus 100, information that fixes the angle “θ” formed by the screen center direction and the front direction of the user's face (hereinafter referred to as “fixing information”). The remote controller 180R and the broadcast receiving apparatus 100 can communicate the “fixing information” by including another communication unit such as a BlueTooth (registered trademark) communication unit, an NFC communication unit, and an infrared communication unit.

In addition, in the state where the banner display 192B3 is displayed, the cursor position is moved so as to select “non-fixed” using the cursor key (up, down, left, and right) 180R2 and the determination key 180R3 is pressed, whereby the remote controller 180R executes the following operation. That is, the remote controller 180R transmits, to the broadcast receiving apparatus 100, information that does not fix the angle “θ” formed by the screen center direction and the front direction of the user's face (hereinafter referred to as “non-fixing information”). The remote controller 180R and the broadcast receiving apparatus 100 can communicate the “non-fixing information” by including another communication unit such as a BlueTooth (registered trademark) communication unit, an NFC communication unit, and an infrared communication unit.

Note that the configuration in which the “fixing information” and the “non-fixing information” are assigned to the color keys (blue, red, green, and yellow) 180RD and the “fixing information” and the “non-fixing information” is switched each time the color keys (blue, red, green, and yellow) 180RD are pressed is also possible.

The broadcast receiving apparatus 100 that has received the “fixing information” or the “non-fixing information” calculates the value of the angle “θ” as a fixed value (as an example, 0 degrees) or the angle “θ” formed by the screen center direction and the front direction of the user's face to obtain the calculation information to be output to the audio output unit of the HMD, the earphone, the headphone, or the like. As described above, the calculation may be executed at the audio decoders 146s and 146U in FIGS. 2F and 2G in the broadcast receiving apparatus 100. More specifically, the calculation may be executed at the audio decoder 10100 in FIG. 15B to be incorporated in the audio decoders 146S and 146U.

With the system for the advanced digital broadcasting service including the broadcast receiving apparatus 100 having some or all of the functions according to the embodiment of the present disclosure described above, the broadcast receiving apparatus 100 can fix “θ” in FIG. 14B (for example, 0 degrees), calculate the sound information including the audio information, and output the sound information, no matter which direction the front direction of the user's face is. Therefore, in a case where the front direction of the user's face cannot be accurately acquired or in a case where the user feels uncomfortable in the sound emission direction, the sound image localization direction can be fixed.

### Modification of Third Embodiment

### [Correction of θ in Case of Non-fixed Sound Image Localization Mode]

The present modification relates to setting of 0 in a case of the non-fixed sound image localization mode. In the case of the non-fixed sound image localization mode of the above-described embodiment, the broadcast receiving apparatus 100 executes the audio processing by receiving the input of the information related to the front direction of the user's face to cause the sound to be emitted from the audio output unit of the earphone, the headphone, or the like such that the sound image is localized in the image displayed on the screen of the broadcast receiving apparatus 100 in accordance with the change in the front direction of the user's face. However, if the initial value is erroneously set in a case where the front direction of the user's face is calculated with the gyro sensor, the front direction of the user's face will continue to be in the wrong direction. Therefore, in the present modification, a method of setting “θ” using the actual direction of the user's face as a new front direction will be described.

FIG. 37 is a flowchart illustrating a correction operation of θ in a case of the non-fixed sound image localization mode of the present modification.

In step S301, the broadcast receiving apparatus 100 determines whether a reset button has been pressed. In a case where the reset button has been pressed (step S301: Yes), the broadcast receiving apparatus 100 proceeds to step S302. In a case where the reset button has not been pressed (step S301: No), the broadcast receiving apparatus 100 proceeds to step S303. Here, the reset button may be newly provided on the remote controller 180R (not illustrated). In addition, the determination that the reset button has been pressed may be made by pressing the menu key 180RA to display a reset region (not illustrated) on the monitor 192 of the broadcast receiving apparatus 100, selecting the reset region using the cursor keys (up, down, left, and right) 180R2, and then pressing the determination key 180R3. Furthermore, the color keys (blue, red, green, and yellow) 180RD may be configured as the reset button. Furthermore, the reset button may be provided in the HMD, the earphone, or the headphone, and information indicating that the reset button has been pressed may be output to the broadcast receiving apparatus 100. The information indicating that the reset button has been pressed is realized when each device is provided with another communication unit such as a BlueTooth (registered trademark) communication unit, an NFC communication unit, and an infrared communication unit.

In step S302, the broadcast receiving apparatus 100 sets “θ” using the direction of the user's face in the case where the reset button has been pressed as the new front direction of the user's face.

In step S303, the broadcast receiving apparatus 100 calculates the audio information using “θ” set as the new front direction of the user's face at the audio decoders 146S and 146U or the like and outputs the calculated calculation information to the audio output unit of the HMD, the earphone, the headphone, or the like, and the audio output unit emits the calculation information to the auditory sense of the user.

With the system for the advanced digital broadcasting service including the broadcast receiving apparatus 100 having some or all of the functions according to the modification of the present disclosure described above, it is possible to correct the front direction of the user's face to the direction in which the user actually faces with the reset button even in a case where the broadcast receiving apparatus 100 erroneously recognizes the front direction of the user's face.

As described above, according to the present control example, the broadcast receiving apparatus identifies the sound recording location of the audio for the program from the metadata or the content of the program information, acquires the sound field information of the location from the server to generate the reverberant sound, generates the synthesized sound in which the reverberant sound is added to the original sound, and causes the audio output device to output the synthesized sound. With such an operation of the broadcast receiving apparatus, the viewer can enjoy the same realistic feeling as if he/she is in the sound recording location. In addition, when the listening point in the sound recording location is specified, the broadcast receiving apparatus generates a synthesized sound corresponding to a case where the audio from the sound source is listened to at the listening point, so that the viewer can reproduce the audio to be listened to at a desired seat position. In addition, the broadcast receiving apparatus moves the listening point in the sound recording location in accordance with the partial enlargement operation of the broadcast image and virtually changes the direction in which the sound comes, so that the viewer can enjoy a more realistic experience in which the video and the sound are synchronized.

In the foregoing, the examples of the embodiments of the present invention have been described with reference to first, second, and third embodiments, but the configuration for realizing the technique of the present invention is not limited to the above embodiments, and various modifications are conceivable. For example, a part of the configuration of a certain embodiment can be replaced with the configuration of another embodiment, and the configuration of another embodiment can be added to the configuration of a certain embodiment. These are all within the scope of the present invention. In addition, numerical values, messages, and the like appearing in the text and the drawings are merely examples, and the effect of the present invention is not impaired even if different ones are used.

The functions and others of the present invention described above may be realized by hardware by designing part or all of them by, for example, integrated circuits. Also, they may be realized by software by interpreting and executing the operating program for realizing each function by a microprocessor unit or the like. It is also possible to use hardware and software together.

Note that the above-described software that controls the broadcast receiving apparatus 100 may be stored in advance in the ROM 103 and/or the storage 110 of the broadcast receiving apparatus 100 at the time of product shipment. It may be acquired from a server device on the Internet 800 via the LAN communication unit 121 after product shipment. Also, the software stored in a memory card, an optical disc, or the like may be acquired via the extension interface 124 or the like. Similarly, the software that controls the portable information terminal 700 may be stored in advance in the ROM 703 and/or storage 710 of the portable information terminal 700 at the time of product shipment. It may be acquired from a server device on the Internet 800 via the LAN communication unit 721 or the mobile phone network communication unit 722 after product shipment. Also, the software stored in a memory card, an optical disc, or the like may be acquired via the extension interface 724 or the like.

Further, the control lines and information lines that are considered to be necessary for description are illustrated in the drawings, and all of the control lines and information lines in the product are not necessarily illustrated. In practice, it is safe to assume that almost all configurations are connected to each other.

### REFERENCE SIGNS LIST

100: broadcast receiving apparatus, 101: main controller, 102: system bus, 103: ROM, 104: RAM, 110: storage (accumulator), 121: LAN communication unit, 124: extension interface, 125: digital interface, 130C, 130T, 130L, 130B: tuner/demodulator, 140S, 140U: decoder, 180: operation input unit, 191: video selector, 192: monitor, 193: video output unit, 194: audio selector, 195: speaker, 196: audio output unit, 180R: remote controller, 200, 200C, 200T, 200S, 200L, 200B: antenna, 201T, 201L, 201B: converter, 300, 300T, 300S, 300L: radio tower, 400C: headend of cable television station, 400: broadcast station server, 500: service provider server, 600: mobile phone communication server, 600B: base station, 700: portable information terminal, 800: Internet, 800R: router device, 900: information server, 910: headphone, 920: HMD

1. A broadcast receiving apparatus capable of receiving a signal of each sound source via a broadcasting wave, the broadcast receiving apparatus comprising:
a broadcast receiver configured to receive the broadcasting wave;
an audio output unit including a plurality of speakers and configured to output audio according to the signal of each sound source transmitted from the broadcast receiving apparatus; and
a controller,
wherein the controller
determines a reproduction position of the audio based on the signal of each sound source according to arrangement information of the plurality of speakers,
calculates a signal corresponding to a 22.2 ch audio channel based on the signal of each sound source, and then converts the signal corresponding to the 22.2 ch audio channel into a signal for the audio output unit.

2. The broadcast receiving apparatus according to claim 1,
wherein the broadcasting wave transmits, to the broadcast receiver, a parameter that describes information on whether or not to permit a user to set the reproduction position for each of the signal of each sound source, and
wherein the reproduction position setting is selected by the controller from preset positions transmitted via the broadcasting wave, or is set by the user by limiting a range.

3. The broadcast receiving apparatus according to claim 1, further comprising an operation input unit configured to input a control signal from a remote controller,
wherein the user can set the reproduction position of the audio based on the signal of each sound source using the remote controller.

4. The broadcast receiving apparatus according to claim 1, further comprising a communication unit capable of receiving data via a network,
wherein the communication unit receives an additional audio signal different from the signal of each sound source via the network, and
wherein the controller reproduces audio based on the audio signal together with the audio of the signal of each sound source received via the broadcasting wave.

5. The broadcast receiving apparatus according to claim 1,
wherein, in a case where the broadcast receiver receives emergency broadcasting, the controller invalidates a setting related to audio reproduction set by a user and changes the setting related to the audio reproduction to a setting for the emergency broadcasting.

6. A content protection method in a receiving apparatus configured to receive digital broadcasting by which first control information, second control information, and third control information, and a content including an audio signal are transmitted,
the first control information and the second control information being combined to indicate a copy control state of the content, and
the third control information indicating a type of the audio signal included in the content,
the content protection method comprising:
a reception step of receiving the digital broadcasting; and
an output step of outputting the content included in the received digital broadcasting to external equipment,
wherein a copy control state when the content is output in the output step is determined according to a copy control state of the content when received in the reception step and the type of the audio signal included in the content.

7. A content protection method in a receiving apparatus configured to receive digital broadcasting by which first control information, second control information, and third control including an audio signal are information, and a content transmitted,
the first control information and the second control information being combined to indicate a copy control state of the content, and
the third control information indicating a type of the audio signal included in the content,
the content protection method comprising:
a reception step of receiving the digital broadcasting; and
an output step of outputting the content included in the received digital broadcasting to external equipment,
wherein, for a content received in a state where a copy control state where copying is possible for only one generation or a copy control state where copying is possible in a limited number is indicated by a combination of the first control information and the second control information and the third control information indicates that an object-based audio signal is included, a copy control state in a case of performing stream output via an IP interface of the receiving apparatus in the output step is a severer copy control state for output than a copy control state in a case of performing digital audio output by decoding the audio signal of the content at the receiving apparatus in the output step.

8. The content protection method according to claim 7, further comprising an accumulation step of accumulating the content received in the reception step,
wherein the output step is performed for a content accumulated in the accumulation step.

9. A broadcast receiving apparatus capable of receiving a broadcasting wave including a signal of each sound source, the broadcast receiving apparatus comprising:
a broadcast receiver configured to receive the broadcasting wave;
a transmitter configured to transmit an audio signal to an audio output device including a plurality of speakers based on the signal of each sound source included in the received broadcasting wave; and
a controller,
wherein the controller
acquires a sound field characteristic that is an acoustic characteristic in an audio recording location of the sound source based on information included in the broadcasting wave,
generates a signal of a reverberant sound of each sound source based on the signal of each sound source and the sound field characteristic, and
generates a signal of a reverberant sound added audio in which the reverberant sound is added to audio of the signal of each sound source based on the signal of each sound source and the signal of the reverberant sound of each sound source, and
wherein the transmitter transmits the signal of the reverberant sound added audio as the audio signal to the audio output device.

10. The broadcast receiving apparatus according to claim 9,
wherein the controller acquires the sound field characteristic from the information included in the broadcasting wave.

11. The broadcast receiving apparatus according to claim 9, further comprising a communication unit configured to receive data via a network,
wherein the controller specifies the recording location based on the information included in the broadcasting wave, and acquires the sound field characteristic of the recording location from a server via the network through the communication unit.

12. The broadcast receiving apparatus according to claim 9,
wherein the controller
receives a specified listening position in the recording location, and
generates the signal of the reverberant sound added audio such that the reverberant sound added audio is close to audio in a case where the audio of each sound source is listened to at the listening position.

13. The broadcast receiving apparatus according to claim 12,
wherein the controller changes the listening position in accordance with a partially enlarged display operation of a broadcast image.

14. The broadcast receiving apparatus according to claim 9,
wherein the controller generates the signal of the reverberant sound added audio such that the reverberant sound added audio is corrected based on a head-related transfer characteristic of a viewer.

15. The broadcast receiving apparatus according to claim 9,
wherein the recording location is a hall or a theater.

16. The broadcast receiving apparatus according to claim 9,
wherein the audio output device is a headphone or a head-mounted display.

17. A reverberant sound addition processing method in a broadcast receiving apparatus capable of receiving a broadcasting wave including a signal of each sound source, the method comprising:
receiving the broadcasting wave;
acquiring a sound field characteristic that is an acoustic characteristic in an audio recording location of the sound source based on information included in the received broadcasting wave;
generating a signal of a reverberant sound of each sound source based on the signal of each sound source and the sound field characteristic; and
generating a signal of a reverberant sound added audio in which the reverberant sound is added to audio of the signal of each sound source based on the signal of each sound source and the signal of the reverberant sound of each sound source.

18. A broadcast receiving apparatus capable of receiving an object-based signal or a Higher Order Ambisonics (HOA) method signal via a broadcasting wave, the broadcast receiving apparatus comprising:
a broadcast receiver configured to receive the broadcasting wave;
a transmitter configured to transmit, to an audio output unit, an audio signal generated in accordance with the object-based signal or the HOA method signal included in the broadcasting wave received by the broadcast receiver; and
a controller,
wherein the controller converts the object-based signal or the HOA method signal into the audio signal to be transmitted to the audio output unit according to arrangement information of the audio output unit.

19. The broadcast receiving apparatus according to claim 18,
wherein the audio output unit is any of an earphone, a headphone, and a head mounted display (HMD).

20. The broadcast receiving apparatus according to claim 18,
wherein the arrangement information is output from the audio output unit and input to the broadcast receiving apparatus.

21. The broadcast receiving apparatus according to claim 18,
wherein the arrangement information includes an azimuth angle formed by a front direction of a face of a user wearing the audio output unit and a screen center direction of the broadcast receiving apparatus.

22. The broadcast receiving apparatus according to claim 21, further comprising an operation input unit configured to input a control signal from a remote controller,
wherein the user can set whether the azimuth angle is fixed or variable using the remote controller.

23. The broadcast receiving apparatus according to claim 22,
wherein an angle in a case where the azimuth angle is fixed is zero degrees.

24. The broadcast receiving apparatus according to claim 22,
wherein an azimuth angle setting mode in which the front direction of the face of the user wearing the audio output unit is newly set to newly set the azimuth angle in a case where the azimuth angle is variable is provided.

25. The broadcast receiving apparatus according to claim 24,
wherein the azimuth angle setting mode is set from the remote controller or the audio output unit.

26. A controlling method of a broadcast receiving apparatus capable of receiving an object-based signal or a Higher Order Ambisonics (HOA) method signal via a broadcasting wave, the method comprising:
a broadcast reception step of receiving the broadcasting wave;
a transmission step of transmitting, to an audio output unit, an audio signal generated in accordance with the object-based signal or the HOA method signal included in the broadcasting wave received in the broadcast reception step; and
a control step of converting the object-based signal or the HOA method signal into the audio signal to be transmitted to the audio output unit according to arrangement information of the audio output unit.
